(19) United States
(12) Patent Application Publication
(10) Pub. No.: US 2013/0214909 A1
(43) Pub. Date: Aug. 22, 2013

(54) AIRPLANE MODE FOR WIRELESS TRANSMITTER DEVICE AND SYSTEM USING SHORT-RANGE WIRELESS BROADCASTS

(71) Applicant: QUALCOMM Incorporated, (US)

(72) Inventors: Neville J Meijers, San Diego, CA (US); Stephen A. Sprigg, Poway, CA (US); Charles S. Wurster, San Diego, CA (US); Kevin E. Hunter, La Jolla, CA (US); Leif A. Woodahl, Poway, CA (US); Paul E. Jacobs, La Jolla, CA (US)

(73) Assignee: QUALCOMM Incorporated, San Diego, CA (US)

(21) Appl. No.: 13/833,262

(22) Filed: Mar. 15, 2013

Related U.S. Application Data
(63) Continuation-in-part of application No. 13/773,379, filed on Feb. 21, 2013.
Application No. 13/773,379 is a continuation-in-part of application No. 13/773,336, filed on Feb. 21, 2013.
(60) Provisional application No. 61/601,620, filed on Feb. 22, 2012.
(60) Provisional application No. 61/637,834, filed on Apr. 24, 2012.
(60) Provisional application No. 61/693,169, filed on Aug. 24, 2012.
(60) Provisional application No. 61/670,226, filed on Jul. 11, 2012.
(60) Provisional application No. 61/701,457, filed on Sep. 14, 2012.
(60) Provisional application No. 61/713,239, filed on Oct. 12, 2012.
(60) Provisional application No. 61/716,373, filed on Oct. 19, 2012.
(60) Provisional application No. 61/717,964, filed on Oct. 24, 2012.
(60) Provisional application No. 61/728,677, filed on Nov. 20, 2012.
(60) Provisional application No. 61/745,395, filed on Dec. 21, 2012.
(60) Provisional application No. 61/745,308, filed on Dec. 21, 2012.

(51) Int. Cl. H04H 20/62

(52) U.S. Cl. CPC H04H 20/62
USPC 340/10.5

(57) ABSTRACT

Methods, systems and devices for tracking and handling broadcast devices associated with luggage. A wireless identity transmitter within luggage may periodically transmit wireless broadcast messages that include obscured identifiers. When within proximity, a proximity broadcast receiver, such as a stationary device within an airport, may receive and relay the broadcast messages to a server which may process the included information. Based on decrypting the obscured identifiers, the central server may determine proximity information of devices related to the relayed messages. The proximity broadcast receiver may transmit messages based on whether the wireless identity transmitter should be handled via a luggage service. Additionally, the wireless identity transmitter may activate/deactivate an operational mode for use in an aircraft in response to receiving disable and enable wireless signals from proximate signaling transmitters. After receiving a disable wireless signal, the wireless identity transmitter may not transmit wireless signals until receiving an enable wireless signal.

### RELATED APPLICATIONS

The present application is a continuation-in-part of and claims priority to U.S. patent application Ser. No. 13/733,379, titled “Platform for Wireless Identity Transmitter and System Using Short-Range Wireless Broadcasts,” filed Feb. 21, 2013 and U.S. patent application Ser. No. 13/773,336, titled “Preserving Security By Synchronizing a Nonce or Counter Between Systems,” filed Feb. 21, 2013, each of which claims the benefit of priority to U.S. Provisional Application No. 61/601,620, filed Feb. 22, 2012, U.S. Provisional Application No. 61/637,834, filed Apr. 24, 2012, U.S. Provisional Application No. 61/693,169, filed Aug. 24, 2012, U.S. Provisional Application No. 61/670,226, filed Jul. 11, 2012, U.S. Provisional Application No. 61/701,457, filed Sep. 14, 2012, U.S. Provisional Application No. 61/713,239, filed Oct. 12, 2012, U.S. Provisional Application No. 61/716,373, filed Oct. 19, 2012, U.S. Provisional Application No. 61/717,964, filed Oct. 24, 2012, U.S. Provisional Application No. 61/728,677, filed Nov. 20, 2012, and U.S. Provisional Application No. 61/745,395, filed Dec. 21, 2012, U.S. Provisional Application No. 61/745,308, filed Dec. 21, 2012, the entire contents of all of which are hereby incorporated by reference.

### BACKGROUND

Cellular and wireless communication devices have seen explosive growth over the past several years. This growth has been fueled by better communications hardware, larger networks, and more reliable protocols. Today's smartphones include cameras, GPS receivers, Bluetooth® transceivers, and of course the cellular communication capabilities (e.g., LTE, 3G and/or 4G network access) to enable the devices to establish data communication links with the Internet. Smartphones are now very widely deployed in society. Additionally, the components and capabilities in smartphones are now very affordable, enabling the capabilities to be deployed in other types of devices.

Numerous solutions have been proposed to facilitate tracking or locating persons or assets leveraging cellular and wireless devices. Most of these systems involve the development of a wearable device that communicates the position of the wearer to a server. Others involve establishment of a radio connection between the wearer and a cellular device. In both cases, these systems suffer from issues of cost, effectiveness and practicality, which limit their viability.

Additionally, tracking luggage through airports is often difficult and inconvenient. Many times, travelers wait at a baggage claim area without knowing whether the luggage has arrived or where their luggage is within the claim area. For example, luggage may be given to an airport employee (e.g., a bag handler) only for it to be misplaced or forgotten. So, tracking luggage with wireless transmissions, in a similar manner to tracking packages as they are delivered via postal services, may be a good solution for travelers. However, devices that transmit wireless signals may be restricted while on an airplane, and thus travelers may not have a convenient way to wirelessly track luggage.

### SUMMARY

The various embodiments provide systems, devices, and methods for tracking and handling luggage based on proximity of wireless devices. In general, a compact wireless identity transmitter associated with a user may be configured to broadcast messages that include a unique and secure identification code via a short-range wireless radio, such as a Bluetooth® Low Energy (LE) transceiver. In various embodiments, the wireless identity transmitter may be affixed to or placed within an asset, such as a piece of carry-on baggage, a trunk, a suitcase, a container, and/or clothing. The identification broadcast packets (“broadcast messages”) may be received by physically proximate proximity broadcast receivers (PBR), which may be dedicated receivers, smartphones configured with a PBR application, tablet computers configured with a PBR application, and stationary receivers, to name just a few examples. The broadcast messages may be received by proximity broadcast receivers when the wireless identity transmitter is within reception range (e.g., within 0 to 25 feet). Proximity broadcast receivers may be mobile (e.g., smartphones configured with a PBR application) or stationary. Stationary proximity broadcast receivers may be positioned in within an airport, such as within a concessions stand, a conveyor belt, and/or a boarding gate, or other arbitrary places, such as movie theaters, malls, houses, vehicles, or retail stores. Because the wireless identity transmitter broadcasts short-range wireless signals, the location of the wireless identity transmitter may be approximately the location of the proximity broadcast receiver receiving the broadcast signals. Proximity broadcast receivers may relay received broadcast messages, along with other information (e.g., timestamp data, proximity information, etc.), to a central server in the form of sighting messages. Such a central server may use the information received in sighting messages to track the wireless identity transmitter, and thus a user associated with that device.

The central server may maintain a database of relayed information that may represent both historical and actively updated information for the wireless identity transmitter, such as proximities to proximity broadcast receivers and/or predefined areas over a period. The central server may use the identification code within the relayed messages to identify the wireless identity transmitter, and thus the user associated with the device. In this way, when the wireless identity transmitter is affixed to or otherwise collocated with a tracked item (e.g., lost, stolen, or searched for items), the central server may locate the item based on messages received from proximity broadcast receivers. Based on sightings by proximity broadcast receivers within the airport, real-time proximity information of such wireless identity transmitters (and thus the luggage) may be transmitted to users associated with the luggage. For example, a traveler may receive a SMS text message from the central server indicating that a suitcase with an included wireless identity transmitter has arrived at a baggage claim conveyor. Additionally, proximity broadcast receivers within the airport may receive messages from the central server and perform operations to process proximate luggage associated with luggage services. For example, a proximity broadcast receiver may transmit a message to a baggage handler's mobile device instructing a piece of luggage to be removed from a conveyor and to a van for delivery to a home address.

In another embodiment, a wireless identity transmitter may be configured to operate in various states of an airplane mode that manages the wireless identity transmitter's ability to broadcast wireless signals. The wireless identity transmitter may normally operate in a “deactivated” airplane mode that does not restrict the broadcast of wireless signals. However, in response to receiving special signals from proximate transmitter devices, the wireless identity transmitter may be configured to operate in an “activated” airplane mode that prohibits the broadcast of wireless signals. The activated airplane mode may be important in order to automatically configure wireless identity transmitters to comply with Federal Aviation Administration regulations that forbid certain in-flight transmissions.

Further, deactivation signaling transmitters may be configured to transmit disable wireless signals that cause wireless identity transmitters to enter the activated airplane mode and suspend broadcasting wireless transmissions. Similarly, activation signaling transmitters may be configured to transmit enable wireless signals that cause wireless identity transmitters to enter the deactivated airplane mode and resume broadcasting wireless transmissions. Such signaling transmitters may be stationed at strategic locations within the airport, such as near luggage conveyor belts, in luggage sorting facilities, in or near doorways leading to the tarmac, within luggage carts that carry luggage to and from aircraft, and/or within aircraft. For example, deactivation signaling transmitters may be located within a portal area where travelers go towards an aircraft, and activation signaling transmitter may be located in baggage claim areas where luggage is deposited after passengers deplane the aircraft.

In another embodiment, proximity broadcast receivers may receive scripts from a central server in response to receiving broadcast messages from wireless identity transmitters. Based on identifiers within sighting messages, the central server may identify stored profiles associated with wireless identity transmitters and determine conditions that define how proximity broadcast receivers may operate when within proximity of the wireless identity transmitters. The central server may generate scripts that include commands, actions, or instructions for proximity broadcast receivers to execute based on such conditions. For example, a smartphone configured to operate as a proximity broadcast receiver may receive a script that configures the smartphone to operate in a silent mode when within a concert hall. In another embodiment, the central server may generate scripts based on the conditions related to wireless identity transmitters as well as profiles associated with the proximity broadcast receivers. For example, a script may include commands for a proximity broadcast receiver to only enter a silent mode for a few minutes instead of a longer period due to stored preferences associated with the proximity broadcast receiver.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system diagram illustrating network components suitable for use in various embodiments.

FIG. 2 is a communication system diagram illustrating network components of embodiment architectures suitable for use in various embodiments.

FIG. 3 is a process flow diagram illustrating an embodiment method for broadcasting an identifier from a wireless identity transmitter.

FIG. 4 is a process flow diagram illustrating an embodiment method for a wireless identity transmitter receiving configuration settings after performing boot-up operations.

FIG. 5 is a process flow diagram of an embodiment method for a wireless identity transmitter performing two-way wireless communications with a proximity broadcast receiver.

FIG. 6 is a component diagram illustrating various modules within a mobile proximity broadcast receiver suitable for use in various embodiments.

FIG. 7 is a process flow diagram illustrating an embodiment method of a mobile proximity broadcast receiver relaying a wireless identity transmitter's identifier along with other data such as a time or location.

FIG. 8 is a call flow diagram for responding to a user request for a wireless identity transmitter's location in accordance with various embodiments.

FIG. 9 is a process flow diagram illustrating an embodiment method of performing code within a received broadcast message.

FIG. 10 is a process flow diagram illustrating an embodiment method of receiving an instruction from a central server in response to transmitting a sighting message based on proximity to a wireless identity transmitter.

FIG. 11A is a process flow diagram illustrating an embodiment method for a proximity broadcast receiver relaying a received broadcast message to and receiving a return message from a central server.

FIG. 11B is a process flow diagram illustrating an embodiment method for a proximity broadcast receiver indicating proximity to a wireless identity transmitter.

FIG. 12 is a component diagram illustrating various modules within a central server suitable for use in various embodiments.

FIG. 13 is a diagram illustrating a wireless identity transmitter registration process for use in various embodiments.

FIGS. 14A and 14B are process flow diagrams illustrating embodiment methods for a central server to process sighting messages received from proximity broadcast receivers.

FIGS. 15A-B are call flow diagrams illustrating communications between a wireless identity transmitter, a proximity broadcast receiver, and a central server in accordance with various embodiments.

FIG. 16 is a process flow diagram illustrating an embodiment method for a central server receiving sighting messages from a proximity broadcast receiver and transmitting return messages including various data.

FIG. 17 is a process flow diagram illustrating an embodiment method for a central server determining whether a proximity broadcast receiver has lost a wireless identity transmitter.

FIGS. 18A and 18C are communication system diagrams of mobile proximity broadcast receivers in communication with a wireless identity transmitter.

FIGS. 18B and 18D are process flow diagrams illustrating embodiment methods for determining the location of the wireless identity transmitter in the communication systems illustrated in FIGS. 18A and 18C, respectively.

FIG. 19 is a process flow diagram illustrating an embodiment method for a server handling a rolling identifier.

FIG. 20 is a process flow diagram illustrating embodiment operations by a wireless identity transmitter and a central server for transmitting and processing rolling identifiers encrypted with an encryption algorithm.

FIG. 21A is a process flow diagram illustrating an embodiment method for a wireless identity transmitter generating and broadcasting rolling identifier payloads using an encryption algorithm.

FIG. 21B a process flow diagram illustrating an embodiment method for a central server receiving and handling rolling identifier payloads using an encryption algorithm.

FIG. 22 is a process flow diagram illustrating embodiment operations by a wireless identity transmitter and a central server for transmitting and processing rolling identifiers using a pseudo-random function.

FIG. 23A is a process flow diagram illustrating an embodiment method for a wireless identity transmitter generating and broadcasting rolling identifier payloads using a pseudo-random function.

FIG. 23B a process flow diagram illustrating an embodiment method for a central server receiving and handling rolling identifier payloads using a pseudo-random function.

FIG. 24A is a process flow diagram illustrating an embodiment method for a wireless identity transmitter generating and broadcasting messages with rolling identifiers and encoded nonces or counters.

FIGS. 24B-24C are process flow diagrams illustrating embodiment methods for a central server receiving and handling messages including rolling identifiers and encoded nonces or counters.

FIG. 25A is a process flow diagram of an embodiment method for a proximity broadcast receiver transmitting messages in association with a luggage service.

FIG. 25B is a process flow diagram of an embodiment method for a central server performing operations in response to receiving a sighting message from a proximity broadcast receiver related to a luggage service.

FIG. 26A is a diagram showing a deactivation signaling transmitter broadcasting a disable wireless signal that instructs a wireless identity transmitter to operate in a mode in which the wireless identity transmitter is disabled from transmitting wireless signals.

FIG. 26B is a diagram showing an activation signaling transmitter broadcasting an enable wireless signal that instructs a wireless identity transmitter to operate in a mode in which the wireless identity transmitter is enabled to transmit wireless signals.

FIG. 27 is a process flow diagram of an embodiment method for configuring a wireless identity transmitter to stop transmitting wireless signals (e.g., broadcast messages) in response to receiving a disable wireless signal.

FIGS. 28-30 are process flow diagrams of embodiment methods for configuring a wireless identity transmitter to disable transmitting wireless signals in response to receiving a disable wireless signal and enable transmitting wireless signals in response to receiving a subsequent enable wireless signal.

FIG. 31 is a process flow diagram of an embodiment method for a signaling transmitter to broadcast disable wireless signals and/or enable wireless signals in response to receiving an input.

FIG. 32 is a process flow diagram of an embodiment method for a signaling transmitter re-broadcasting disable wireless signals and/or enable wireless signals based on receiving broadcast messages from proximate wireless identity transmitters.

FIG. 33 is a process flow diagram of an embodiment method for a proximity broadcast receiver performing scripts in response to receiving broadcast messages from a proximate wireless identity transmitter.

FIG. 34 is a process flow diagram of an embodiment method for a central server transmitting scripts to a proximity broadcast receiver in response to receiving sighting messages indicating wireless identity transmitter identifiers.

FIGS. 35A-35B are component block diagrams of wireless identity transmitters in accordance with various embodiments.

FIGS. 36A-36B are component block diagrams of proximity broadcast receivers in accordance with various embodiments.

FIG. 37 is a component block diagram of a mobile device suitable for use in various embodiments.

FIG. 38 is a component block diagram of a server device suitable for use in various embodiments.

FIG. 39 is a component block diagram of a signaling transmitter device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile device” is used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with a short-range radio (e.g., a Bluetooth® radio, a Peanut® radio, a WiFi radio, etc.) and a wide area network connection (e.g., an LTE, 3G or 4G wireless wide area network transceiver or a wired connection to the Internet). Reference to a particular type of computing device as being a mobile device is not intended to limit the scope of the claims unless a particular type of mobile device is recited in the claims.

The term “broadcast message” is used herein to refer to short-range wireless broadcast signals broadcast by wireless identity transmitters (defined below) that may include identification information (i.e., identifiers) associated with the wireless identity transmitters and/or their users. Such identifiers may be periodically changed and encrypted, encoded, or otherwise obscured (i.e., rolling identifiers). In various embodiments, broadcast messages may include other identifying information, such as Bluetooth® MAC addresses and nonces or counters, which may also be encrypted. Additionally, broadcast messages may include metadata and other data, such as characteristics of the transmitting wireless identity transmitter (e.g., device type), sensor data, and/or commands or other instructions. In various embodiments, broadcast messages may be transmitted via a wireless communication protocol, such as Bluetooth® Low Energy, WiFi, WiFi Direct, Zigbee®, Peanut®, and other RF protocol. In various embodiments, because of the high unreliability of certain short-range transmission channels, broadcast messages may be single packet transmissions limited to a certain size (e.g., 80 bits, 10 bytes, 20 bytes, etc.). For example, the payload of an embodiment broadcast message may be 80 total bits, including 4 bits that indicate battery status information and 76 bits that indicate a rolling identifier. As another example, an embodiment broadcast message may include 20 bits representing a nonce or counter and 60 bits representing a rolling identifier, such as generated with a pseudo-random function or encryption algorithm.

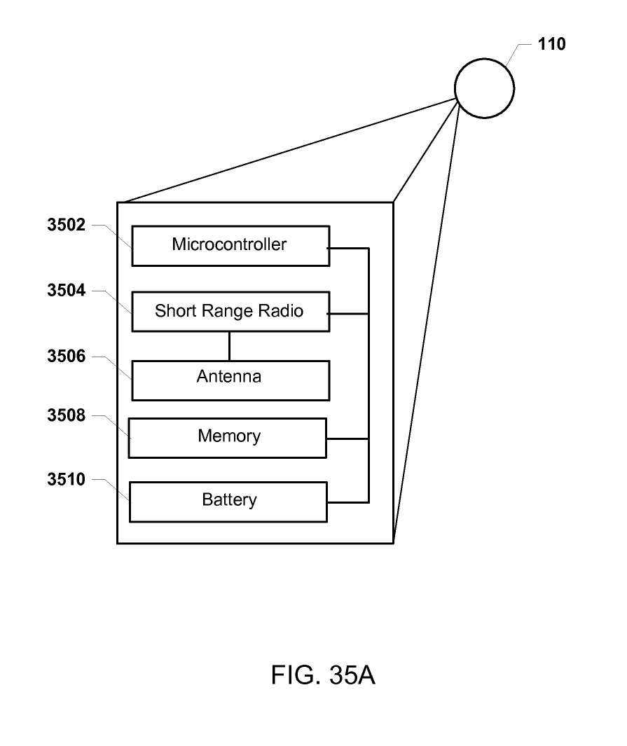

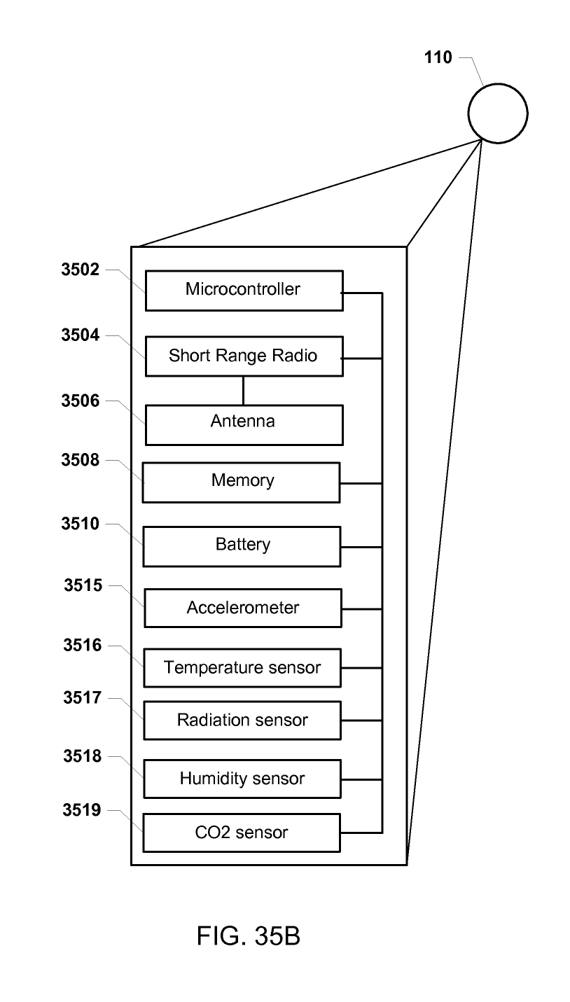

The term “wireless identity transmitter” is used herein to refer to a compact device configured to periodically transmit broadcast messages via short-range wireless transmitters. Wireless identity transmitters may be mobile, such as when carried or affixed to mobile persons or items, or alternatively may be stationary, such as when installed within buildings. Wireless identity transmitters may store and be associated with a unique device identifier (i.e., a “deviceID”), such as a factory ID. In an embodiment, the unique device identifier may be a code 56-bits in length. In various embodiments, for security purposes, this unique device identifier, along with other data (e.g., nonce or counter values), may be encoded, encrypted, or otherwise obfuscated when included within broadcast messages as a “rolling identifier.” Wireless identity transmitters may be configured to maintain inaccurate time (e.g., UTC) information, such as by using a 30 ppm 16 kHz crystal oscillator as a clock. In an embodiment, the wireless identity transmitter may be within or a mobile device, or alternatively, operations may be performed by a mobile device that are similar to the operations of the wireless identity transmitter. For example, a smartphone may execute software that configures that smartphone to utilize its Bluetooth® radio to transmit broadcast messages that include a secured, unique identifier. Wireless identity transmitters are described in more detail below with reference to FIGS. 35A-35B. In various figures and diagrams of this disclosure, wireless identity transmitters may be referred to as “WIT” or “WITs”.

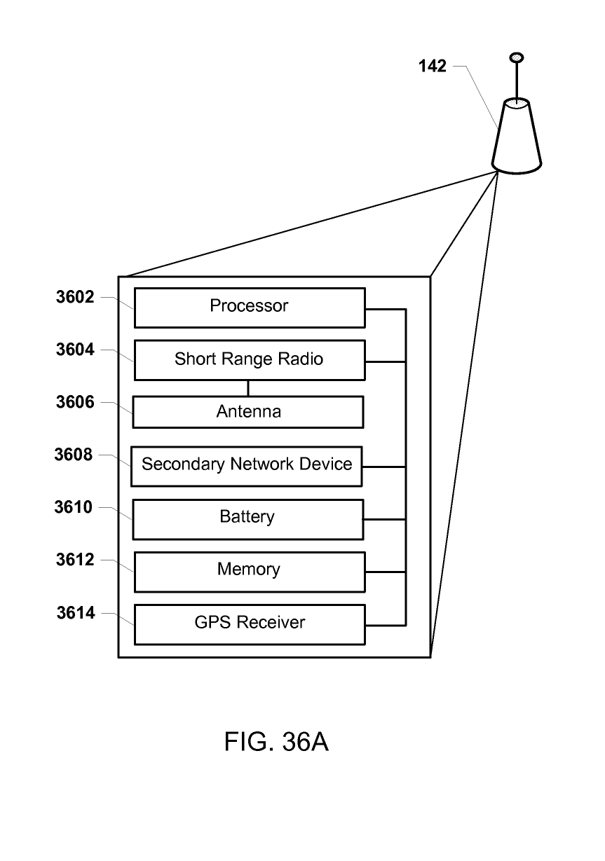

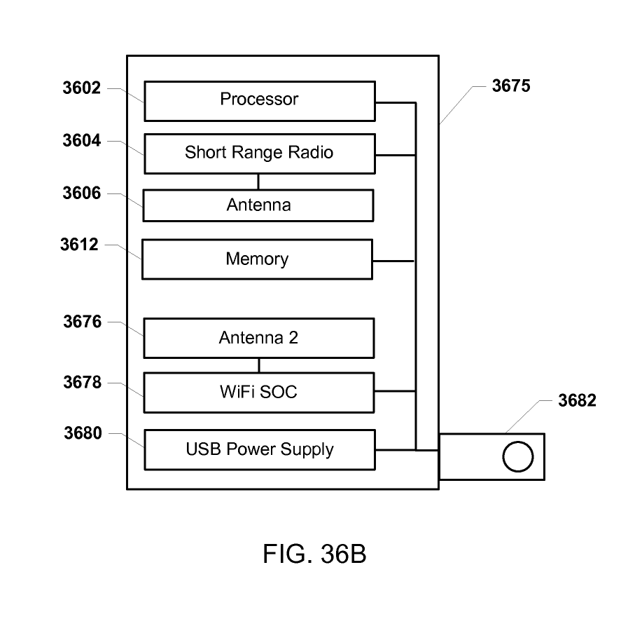

The term “proximity broadcast receiver” is used herein to refer to devices that are configured to receive broadcast messages, such as transmitted by wireless identity transmitters. In various embodiments, proximity broadcast receivers may be stationary devices (or “stationary proximity broadcast receivers”) permanently positioned throughout places (e.g., buildings, retail stores, etc.) or alternatively may be mobile devices configured to operate as proximity broadcast receivers (or “mobile proximity broadcast receivers”). For example, a smartphone may be configured to receive broadcast messages and operate as a mobile proximity broadcast receiver. Reference to a particular type of computing device as being a proximity broadcast receiver is not intended to limit the scope of the claims unless a particular type of device is recited in the claims. Further, unless otherwise indicated, references to proximity broadcast receivers throughout this disclosure are not intended to limit any method or system to a particular type of proximity broadcast receiver device (e.g., wireless or stationary). Proximity broadcast receivers are described in more detail below with reference to FIGS. 36AA-36B. In various figures and diagrams of this disclosure, proximity broadcast receivers may be referred to as “PBR” or “PBRs,” and mobile proximity broadcast receivers are referred to in the figures as “MPBR” or “MPBRs.”

The terms “identity transceiver” and “wireless identity transceiver” are used herein to refer to devices that are configured to receive and transmit broadcast messages. In other words, an identity transceiver may function as both a proximity broadcast receiver and an identity transmitter. For example, a smartphone may be configured to broadcast short-range signals that include its unique identifier as well as receive broadcast messages from wireless identity transmitters within proximity. Throughout this disclosure, various operations may be described as being distinctly performed by either a wireless identity transmitter or a proximity broadcast receiver, however, those skilled in the art should appreciate that a device configured to operate as an identity transceiver may be configured to perform any or all of the same operations and thus may be interchangeable with references to either a wireless identity transmitter or a proximity broadcast receiver.

The term “sighting message” is used herein to refer to reports, signals, and/or messages sent by proximity broadcast receivers to a central server in response to receiving broadcast messages from wireless identity transmitters. Sighting messages may be transmissions that include part or all of the information encoded in received broadcast messages, including any obscured or encrypted information, such as identifiers of wireless identity transmitters. Additionally, sighting messages may include metadata and other information (or “associated data”), such as the sending proximity broadcast receivers' identification information (e.g., device ID, third-party affiliations, etc.), whether the proximity broadcast receiver paired with a wireless identity transmitter, transmissions context information (e.g., a code indicating the sighting message is related to an alert or a registered service), information regarding software or applications executing on proximity broadcast receivers (e.g., app IDs), location information, proximity information with respect to known areas within a place, and timestamp data. In an embodiment, sighting messages may also include authentication information (e.g., secret keys, passes, special codes, digital certificates, etc.) that may be used by a central server to confirm the identification (or identification information) of proximity broadcast receivers transmitting the sighting messages. For example, a sighting message may include a code from a hash function that can be decoded by the central server to ensure the sending proximity broadcast receiver is associated with a particular registered service. In various embodiments, sighting messages may be sent immediately after receipt of broadcasts (e.g., when related to an alert), buffered, or scheduled along with other scheduled transmissions.

The various embodiments provide systems, devices, and methods for tracking and handling items of interest, such as luggage, and controlling mobile device behaviors, settings or functionality based on the proximity of wireless devices to particular locations. The wireless identity transmitter may be a compact device configured to transmit a packet with a secured identification code (i.e., a rolling identifier) in a format that can be received by any proximity broadcast receiver within range of the short-range wireless broadcast. Since the wireless identity transmitter relies on relatively short-range wireless signaling (e.g., short-range radio signals, Peanut®, Zigbee®, RF, WiFi, Bluetooth® Low Energy signals, light signals, sound signals, etc.) to transmit broadcast messages that include its identifier, only proximity broadcast receivers within proximity of the transmitter may receive such broadcast messages. Thus, a proximity broadcast receiver's own location may provide an approximate location for the wireless identity transmitter at the time of receipt of a broadcast message. Wireless identity transmitters may be deployed by various parties registered with the central server, such as travelers, government agencies, merchants, retailers, and stores. In an embodiment, the broadcast range of wireless identity transmitters may be from three or less to one hundred feet while within a building.

Proximity broadcast receivers, in particular mobile proximity broadcast receivers (e.g., smartphones, etc.), may be configured with processor-executable instructions, such as an application that users may download or that may be incorporated in the device by the manufacturer. By configuring many mobile devices with such an application, a wide spread network of proximity broadcast receivers may be deployed for little or no cost, taking advantage of the popularity of smartphones. Stationary proximity broadcast receivers may be deployed in various places, such as throughout retail stores or airports, to supplement the network of smartphones. For example, proximity broadcast receivers may be located coincident to, within, or otherwise within proximity of predefined areas within a place, such as conveyor belts in a terminal or gate walkways in an airport.

Each proximity broadcast receiver receiving a broadcast message from the wireless identity transmitter may pass information to a central server for processing, such as by transmitting sighting messages including the rolling identifier of the wireless identity transmitter. Sighting messages transmitted by proximity broadcast receivers to the central server may include part or all of the information encoded in received broadcast messages from proximate wireless identity transmitters, including any rolling, obscured, or encrypted information related to the wireless identity transmitters. In various embodiments, sighting messages may be sent immediately after receipt of broadcast message (e.g., when related to an alert), buffered, scheduled along with other scheduled transmissions, or otherwise based on characteristics of broadcast message. Sighting messages may include metadata, header information, or other encodings to indicate various reported data. For example, a sighting message may contain metadata that includes a code for a particular merchant, and may therefore indicate that the sighting message was transmitted by a proximity broadcast receiver within the merchant's store. As another example, a sighting message may contain metadata that includes a code indicating a user's smartphone and therefore the proximity broadcast receiver may be a mobile proximity broadcast receiver belonging to the user. In an alternative embodiment, intermediate devices, such as a local router, server, or other computing device, may receive sighting messages from proximity broadcast receivers and may in turn pass each sighting message to the central server.

Upon receipt of sighting messages, the central server may decode, decrypt, or otherwise access obscured information (e.g., rolling identifiers) within the sighting messages. For example, the central server may decode a broadcast message within a sighting message and determine the user associated with the broadcast message using data stored within a registration database. Based on the location of a proximity broadcast receiver that transmitted a sighting message, the central server may determine the proximity of the related broadcast message, or the approximate proximity. For example, since a stationary proximity broadcast receiver that transmits a sighting message is within proximity of a user's wireless identity transmitter at the time of receiving a broadcast message, the central server may determine the user's wireless identity transmitter is within several feet of the GPS coordinates indicated in the proximity broadcast receiver's sighting message or known to the central server in the case of fixed proximity broadcast receivers.

Further, the central server may be configured to perform various operations in response to receiving and processing sighting messages. For example, the central server may transmit return messages to devices associated with an airport or other third-party (e.g., a merchant or retailer), such as a local server, a mobile device or other computing device used by an employee (e.g., a tablet device used by a baggage handler/customer service rep, etc.), and/or a proximity broadcast receiver (e.g., a stationary proximity broadcast receiver within a baggage claim area that relayed a broadcast message from a wireless identity transmitter within a suitcase).

With the above described framework, various embodiments may be used to track and handle luggage associated with wireless identity transmitters. Users registered with a central server may associate wireless identity transmitters with luggage, such as cargo trunks, suitcases and carry-on bags, so that approximate proximities of the luggage may be obtained from the central server. In particular, the central server may transmit messages that indicate the most recent (or last reported) proximity information of wireless identity transmitters associated with luggage. For example, the central server may transmit new proximity information to a user's smartphone in response to receiving sighting messages from proximity broadcast receivers near the user's luggage within an airport. The central server may continually receive updated proximity information (e.g., nearby GPS coordinates) of wireless identity transmitters associated with luggage as the luggage is moved through various areas of an airport that include proximity broadcast receivers. The central server may transmit updated proximity information to the users associated with the luggage. For example, upon arriving at a destination airport, a user may use an app executing on a smartphone to request updated proximity information of a wireless identity transmitter within his/her carry-on bag that was placed underneath an airplane before a flight. In various embodiments, such messages may be transmitted automatically or in response to the central server receiving a request for updated information.

In an embodiment, proximity broadcast receivers may be associated with a luggage service that is known to the central server. The luggage service may be a program that users may opt-in to, sign up for, or otherwise register to participate in that may initiate actions to process luggage within an airport. In response to receiving a message from the central server indicating a proximate wireless identity transmitter is related to the luggage service, a proximity broadcast receiver may initiate various actions within the airport, such as transmitting instructions to baggage handlers to move luggage associated with the wireless identity transmitter. The proximity broadcast receiver may also announce when wireless identity transmitters are within proximity, such as by rendering audio samples to indicate a bag is to be handled according to the luggage service. In an embodiment, the proximity broadcast receiver may transmit a message that instructs the proximate luggage to be delivered to an address associated with a registered user. For example, the message may instruct a customer service representative to place a suitcase on a delivery van for delivery to a specific home address. In another embodiment, proximity broadcast receivers may be used to prohibit luggage with wireless identity transmitters from being within particular areas, such as reserved or secure areas within a terminal.

In an embodiment, wireless identity transmitters may also be configured to receive incoming transmissions from proximity broadcast receivers. Incoming transmissions may include firmware updates or upgrades, software instructions, configuration information, and other data to adjust the behavior of the wireless identity transmitters. Wireless identity transmitters may be configured (or scheduled) to selectively receive incoming transmissions based on clock signals, user input data (e.g., button press), or received signals. For example, a trigger signal received from a proximity broadcast receiver may instruct a wireless identity transmitter to activate its receiver for receiving subsequent messages.

Accordingly, a wireless identity transmitter may be configured to operate in an acceptable manner while within an aircraft (i.e., an airplane) based on received signals from proximate signaling transmitters. In particular, as wireless transmissions may be restricted in airplanes and/or airports, the wireless identity transmitter may perform operations to receive wireless signals that disable and enable the wireless identity transmitter from broadcasting or otherwise transmitting signals. For example, when luggage passes through a baggage check-in or sorting area within a terminal, the wireless identity transmitter within the luggage may receive a disable wireless signal that causes the wireless identity transmitter to stop broadcasting identification packets, making the luggage compliant with in-flight regulations and thus safe to be loaded onto the aircraft. Upon arriving at the passenger's destination, the luggage may pass by or through a luggage sorting or claim area and may receive enable wireless signals that enables to wireless identity transmitter to resume transmitting broadcast messages.

The wireless identity transmitter may be configured to periodically listen for incoming disable and enable wireless signals from signaling transmitters. If the wireless identity transmitter receives a disable wireless signal when listening for incoming messages, the wireless identity transmitter may be configured to operate in an “activated” airplane mode during which the wireless identity transmitter may not transmit wireless signals but may still continually listen for incoming messages. In other words, while configured to operate in activated airplane mode (e.g., once a disable wireless signal has been received), the wireless identity transmitter may not transmit any broadcast messages until an incoming enable wireless signal is received. For example, while listening for an enable wireless signal, the wireless identity transmitter may not transmit broadcast messages that include secured identifiers (e.g., rolling identifiers). However, when an enable wireless signal is received while the airplane mode is activated, the wireless identity transmitter may return to a normal operational mode in which broadcast messages may be transmitted (i.e., airplane mode may be deactivated). In an embodiment, the wireless identity transmitter may listen for incoming messages (e.g., disable wireless signals, enable wireless signals, other communications, etc.) after a predefined period elapses, such as every few minutes (e.g., five minutes), and may listen for incoming messages for a predefined period, such as a few seconds.

In an embodiment, a wireless identity transmitter may propagate received disable wireless signals and/or enable wireless signals. In particular, after receiving a disable and/or enable wireless signal, the wireless identity transmitter may periodically broadcast the received signal for a propagation period such that other wireless identity transmitters within proximity may receive the signal as well. The wireless identity transmitter may broadcast a received disable wireless signal during a disable wireless signal propagation period (or a “DTX propagation period”) that may occur in response to receiving the disable wireless signal and prior to the wireless identity transmitter disabling its transmitter (e.g., a Bluetooth LE radio). Likewise, the wireless identity transmitter may broadcast a received enable wireless signal during an enable wireless signal propagation period (or an “ETX propagation period”) that may occur after the wireless identity transmitter re-enables its transmitter in response to receiving the enable wireless signal.

In another embodiment, enable and/or disable wireless signals may include various software instructions that may be executed by wireless identity transmitters when such signals are received. For example, a received enable wireless signal may include, instructions directing the receiving wireless identity transmitter to cancel a sleep cycle or routine, and a received disable wireless signal may include instructions directing the receiving wireless identity transmitter to cancel a broadcasting cycle or routine. In an embodiment, wireless identity transmitters may be configured to execute concurrent cycles, circuitry, or routines that enable the wireless identity transmitters to sleep, wake, and broadcast messages as well as monitor for incoming disable and/or enable wireless signals. Based on incoming (or received) disable and/or enable wireless signals, wireless identity transmitters may activate or deactivate the cycles, circuitry, or routines that enable the wireless identity transmitters to sleep, wake, and broadcast messages or signals.

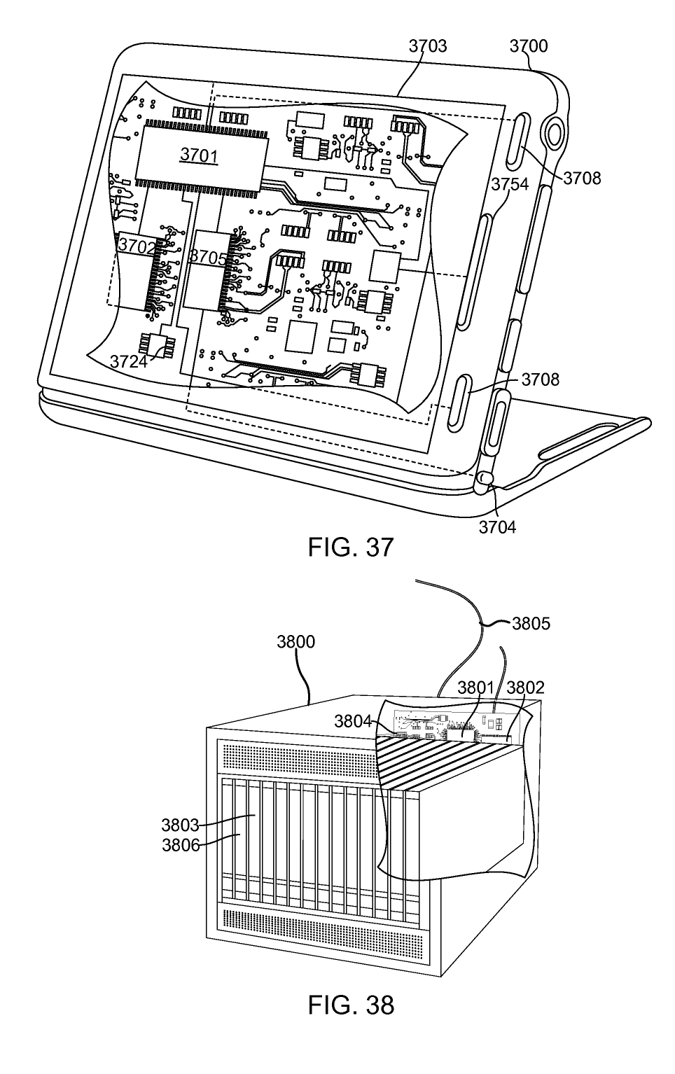

Disable and enable wireless signals may be transmitted via short-range transmissions by signaling transmitters positioned throughout a place, such as a terminal, a gate, a baggage handling area, an aircraft, and/or travel paths (e.g., doorways, halls, ramps, conveyor belts, etc.). Deactivation signaling transmitters may be configured to broadcast disable wireless signals, and activation signaling transmitters may be configured to broadcast enable wireless signals. For example, a deactivation signaling transmitter may broadcast disable wireless signals within the cargo hold of an airplane and an activation signaling transmitter may broadcast enable wireless signals near a conveyor belt taking luggage to a baggage claim area. Those skilled in the art should appreciate that a single device with short-range wireless broadcasting capabilities (e.g., a Bluetooth LE radio) may be configured to operate as both a deactivation signaling transmitter and an activation signaling transmitter. For example, a signaling transmitter (i.e., a proximity broadcast receiver) as described below with reference to FIG. 37 may be configured to perform operations to transmit disable signals and/or enable wireless signals, as well as continue to process incoming broadcast messages from proximate wireless identity transmitters. Thus, any references to deactivation signaling transmitters and/or activation signaling transmitters may be for the purpose of descriptive clarity of the various signaling embodiments.

In various embodiments, deactivation signaling transmitters and/or activation signaling transmitters may be activated or otherwise configured to transmit short-range wireless signals (e.g., disable and/or enable wireless signals) in response to user input. For example, a deactivation signaling transmitter may broadcast disable wireless signals in response to a user pressing a button on the transmitter. Alternatively, sensor data, such as accelerometer or altimeter sensor data, may trigger the broadcast of disable and/or enable wireless signals. For example, a proximity broadcast receiver located within an airplane and configured to operate as a deactivation signaling transmitter may begin broadcasting disable wireless signals in response to an accelerometer detecting movement of the aircraft, such as when the aircraft begins taxiing, or from an altimeter sensor detecting a change in altitude indicating that the airplane has taken off. As another example, accelerometer data indicating the airplane has landed may be used as an indication that an activation signaling transmitter should begin broadcasting enable wireless signals.

For the purpose of illustration, a proximity broadcast receiver (i.e., a device capable of receiving and relaying short-range wireless broadcast messages) may also be configured to operate as both a deactivation signaling transmitter and an activation signaling transmitter. In other words, the proximity broadcast receiver may be configured to receive broadcast messages from a proximate wireless identity transmitter, as well as broadcast both disable and enable wireless signals that may be received by the wireless identity transmitter. The proximity broadcast receiver may broadcast disable and/or enable wireless signals for some time period greater than a period that wireless identity transmitters are configured to not listen for incoming messages (i.e., a sleep period), assuring that all proximate wireless identity transmitters can receive and respond to the disable and/or enable wireless signals. In an embodiment, the proximity broadcast receiver may also be configured to receive and store messages received from wireless identity transmitters within proximity that indicate the wireless identity transmitters have received disable and/or enable wireless signals. For example, the proximity broadcast receiver may store a list or data table of identities of wireless identity transmitters reporting reception of disable and/or enable wireless signals, and may monitor broadcasts from particular wireless identity transmitters to determine whether they have been disabled or enabled.

In various embodiments, the central server may serve as a “middle-man” that may deliver information to third-parties without providing any identifying information of registered users. In other words, the central server may act as an indirection mechanism that keeps the personal information related to wireless identity transmitters and/or proximity broadcast receivers anonymous. For example, a proximity broadcast receiver in an airport may receive a message that indicates a bag with an included wireless identity transmitter should be removed from a conveyor without indicating the identity of the user who owns the bag. In various embodiments, the central server may store and utilize permissions or permissions settings that indicate whether registered users authorize to have their identity or other related user data provided to third parties. Permissions may be set, provided, or otherwise indicated by users when they register a wireless identity transmitter and/or mobile proximity broadcast receiver with the central server. In an embodiment, the central server may check stored permissions related to users, such as stored within user profiles, to determine whether messages that share the user's data are authorized by the user. For example, when a sighting message is received related to a luggage service, the central server may include a user's relevant personal data (e.g., a photo, an address, etc.) within a return message to a proximity broadcast receiver only when authorized by the user's permissions. In other words, users may be anonymous to third-parties based on privacy preferences stored in the central server.

In various embodiments, companies, organization and institutions (e.g., schools, stores, parks, airports, shopping malls, office buildings, etc.) may deploy stationary proximity broadcast receivers to receive and relay broadcast messages from users' wireless identity transmitters. Alternatively, places may deploy stationary wireless identity transmitters and users' mobile proximity broadcast receivers may receive and relay broadcast messages. In further embodiments, places may employ both proximity broadcast receivers and wireless identity transmitters to receive, relay, and process data from both users carrying wireless identity transmitters and/or mobile proximity broadcast receivers. Regardless of the source of broadcast messages, the central server (or a local computing device) may determine approximate proximities between a proximity broadcast receiver and a wireless identity transmitter based on received sighting messages.

Additionally, based on identification of the proximity broadcast receiver and the wireless identity transmitter related to a received sighting message, the central server may be configured to determine which device is related to a registered service (e.g., a retail store, an airport, a luggage service, etc.) and which is related to a user (e.g., a user). The term “registered service” may be used herein to refer to a party or service that is registered, authenticated, valid, or otherwise known to a central server and that may be related with sighting messages. Registered services may include airports, airlines, merchants, retailers, services, stores (e.g., big-box retailers, local coffee shops, etc.), and various other third-parties that are registered with the central server. Registered services may also include known routines, actions, or services managed by the central server, such as particular searches or active alerts, or alternatively applications that may be executing on a mobile device (e.g., a third-party app). In an embodiment, registered services may further include any third-parties that have registered as developers with the central server. For example, a registered service may correspond to a merchant that has registered proximity broadcast receivers with the central server. In an embodiment, registered users (e.g., users) employing mobile proximity broadcast receivers that transmit sighting messages in response to receiving broadcast messages from others' wireless identity transmitters (e.g., a merchant's stationary identity transmitter positioned within a retail store) may also be considered registered services by the central server.

For illustration purposes, a stationary proximity broadcast receiver positioned on top of a baggage conveyor within an airport terminal may receive a broadcast message from a wireless identity transmitter within a piece of luggage on the conveyor. In response, the proximity broadcast receiver may transmit a sighting message to the central server. Upon receive of the sighting message, the central server may determine that the wireless identity transmitter belongs to a registered user (e.g., a traveling businessman) based on a stored profile that corresponds to a rolling identifier within the broadcast message and that the proximity broadcast receiver is associated with an airline based on an identifier of the proximity broadcast receiver included within metadata in the sighting message. From this information, the central server may transmit luggage proximity information to the registered user's mobile device.

In an embodiment, a proximity broadcast receiver may be configured to perform scripts configuring the proximity broadcast receiver to operate in manners, modes, or routines based on profiles stored in a central server. In particular, identifiers within sighting messages transmitted by the proximity broadcast receiver may be linked by the central server to stored profiles associated with wireless identity transmitters. Profiles may indicate conditions, such as characteristics of areas or installations of wireless identity transmitters and operating suggestions or requirements for devices within proximity of associated wireless identity transmitters (e.g., no wireless signals allowed, etc.). Based on the profiles associated with wireless identity transmitters indicated in sighting messages, the central server may generate scripts that may control the operations, configurations, and/or actions of the proximity broadcast receiver. For example, scripts may include commands to configure the proximity broadcast receiver to enter a sleep, silent, or activated airplane mode when within proximity of a wireless identity transmitter that is located in an aircraft that has taken off. Further, the central server may also utilize profiles associated with the proximity broadcast receiver when generating scripts. For example, when a profile associated with the proximity broadcast receiver indicates a user preference that an embedded microphone never be deactivated by a script, the central server may generate a script that instructs the proximity broadcast receiver to only deactivate an embedded camera when the proximity broadcast receiver is within an area associated with a profile that requests recording devices be deactivated.

In various embodiments, a wireless identity transmitter may be configured to periodically generate new identification data (referred to as a rolling identifier) that may be decoded by a central server to reveal the unique device identifier and other identifying information of the wireless identity transmitter. For example, a wireless identity transmitter may be configured to periodically broadcast a Bluetooth® packet including an encoded version of the wireless identity transmitter's device identifier (i.e., deviceID). Such encryption of identifiers indicated in broadcast messages may be required to enable the central server to reliably identify the wireless identity transmitter that sent the broadcast message while forcing a third-party (e.g., passive attacker) to determine the origin of the broadcast message by guessing. For example, if the identifier was static, the third party could sniff the identifier, such as by impersonating a proximity broadcast receiver, and then use the identifier to track the wireless identity transmitter. Rolling identifiers may make such an attack impossible if the third party lacks the means of generating the encrypted identifiers.

Since a single packet broadcast message may not support a payload that can fit a cipher text of a conventional asymmetric key encryption, standard private/public key pair encryption may not be useable in the various embodiments. Additionally, wireless identity transmitters are generally broadcast-only devices, so there is no back channel that is typically required in conventional encryption schemes. Therefore, the central server in various embodiments may process encrypted message payloads by pre-provisioning a shared secret key unique to each wireless identity transmitter. Such secret keys may be associated with each wireless identity transmitter's unique device identifier at the central server and may be used to decode data (e.g., identifiers) encoded by the each wireless identity transmitter.

Performing an embodiment method, a wireless identity transmitter may use a streaming-like encryption algorithm (e.g., AES-CTR) to encrypt its device identifier, shared secret key, and a nonce or counter, broadcasting a payload that includes the encrypted data with and the nonce or counter in the clear. Performing another embodiment method, a wireless identity transmitter may use a pseudo-random function to encrypt the device identifier, shared secret key, and a nonce or counter, broadcasting a payload that includes the encrypted data without the nonce or counter in the clear. Performing another embodiment method, a wireless identity transmitter may use a combination of a streaming-like encryption and pseudo-random function encryption to generate a payload to broadcast. In an embodiment, the wireless identity transmitter and the central server may each have a cryptographically secure pseudo-random number generator or algorithm that is used to generate identifiers on a common time scale so that any given moment, the central server can calculate the identifier being transmitted by a particular wireless identity transmitter.

In various embodiments, the wireless identity transmitter may maintain a nonce or counter (or clock data) that periodically increments to represent the passage of time and that may be used in various encryption methods. When the wireless identity transmitter is powered on (or the battery is replaced), the nonce or counter may be set to a known initial value, such as 0. As the wireless identity transmitter functions, the nonce or counter may increase periodically (e.g., increment by one every several seconds/minutes/hours). If the wireless identity transmitter encounters inconsistent power (e.g., the battery is taken out or replaced), the nonce or counter may reset. Using such a nonce or counter, a wireless identity transmitter may be configured to periodically broadcast messages with encrypted payloads that include changing and encrypted device identification. In an embodiment, an encrypted payload may contain a concatenation of the device's unique identifier (i.e., the deviceID) and a current nonce or counter value for that wireless identity transmitter. In an embodiment, the wireless identity transmitter may encrypt the concatenated data using a secret key. Payloads may be broadcast at varying frequencies and may be received by proximity broadcast receivers or a central server for processing.

In an embodiment, the central server may be configured to identify wireless identity transmitters by matching received encrypted payloads with pre-generated payloads (or model payloads) corresponding to registered wireless identity transmitters. Based on information obtained during registration operations between the central server and wireless identity transmitters, the central server may store unique information about each wireless identity transmitter. For example, the central server may know the secret key, device identifier (or deviceID), and initial nonce or counter value of a wireless identity transmitter based on registration communications. Using such stored information, the central server may generate a series of model payloads that the wireless identity transmitter is expected (or likely) to broadcast within a time period, such as a 24-hour period. If the central server receives a payload that matches any of these model payloads, the central server may determine the identity of the originating wireless identity transmitter, as well as a loosely-accurate nonce or counter value within the wireless identity transmitter. Model payloads may be generated based off of a current, synched nonce or counter for each registered wireless identity transmitter (i.e., current model payloads). In an embodiment, the central server may also adjust for wireless identity transmitter clock skew by keeping a window of model payloads. For example, the central server may generate payloads using nonce or counter values representing times before and after an expected nonce or counter. The central server may also determine the period of the wireless identity transmitter clock by monitoring the change in the received payloads over time. In an embodiment, the central server may track changes of the reported nonce or counter values of a wireless identity transmitter and may report how inaccurate a device clock is for a particular period of time.

Model payloads may also be generated based off of initial nonce or counter values reported by each registered wireless identity transmitter during registration operations (i.e., initial model payloads). When a wireless identity transmitter is powered off and on again (e.g., rest, battery replaced, etc.), the wireless identity transmitter may reset to the original or initial nonce or counter value. If an encrypted payload received at the central server does not match any current model payload, the central server may compare the received encrypted payload to stored initial model payloads. When the central server finds an initial model payload matches the received encrypted payload (e.g., the wireless identity transmitter was reset), the central server may update a database to indicate the corresponding wireless identity transmitter's nonce or counter was reset, thus resynchronizing with the reset wireless identity transmitter's clock.

In a situation in which a wireless identity transmitter pauses for a period of time but does not reset its nonce or counter used for generating encrypted payloads, payloads subsequently generated by the wireless identity transmitter may not match expected payloads stored in the central server (e.g., current model payloads and initial model payloads). To address this situation, the central server may determine that a pause occurred when model payloads and/or nonce or counter values do not match a received encrypted payload. The central server may identify the wireless identity transmitter by performing a brute-force search of all known and/or registered wireless identity transmitters represented in a database and decode the received encrypted payload based on recorded secret keys and device identifications. In an embodiment, the brute-force search may include only wireless identity transmitters that have not broadcast payloads recently received by the central server.

For the purposes of this disclosure, the various embodiment methods for decoding, decrypting, and otherwise accessing obscured identification information (e.g., rolling identifiers) are described as being performed by a central server to associate such information with registered users and/or registered devices. However, those skilled in the art should appreciate that any computing device with authorization may be configured to perform such operations to decipher obscured identification information broadcast by wireless identity transmitters. For example, a mobile proximity broadcast receiver (e.g., a smartphone) employed by a user may utilize the various methods for decrypting, decoding, and otherwise accessing rolling identifiers that are associated with wireless identity transmitters also owned by that user.

Additional precautions may be important to protect against security breaches, such as hacker attacks against databases associated with a central server, as well as to provide registered users (e.g., merchants, parents, children, etc.) peace of mind and confidence their privacy may be fully protected. Such privacy safeguards may be provided to parties registered with embodiment systems by storing identifying information (e.g., names, addresses, financial information, medical information, etc.) separately from other information related to tracking devices and/or proximity information of users. In particular, to avoid unintended leaking of personal information of registered merchants, customers, children, or individuals, embodiment systems may utilize “double-blind” architectures. For example, such a double-blind architecture may use a first unit (e.g., a server, database, or other computing hub) that stores and has access to information related to the proximity information or other location-based data of registered users' devices (e.g., wireless identity transmitters, proximity broadcast receivers, identity transceivers, mobile devices, etc.). In other words, the first unit may access information associated with sighting messages that indicate approximate locations/proximities of various users' devices. However, the first unit may not store uniquely identifying personal information, such as user names, addresses, and/or social security numbers. Instead, a second unit may store the identifying personal information without being configured to access any location/proximity information as used by the first unit. The first and second units may use anonymous identifiers that connect data stored within the two units without indicating the protected information stored in either unit. In an embodiment, the first and second units may be maintained by separate entities (e.g., service providers), and further, at least one of such entities may be trusted by registered users who provide identifying information.

The various embodiments may leverage a large infrastructure of mobile devices already in place. Many modern mobile devices, such as smartphones, are already equipped with multiple radios, including short-range radios such as Bluetooth® radios, and therefore may be configured to perform as mobile proximity broadcast receivers and receive identification codes from a proximate wireless identity transmitter. For example, a customer carrying a smartphone configured to operate as a mobile proximity broadcast receiver (or mobile identity transceiver) may receive broadcast messages from wireless identity transmitters within a retail store. Mobile devices are also often equipped with a clock that may provide a current time and a GPS receiver that may provide a current location whenever a wireless identity transmitter identifier is received. The mobile devices may communicate these identification codes, times, and locations via sighting messages to central servers through longer range network connections, such as a cellular radio connection. Thus, many of the large number of mobile devices already in use or soon to be in use may be incorporated as mobile proximity broadcast receivers to extend the reach of various embodiment systems.

By relying on the long-range radios and other services of proximity broadcast receivers to report the location and time of received broadcast message (or “sightings”) to a central server, wireless identity transmitters can be relatively small, inexpensive, and simple devices, including little more than a short-range radio, such as a Bluetooth® LE transceiver, and a battery. In various embodiments, wireless identity transmitters may also include additional short-range radios, such as Peanut® radios. In various embodiments, the wireless identity transmitters may not include a user interface, multiple radios, global positioning system (GPS) receiver, or other features common on mobile devices. Embodiment wireless identity transmitters may also consume very little power allowing them to be deployed without needing to be frequently recharged or replaced. These characteristics make them ideal for a wide variety of uses and implementation in a variety of physical configurations. For example, wireless identity transmitters may be easily hidden or incorporated into many different personal objects, such as buttons, watches, shoes, briefcases, backpacks, ID badges, clothing, product packaging, etc.

In further embodiments, wireless identity transmitters and proximity broadcast receivers may be configured to exchange transmissions using various wireless technologies, such as LTE-D, peer-to-peer LTE-D, WiFi, and WiFi Direct. In an embodiment, wireless identity transmitters may be configured to broadcast messages via a WiFi radio such that proximity broadcast receivers with WiFi transceivers may receive the broadcast messages. In such embodiments, wireless identity transmitters may utilize WiFi transmissions to broadcast identification information similar to WiFi access point broadcasts advertisements. For example, a wireless identity transmitter including a WiFi radio may be configured to transmit broadcast messages via WiFi transmissions with low power so that the reception range is limited, thereby providing a short-range radio signal with a range similar to that of Bluetooth® LE transmissions. In utilizing various wireless broadcast technologies and communication protocols with wireless identity transmitters, proximity broadcast receivers with limited capabilities may still be capable of receiving and processing broadcast messages from wireless identity transmitters. For example, a smartphone configured to operate as a mobile proximity broadcast receiver and including a WiFi transceiver but not a Bluetooth® LE radio may receive and process broadcast messages from a wireless identity transmitter configured to broadcast short-range signals with a WiFi radio. In an embodiment, wireless identity transmitters may broadcast over multiple radios, such as a Bluetooth® LE transceiver and a low-power WiFi transceiver, in order to enable more models of proximity broadcast receivers (e.g., more types of smartphones) to receive and relay sightings.

Wireless identity transmitters and proximity broadcast receivers are described throughout this disclosure as exchanging short-range wireless signals that include short-range RF signals, such as Bluetooth®, Bluetooth® Low Energy, Peanut, Zigbee, etc. However, such short-range wireless signals are not limited to short-range RF signals, and wireless identity transmitters may broadcast messages using other forms of wireless signaling, such as infrared light, visible light, vibration, heat, inaudible sound, and audible sound, as well as combinations of radio frequency (RF) signals and non-RF signals. For example, wireless identity transmitters may emit heat signals, such as infrared light, using infrared light-emitting diodes or other components capable of emitting infrared radiation. Additionally, wireless identity transmitters may emit vibration signals using vibration motors and other mechanical components capable of generating controlled vibrations. Wireless identity transmitters may also emit light signals from a number of common emitters, such as light emitting diodes, incandescent lights and projectors. Light signals may be received by light sensors (e.g., cameras) on proximity broadcast receivers, and may include visuals, such as lights, colors, and imagery (e.g., photos, projections, videos, symbols, etc.). Wireless identity transmitters may also or alternatively emit audible or inaudible (i.e., infrasonic or ultrasonic) sound signals from a speaker (e.g., a piezoelectric speaker). Sound signals may be received by a microphone of the proximity broadcast receivers, and may include a variety of sounds, such as beeps, voices, noise, clicks, ultrasounds, tones, and musical notes.

Wireless identity transmitters may be configured to broadcast the various short-range wireless signals in particular sequences, patterns, manners, durations, or manifestations such that proximity broadcast receivers may convert the signals into data in a manner similar to how RF signals (e.g., Bluetooth® LE signals) are interpreted in embodiments described herein. For example, a wireless identity transmitter may broadcast particular sequences of modulating visible or sound signals, such as strings of differing musical notes, changing images, or flashing lights that a proximity broadcast receiver may receive and convert into data that includes an identity of the wireless identity transmitter. In an embodiment, proximity broadcast receivers may convert such wireless signals into data (and vice versa) based on matching sequences of signals with patterns within predefined protocols. As an illustrative example, a wireless identity transmitter affixed to the outside of a child's clothing may periodically emit a sequence of flashes using an embedded light source (e.g., an LED bulb) that may be received, converted to data, and relayed by a proximity broadcast receiver to a central server for determining identification information related to the child. As another example, a wireless identity transmitter within a business establishment may be mounted on the ceiling and may periodically emit a sequence of flashes using an embedded light source that may be received, converted to data, and relayed by a proximity broadcast receiver to a central server to obtain coupons, announcements or customer-incentives tied to the customer being on the premises.

The various embodiments are described within this disclosure as including communication systems for providing intermediary communications between wireless identity transmitters, proximity broadcast receivers (e.g., mobile proximity broadcast receivers and stationary proximity broadcast receivers) and a central server that utilize short-range messaging (such as with Bluetooth® LE signaling) that enables proximity detection based simply on signal reception. However, the various embodiments are not limited to the described communication systems and methods, and other communication systems, protocols, devices, methods and messaging protocols may be used to convey information to a central server to enable identifying when customers are within proximity of predefined areas to enable the central server to distribute relevant marketing information without disclosing identities of customers. For example, transceivers in a retail store may be configured to monitor for WiFi, Zigbee®, Bluetooth®, Peanut®, and/or other radio frequency signaling from customers' mobile devices or wireless broadcasting devices within proximity of predefined areas, and relay proximity information to a central server that delivers coupons to customers. Further, embodiments may not require determining exact locations for wireless identity transmitters and/or proximity broadcast receivers but instead may determine approximate and/or relative locations of devices between each other. Accordingly, references to determining location and/or distance throughout the disclosure may be for the purpose of determining proximity between signaling devices.

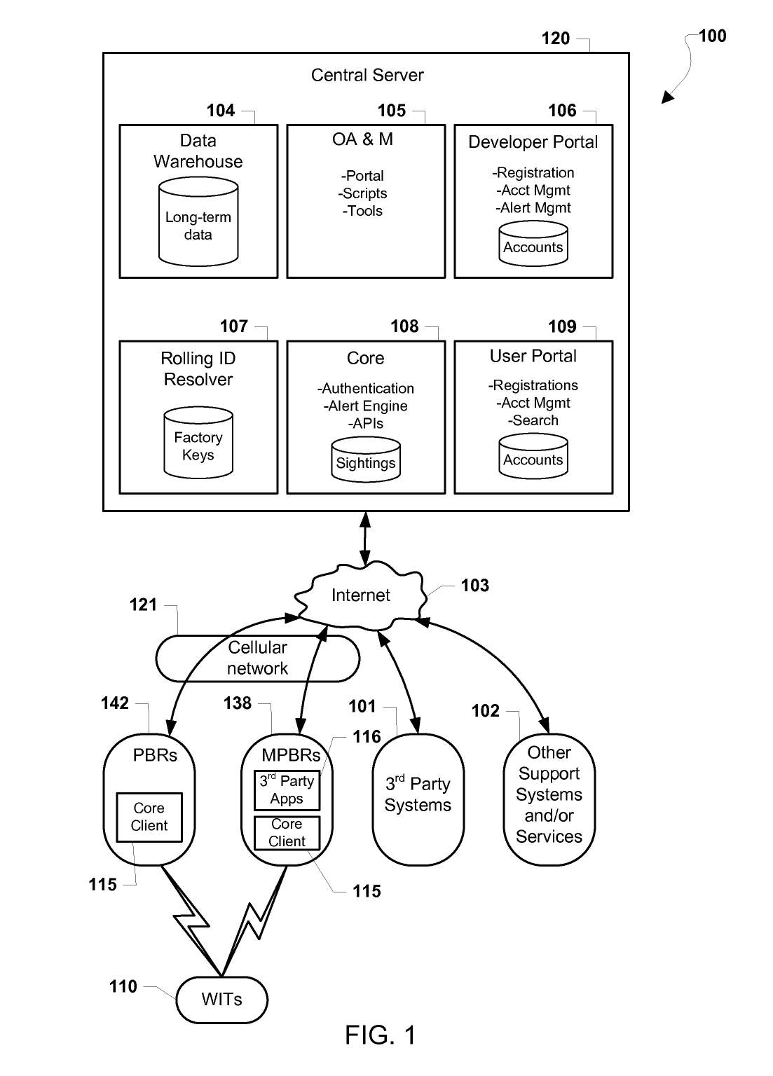

FIG. 1 illustrates an exemplary system 100 that may be used in various embodiments. In general, a central server 120 may be configured to receive, store, and otherwise process data corresponding to wireless identity transmitters 110. The central server 120 may be configured to exchange communications with various devices via the Internet 103, such as proximity broadcast receivers 142, mobile proximity broadcast receivers 138, third-party systems 101, and other support systems and/or services 102. The wireless identity transmitters 110 may broadcast messages that may be received by nearby proximity broadcast receivers 142 and/or the mobile proximity broadcast receivers 138 via short-range wireless signals. The proximity broadcast receivers 142, 138 may utilize long-range communications to relay received broadcast messages as sighting messages to the central server 120 via the Internet 103. For example, the proximity broadcast receivers 142 and mobile proximity broadcast receivers may utilize a cellular network 121 to transmit sighting messages to the central server 120. The third-party systems 101 may include merchant servers, retail store computing devices, computing devices associated with emergency services. The other support systems and/or services 102 may include computing devices associated with various technologies, such as computing devices utilized by users to provide registration information, systems that deliver user-relevant content (e.g., Qualcomm Gimbal™), and services that provide location-specific information (e.g., Qualcomm IZat™).

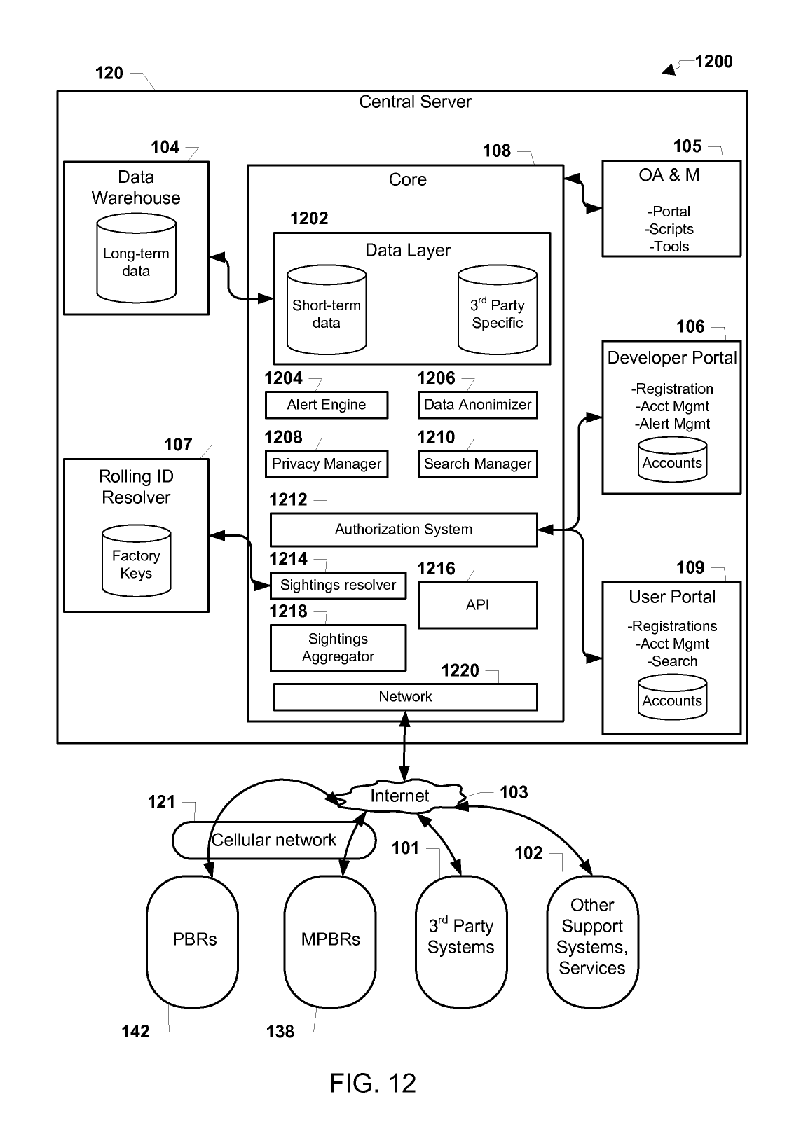

The central server 120 may include several components 104-109 to perform various operations to process data, such as received from proximity broadcast receivers 142, 138, third-party systems 101, or other support systems and/or services 102. In particular, the central server 120 may include a data warehouse component 104 that may store long-term data (e.g., archived user data, past location information, etc.). The central server 120 may also include an operations, administration and management (or OA&M) component 105 that may manage, process and/or store software associated with user portal accesses, scripts, tools (e.g., software utilities, routines, etc.), and any other elements for administering the central server 120. The central server 120 may also include a developer portal component 106 that may store developer account data and perform registration, account management, and alert (or notice) management routines associated with developers, such as vendors or merchants that register to interact with users of wireless identity transmitters 110. The central server 120 may also include a rolling identifier (or ID) resolver component 107 that may store factory keys associated with wireless identity transmitters 110 as well as perform operations, software, or routines to match encrypted, encoded, rolling, or otherwise obfuscated identification information within received sighting messages with affiliated user data. The central server 120 may also include a user portal component 109 that may store user account data and perform registration, account management, and search routines associated with users, such as persons associated with wireless identity transmitters 110. The central server 120 may also include a core component 108 that may process sighting messages, execute an alert or notice engine module, handle application programming interface (API) commands, and exchange data with other components within the central server 120. The core component 108 is described below with reference to FIG. 12.

In various embodiments, the various system components 104-109 may be computing devices, servers, software, and/or circuitry that is included within, connected to, or otherwise associated with the central server 120. For example, the core component 108 may be a server blade or computing unit included within the central server 120. As another example, the data warehouse component 104 may be a remote cloud storage device that the central server 120 communicates with via Internet protocols.

In an embodiment, the proximity broadcast receivers 142 and mobile proximity broadcast receivers 138 may be configured to execute a core client module 115 that may be software, instructions, routines, applications, operations, or other circuitry that enable the proximity broadcast receivers 142, 138 to process received broadcast messages from proximate wireless identity transmitters 110. The core client module 115 may also handle communications between the proximity broadcast receivers 142, 138 and the central server 120, such as transmitting sighting messages and receiving return messages from the central server 120. Further, the mobile proximity broadcast receivers 138 may be configured to execute third-party applications module 116 that may related to performing software instructions, routines, applications, or other operations provided by various third-parties (e.g., merchant apps). In an embodiment, when configured as registered services with the central server 120, the third-party applications module 116 may receive various data from the core client module 115. For example, a third-party application that is registered with the central server 120 may be configured to receive notifications from the core client module 115 when the user of the mobile proximity broadcast receiver 138 enters, remains, and/or leaves a particular place (e.g., a geofence, a retail store, etc.).

In another embodiment, the mobile proximity broadcast receivers 138 may be configured to receive and transmit broadcast messages and may also be referred to as “wireless identity transceivers.” For example, a user may employ a smartphone that is configured to receive broadcast messages from nearby wireless identity transmitters 110 as well as broadcast signals that include identifying information associated with the user.

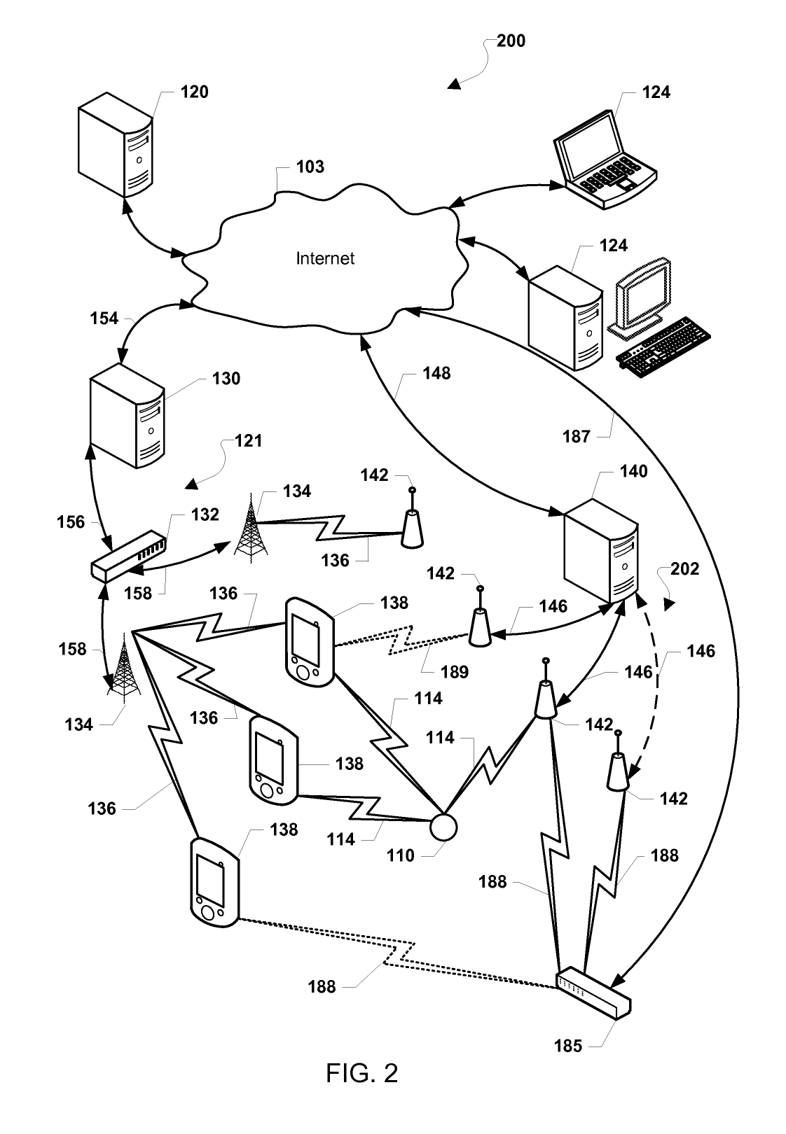

FIG. 2 illustrates an exemplary communication system 200 that may be used in various embodiments. The communication system 200 effectively enables wireless identity transmitters 110 (e.g., Bluetooth® LE transmitters) to transmit broadcast messages that include identification information to the central server 120 via a plurality of mobile proximity broadcast receivers 138 and/or stationary proximity broadcast receivers 142, without the need to negotiate a direct communication link. Such broadcast messages may be collected automatically by any proximity broadcast receiver within proximity (or broadcast range) of wireless identity transmitters. For example, a mobile proximity broadcast receiver 138 within a certain proximity may receive a broadcast message transmitted by a Bluetooth® radio within the wireless identity transmitter 110.

The communication system 200 may include a wireless identity transmitter 110. The wireless identity transmitter 110 may be coupled with various objects. For example, it may be embedded in a bracelet. The wireless identity transmitter 110 may transmit a short-range wireless signal 114, such as a broadcast message as described above. For example, this short-range wireless signal 114 may be a periodic broadcast of a packet, which includes the wireless identity transmitter's identification code. Alternately, the short-range wireless signal 114 may be an attempt to establish a wireless communication link with any of a plurality of mobile devices 138 that may be acting as proximity broadcast receivers (i.e., mobile proximity broadcast receivers). The short-range wireless signal 114 may be received by proximate proximity broadcast receivers, such as stationary proximity broadcast receivers 142 and/or mobile proximity broadcast receivers 138.

The short-range wireless signal 114 may be according to any of a variety of communication protocols, such as Bluetooth®, Bluetooth® LE®, Wi-Fi, infrared wireless, induction wireless, ultra-wideband (UWB), wireless universal serial bus (USB), Zigbee®, Peanut®, or other short-range wireless technologies or protocols which have or which can be modified (e.g., by restricting transmit power) to limit their effective communication range to relatively short range (e.g., within about 100 meters). In some embodiments, the wireless identity transmitter 110 may use the low energy technology standardized in the Bluetooth® 4.0 protocol (or later versions). For example, in some embodiment systems a wireless identity transmitter 110 may periodically broadcast identification packets configured as an advertiser as described in the Bluetooth® 4.0 protocol, and proximate proximity broadcast receivers 142, 138 may be configured to act as scanners according to that protocol.

The Bluetooth® protocol and Bluetooth® devices (e.g., Bluetooth® LE devices) have a relatively short effective communication range, are widely used in deployed communication and computing devices, have standard advertising or pairing procedures that meets the discovery and reporting needs of various embodiments, and exhibit low power consumption, which make the protocol ideal for many applications of the various embodiments. For this reason, Bluetooth® and Bluetooth® LE protocols and devices are referred to in many of the examples herein for illustrative purposes. However, the scope of the claims should not be limited to Bluetooth® or Bluetooth® LE devices and protocol unless specifically recited in the claims. For example, Peanut® transceivers may be included within wireless identity transmitters 110 and may be used to transmit two-way communications with proximity broadcast receivers 142, 138 also configured to utilize Peanut® short-range radio transmissions.

The communication system 200 may include a plurality of stationary proximity broadcast receivers 142, which may be deployed by authorities, merchants, or various third-parties throughout a region, building, or place. Such stationary proximity broadcast receivers 142 may be designed specifically for wireless identity transmitters 110 (or include such tracking functions in addition to other primary functionality, such as traffic lights, utility transformers, etc.). Stationary proximity broadcast receivers 142 may be located in strategic locations within a locality, such as forming a perimeter about a community and/or being located in high traffic areas (e.g., major intersections and highway on-ramps). The stationary proximity broadcast receivers 142 may be in communication with a local area network 202, such as a WiFi network, that may include an Internet access server 140 that provides a connection 148 to the Internet 103. Stationary proximity broadcast receivers 142 may be connected to the local area network 202 by a wired or wireless link 146. In various embodiments, the stationary proximity broadcast receivers 142 may be contained within or located nearby the Internet access server 140. For example, the stationary proximity broadcast receivers 142 may be components within the Internet access server 140 or alternatively, may be placed on top of or to the sides of the Internet access server 140. In an embodiment, stationary proximity broadcast receivers 142 may be located in strategic places within a locality, such as forming a perimeter about a community and/or being located in high traffic areas (e.g., along aisles of a retail store, at entry ways to buildings, etc.). In an embodiment, stationary proximity broadcast receivers 142 may have additional functionality. For example, stationary proximity broadcast receivers 142 may also function as or be included within cash registers, point-of-sale devices, and/or display units within a retail store.

The communication system 200 may also include one or more mobile devices configured to act as mobile proximity broadcast receivers 138. The mobile proximity broadcast receivers 138 may be typical mobile devices or smartphones communicating with a cellular network 121 via long-range wireless links 136 to one or more base stations 134 coupled to one or more network operations centers 132 by a wired or wireless connection 158. Such cellular network 121 may utilize various technologies, such as 3G, 4G, and LTE. The network operations centers 132 may manage voice calls and data traffic through the cellular network 121, and typically may include or may be connected to one or more servers 130 by a wired or wireless connection 156. The servers 130 may provide a connection 154 to the Internet 103. In the various embodiments, the mobile proximity broadcast receivers 138 may be mobile devices configured by an application or other software module to act as proximity broadcast receivers to relay reports of received broadcast messages from wireless identity transmitters 110 (i.e., sighting messages) to the central server 120 by way of the Internet 103. In an embodiment, stationary proximity broadcast receivers 142 may also communicate with the cellular network 121 via long-range wireless links 136 to a base station 134.

Proximity broadcast receivers 138, 142 may be configured to report contacts (or sightings) with a wireless identity transmitter 110 to a central server 120 via the Internet 103. For example, the proximity broadcast receivers 142 may transmit a sighting message to the central server 120 that includes a rolling identifier corresponding to the identity of a user of the wireless identity transmitter 110. Each time a proximity broadcast receiver 138, 142 receives an identifier from a wireless identity transmitter 110, the identifier may be associated with the time of the connection and the location of the proximity broadcast receiver 138, 142, and this information may be transmitted to the central server 120, such as within a sighting message. In some embodiments, the identifier, the time, and the location of the contact may be stored in the memory of the proximity broadcast receiver 138, 142 (or an intermediary server 130, 140) for later reporting, such as in response to a query message broadcast or multicast by the central server 120. Also, the central server 120 may store location information reported by sighting messages in a database, which may be used for locating, tracking or otherwise monitoring movements of the wireless identity transmitter 110.

In an embodiment, mobile proximity broadcast receivers 138 may be configured to exchange short-range wireless signals 189 with stationary proximity broadcast receivers 142. In other words, a mobile proximity broadcast receiver 138 may be configured to operate as a wireless identity transceiver that is capable of receiving short-range wireless signals 114 (i.e., broadcast messages) from the wireless identity transmitter 110 as well as transmitting short-range wireless signals 189 for receipt by proximity broadcast receivers 142.

In an embodiment, proximity broadcast receivers 138, 142 may transmit wireless signals 188 to a wireless router 185, such as part of the local area network 202, which may provide a connection 187 to the Internet 103. For example, the stationary proximity broadcast receivers 142 may transmit sighting messages that include data from broadcast messages transmitted by the wireless identity transmitter 110 to a WiFi wireless router 185.

The central server 120 may also be connected to the Internet 103, thereby allowing communication between proximity broadcast receivers 142, 138 and the central server 120. As described above, the central server 120 may include a plurality of components, blades, or other modules to process sighting messages and data received from proximity broadcast receivers 142, 138. Further embodiments may provide a direct connection (not shown) between the central servers 120 and any of the mobile device network components, such as the network operations centers 132, to more directly connect the proximity broadcast receivers 142, 138 and the central servers 120.

The communication system 200 may also include computing terminals 124, such as personal computers at home or work, through which users may communicate via the Internet 103 with the central server 120. Such terminals 124 may allow users, such as parents, police, fire, medical attendants, and other authorized authorities to register devices (e.g., wireless identity transmitters 110), access tracking records on the central servers 120, and/or to request that the central server 120 initiate a search for a particular wireless identity transmitter 110. In an embodiment, users may use such terminals 124 to register wireless identity transmitters 110, proximity broadcast receivers 142, 138 (e.g., smartphones configured to execute client software associated with the central server), and/or identity transceivers (not shown), such as by accessing web portals and/or user accounts associated with the central server 120. Similarly, third-parties, such as merchants, may use terminals 124 to register wireless identity transmitters 110, proximity broadcast receivers 142, 138 (e.g., stationary receivers configured to execute client software and relay broadcast to the central server), and/or identity transceivers (not shown).

Based on the location of the proximity broadcast receivers 138, 142 within a place, multiple proximity broadcast receivers 138, 142 may be within the broadcast area of the wireless identity transmitter 110 and may concurrently receive broadcast messages. The central server 120 may detect when proximity broadcast receivers 138, 142 concurrently (or within a certain time period) transmit sighting messages that indicate receipt of broadcast messages from the wireless identity transmitter. Such concurrent sighting messages may be used to determine more precise proximity information relating to the wireless identity transmitter at the time of broadcasting.

The communication system 200 may operate in a passive information gathering mode and/or an active search mode. In the passive information gathering mode, proximity broadcast receivers 138, 142 may continuously listen for broadcasts from any wireless identity transmitters 110, and report all identifier reception events via sighting messages (e.g., transmissions including identifiers, time and location) to the central server 120. When no active search is underway (i.e., no one is looking for a particular wireless identity transmitter 110), sightings of wireless identity transmitters 110 or received broadcast messages from wireless identity transmitters 110 may be stored in memory of the proximity broadcast receivers 138, 142 or the central server 120 for access at a later time. In order to protect privacy, such stored data may be stored for a limited period of time, such as a day, a week or a month, depending upon the person or asset being tracked. Then, if a person or asset is discovered to be missing, the stored data may be instantly accessed to locate and track the associated wireless identity transmitter 110, or at least determine its last reported location.

In a modification of the passive tracking mode, each proximity broadcast receiver 138, 142 may store IDs, times and locations corresponding to received broadcast messages (or contacts) from wireless identity transmitters 110 for a limited period of time. Alternatively, such information may be stored in servers 130, 140 connected to such proximity broadcast receivers 138, 142. Then, if a person or asset associated with a wireless identity transmitter 110 is discovered missing, a search can be initiated by the central server 120 querying the proximity broadcast receivers 138, 142 (or servers 130, 140) to download their stored data (e.g., databases indicating contacts with wireless identity transmitters 110) for analysis and storage in a database of the central server 120.

In an embodiment, in order to limit the demands on civilian mobile devices configured to operate as mobile proximity broadcast receivers 138, the passive tracking mode may only be implemented on the stationary proximity broadcast receivers 142. While the fewer number of such devices means the tracking of wireless identity transmitters 110 may be less effective, this embodiment may nevertheless enable receiving broadcast messages and thus the tracking of wireless identity transmitters 110 through high-traffic zones, such as intersections, highway on/off ramps, bus stations, airports, etc.

In the passive information gathering mode/embodiment, a user may use the communication system 200 to request the location of a particular wireless identity transmitter 110, such as by sending a request from a terminal 124 to the central server 120. For example, a mother may log in on her home computer terminal 124 and request the location of the wireless identity transmitter 110 in her child's backpack. The request may include a serial number, code, or other identifier corresponding to the wireless identity transmitter 110. The central server 120 may search the stored identification messages for the serial number, code, or other identifier and return any reported locations matching entered information, along with the times of such locations were reported via sighting messages. In further embodiments, the serial number or code entered by the parent may be cross-referenced with the identifier that the requested wireless identity transmitter 110 communicates in broadcast messages and that are relayed to the central server 120 in sighting messages submitted by proximity broadcast receivers 138, 142. In this manner only an authorized user (i.e., someone who knows the access code, password, or other secret code associated with a particular wireless identity transmitter 110) can obtain information regarding a given wireless identity transmitter 110 even though data is being gathered continuously.

In the active search mode/embodiment, the central server 120 may instruct proximity broadcast receivers 138, 142 to actively search for a particular wireless identity transmitter 110 (i.e., a “targeted” wireless identity transmitter). An active search may be initiated in response to a request received from a terminal 124. Such a request may include the identifier for the particular wireless identity transmitter 110, or an account number/name that is or can be cross-linked to the identifier of the wireless identity transmitter 110. The central server 120 may transmit activation messages, such as via broadcast or multicast, to proximity broadcast receivers 138, 142 that may instruct proximity broadcast receivers 138, 142 to search for a particular wireless identity transmitter 110 and that may include an identifier of the targeted wireless identity transmitter 110 (i.e., target device ID). For example, an activation message corresponding to an active search for a targeted wireless identity transmitter 110 may include a rolling identifier that the wireless identity transmitter 110 changes periodically in an unpredictable manner and that is known to the central server 120. In an embodiment, activation messages transmitted, broadcast or multicast by the central server 120 may be sent only to proximity broadcast receivers 138, 142 within particular sectors or within a given distance of a particular location. Alternatively, the activation messages may identify particular sectors or a distance from a particular location to enable the proximity broadcast receivers 138, 142 to determine whether the activation message is applicable to them based on their own known location. In this manner the search can be focused on a given area, such as a sector encompassing the last known location of the wireless identity transmitter 110 or an eye witness sighting. By focusing the search in this manner, proximity broadcast receivers 138, 142 not within the sector of search need not be activated.

In the active search mode/embodiment, in response to receiving activation messages from the central server 120 that include target device IDs and determining that they are within the identified sector of search, proximity broadcast receivers 138, 142 may configure their short-range radios (e.g., Bluetooth® radio) to listen for broadcast messages having the identifiers. In other words, the proximity broadcast receivers 138, 142 may be considered activated for a search and may or pairing attempts with an identifier look for the identifiers included in the activation message (i.e., target device IDs). In embodiments that do not rely on pairing with the wireless identity transmitter, proximity broadcast receivers 138, 142 matching an identifier within a received broadcast message to a target device ID within an activation message may promptly report the event to the central server 120 via sighting messages transmitted via links 146 or long-range wireless links 136. In embodiments that rely on pairing or an exchange of messages between the wireless identity transmitter and proximity broadcast receivers, proximity broadcast receivers 138, 142 may listen for and only complete communication handshaking or pairing with a device that broadcasts the target device ID, and ignore other pairing attempts. In this alternative embodiment, proximity broadcast receivers 138, 142 may be protected from pairing with unauthorized devices while in the active search mode. Also, proximity broadcast receivers 138, 142 may modify the pairing process in the active search mode to terminate the communication link as soon as the device ID is received, further protecting against pairing with unauthorized devices in the active search mode. In the active search mode/embodiment, proximity broadcast receivers 138, 142 receiving the target device ID may promptly report that event to the central server 120 via a wired or wireless link to the Internet 103. As mentioned above, such a report may include the location of the proximity broadcast receiver 138, 142 and the time when the identifier was received if the report is not transmitted immediately. In the active search mode/embodiment, each sighting message received by the central server 120 may be reported to an interested person or authority, such as in the form of a webpage showing an update location indicator on a map.

Further, in the active search mode/embodiment, an authorized user, such as a police, FBI, fire/rescue or other person of authority may use the communication system 200 to activate a search for a particular wireless identity transmitter 110, such as by using a terminal 124 to provide the central server 120 with the target device ID and search location or sectors to be searched. For example, a mother discovering that her child is missing may call the police and provide them with an identifier of the wireless identity transmitter 110 concealed in her child's clothing. With the search activated, the central server 120 may transmit an alert (or message that indicates a search for a wireless identity transmitter has been activated) to proximity broadcast receivers 138, 142 within the initial targeted search sector. The central server 120 may then activate a webpage that presents a map of the search area and that may be maintained in near-real time so, that as relevant sighting messages are received, reported location information is displayed on the map. Authorized users may then access the website (or other information provided by the server) to coordinate in-person search efforts.

Of course, information gathered and stored in proximity broadcast receivers 138, 142 or in a database of the central server in the passive mode may be used upon initiation of an active search, such as to identify an initial search location or sector, track recent locations and movements, and to provide/display a history of locations reported by sighting messages that may be combined with near-real time search reports.

In another embodiment, the communication system 200 may further include a plurality of wireless identity transmitters (not shown in FIG. 2) that are placed throughout a building. In such a situation, the plurality's broadcast areas may cover a large portion of the enclosed area of such a building. For example, the building may be a retail store and the plurality of wireless identity transmitters may be permanently stationed throughout the sales floor of the building. As a mobile proximity broadcast receiver 138, such as a smartphone carried by a customer, moves throughout the building and within the broadcast areas of the plurality of wireless identity transmitters, the mobile proximity broadcast receiver 138 may receive broadcast messages associated with the building. In another embodiment, the Internet access server 140 may be configured to store, receive, and otherwise process information relevant to the building. For example, the Internet access server 140 may be configured to perform as a local server for a retail store or alternatively a point-of-sale device that is configured to perform software and operations for conducting transaction with customers. For example, the Internet access server 140 may be configured to perform operations related to a customer purchase within a retail store building.

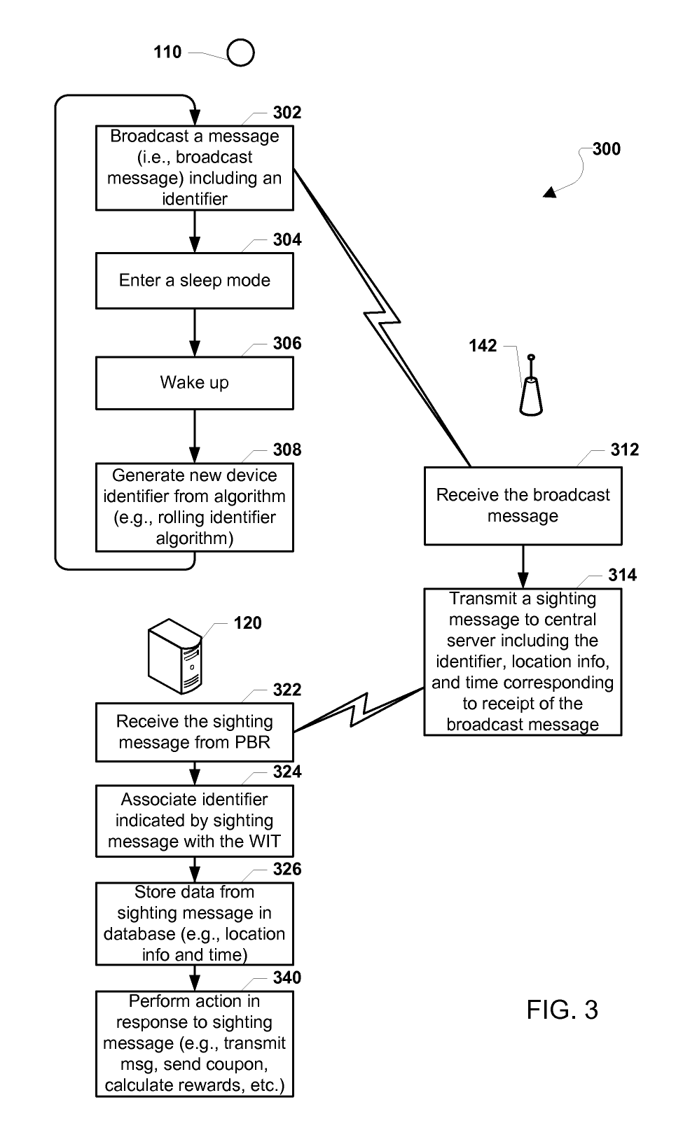

FIG. 3 illustrates an embodiment method 300 for implementation in a wireless identity transmitter 110 (referred to as “WIT” in FIG. 3), a proximity broadcast receiver 142, and a central server 120. In block 302, a wireless identity transmitter 110 may broadcast a message that includes an identifier, such as a broadcast message as described above. For example, the wireless identity transmitter 110 may broadcast a Bluetooth® LE advertising packet that includes a rolling identifier as described herein. This may be accomplished in block 302 by a microcontroller within the wireless identity transmitter 110 determining that it is time to broadcast its identifier, configuring a suitable broadcast message (e.g., an advertisement packet as specified for Bluetooth® LE devices in the Bluetooth®4.0 protocol), and transmitting that packet via a short-range radio.

In various embodiments, the message broadcast by the wireless identity transmitter (i.e., the broadcast message) may include an identifier segment, such as a rolling identifier. In various embodiments, the broadcast message may also include additional segments, such as a type segment. The type segment may indicate the type of wireless identity transmitter. For example, wireless identity transmitters may be marketed for various purposes, such as child safety devices, dog collars, or security tags for stores. The wireless identity transmitters may have a different type segment based on the intended purpose (e.g., one code for child safety devices, a second code for dog collars, etc.). Type segments may be static and set by manufacturers, while the remaining portion of the identifier may be unique to each device, and may roll as described below. The type segment may also be changed by a user, such as when a wireless identity transmitter is reset for a different purpose or application.

In other embodiments, a broadcast message may also include one or more static or dynamic segments with instructions or commands to be implemented by a proximity broadcast receiver. Such command segments may also be passed along to instruct a central server or other network device. Command segments may be set or static, similar to type segments, or may vary over time based on various conditions, such as pairings or data from one or more proximity broadcast receivers. Such command settings may also be configured by a user of the wireless identity transmitter. Second or additional segments may also indicate the status of the wireless identity transmitter. For example, a second segment may indicate the remaining power or estimated time left before the battery dies. Proximity broadcast receivers or a central server may interpret this status and respond accordingly.

Returning to FIG. 3, in block 304, the wireless identity transmitter 110 may enter a sleep mode. For example, after broadcasting the broadcast message having the identifier, the wireless identity transmitter 110 may be configured to enter a power conservation state that may continue for a predetermined period of time. In various embodiments, the wireless identity transmitter 110 may sleep for a predetermined time, never sleep, or sleep for varying times determined based on various inputs. In block 306, the wireless identity transmitter 110 may wake up from the sleep mode, such as after the predetermined duration expires. In block 308, the wireless identity transmitter 110 may generate a new device identifier from an algorithm, such as a rolling identifier algorithm. For example, the wireless identity transmitter 110 may generate a rolling identifier using a pseudo-random function or a streaming-like encryption algorithm (e.g., AES-CTR), as described below. The wireless identity transmitter 110 may then return to block 302 to broadcast again. In an embodiment, the broadcast message may contain timing, counter, count-down, or scheduling information indicating the availability of the wireless identity transmitter for receiving messages. For example, the broadcast message may indicate that the wireless identity transmitter will accept incoming configuration messages within a specified time window. In various embodiments, the operations in blocks 302-308 may be performed by an identity transceiver (e.g., a smartphone configured to operate as both an identity transmitter and a proximity broadcast receiver).

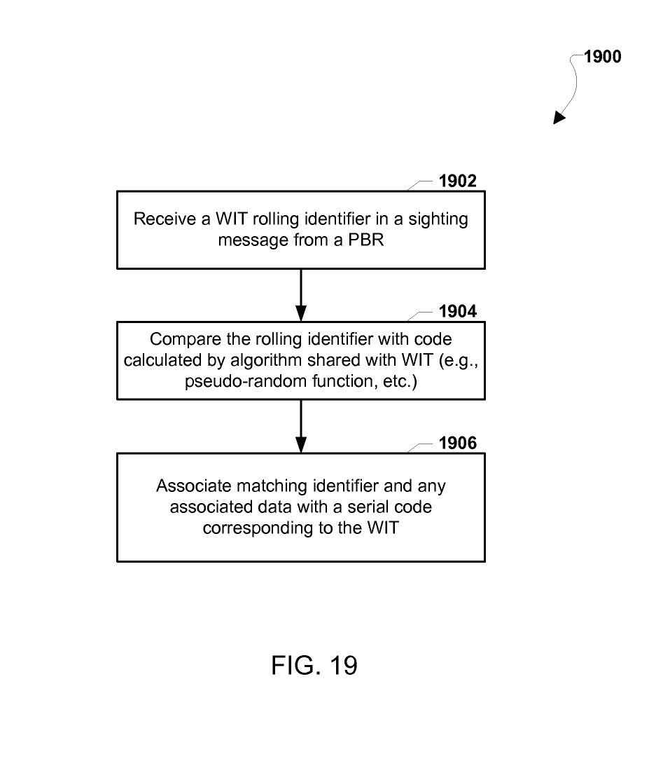

As mentioned above, the algorithm (or rolling identifier algorithm) used in block 308 may generate a rolling identifier which is very difficult to predict or recognize by a device or system that does not know either an identity of the wireless identity transmitter 110 (e.g., a MAC or Bluetooth® ID), a decode key, and/or the algorithm used to generate the rolling identifier. As discussed below with reference to FIG. 19, the central server 120, configured with the algorithm (or a decoding algorithm) or a decode key, and in possession of the wireless identity transmitter 110 identities, can use the rolling identifier to determine a corresponding account or device identity. While method 300 shows the rolling identifier changing with every wake and broadcast cycle as one example, in other embodiments the identifier may be changed less frequently, such as once per minute, once per hour, etc. In such embodiments, the operation of generating a new identifier in block 308 may be performed only at the designated interval, so at other times upon waking (i.e., block 306) the wireless identity transmitter 110 may return to block 302 to broadcast the identifier. Various algorithms for generating rolling identifiers or other encoded identifiers, as well as other decoding algorithms, are discussed below as well as in related application U.S. patent application Ser. No. 13/773,336, entitled “Preserving Security By Synchronizing a Nonce or Counter Between Systems,” the entire contents of which are hereby incorporated by reference for purposes of algorithms for generating, transmitting and decoding rolling identifiers and other data.

The method 300 also illustrates operations that may be implemented in the proximity broadcast receiver 142. In block 312, the proximity broadcast receiver 142 may receive the broadcast message from the wireless identity transmitter 110. The proximity broadcast receiver 142 may receive the broadcast message when within proximity of the wireless identity transmitter 110 (i.e., within communication range). When the broadcasted message with included identifier is received, the proximity broadcast receiver 142 may analyze header or metadata within the received broadcast message, as well as parse and evaluate various data within the broadcast message. In an embodiment, the broadcast message may contain encrypted and non-encrypted data that the proximity broadcast receiver 142 may or may not be configured to decrypt or otherwise access. In block 314, the proximity broadcast receiver 142 may transmit a sighting message to the central server 120 including the identifier, location information, and time corresponding to the receipt of the broadcast message. This transmission may be accomplished via a wireless wide area network, such as a cellular data network coupled to the Internet. In various embodiments, the operations in blocks 312 and 314 may be performed by a stationary proximity broadcast receiver, a mobile proximity broadcast receiver, or alternatively, an identity transceiver (e.g., a smartphone configured to operate as both a transmitter and a receiver).

In general, sighting messages may include metadata or header information that may describe received broadcast messages (e.g., message size, indicators of subject matter, etc.), the proximity broadcast receiver 142, such as the proximity broadcast receiver identification (e.g., a code, username, etc.), indications of services with which the proximity broadcast receiver 142 is affiliated regarding the server (e.g., the proximity broadcast receiver 142 participates in a tracking program for a particular vendor, merchant, area, etc.), as well as the conditions at the time of receipt of the broadcast message. For example, the sighting message may include signal strength information of the received broadcast message. In an embodiment, sighting messages may each include codes, flags, or other indicators that describe the general topic, subject matter, or reason for the sighting message. For example, the sighting message may contain a flag that indicates a relation to an active alert.

Additionally, sighting messages may include location information of the proximity broadcast receiver 142. In particular, sighting messages may indicate network-specific information that relates to a location. For example, a sighting message may indicate the cell site (e.g., cell site ID), cellular network tower (e.g., cell tower ID), or other wireless network with which a mobile proximity broadcast receiver was in communication at the time of receipt of the broadcast message. Further, sighting messages may include more refined location information based on data from global positioning systems (GPS) or chips included within the proximity broadcast receiver 142. For example, the proximity broadcast receiver 142 may determine GPS information (i.e., GPS coordinates) of the proximity broadcast receiver 142 at the time of receipt of a broadcast message, including the coordinates in the corresponding sighting message. In an embodiment, sighting messages may also include sensor data from various sensors within the proximity broadcast receiver 142, such as accelerometers, gyroscopes, and magnetometers. Further, sighting messages may include authentication information that may confirm the legitimacy of the sighting message as coming from a known, registered, or otherwise valid proximity broadcast receiver 142. For example, authentication information included in a sighting message may include secret codes, certificates, or hash data that is shared between the proximity broadcast receiver and the central server 120.

In various embodiments, the proximity broadcast receiver 142 may generate sighting messages by appending data and various information to broadcast messages received from the wireless identity transmitter 110. In an embodiment, sighting messages may include the entirety of received broadcast messages or, alternatively, only portions of the received broadcast messages that the proximity broadcast receiver 142 determines to be of significance. For example, the proximity broadcast receiver 142 may extract particular header or metadata information from a broadcast message before generating a corresponding sighting message. As another example, the proximity broadcast receiver 142 may compress, abbreviate, truncate and/or summarize data within the broadcast message. In another embodiment, the proximity broadcast receiver 142 may simply redirect, relay, or retransmit received broadcast messages to the central server.

Sighting messages may be transmitted via a wireless or wired communication link, such as a wireless cellular network, a local area network configured to communicate via Internet protocols, a long-range radio communication link, or a short-range radio. For example, the proximity broadcast receiver 142 may transmit sighting messages over a cellular network via the Internet to the central server. As another example, the proximity broadcast receiver 142 may transmit sighting messages via a wired Ethernet connection.

Returning to FIG. 3, the method 300 also illustrates operations that may be implemented in the central server 120. In block 322, the central server 120 may receive the sighting message from the proximity broadcast receiver 142. In block 324, the central server 120 may associate an identifier indicated by the sighting message with the wireless identity transmitter 110. The central server 120 may associate the identifier within the sighting message with an account registered/created by a user. Associating the identifier with a particular wireless identity transmitter 110 or user account may be accomplished by comparing the identifier with a database of codes corresponding to the wireless identity transmitter 110 or user accounts to determine the database record in which information from the sighting message (e.g., location info) should be stored. Since in some embodiments the wireless identity transmitter 110 identifier changes (rolls) frequently, this process may involve comparing the identifier received in the sighting message to several possible serial codes generated by a pseudo-random number generator algorithm, or applying a reverse algorithm which uses the received identifier as an input and outputs the corresponding account number. In block 326, the central server 120 may store data from the sighting message in a database, such as location information and time data. For example, the central server 120 may determine the location of the proximity broadcast receiver 142 when the broadcast message was received based evaluating the received sighting message, and may store that data in a database linked to the wireless identity transmitter 110 or its user/owner.

In block 340, the central server 120 may perform an action in response to the sighting message, such as transmit a message to a recipient, send a coupon, and/or calculate rewards. In an embodiment, the central server 120 may transmit a return message to a recipient, such as the proximity broadcast receiver 142, that includes instructions, software, or codes indicating how the proximity broadcast receiver 142 may respond to the received broadcast message. For example, the return message may direct the proximity broadcast receiver 142 to transmit a link advertisement message. Recipients of such messages from the central server may include various devices and parties, including computing devices of registered services (e.g., merchants, emergency personnel), mobile devices of users, and proximity broadcast receivers (e.g., the proximity broadcast receiver 142 that received the broadcast message). In another embodiment, the central server 120 may use the stored data to identify when the wireless identity transmitter 110 enters, is within, and/or leaves a designated area. In other words, the central server 120 may identify when the wireless identity transmitter 110 comes within proximity, stays within proximity, or leaves proximity of a proximity broadcast receiver 142.

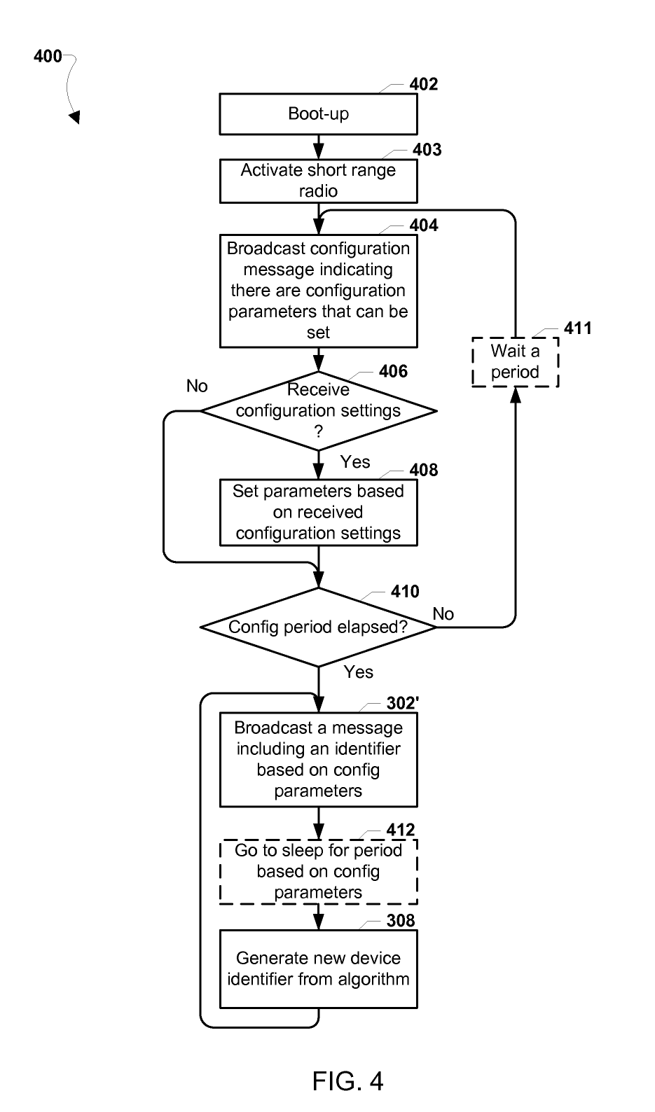

FIG. 4 illustrates an embodiment method 400 for a wireless identity transmitter (referred to as “WIT” in FIG. 4) receiving configuration settings after performing boot-up operations. Typically, wireless identity transmitters may only perform one-way communications, broadcasting signals for receipt by proximity broadcast receivers. However, wireless identity transmitters may be configured to selectively engage in two-way communications with other devices with similar short-range wireless signaling capabilities (e.g., Bluetooth® LE transceivers). In particular, upon initialization operations (or “booting-up”), a wireless identity transmitter may be configured to receive incoming short-range wireless communications from proximity broadcast receivers. For example, when a battery is replaced or inserted for the first time, the wireless identity transmitter may accept incoming Bluetooth® packets for a predefined period of time, such as sixty seconds. Alternatively, the wireless identity transmitter may receive incoming messages as part of power-cycling (e.g., receive for the sixty seconds after a reboot of the wireless identity transmitter).

Such incoming short-range wireless communications may include instructions, software, firmware, commands, or other code for setting values for configuration parameters utilized by the wireless identity transmitter for performing various functions. In particular, the incoming communications may include configuration settings (or values) the wireless identity transmitter may use to set or modify established configuration parameters associated with transmitting broadcast messages that include identification information of the wireless identity transmitter. In an embodiment, incoming communications that include configuration settings may be Bluetooth® signals (e.g., setters or getters) that may not require pairing operations between the sender and receiver (i.e., the wireless identity transmitter). In other words, the incoming communications may be non-pairing Bluetooth® advertisements.

Configuration parameters may include the transmit interval for transmitting broadcast messages (i.e., how often the wireless identity transmitter should broadcast packets that include its identity) and the transmit power for transmitting broadcast messages (i.e., what signal strength to use when broadcasting). For example, received configuration settings may vary the intervals (i.e., broadcasting frequency) at which the wireless identity transmitter broadcasts its identifier in a manner configured to facilitate accurate tracking of the wireless identity transmitter while conserving battery power. This may be important as setting transmit power configuration parameters may affect the battery service life of the wireless identity transmitter (e.g., a longer interval may include a longer sleep mode and thus decreased power consumption). In an embodiment, configuration parameters may also include a debug parameter that may be set or modified by a manufacturer or administrative party (e.g., a central server). The debug parameter may be utilized by software or algorithms executed by the wireless identity transmitter and may indicate when the wireless identity transmitter should generate new identifiers to broadcast (e.g., an interval for generating a new rolling identifier or Bluetooth® MAC address identifier). In another embodiment, incoming communications with configuration settings may include commands that instruct the wireless identity transmitter to change the data represented within broadcast messages, such as by entering/exiting an encoded mode. Alternatively, incoming communications may include instructions for the wireless identity transmitter to shorten its broadcast signal range to emulate near field communications (NFC).

In block 402, the wireless identity transmitter may boot-up. In other words, the wireless identity transmitter may be energized, initialized, and otherwise configured to operate from a hibernating, sleep, dormant, or otherwise deactivated state. In various embodiments, the boot-up operations may be performed in response to a user input (e.g., a button press), the insertion of a battery in the wireless identity transmitter, or receiving a short-range wireless signal (e.g., an activation signal). In block 403, the wireless identity transmitter's short-range radio may be activated. This activation may be accomplished by a timer or by the microcontroller determining that a duration has expired since the boot-up operations were performed or concurrently with the boot-up operations. In an embodiment, the activation of the short-range radio may be a routine within the boot-up operations in block 402.

In block 404, the wireless identity transmitter may broadcast a configuration message indicating there are configuration parameters that can be set in the wireless identity transmitter. For example, the configuration message may include the wireless identity transmitter's identity (or identifier) as well as an indication that a certain number or type of configuration parameters can be set, modified, or initialized by subsequent short-range wireless signals. In an embodiment, the configuration message may include a list of configuration parameters available to be set, such as the transmit interval.

In an alternative embodiment, the configuration message may include an indicator that the wireless identity transmitter is available to receive configuration settings. In such an embodiment, any responding devices, such as proximate proximity broadcast receivers, may transmit responses (e.g., Bluetooth® LE signals) that request the list of configuration parameters. In response to receiving such a request, the mobile proximity broadcast receiver may transmit a second message that includes the list of configuration parameters.

In determination block 406, the wireless identity transmitter may determine whether configuration settings are received, such as in a short-range wireless signal from a proximate proximity broadcast receiver or identity transceiver. The wireless identity transmitter may monitor the short-range radio to determine whether a response is received from a proximate device. A response may be in the form of a simple response packet or pulse that the wireless identity transmitter microcontroller can recognize, or alternatively, an advertisement according to the Bluetooth® LE protocol. If configuration settings are received (i.e., determination block 406=“Yes”), in block 408 the wireless identity transmitter may set parameters based on the received configuration settings. For example, the wireless identity transmitter may set a value that indicates how often it transmits broadcast messages. If no configuration settings are received (i.e., determination block 406=“No”), or if the wireless identity transmitter performs the operations in block 408, in determination block 410 the wireless identity transmitter may determine whether a configuration period has elapsed. For example, the wireless identity transmitter may evaluate a counter or timer to determine whether a predefined number of seconds (e.g., 60 seconds) have elapsed since the boot-up operations were performed. If the configuration period has not elapsed (i.e., determination block 410=“No”), in optional block 411 the wireless identity transmitter may wait a period, such as a number of milliseconds, seconds, etc., and then may continue with the operations in block 404.

However, if the configuration period has elapsed (i.e., determination block 410=“Yes”), in block 302′ the wireless identity transmitter may broadcast a message including an identifier based on the configuration parameters. For example, the wireless identity transmitter may transmit a broadcast message at a signal strength indicated by configuration parameters set in response to receiving configuration settings (or values) from a nearby proximity broadcast receiver. In optional block 412, the wireless identity transmitter may go to sleep for a period based on the configuration parameters, such as a transmit interval configuration parameter. In block 308, the wireless identity transmitter may generate a new device identifier (e.g., rolling identifier) from an algorithm, and may continue with the operations in block 302′.

In alternate embodiments, the wireless identity transmitter may be configured to receive incoming messages from proximity broadcast receivers based on clock timing (or clock signals), detected inputs from a user (e.g., a detected button press), or information within a previously received signal (e.g., a received message from a proximity broadcast receiver may instruct the wireless identity transmitter to become available for subsequent messages at a particular future time).

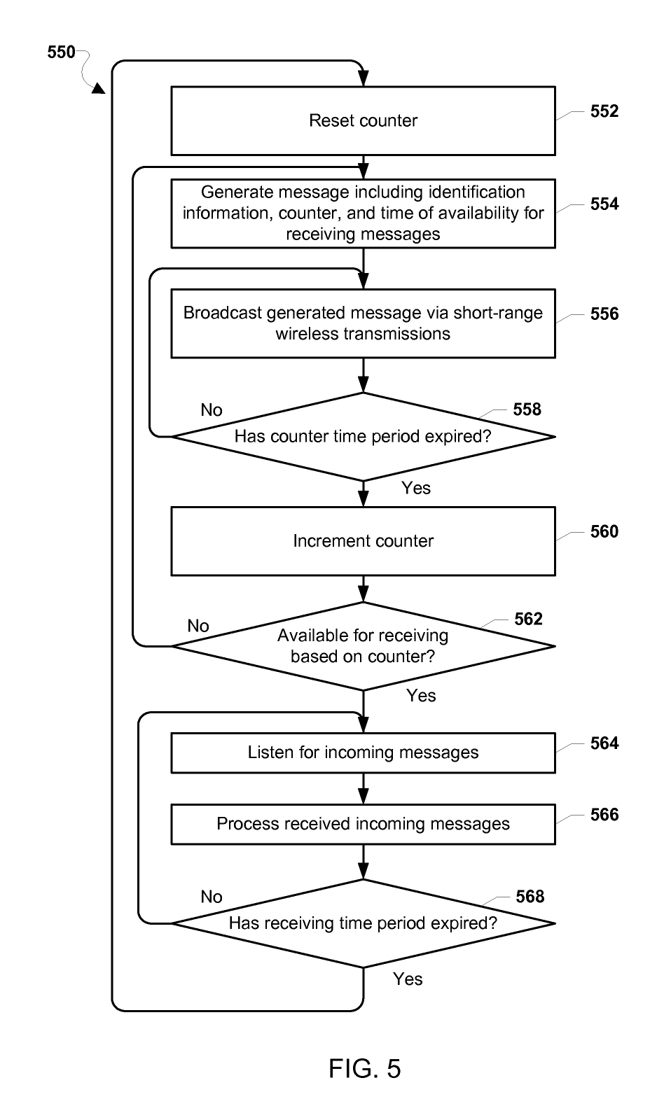

FIG. 5 illustrates an embodiment method 550 for a wireless identity transmitter performing two-way wireless communications with a proximity broadcast receiver. As described above, wireless identity transmitters may typically be used for one-way signaling, such as transmitting broadcast messages for receipt, use, and relay by proximity broadcast receivers. However, wireless identity transmitters may be configured to conduct two-way communications in order to receive firmware, software instructions or trigger signals directing the transmitter to perform certain operations (e.g., activate sensors), configuration data, and other information the wireless identity transmitter may use to transmit broadcast messages. Such two-way communications may be available to wireless identity transmitters that include short-range radio transceivers, such as Bluetooth® radios. However, wireless identity transmitters may be configured to selectively engage in two-way communications with proximity broadcast receivers to minimize power consumption and maximize battery service life. In an embodiment, the wireless identity transmitter may broadcast messages indicating to proximity broadcast receivers a period of time when the wireless identity transmitter may be available for receiving messages from proximity broadcast receivers, and may receive messages for a limited or predefined period of time.

In block 552, the wireless identity transmitter may reset a counter, such as a counter variable to indicate the beginning (or initialization) of a period during which the wireless identity transmitter may not receive messages. The counter may be reset to a zero value and may be incremented up to a predefined number during the operations of the method 550. Alternatively, the counter may be reset or initialized at a predefined number and decremented down to a zero value. The use of a counter variable is merely a non-limiting example technique for the wireless identity transmitter determining when to configure itself for receiving messages. In alternate embodiments, the wireless identity transmitter may instead determine when to be available for receiving incoming messages based on clock timing (or clock signals), detected inputs from a user (e.g., a detected button press), information within a previously received signal (e.g., a received message from a proximity broadcast receiver may instruct the wireless identity transmitter to become available for subsequent messages at a particular future time), or power-cycling (e.g., one such time might be for the sixty seconds after initial boot-up or reboot of the wireless identity transmitter).

In an embodiment, the wireless identity transmitter may be roughly in clock synchronization with or maintain the counter variable that it is known and roughly tracked by various proximity broadcast receivers (e.g., smartphones, listening radios throughout a place, etc.) and/or a central server. For example, when the wireless identity transmitter is activated (e.g., turned on, initialized by inserting a battery, etc.), a user may register the wireless identity transmitter with a central server that stores the wireless identity transmitter identification along with information that enables the central server to estimate a nonce or counter value or clock timing within the wireless identity transmitter. In an embodiment, such a nonce or counter variable or clock synchronization may be used to disambiguate wireless identity transmitter identities and/or be used as a decryption key for obfuscated or encoded messages. Such registration and synchronization operations are described further below.

In block 554, the wireless identity transmitter may generate a message including identification information, counter, and time of availability for receiving messages. The generated message may include information about the wireless identity transmitter's identity (e.g., a serial code/number, a username, or a rolling identifier). In an embodiment, the generated message may be encrypted, encoded, or otherwise obscured to prevent proximity broadcast receivers from determining the identity of the wireless identity transmitter and/or the user thereof. For example, the generated message may employ a rolling identifier or code known only to the wireless identity transmitter and a central server but not proximity broadcast receivers.

The generated message may also include information indicating a time or condition when the wireless identity transmitter may be available for accepting communications for proximity broadcast receivers. For example, the message may describe the current value of the counter or indicate a count-down timer showing when the wireless identity transmitter may be available. In another embodiment, the generated message may include instructions for proximity broadcast receivers to enable successful transmissions to the wireless identity transmitter. For example, the generated message may contain specifications (e.g., required codes, content, delivery time, etc.) for any messages transmitted by proximity broadcast receivers to the wireless identity transmitter.

In block 556, the transmitter may broadcast the generated message via short-range wireless transmissions, such as Bluetooth® LE packets. If within the range of the short-range broadcasts, a proximity broadcast receiver may receive and process the broadcasts as described below.

The wireless identity transmitter may periodically broadcast the same generated message multiple times for each counter time period. In other words, the wireless identity transmitter may broadcast the generated message more than once before modifying the counter variable value. In determination block 558, the wireless identity transmitter may determine whether the predetermined counter time period has expired. If the counter time period has not expired (i.e., determination block 558=“No”), the wireless identity transmitter may continue to broadcast the generated message periodically in block 556.

If the counter time period has expired (i.e., determination block 558=“Yes”), in block 560 the wireless identity transmitter may increment the counter and, in determination block 562, determine whether the wireless identity transmitter has become available for receiving messages based on the counter value. For example, the wireless identity transmitter may compare the current counter variable value to a predefined maximum (or minimum) counter value. As stated above, in various other embodiments, the wireless identity transmitter may determine availability for receiving messages based on other evaluations of time or instructions stored within the wireless identity transmitter.

If it is not available to receive messages (i.e., determination block 562=“No”), the wireless identity transmitter may continue with the operations in block 554 to generate a new message to broadcast. If the wireless identity transmitter is available to receive messages (i.e., determination block 562=“Yes”), in block 564 the wireless identity transmitter may listen for incoming messages, such as by monitoring a receiver circuit for incoming short-range radio transmissions, and in block 566 the wireless identity transmitter may process any received incoming messages, such as with software or operations running on a processor or wireless modem within the wireless identity transmitter.

In determination block 568, the wireless identity transmitter may determine whether the receiving time period has expired. In other words, the wireless identity transmitter may determine whether incoming messages may still be received. The time period for receiving incoming messages may be based on a nonce or counter variable maintained by the wireless identity transmitter, a clock signal indication, or information within a received message. If the receiving time period has not expired (i.e., determination block 568=“No”), the wireless identity transmitter may continue to listen for incoming messages in block 564. However, if the receiving time period has expired (i.e., determination block 568=“Yes”), the wireless identity transmitter may repeat the process by returning to block 552.

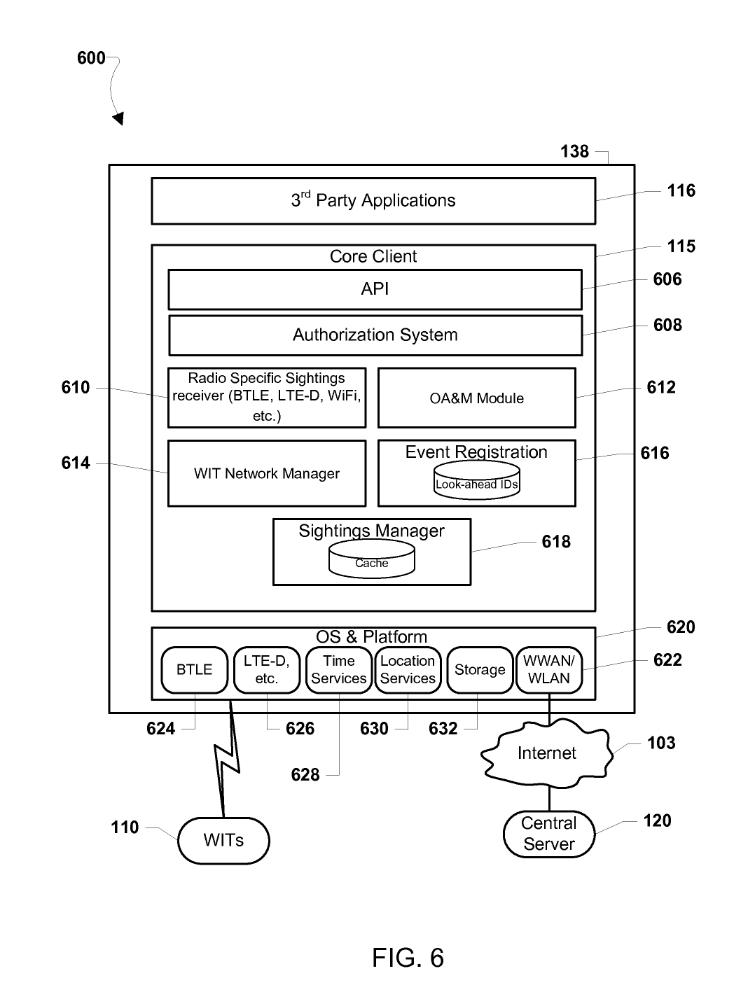

FIG. 6 illustrates various modules within a mobile proximity broadcast receiver 138. As described above, proximity broadcast receivers may include stationary proximity broadcast receivers, such as dedicated devices placed around a building, and mobile proximity broadcast receivers 138, such as mobile devices that are configured to perform operations to receive broadcast messages from wireless identity transmitters 110 and transmit sighting messages over the Internet 103 to a central server 120 via long-range communications (e.g., via WiFi or a cellular network). The various modules and components are described below in the context of elements within a mobile proximity broadcast receiver 138, however in various embodiments, any proximity broadcast receiver, such as a stationary proximity broadcast receiver, may include similar modules and/or components.

The mobile proximity broadcast receiver 138 may include a core client module 115 that may be software, instructions, routines, applications, operations, or other circuitry utilized to process received broadcast messages from proximate wireless identity transmitters 110. The core client module 115 may also handle communications between the proximity broadcast receivers 142, 138 and the central server 120, such as transmitting sighting messages and receiving return messages from the central server 120. For example, the core client module 115 may operate as a background service that performs operations, such as uploading or transmitting sighting messages, without interaction from a user.

The core client module 115 may include an API component 606 that corresponds to application programming interface data, code, or other commands related to broadcast messages and/or sighting messages. For example, the API component 606 may be utilized by a proximity broadcast receiver when listening for Bluetooth® LE advertising packets received from the wireless identity transmitter 110. As another example, the API component 606 may be utilized to register the mobile proximity broadcast receiver 138 to receive notifications, alerts, or other communications corresponding to wireless identity transmitters 110. The core client module 115 may also include an authorization system component 608 for processing received broadcast messages. For example, the mobile proximity broadcast receiver 138 may support oAuth for authorization requests and xAuth for approved communication partners. The core client module 115 may also include a radio specific sightings receiver component 610 (e.g., a component for handling Bluetooth® LE, LTE-D, WiFi, and other communications), an operations, administration, and management module 612, a wireless identity transmitter network manager component 614, an event registration component 616 that relates to stored look-ahead identifiers, and a sightings manager component 618. In an embodiment, the event registration component 616 may store numerous rolling identifiers downloaded from the central server 120 and corresponding to a particular wireless identity transmitter 110, such as a set of rolling identifiers that may match possible rolling identifiers broadcast by the wireless identity transmitter 110 during a certain time window.

Like many modern mobile devices, the mobile proximity broadcast receiver 138 may be configured to execute third-party applications (or “apps”), and thus may include a third-party applications module 116 that may execute, manage, and otherwise perform software instructions and routines related to applications provided by various third-parties (e.g., merchants). For example, the third-party applications module 116 may receive various data from the core client module 115 to be used by various third-party applications. For illustration purposes, a third-party application related to a department store that is registered with the central server 120 may be configured to receive notifications from the core client module 115 when the user of the mobile proximity broadcast receiver 138 enters, remains, and/or leaves the department store (e.g., a geofence of the store). In an embodiment, for optimization purposes, applications or apps executing via the third-party applications module 116 may register or otherwise be configured to received notifications from the core client module 115 when particular wireless identity transmitters are within proximity, or alternatively, leave proximity. For example, applications may register in advance with the core client module 115 to receive event notifications that indicate whether a particular wireless identity transmitter enters proximity, stays within proximity (e.g., standing nearby and not moving), or leaves proximity of a proximity broadcast receiver.

The mobile proximity broadcast receiver 138 may also include an operating system and platform module 620 for performing various operations and managing circuitry, such as short-range signal receiver circuitry. In particular, the operating system and platform module 620 may include a Bluetooth® Low Energy module 624 for processing communications utilizing Bluetooth® LE protocols, a cellular network module 626 for processing communications corresponding to various cellular and similar long-range wireless networks (e.g., LTE-D, etc.). The operating system and platform module 620 may also include a time services component 628 that may track time and generate timestamp data, a location services component 630 that may maintain low-precision location data or alternatively more precise GPS (or A-GPS) location data, a storage component 632, and a wireless wide area network/wireless local area network component 622 for enabling communications via WiFi or other wireless networks.

In an embodiment, the core client module 115 may request from the central server sets of wireless identity transmitter identifiers (e.g., rolling identifiers of all transmitters on an interested list, identifiers for all transmitters owned by a user, etc.). Such sets may correspond to wireless identity transmitters that are currently in use and are expected to be in use for some period of time.

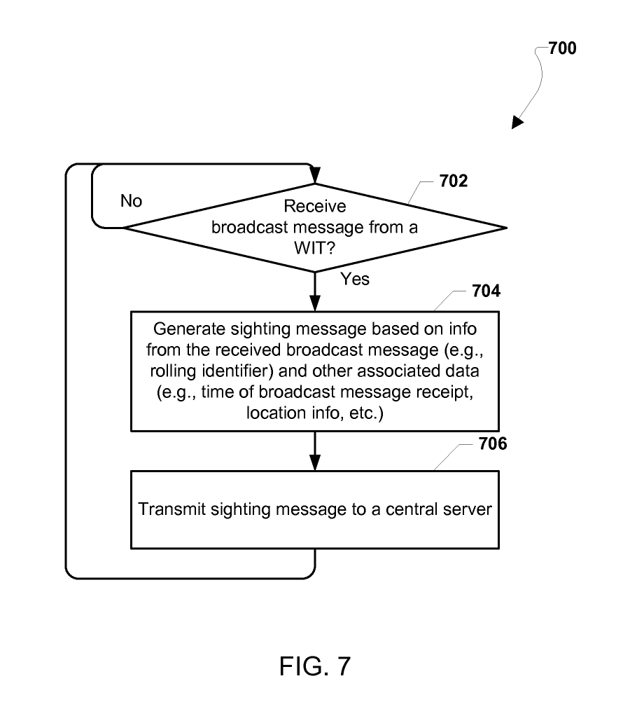

FIG. 7 illustrates an embodiment method 700 that may be implemented on a proximity broadcast receiver, such as a stationary proximity broadcast receiver or a mobile proximity broadcast receiver. In determination block 702, the proximity broadcast receiver may determine whether a broadcast message is received. For example, the proximity broadcast receiver may begin listening for broadcast advertisement packets or pairing attempts by wireless identity transmitters. As discussed above, in the passive mode/embodiment, the proximity broadcast receiver may continuously be in a monitoring mode, or begin listening for particular identifiers in response to an alert (or search activation message) received from a central server. In embodiments in which pairing takes place, the pairing may be established automatically if the proximity broadcast receiver is set to pair with any wireless identity transmitter without using a key, by using a key saved from a previous pairing with the wireless identity transmitter, or by using a key received from a central server. If the proximity broadcast receiver does not receive a broadcast message (i.e., determination block 702=“No”), the proximity broadcast receiver may continue with the operations in determination block 702.

If the proximity broadcast receiver receives a broadcast message (i.e., determination block 702=“Yes”), in block 704 the proximity broadcast receiver may generate a sighting message based on information from the received broadcast message and other associated data. In particular, the sighting message may include an identifier specific to the wireless identity transmitter that transmitted the received broadcast message, such as a rolling identifier (i.e., an encoded device identifier), MAC address, or other unique code that may be used to identify the particular wireless identity transmitter. In alternate embodiments, the wireless identity transmitter's identifier may be received as part of a pairing process. The other associated data may include various information related to the receipt of the broadcast message, such as the time the proximity broadcast receiver received the broadcast message, location information, the proximity broadcast receiver's identification information, related services (e.g., associated merchants), and signal strength information. In other words, the proximity broadcast receiver may associate data about present conditions (e.g., a timestamp, GPS coordinates, Cell ID of the closest base station, etc.) with the broadcast message and/or the wireless identity transmitter's identifier. This data may be stored in any of various types of data structures, such as an array with one or more identifiers associated with timestamps and GPS coordinates from when the sighting corresponding to each identifier occurred. In an embodiment, the sighting message may include authentication data, such as a digital certificate or code, that may be used by a central server to confirm the identity of the proximity broadcast receiver. For example, within the metadata of the sighting message, the proximity broadcast receiver may include a special hash code known only to the proximity broadcast receiver and the central server.

In block 706, the proximity broadcast receiver may transmit the sighting message to a central server, such as via a cellular (e.g., an LTE, 3G, or 4G network) or other network and the Internet as discussed above with reference to FIGS. 2A-2B. Upon reporting a contact event by transmitting the sighting message, the proximity broadcast receiver may promptly return to perform the operations in determination block 702 and await further broadcasts from wireless identity transmitters. This enables the proximity broadcast receiver to continuously report contact events to the central server.

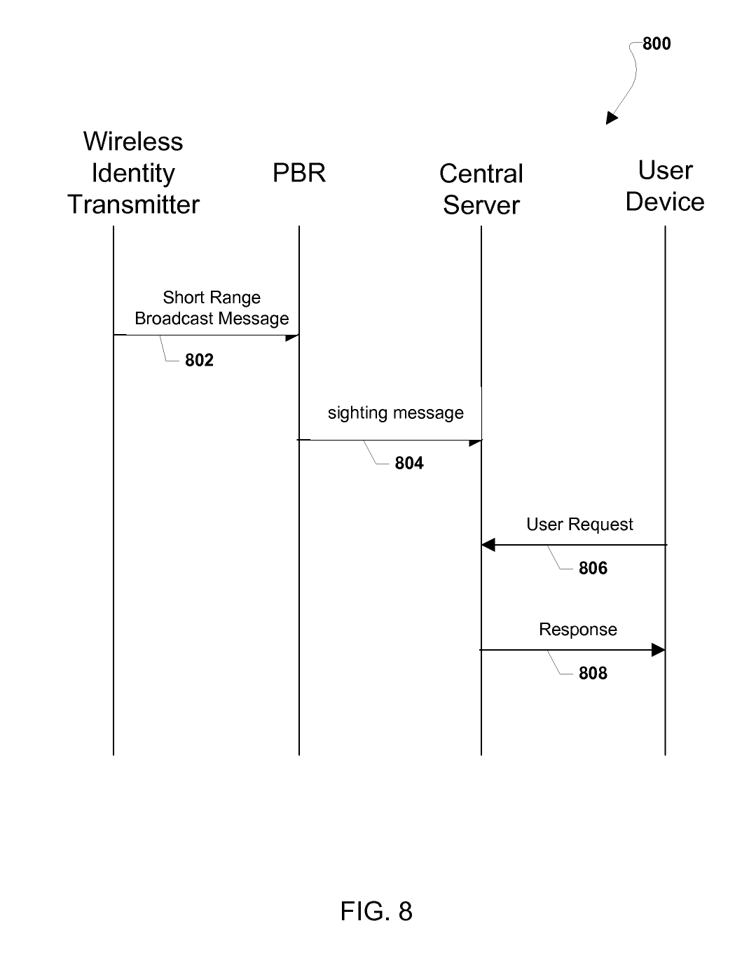

FIG. 8 is a call flow diagram 800 illustrating communications during various embodiments. A wireless identity transmitter 110 may transmit a short-range broadcast message 802 (e.g., a Bluetooth® LE signal) to a proximity broadcast receiver, such as a mobile proximity broadcast receiver (e.g., a mobile device, cellular phone, etc.) or various other proximity broadcast receivers as discussed above. The broadcast message 802 may contain an identifier for the wireless identity transmitter. The proximity broadcast receiver may transmit (or upload) the wireless identity transmitter's identifier along with any associated data (e.g., timestamp, GPS coordinates, Cell ID, etc.) as a sighting message 804 to a central server 120. The central server 120 may receive the sighting message 804 and store many different identifiers from one or more proximity broadcast receivers.

In some embodiments, identifiers and the associated data may be transmitted (or uploaded) to the central server without any of a user's personal data to protect privacy. In the various embodiments attempting to leverage personal mobile phones, the phone users may opt-in as mobile proximity broadcast receivers. However, these phone users may refuse to opt-in if they fear that personally identifiable data will also be transmitted to the central server. Therefore, an application for uploading received identifiers installed on these personal mobile devices (i.e., mobile proximity broadcast receivers) may prohibit transmission of personal data or other data that may identify the mobile proximity broadcast receivers.

The central server 120 may receive a user request 806 from a user device, such as a terminal 124 or a mobile device, requesting the location of a wireless identity transmitter. This request may be sent by a user after logging into an account associated with a particular wireless identity transmitter. For example, each wireless identity transmitter may be registered with an authenticated user such that a request 806 for the registered wireless identity transmitter's location can only be transmitted after the authenticated user logs into a secure account.

After receiving a user request 806, the central server 120 may search through the previously reported wireless identity transmitter identifiers that are received via sighting messages to find any matches with the identifier of the requested wireless identity transmitter. Any matches could be reported to the user in a response 808. The response 808 may also include associated data (e.g. timestamp, GPS coordinates, Cell ID) within the sighting message 804. A user may use this associated data to help locate or track the wireless identity transmitter (e.g., a mother could look for a lost child at the latest location reported for the child's wireless identity transmitter).

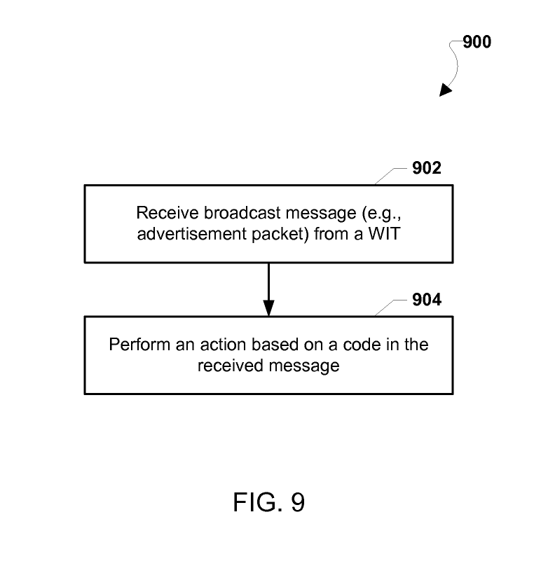

FIG. 9 illustrates an embodiment method 900 for including a type or command segment. In block 902, a proximity broadcast receiver may receive a broadcast message, such as a broadcast advertising packet, from a wireless identity transmitter (referred to as “WIT” in FIG. 9). In alternate embodiments, this message may be sent over a connection established by pairing or as part of the pairing procedure. The broadcast message may contain an identifier segment, as well as an additional segment or code, such as a type segment or command segment. The proximity broadcast receiver may perform an action based on this code in the received broadcast message in block 904. In various embodiments, this action may include any operation the proximity broadcast receiver is capable of performing. For example, the proximity broadcast receiver may assign different levels of priority to messages or identifiers based on a type segment or command segment (e.g., child safety devices have higher priority than security tags from stores). Received messages or identifiers with higher priority may be transmitted to a central server first or deleted last from a proximity broadcast receiver's local log.

A proximity broadcast receiver may handle the broadcast message or identifier differently based on a type or command segment. For example, the message may be stored locally for a certain time (e.g., various times depending on the value of the segment) prior to being transmitted to a central server. Alternatively, the message or identifier, along with any associated data such as timestamps and GPS coordinates, may be transmitted to multiple locations.

As another example, a proximity broadcast receiver may initiate various communications based on the type and/or command segments. The proximity broadcast receiver may report to particular URLs, transmit an SMS message, initiate a phone call, or establish new network connections. In various embodiments, some of these actions may be optionally disabled to protect user privacy.

In further embodiments, the proximity broadcast receiver may be configured to transmit the additional segment or other message to another network device for the other network device to take some action. For example, the proximity broadcast receiver may forward the message along with associated data to the central server. The central server may perform an action based on the additional segment in the message, such as automatically sending a message to a user without waiting for a user request.

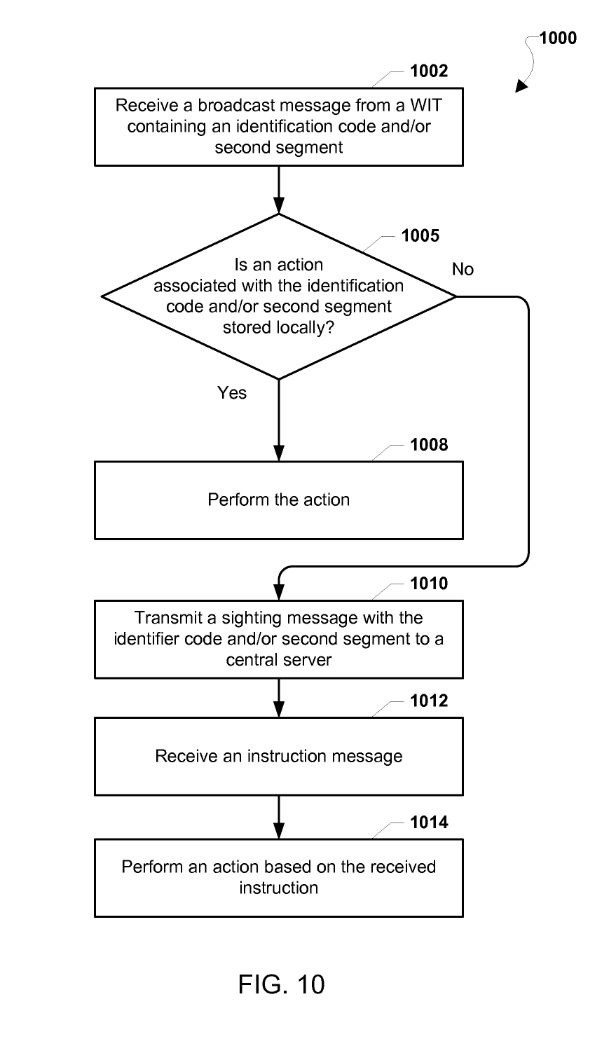

FIG. 10 illustrates an embodiment method 1000 for providing content based on proximity to a wireless identity transmitter. A proximity broadcast receiver may receive a broadcast message from a wireless identity transmitter (referred to as “WIT” in FIG. 10) containing an identification code and/or second segment in block 1002. The proximity broadcast receiver may determine whether an action associated with the identification code and/or second segment is stored locally (e.g., in the proximity broadcast receiver's memory) in determination block 1005. If an associated action is found locally (i.e., determination block 1005=Yes), the action may be performed by the proximity broadcast receiver in block 1008.

If an associated action is not found locally (i.e., determination block 1005=No), the proximity broadcast receiver may transmit a sighting message with the identifier and/or second segment to a central server in block 1010. In an embodiment, the proximity broadcast receiver may transmit a message to another device, such as a user device. The proximity broadcast receiver may receive an instruction message in block 1012. This instruction may be sent by the central server or other device in response to the sighting message with the identifier and/or second segment. In block 1014, the proximity broadcast receiver may perform an action based on the received instruction message, such as access content by going to a web page or other online resource. In alternate embodiments, the proximity broadcast receiver may skip the determination block 1005 and automatically proceed to either transmit a sighting message in block 1010 or attempt to perform an action stored locally.

A proximity-based content publishing system may be used for a wide range of activities. For example, teens may carry a wireless identity transmitter with them that they point to their social networking pages (e.g., Facebook®). When they are proximate to friends, the pages can be quickly accessed on proximity broadcast receivers (i.e., mobile phones configured to operate as mobile proximity broadcast receivers). Realtors may setup a web page for a home and affix to the home's signpost a wireless identity transmitter pointing to the web page so that anyone driving by the home can access that information. Stores may include wireless identity transmitters with products to provide dynamic displays such as links to coupons, customer reports, or additional nutritional information. If a lost dog has a wireless identity transmitter on its collar, instead of trying to wrestle the dog for access to his collar, a proximity broadcast receiver may simply access the wireless identity transmitter and send a message or call the owner.

The various features and alternative actions may enable the system to have flexible and extensible functionality. The functionality could be added later as the actions taken are controlled by applications that may be updated in proximity broadcast receivers over time.

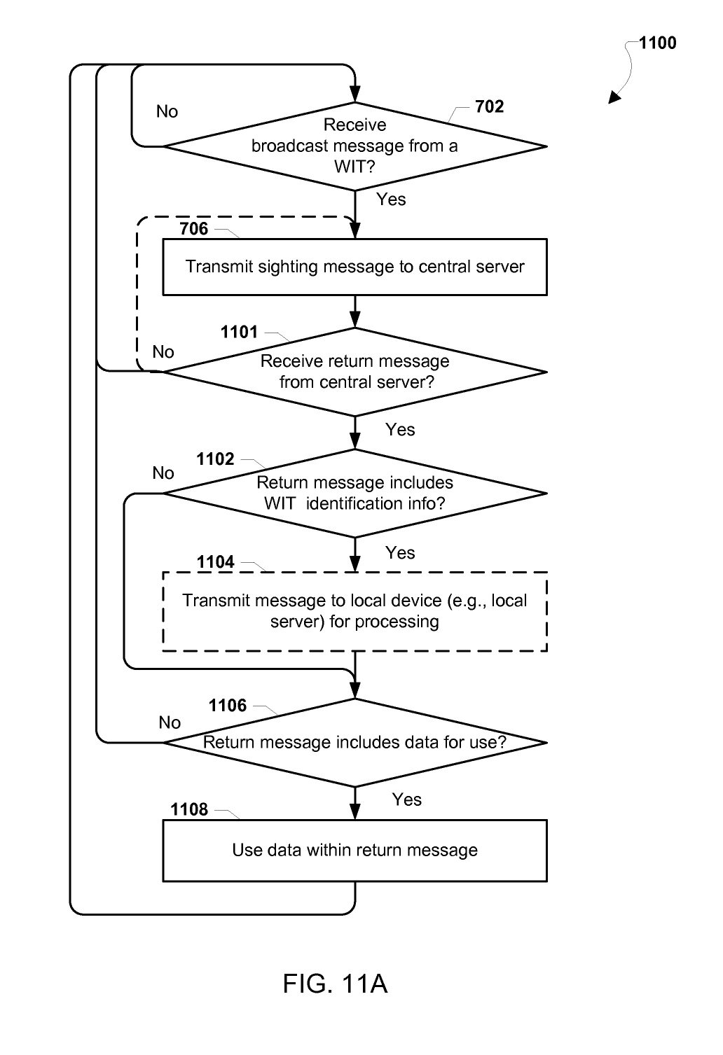

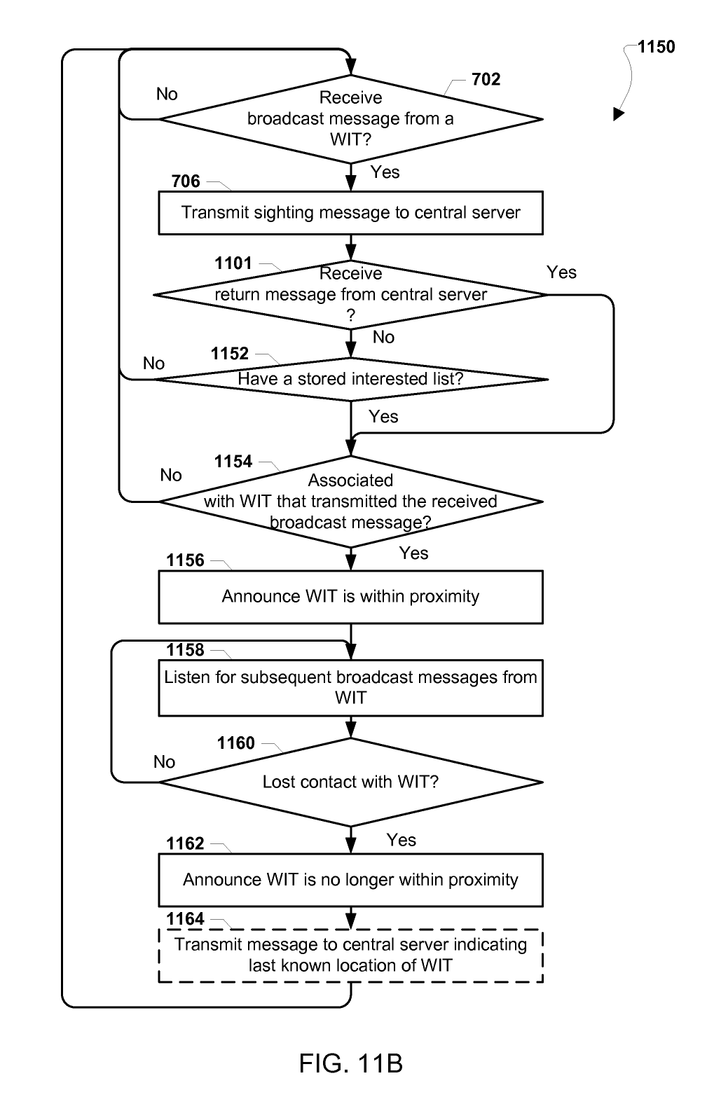

FIG. 11A illustrates an embodiment method 1100 for a proximity broadcast receiver relaying a broadcast message to and receiving a return message from a central server. Proximity broadcast receivers may be connected to facilities, such as houses, stores, gyms, schools, etc., and may be configured to execute various operations relating to those facilities. For example, a proximity broadcast receiver may be contained within equipment that executes software routines. Such proximity broadcast receivers may be configured to execute particular routines in response to receiving broadcast messages from a wireless identity transmitter (referred to as “WIT” in FIG. 11). For example, the proximity broadcast receiver may modify the execution of operations to suit preferences of the user of the wireless identity transmitter.

However, as discussed above, the wireless identity transmitter may obscure, encode, or encrypt data within broadcast messages to protect the privacy and identity of the wireless identity transmitter user. For example, the broadcast messages may not transmit the user's identity in the clear. To determine the identity information related to received broadcast messages, the proximity broadcast receiver may relay the broadcast messages to the central server, which may identify the wireless identity transmitter and its user based on information in the messages (e.g., a disguised, rolled, or encrypted device ID). As discussed above, the central server may store a secret to decrypt messages transmitted by the wireless identity transmitter. In response to receiving a sighting message, the central server may transmit a return message to the proximity broadcast receiver including identification information of the wireless identity transmitter.

In an embodiment, the central server may also store additional information relevant to the operations of the facility associated with the proximity broadcast receiver. For example, the central server may be an information hub that stores proprietary information related to the operations of the facility the proximity broadcast receiver is within. As another example, the central server may contain instructions for the proximity broadcast receiver to perform based on the identity of the wireless identity transmitter. Accordingly, the central server may transmit a return message that may not identify the wireless identity transmitter (or its user) related to a sighting message, but may instead includes data relevant to the wireless identity transmitter. In various embodiments, return messages may include or not include either data or identification information based on the preferences of the user of the wireless identity transmitter and/or the services associated with the proximity broadcast receiver. For example, the proximity broadcast receiver may be registered as relating to a trusted service for the user of the wireless identity transmitter, and therefore the central server may transmit return messages that identify the user. As another example, the user of the wireless identity transmitter may have set privacy permissions (or settings) during a registration procedure with the central server that enable anonymous data to be distributed to proximity broadcast receivers. Privacy permissions are further discussed below.

In determination block 702, the proximity broadcast receiver may determine whether a broadcast message is received, such as from a wireless identity transmitter. If no broadcast message is received (i.e., determination block 702=“No”), the proximity broadcast receiver may continue with the operations in determination block 702. If a broadcast message is received (i.e., determination block 702=“Yes”), in block 706 the proximity broadcast receiver may transmit a sighting message to a central server. For example, the sighting message may include identification information of the wireless identity transmitter as well as associated data, such as the location of the proximity broadcast receiver and a timestamp. In determination block 1101, the proximity broadcast receiver may determine whether a return message from the central server is received. In an embodiment, the proximity broadcast receiver may record identification information about the sighting message and may compare that information to received messages to find a match. If no return message is received (i.e., determination block 1101=“No”), the proximity broadcast receiver may continue with the operations in determination block 702. Alternatively, if no return message is received (i.e., determination block 1101=“No”), the proximity broadcast receiver may optionally re-transmit the sighting message to the central server in block 706. In an embodiment, the proximity broadcast receiver may retransmit sighting messages a predefined number of times over a period of time when no return message is received.

When a return message is received (i.e., determination block 1101=“Yes”), in determination block 1102 the proximity broadcast receiver may determine whether the return message includes wireless identity transmitter identification information. For example, identification information may include user names, addresses, sensitive information (e.g., social security number, banking information, passwords, etc.), and other data describing the wireless identity transmitter and/or the user of the wireless identity transmitter. If the return message does contain identification information (i.e., determination block 1102=“Yes”), in optional block 1104 the proximity broadcast receiver may transmit a message to a local device, such as a local server, for processing. In other words, the proximity broadcast receiver may relay the identification information in the return message to a local device associated with proximity broadcast receiver and/or the facility in which the proximity broadcast receiver is located. For example, the proximity broadcast receiver may transmit the identification information of the wireless identity transmitter to a local computing device of a gym, retail store, a school, or other third-party that may in turn determine instructions for the proximity broadcast receiver based on the identification information. In an embodiment, the local device may store the identification information and/or relate the information to database data for further use with the various related devices of the facility.

If the return message does not include identification information (i.e., determination block 1102=“No”) or the proximity broadcast receiver transmits a message to the local device in optional block 1104, the proximity broadcast receiver may determine whether the return message includes other data for use, such as by the proximity broadcast receiver or other devices associated with the proximity broadcast receiver in determination block 1106. For example, the return message may include commands or instructions for the proximity broadcast receiver to perform. Additionally, the data may contain configuration data (or configuration information) that may be used by various devices to accommodate the wireless identity transmitter and/or the preferences of the wireless identity transmitter's user. For example, the return message may contain software instructions for the proximity broadcast receiver to use or transfer to the local device, the wireless identity transmitter, or various other associated devices. If the return message includes data for use (i.e., determination block 1106=“Yes”), in block 1108 the proximity broadcast receiver may use the data within the return message. For example, the proximity broadcast receiver may execute operations to utilize configuration data from the return message (e.g., set equipment to suit the user's preferences). If the return message does not contain data for use by the proximity broadcast receiver (i.e., determination block 1106=“No”), the proximity broadcast receiver may continue with the operations in determination block 702.

As a non-limiting, illustrative example: the proximity broadcast receiver may be connected to a piece of exercise equipment within a fitness facility that is registered with a central server (i.e., the facility relates to a registered service). When the proximity broadcast receiver receives a broadcast message from the wireless identity transmitter carried by a user intending to work-out on the exercise equipment, the proximity broadcast receiver may transmit a sighting message to the central server. The proximity broadcast receiver may receive a return message from the central server that includes data which may be used to configure the exercise equipment to suit the anatomical dimensions and preferences of the user of the wireless identity transmitter without necessarily sharing the user's identity. For example, the proximity broadcast receiver may use the data to adjust the height of the equipment's seat or pedals. As another example, the data may define a workout routine to be executed on the exercise equipment. Alternatively, the return message may include the user's fitness facility identification, which the proximity broadcast receiver may transmit to a local server (e.g., a gym administrative server). The local server may compare the user's fitness facility identification to a local database and in response to the comparison, may transmit personalized configuration instructions to the proximity broadcast receiver and exercise equipment. Other non-limiting but illustrative applications of return message data may include configuring rental cars (e.g., seat positions, settings, etc.) and computer components (e.g., mouse, keyboards, etc.) for personalized use by the user of the wireless identity transmitter.

In an embodiment, return messages may include identification information such as photographic imagery useful to identify the user of the wireless identity transmitter. For example, in response to receiving a return message identifying the user of the wireless identity transmitter, the proximity broadcast receiver may display an image of the user or a sample of the user's handwriting (e.g., a signature). This functionality may be used by emergency personnel, citizens on alert, or merchants when attempting to quickly verify the identity of a person (e.g., a missing child, customer, etc.) equipped with a wireless identity transmitter. In another embodiment, a merchant's proximity broadcast receiver engaged in a business transaction (e.g., a point-of-sale device with an embedded proximity broadcast receiver) may transmit a sighting message including information broadcast by a proximate user's wireless identity transmitter. The resulting return message may include confirmation that the identities of the registered user of the wireless identity transmitter and the user match (i.e., the in-store person matches the user indicated in the central server as relating to the wireless identity transmitter). Additionally, if the identities are the same, the return message may include additional information to assist in the transactions, such as payment information, credit card numbers, or contact information for follow-up communications.

In another embodiment, the return message from the central server may include software instructions and/or data that may cause the proximity broadcast receiver to modify, adjust, remove, activate, or disable components, sensors, features, software, and/or functions of the proximity broadcast receiver. For example, the return message may include software instructions that the proximity broadcast receiver executes upon receiving the return message, or triggers the proximity broadcast receiver to execute a pre-loaded routine or enter a particular operating mode. Such software instructions may define operations the proximity broadcast receiver may execute that configure the proximity broadcast receiver, such as activating (or de-activating) a camera component, a cellular network modem, speaker systems, WiFi transceivers, etc. As another example, the return message may instruct the proximity broadcast receiver, such as a smartphone configured to operate as a mobile proximity broadcast receiver, to execute an application, transmit a message (e.g., email, SMS, short-range radio signal, etc.), or turn itself off. Software instructions within such return messages may include timing information that indicates when affected components, sensors, features, software, and/or functions may be configured and/or re-configured. For example, the return message may include instructions that cause the proximity broadcast receiver to disable a microphone for a certain period of time. In an embodiment, the proximity broadcast receiver may be configured to reverse any modifications, adjustments, operating mode selections, or other configurations identified in return message software instructions after a period of time and/or when the proximity broadcast receiver no longer receives broadcast messages from wireless identity transmitters related to the return message. For example, the proximity broadcast receiver may disable the speakers on the proximity broadcast receiver so long as the proximity broadcast receiver receives broadcast messages from the wireless identity transmitter. In another embodiment, the proximity broadcast receiver may modify, adjust, remove, activate, or disable components, sensors, features, software, and/or functions of the proximity broadcast receiver based on information within received broadcast messages. For example, the proximity broadcast receiver may process a received broadcast message and execute detected software instructions that direct the proximity broadcast receiver to disable a sensor, such as a camera.

FIG. 11B illustrates an embodiment method 1150 for a proximity broadcast receiver indicating proximity to a wireless identity transmitter. Proximity broadcast receivers may be associated with particular wireless identity transmitters, and may announce when those wireless identity transmitters enter and leave the proximity of the proximity broadcast receivers. In other words, a virtual “leash” may be implemented with a proximity broadcast receiver and an associated wireless identity transmitter. Proximity announcements may be useful for ensuring that assets, such as pets, equipment, and/or children, stay close to a proximity broadcast receiver and are otherwise tracked. For example, a parent carrying a proximity broadcast receiver and placing a wireless identity transmitter on a child may be notified when the child strays away. As another example, the user of a proximity broadcast receiver may receive an announcement (e.g., a SMS text message, a beep, etc.) when an item of interest equipped with a wireless identity transmitter comes close to him/her (e.g., a package or piece of luggage has arrived).

As described above, in determination block 702, the proximity broadcast receiver may determine whether a broadcast message from a wireless identity transmitter (referred to as “WIT” in FIG. 11B) is received. If no broadcast message is received (i.e., determination block 702=“No”), the proximity broadcast receiver may continue with the operations in determination block 702. If a broadcast message is received (i.e., determination block 702=“Yes”), in block 706 the proximity broadcast receiver may transmit a sighting message to a central server, such as a message that indicates the broadcast message contents, as well as the time and location at which the proximity broadcast receiver received the broadcast message. In determination block 1101, the proximity broadcast receiver may determine whether a return message from the central server is received, such as a message sent in response to the sighting message transmitted in block 706. If no return message is received (i.e., determination block 1101=“No”), in determination block 1152, the proximity broadcast receiver may determine whether the proximity broadcast receiver has a stored interested list. Such an interested list may include a set of identifiers of wireless identity transmitters that the proximity broadcast receiver is searching for, interested in, or otherwise registered to receive notices about when within proximity. If the proximity broadcast receiver does not have a stored interested list (i.e., determination block 1152=“No”), the proximity broadcast receiver may continue with the operations in determination block 702. In other words, the received broadcast message may not be associated with the proximity broadcast receiver such that an announcement should be made.

However, if the proximity broadcast receiver has a stored interested list (i.e., determination block 1152=“Yes”) or if a return message is received from the central server, in determination block 1154 the proximity broadcast receiver may determine whether the proximity broadcast receiver is associated with the wireless identity transmitter that transmitted the broadcast message. In an embodiment, the proximity broadcast receiver may evaluate the return message and/or stored interested list of identifiers to determine whether the wireless identity transmitter is associated with the proximity broadcast receiver. For example, the return message may provide the identification of the wireless identity transmitter which the proximity broadcast receiver may compare to a locally stored list of associated devices. When a stored interested list is within the proximity broadcast receiver, the proximity broadcast receiver may determine whether there is an association by comparing information related to the received broadcast message to information stored within the proximity broadcast receiver and/or received within a received return message from the central server. For example, the proximity broadcast receiver may determine whether an identifier related to the received broadcast message is indicated within a stored interested list stored within the proximity broadcast receiver. In an embodiment, the return message may simply indicate that the wireless identity transmitter is associated with the proximity broadcast receiver. For example, the return message may include a code, flag, or data that indicates the proximity broadcast receiver is associated and therefore should announce the proximity of the wireless identity transmitter. If the proximity broadcast receiver is not associated with the wireless identity transmitter (i.e., determination block 1154=“No”), the proximity broadcast receiver may continue with the operations in determination block 702.

If the proximity broadcast receiver is associated with the wireless identity transmitter (i.e., determination block 1154=“Yes”), in block 1156 the proximity broadcast receiver may announce the wireless identity transmitter is within proximity, such as by providing a message to the user of the proximity broadcast receiver. The announcement may involve a sound indicator, a displayed message, a vibration, etc. In an embodiment, the proximity broadcast receiver may display (or render) a visual map or other representation that indicates the location of the wireless identity transmitter relative to the proximity broadcast receiver. In other embodiments, the proximity broadcast receiver may perform an announcement by providing information to third-party applications executing on the proximity broadcast receiver, and in turn, the third-party applications may communicate the proximity to the user. For example, an app executing in the background of the proximity broadcast receiver's operating system may pop-up messages on a display unit of the proximity broadcast receiver. In various other embodiments, the announcements may include transmitting emails, SMS text messages, or other transmissions to notify the user of the proximity.

In block 1158, the proximity broadcast receiver may listen for subsequent broadcast messages from the wireless identity transmitter, and in determination block 1160 the proximity broadcast receiver may determine whether the proximity broadcast receiver has lost contact with the wireless identity transmitter. In an embodiment, this determination may be based on the failure to receive any broadcast message from the wireless identity transmitter within a predetermined or predefined period of time. In an embodiment, the proximity broadcast receiver may utilize a tolerance threshold that may determine that contact with the wireless identity transmitter has been lost when the proximity broadcast receiver does not receive broadcast messages of a predefined signal strength. If contact is not lost with the wireless identity transmitter (i.e., determination block 1160=“No”), the proximity broadcast receiver may continue to listen for broadcast messages from the wireless identity transmitter in block 1158.

If contact is lost with the wireless identity transmitter (i.e., determination block 1160=“Yes”), in block 1162 the proximity broadcast receiver may announce the wireless identity transmitter is no longer within proximity, such as by providing a message to the user of the proximity broadcast receiver. In other words, the proximity broadcast receiver may announce the wireless identity transmitter is absent (or has “broken the leash”). This announcement may be similar to as described above (e.g., sounds, displayed message, etc.), but may include different sounds, messages, and other indicators to represent the loss of contact with the wireless identity transmitter. In optional block 1164, the proximity broadcast receiver may transmit a message to the central server indicating the last known location of the wireless identity transmitter.

In an embodiment, the proximity broadcast receiver may display a map of the last known location for all associated wireless identity transmitters. The last known location may not be near the proximity broadcast receiver, and may include a large area, such as a location several miles from the proximity broadcast receiver's current location. For example, a smartphone configured to operate as a mobile proximity broadcast receiver may display a graphical map showing indicators for each of the wireless identity transmitters the smartphone may track within the state. Additionally, the proximity broadcast receiver may periodically receive location information updates from the central server based on information transmitted by various other proximity broadcast receivers. For example, the proximity broadcast receiver may receive a message from the central server that includes the last known location information for all associated wireless identity transmitters as reported in sighting messages from any possible proximity broadcast receiver.

FIG. 12 illustrates a diagram 1200 of various modules within a central server 120. The various modules and components are described below in the context of modules, components, and/or elements within a central server 120. However, in various embodiments, the central server 120 may include or be connected to individual computing devices, server blades, or other units that may perform the operations associated with the various modules and/or components described below.

As described above with reference to FIG. 1, the central server 120 may be configured to receive, store, and otherwise process data corresponding to wireless identity transmitters. For example, the central server 120 may be configured to exchange communications with various devices via the Internet 103, such as proximity broadcast receivers 142 and mobile proximity broadcast receivers 138 communicating via a cellular network 121, third-party systems 101, and other support systems and/or services 102.

The central server 120 may include several components 104-109 to perform various operations to process data, such as received from proximity broadcast receivers 142, 138, third-party systems 101, or other support systems and/or services 102. In particular, the central server 120 may include a core component 108 that may process sighting messages, execute an alert or notice engine module, handle application programming interface (API) commands, and exchange data with other components within the central server 120. The core component 108 may include a data layer module 1202 that may include units for storing short-term data and third-party specific data. The core component 108 may also include an alert engine module 1204 for generating alert messages for transmissions to proximity broadcast receivers and initiating searches of various target wireless identity transmitters. The core component 108 may further include a data anonimizer module 1206 that may generate generic, anonymous, or otherwise processed data based on privacy policies or profile preferences of users. For example, the data anonimizer module 1206 may strip personal information from return messages transmitted to a proximity broadcast receiver associated with a store so that a customer user of a wireless identity transmitter is not identified to the store, but the fact that the user is within the store is still reported to the store. The core component 108 may also include a privacy manager module 1208 that may maintain privacy permission information for various users. For example, the privacy manager module 1208 may include a database of privacy parameters provided by users at registration. In an embodiment, the data anonimizer module 1206 and/or the privacy manager module 1208 may utilize the permissions described below.

The core component 108 may also include a search manager module 1210 for assisting in organizing and administering searches and an authorization system module 1212. The core component 108 may further include a sightings resolver module 1214 that may be utilized by the central server 120 for identifying wireless identity transmitters associated with broadcast messages reported within received sighting messages from proximity broadcast receivers 142, 138. The core component 108 may include an API module 1216 that may include functions and interfaces for initiating operations, a sightings aggregator module 1218 for compounding various sighting messages over a period for transmissions in consolidated form to merchants, third-parties, and other services. The core component 108 may also include a network module 1220 for transmitting and receiving various communications with devices, such as proximity broadcast receivers 142, 138 and third-party systems 101 via the Internet.

The central server 120 may also include a data warehouse component 104 that may store long-term data (e.g., archived user data, past location information, etc.). The data warehouse component 104 may include various databases for storing information pertinent to users of wireless identity transmitters, such as profile information provided by users via registration websites. The data warehouse component 104 may be configured to exchange data with the data layer module 1202 of the core component 108. The central server 120 may also include an operations, administration, and management component 105 that may process and/or store software associated with user portal accesses, scripts, and tools (e.g., software utilities, routines, etc.). The operations, administration, and management component 105 may be configured to exchange data with the core component 108.

The central server 120 may also include a developer portal component 106 that may store developer account data and perform registration, account management, and alert (or notice) management routines associated with developers, such as vendors or merchants that register to interact with users of wireless identity transmitters 110. The central server 120 may also include a user portal component 109 that may store user account data and perform registration, account management, and search routines associated with users, such as persons associated with wireless identity transmitters. The user portal component 109 and developer portal component 106 may be configured to exchange data with the authorization system module 1212 of the core component 108. The central server 120 may also include a rolling identifier (or ID) resolver component 107 that may store factory keys associated with wireless identity transmitters 110 as well as perform operations, software, or routines to match encrypted, encoded, rolling, or otherwise obfuscated identification information within received sighting messages with affiliated user data. The rolling identifier (or ID) resolver component 107 may be configured to exchange data with the sightings resolver module 1214 of the core component 108.

In various embodiments, the modules and components described with reference to FIG. 12, such as the rolling ID resolver component 107, may be performed or otherwise enabled by software instructions, applications, routines, threads, circuitry, or hardware units.

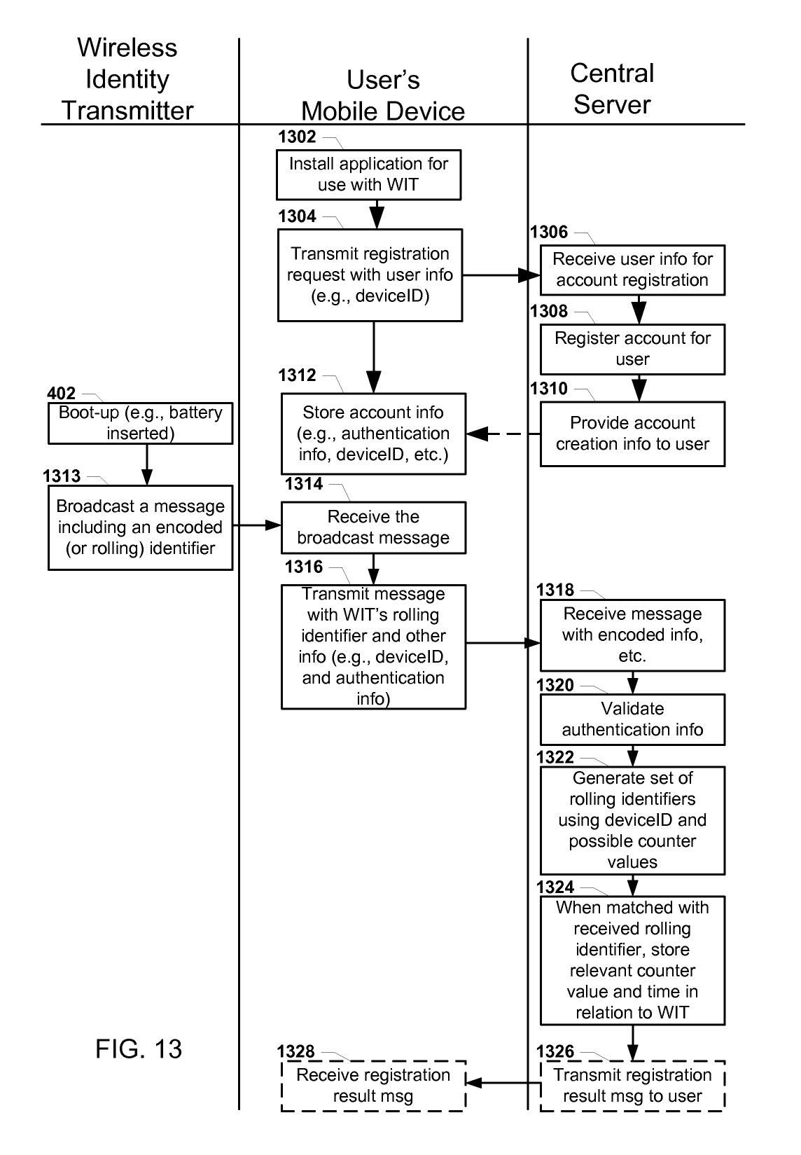

FIG. 13 illustrates a wireless identity transmitter registration process for use in various embodiments. In general, before broadcast messages may be processed by a central server, the central server may require that wireless identity transmitters and their users be registered with the central server. For example, before any tracking, searching, or other location-based activities related to a wireless identity transmitter can be initiated, the central server must be able to determine the users associated with the various wireless identity transmitters circulating in the world. Registration may create links between identifiers transmitted by wireless identity transmitters in broadcast messages, the wireless identity transmitters, and their users. For example, in order to transmit a notification to a missing child's parents that the child has been found, relayed obfuscated (or encoded) identifiers must be matched to account information that indicates the parents' cell phone numbers as stored in relation to a registered user account.

In particular, through registration, a timing mechanism may be synchronized between each wireless identity transmitter and the central server (i.e., a nonce or counter). With such a nonce or counter, a wireless identity transmitter and the central server may encode (or roll) and decode identifiers respectively, keeping the identity associated with the wireless identity transmitter (and its users) concealed and private. The most appropriate time to synchronize such a timing mechanism or nonce or counter may be during a device registration and/or account creation process as described below. For the purpose of FIG. 13, a mobile device, such as a smartphone, is described as being used by a user to perform account creation and registration operations (e.g., the mobile device accesses a web portal to register with the central server, etc.). However, any computing device connected to the Internet and capable of exchanging communications with the central server via a registration web portal or website may be relevant.

In block 1302, a user's mobile device (e.g., an iPhone, Android, tablet device, etc.) may install an application for use with wireless identity transmitters. Such an application (or “app”) may execute on the mobile device's processor as a background service or alternatively may be activated for selective use by the user. As described throughout this disclosure, such an application may enable the mobile device to process short-range broadcast messages from proximate wireless identity transmitters, such as by identifying received signals as broadcast messages and relaying sighting messages having location information to the central server in response. In block 1304, the mobile device may transmit a registration request with user information (e.g., a device identity or “deviceID”). The registration request may be sent to the central server via Internet communications with a web portal, web site, or web server controlled or otherwise accessible by the central server. In other words, the mobile device may invoke the registration process or by providing user information (e.g., device ID) through the installed app by providing the device ID (deviceID) and other information the central server may utilize to bind the registration request to an account. For example, the user's mobile device may access a registration website, receive inputs from the user, and transmit the user input as data to the registration website for use by the central server as described above with reference to FIG. 12. In an embodiment, the user information may include personal information about the user, such as name, address, contact information (e.g., social network sites, cell phone number, email address, telephone number, etc.) age, and other demographic information, as well as identifying information about wireless identity transmitters and/or proximity broadcast receivers that may be associated with the user's account. For example, the user information transmitted to the central server may include the serial number on a wireless identity transmitter and/or a confirmation code produced by the mobile device in response to installing the application with the operations in block 1302. The user information may also include preference information, such as the user's preferred retails stores, product lines, and areas to eat or consume. The user information may further include privacy permissions that indicate how personal information may be distributed or used by the central server, such as discussed below. In an embodiment, users may register as anonymous users, such that the central server does not store any identifying information about the users. For example, an account may be registered that is linked to a non-descript post office box, a disposable cellular telephone number, or other contact information that does not directly identify the user or the holder of the account. This may be important for those who may choose to utilize services provided by the central server, but who are concerned about leaked private or identifying information. In block 1312, the user's mobile device may store account information, such as authentication information (e.g., codes, messages) from the central server or device ID associated with an owned wireless identity transmitter.

In block 1306, the central server may receive the user information for account registration. In block 1308, the central server may register an account for the user. For example, the central server may store the user's information, including provided device identifications, in a database of all registered users. In block 1310 the central server may provide account creation information to the user. The account creation information may include an authentication code or other information the user's mobile device may store for future use. For example, the central server may display confirmation of account creation on a website accessible by the user's mobile device or alternatively may transmit a confirmation signal, text message, email, or other communication to the user's mobile device.

In block 402, the wireless identity transmitter boots-up, such as in response to the user inserting a battery. When the wireless identity transmitter boots, a nonce or counter value may be initialized. For example, the wireless identity transmitter may begin to increment a value that represents the passage of time, starting from a zero value. In block 1313, the wireless identity transmitter may broadcast a message (i.e., a broadcast message) that includes an encoded (or rolling) identifier. For example, the wireless identity transmitter may begin transmitting broadcast messages every few seconds. The wireless identity transmitter may generate rolling identifiers with the embodiment methods described below. In general, the broadcast message may include a payload that includes data generated by performing a pseudo-random function. For example, the wireless identity transmitter may perform a pseudo-random function to generate encoded data based on input values of the wireless identity transmitter's device ID, a nonce or counter value, and a secret key, seed, or other value known only to the wireless identity transmitter and the central server. In an embodiment, the pseudo-random function may be a polynomial time computable function that may utilize a randomly selected seed value only known to the wireless identity transmitter and the central server, such that the pseudo-random function may be computationally indistinguishable from a random function defined on the same domain with output to the same range as the pseudo-random function. In an embodiment, the keyed-hash Message Authentication Code (HMAC) or the cipher-based Message authentication Code (CMAC) may be used as the pseudo-random function.

In an embodiment, the wireless identity transmitter may be required to be activated within a predefined number of seconds within the time the mobile device begins the registration process with the operations in block 1304. In other words, once the wireless identity transmitter begins incrementing its nonce or counter value, the user must register with the central server within a certain period. This enables the central server to try at only a certain number of values when trying to determine the nonce or counter value at the wireless identity transmitter during registration.

In an embodiment, the wireless identity transmitter may indicate an initial broadcast by adjusting data within a broadcast message's payload. For example, the wireless identity transmitter may change a bit within a broadcast message that the central server may recognize as indicating an initialization time period for the wireless identity transmitter. If there are initialization indicators within payloads, the central server may expedite comparisons between received payloads and stored payloads by avoiding comparisons to payloads corresponding to already registered (or recognized) wireless identity transmitters within a central server lookup data table.

In block 1314, the user's mobile device may receive the broadcast message. In other words, based on the installed application (or app), the mobile device may function as a mobile proximity broadcast receiver. An installed application may, such as the app installed with the operations in block 1302, may be waiting to receive such a broadcast message in response to initiating registration operations with the central server via the registration request. In block 1316, the mobile device may transmit the wireless identity transmitter's rolling identifier and other information, such as the stored device ID and authentication information. In an embodiment, the mobile device may extract encoded information from the received broadcast message, such as by using text comparison and/or parsing operations. For example, the mobile device may perform a most-significant bit operation.

In block 1318, the central server may receive the message with the encoded information, as well as the authentication information and the device ID. In block 1320, the central server may validate authentication information, such as in the received message from the mobile device. In particular, the central server may compare the authentication information to information generated in the operations in blocks 1308-1310. In block 1322, the central server may generate a set of rolling identifiers using the device ID and possible nonce or counter values. The central server may compare the encoded identifiers of the set with the rolling identifier received from the mobile device. In an embodiment, the central server may compute a set of encoded data by using a pseudo-random function, such as described above, along with the device ID and a number of nonce or counter values. For example, the central server may execute the pseudo-random function with a seed shared with wireless identity transmitters, the device ID indicated by the mobile device, and many nonce or counter values, starting with 0. In block 1324, when the central server matches the received rolling identifier to one of the rolling identifiers in the generated set, the central server may store relevant nonce or counter value and time in relation to the WIT. The central server may use the nonce or counter value used to generate the matching rolling identifier to sync with the nonce or counter running on the wireless identity transmitter. In an embodiment, the central server may store an indicator that describes the wireless identity transmitter as having been successfully registered and/or synced. In optional block 1326, the central server may then transmit a registration result message to the user, such as by transmitting a message to the mobile device. The registration result message may indicate whether or not the central server was able to match the received encoded identifier with a generated identifier. In optional block 1328, the mobile device may receive the registration result message. In an embodiment, the registration result message indicates that the registration process failed (e.g., the received broadcast message received by the mobile device did not correspond to the user's wireless identity transmitter), the mobile device may re-attempt the registration by receiving and relaying another broadcast message.

The operations described above, particularly within blocks 1313-1324, assume that message processing operations performed by the various devices, as well as any propagation delay, may be much smaller than the time required to increment (or update) the nonce or counter value at the wireless identity transmitter. This ensures that the nonce or counter values at the wireless identity transmitter and central server do not differ by more than 1.

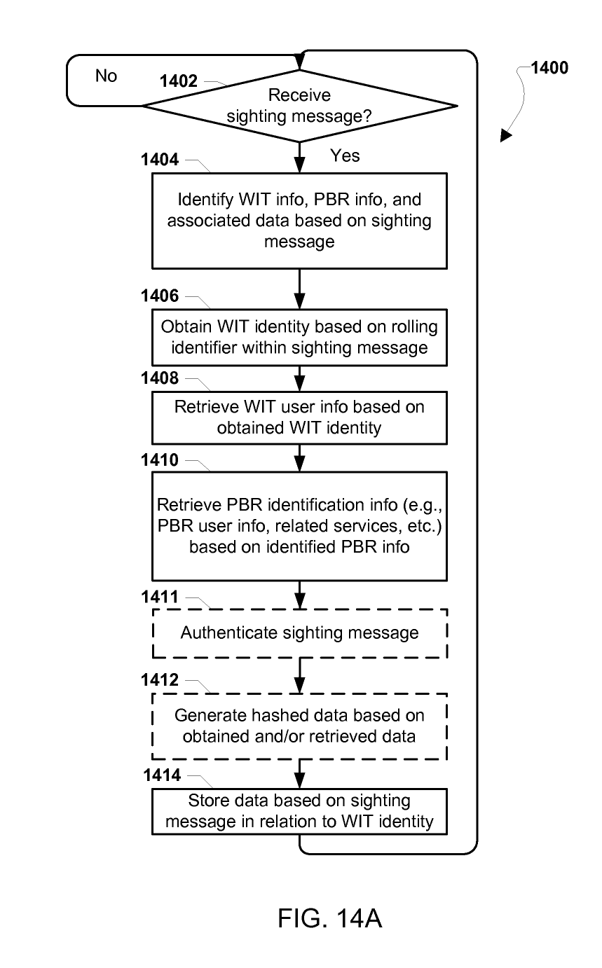

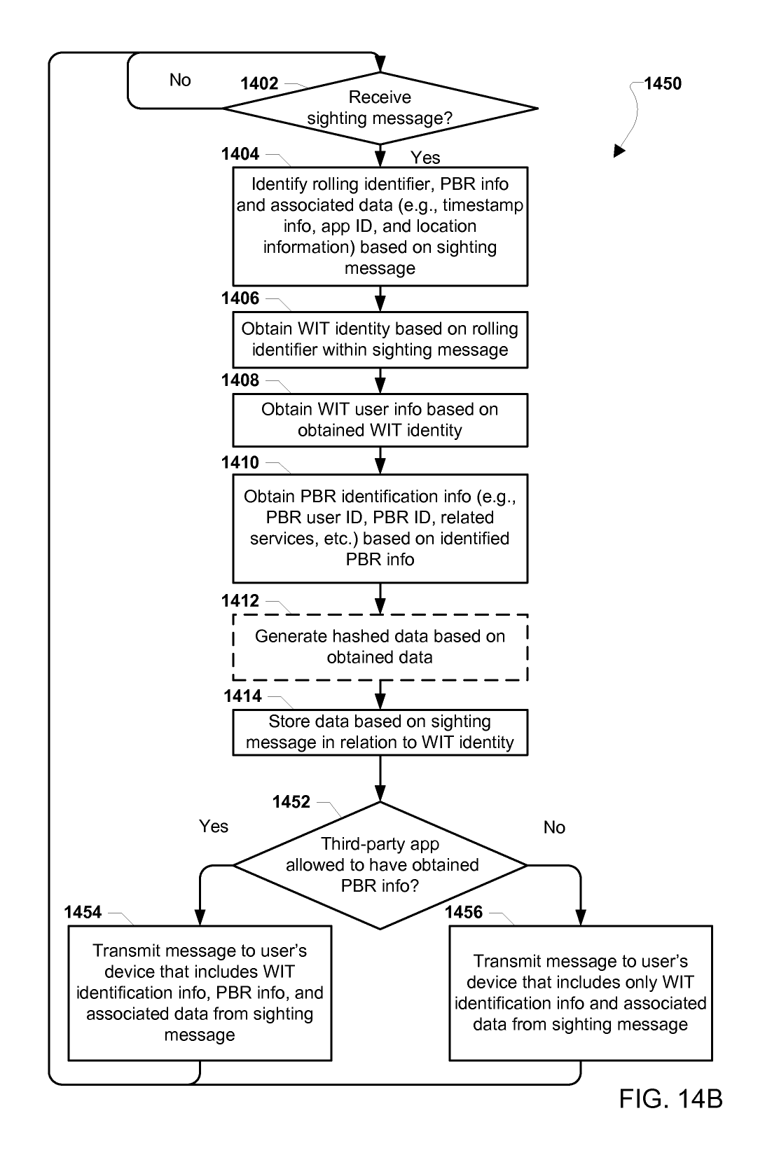

FIG. 14A illustrates an embodiment method 1400 for a central server to process sighting messages received from proximity broadcast receivers. As described above, the central server may be configured to utilize various modules, components, circuitry, and software to process sighting messages. In determination block 1402, the central server may determine whether a sighting message is received. The central server may evaluate a receiving circuit, buffer, queue or other indicator to determine when messages are received from various devices, such as proximity broadcast receivers. In an embodiment, the central server may utilize a network module as described above to determine whether a sighting message is received. In general, sighting messages may be received via long-range communications, such as packets transmitted via a cellular network over the Internet. If the central server does not receive a sighting message (i.e., determination block 1402=“No”), the central server may continue with the operations in determination block 1402.

If the central server receives a sighting message (i.e., determination block 1402=“Yes”), in block 1404 the central server may identify wireless identity transmitter information, proximity broadcast receiver information, and associated data based on the sighting message. The central server may evaluate, parse, and otherwise make accessible various data and information segments within the received sighting message. For example, the central server may parse the sighting message to identify an included broadcast message from the wireless identity transmitter. As another example, the central server may identity encoded data corresponding to a wireless identity transmitter identity (i.e., rolling identifier), proximity broadcast receiver identification information (e.g., a receiver ID), location information, timestamp information, sensor data (e.g., accelerometer sensor data, etc.), identifiers of applications (or apps) associated with a proximity broadcast receiver (e.g., a list of installed applications, an identifier for a relevant app executing on the proximity broadcast receiver, etc.). In an embodiment, the central server may perform the operations of block 1404 with a sightings resolver module as described above.

In block 1406, the central server may obtain the wireless identity transmitter identity based on the rolling identifier within the sighting message. The central server may perform operations to decode, descramble, decrypt, or otherwise make accessible the rolling identifier. For example, the central server may perform operations to apply a secret key or decoding algorithm to obtain the identity of the wireless identity transmitter. In an embodiment, the operations of block 1406 may be performed by the central server by way of a rolling ID resolver component as described above. For example, the central server may cause a sightings resolver module to exchange data with the rolling ID resolver component to obtain a decoded wireless identity transmitter identifier. Embodiment operations to identity the wireless identity transmitter based on a sighting message that includes a rolling identifier are described below.

In block 1408, the central server may retrieve the wireless identity transmitter user information based on the obtained wireless identity transmitter identity. For example, the central server may retrieve user account information related to the wireless identity transmitter, such as demographics information, stored data indicating previous behaviors (e.g., travel paths, location history, etc.). In an embodiment, the operations of block 1408 may be performed by the central server by way of an authorization system module as described above. For example, the central server may cause the authorization system module to exchange wireless identity transmitter identity information with a user portal component to obtain user information as saved within user registration databases.

In block 1410, the central server may retrieve proximity broadcast receiver identification information, such as proximity broadcast receiver user information and related services, based on the identified proximity broadcast receiver information. For example, the central server may retrieve the merchant identity associated with the proximity broadcast receiver that transmitted the received sighting message, the tracking services the proximity broadcast receiver is registered to participate in, as well as any other relevant information to the proximity broadcast receiver. The central server may retrieve email addresses, MAC addresses, phone numbers, and other contact information related to a user of related proximity broadcast receiver based on the information within the sighting message. For example, the central server may determine the user contact information associated with a proximity broadcast receiver that may be used for subsequent transmissions from the central server, such as emails or SMS text messages that indicate proximity to an item of interest. In an embodiment, the central server may determine the identity of a user of a smartphone that is configured to perform operations of a mobile proximity broadcast receiver. In an embodiment, the operations of block 1410 may be performed by the central server by way of an authorization system module as described above. For example, the central server may cause the authorization system module to exchange proximity broadcast receiver information with a developer (or user) portal component to obtain information about related registered services (e.g., merchants, stores, vendors, services, etc.) as saved within developer registration databases.

In optional block 1411, the central server may authenticate the sighting message. Based on authentication information within the received sighting message, the central server may perform authentication operations that confirm the legitimacy of the sighting message as coming from a known or otherwise valid proximity broadcast receiver. As described above, sighting messages may include data, such as secret codes, certificates, or hash data, that can be used to confirm the identities of valid proximity broadcast receivers. As third-parties may attempt to spoof proximity broadcast receivers associated with registered services (e.g., a nefarious spammer may attempt to imitate a merchant's store proximity broadcast receiver by sending a fraudulent sighting message), the central server may check for authentication information that confirms the information within the sighting message is useful and related to a registered service (e.g., a registered merchant, a valid developer, or other party that deploys legitimate proximity broadcast receivers). For example, the central server may detect obscured header information within the sighting message that relates to a merchant established within the central server as a registered developer. When the sighting message does not include authentication information expected by the central server, such as a special code that all proximity broadcast receivers within a certain building possess, or does include authentication information that does not match information stored in the central server, the central server may disregard the sighting message and all included information. For example, a sighting message with out-of-date or incomplete authentication information may be disregarded by the central server, or alternatively stored in a list for potentially fraudulent proximity broadcast receivers.

In optional block 1412, the central server may generate hashed data based on the obtained and/or retrieve data. In an embodiment, the operations of optional block 1412 may be performed by the central server by way of a data anonimizer module as described above. In block 1414, the central server may store data based on the sighting message in relation to the wireless identity transmitter identity. For example, the central server may store identified associated data from the sighting message in a database in relation to the wireless identity transmitter's decoded identity. In an embodiment, the operations of block 1414 may be performed by the central server by way of a data layer module as described above.

FIG. 14B illustrates an embodiment method 1450 for a central server to process sighting messages received from proximity broadcast receivers. The method 1450 is similar to the method 1400 described above, except that the central server may perform the method 1450 to transmit messages for use by a third-party application executing on mobile device carried by a user. As described above, various messages, such as return messages, alerts (or search activation messages), may be transmitted by the central server to various recipients, such as mobile devices associated with a user. For example, the central server may transmit messages to a user's tablet, smartphone, mobile proximity broadcast receiver, or other computing device. A recipient may also include an application or app executing on a mobile device. In an embodiment, the central server may also transmit messages to other third-party recipients or devices, such registered services that may include emergency medical technicians (EMTs), fire, local police, retail store, merchant computing devices, and ad servers.

Messages transmitted by the central server in response to receiving sighting messages may be transmitted to inform devices, such as a mobile phone or mobile proximity broadcast receiver carried by a user, of the location of proximity of known wireless identity transmitters. For example, when a proximity broadcast receiver, such as a stationary proximity broadcast receiver within a retail store, relays a broadcast message from a wireless identity transmitter associated with a user, the central server may respond by transmitting a message back to a mobile device of the user indicating the user is near the store's proximity broadcast receiver. Further, a third-party application running on the user's device may use information within the message. For example, a retail store app running on a user's smartphone may receive a notice that the user has moved within proximity of a display area within proximity of a retail store building. In various other embodiments, the third-party applications may be utilized to track owned items associated with wireless identity transmitters. For example, a particular third-party application may perform a ring tone when the user is within proximity of a searched for missing child.

In determination block 1402, the central server may determine whether a sighting message is received. If the central server does not receive a sighting message (i.e., determination block 1402=“No”), the central server may continue with the operations in determination block 1402. If the central server receives a sighting message (i.e., determination block 1402=“Yes”), in block 1404 the central server may identify wireless identity transmitter information, proximity broadcast receiver information, and associated data based on the sighting message. In block 1406, the central server may obtain the wireless identity transmitter identity based on the rolling identifier within the sighting message. In block 1408, the central server may retrieve the wireless identity transmitter user information based on the obtained wireless identity transmitter identity. In block 1410, the central server may retrieve proximity broadcast receiver identification information, such as proximity broadcast receiver user information and related services, based on the identified proximity broadcast receiver information. In optional block 1412, the central server may generate hashed data based on the obtained and/or retrieve data. In block 1414, the central server may store data based on the sighting message in relation to the wireless identity transmitter identity.

In determination block 1452, the central server may determine whether a third-party application (or app) is allowed to have obtained proximity broadcast receiver information. In other words, based on data stored in the central server that is associated with the user of the wireless identity transmitter, the central server may detect any registered services or third-party applications that are associated with the user's devices. For example, the central server may evaluate database information to identify the user has installed a third-party application on his/her smartphone that corresponds to a retail store. The proximity broadcast receiver information may include proximity broadcast receiver identification (e.g., an ID code or identifier) and the user identity of the proximity broadcast receiver. In an embodiment, the central server may identify whether third-party applications are allowed such information based on the third-party's developer rights, such as indicated when the third-party registered as a developer or registered service, or alternatively based on the user's permission settings, as described below. In an embodiment, the central server may use application identification information provided within the received sighting message to determine whether the third-party applications on the user's device may receive proximity broadcast receiver information. For example, the sighting message may contain indicators of applications (e.g., app IDs) that correspond to the sighting message and thus are allowed to receive any proximity broadcast receiver information from the central server.

If the third-party app is not allowed to have the obtained proximity broadcast receiver information (i.e., determination block 1452=“No”), in block 1456 the central server may transmit a message to the user's device that includes only wireless identity transmitter identification information and associated data from the sighting message. For example, the message transmitted by the central server may include the obtained wireless identity transmitter identity, user information, timestamp data, and location information from the sighting message. If the third-party app is allowed to have the obtained proximity broadcast receiver information (i.e., determination block 1452=“Yes”), in block 1454 the central server may transmit a message to the user's device that includes wireless identity transmitter identification information, proximity broadcast receiver information, and associated data from the sighting message. For example, the message transmitted by the central server to the user's smartphone may include indicators of the obtained proximity broadcast receiver identification (e.g., serial code, group affiliation, merchant category, etc.). The central server may then continue with the operations in determination block 1402. In an embodiment, the central server may utilize an alert engine module, such as described above with reference to FIG. 12, to transmit and/or generate messages for transmission to various devices.

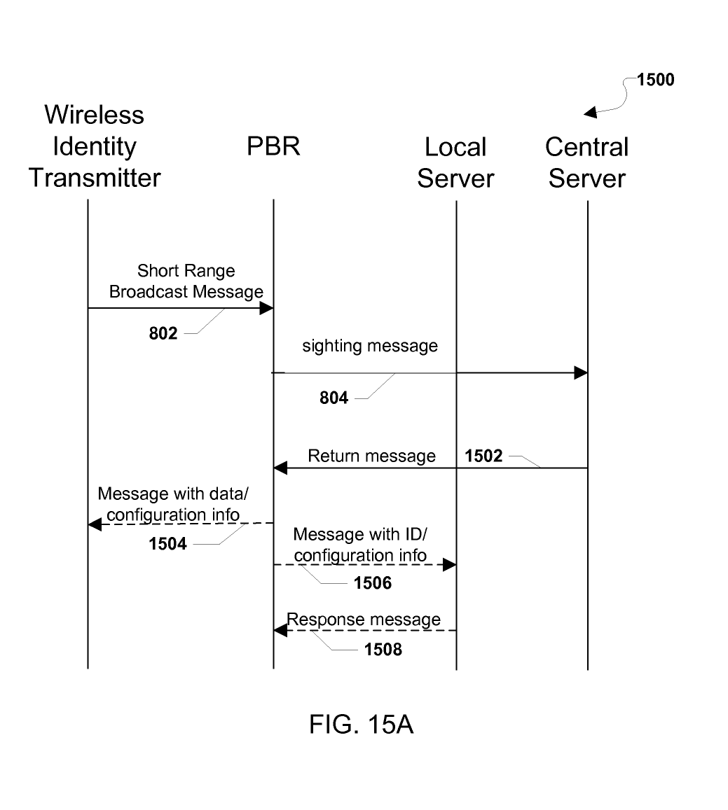

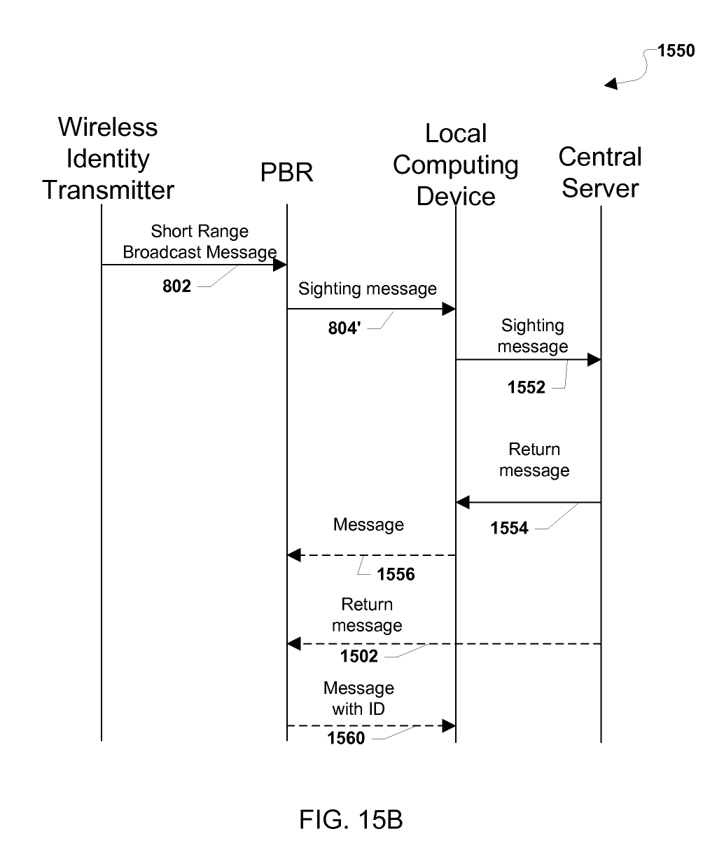

FIG. 15A illustrates an embodiment call flow diagram 1500 illustrating communications between a wireless identity transmitter, a proximity broadcast receiver, and a central server. As described above, the wireless identity transmitter may periodically transmit a short-range broadcast message 802 via a short-range radio. When within signal range of the broadcast message 802, the proximity broadcast receiver may receive the broadcast message 802 using a similar short-range radio. The broadcast message 802 may be processed by the proximity broadcast receiver and related data may be relayed to the central server as a sighting message 804. In an embodiment, the sighting message 804 may include the broadcast message, identification information of the proximity broadcast receiver and/or the wireless identity transmitter, encrypted information the proximity broadcast receiver is incapable of decoding, and other information related to the reception of the broadcast message 802. In an embodiment, the sighting message 804 may be transmitted over various wireless or wired networks that may be configured to communicate via Internet protocols.

The central server may receive and process the sighting message 804. When the central server determines that the sighting message 804 requires a response based on the information in the sighting messages (e.g., metadata requesting a response, the sighting message relates to a wireless identity transmitter that needs to receive upgraded firmware, etc.), the central server may generate and transmit a return message 1502 to the proximity broadcast receiver. In various embodiments, the return message 1502 may contain configuration information, identification information describing the wireless identity transmitter, or other data as described above. The proximity broadcast receiver may receive and process the return message 1502. Based on the data within the return message 1502, the proximity broadcast receiver may optionally transmit a message 1504 to the wireless identity transmitter that may contain configuration information and other data from the central server. The wireless identity transmitter may selectively accept transmissions such as the message 1504 using operations as described above with reference to FIG. 4.

As another option, the proximity broadcast receiver may transmit a message 1506 to a local server based on the return message 1502. The message 1506 may contain wireless identity transmitter identification information, configuration information, software routines, and various other data from the return message 1502 for storage, processing, and otherwise additional use by the local server. Based on the message 1506, the local server may in turn transmit an optional response message 1508 to the proximity broadcast receiver that may include software instructions, configuration data, or other data generated in response to receiving the message 1506.

In an embodiment, the central server may also transmit messages directly to the local server (not shown) that include configuration information and other data. For example, the sighting message 804 from the proximity broadcast receiver may provide the contact information for the local server which the central server may utilize for subsequent communications.

FIG. 15B illustrates an embodiment call flow diagram 1550 illustrating communications between a wireless identity transmitter, a proximity broadcast receiver, a local computing device, and a central server. The local computing device may be a local server, such as within a retail store, or alternatively, a device configured to perform operations of a point-of-sale device (e.g., a cash register). The proximity broadcast receiver may be a stationary receiver device associated with and communicates information to the local computing device. For example, the local computing device and the proximity broadcast receiver may both be associated with a merchant and/or both communicate over a common local area network, such as via a WiFi router. For example, the stationary proximity broadcast receiver may be placed at the cash register of the retail store and may receive transmissions from wireless identity transmitters when customers walk within proximity of the cash register.

As described above, the wireless identity transmitter 110 may periodically transmit a broadcast message 802 via short-range wireless signals (e.g., Bluetooth® LE radio signals). When within signal range of the broadcast message 802, the proximity broadcast receiver may receive the broadcast message 802 using a similar transceiver. The broadcast message 802 may be processed by the proximity broadcast receiver and transmitted to the local computing device as a first sighting message 804′ for processing. The local computing device may in turn transmit a second sighting message 1552 to the central server. The second sighting message 1552 may be identical to the first sighting message 804′ or alternatively a new or modified version of the first sighting message 840′. For example, the second sighting message 1552 may include identification information of the local computing device in addition to a representation of the broadcast message 802.

The central server may receive and process the second sighting message 1552, as described above, and may generate and transmit a return message 1554 to the local computing device. In an embodiment, the local computing device may be configured to act as a message router and may transmit a message 1556 to the proximity broadcast receiver. The message 1556 may be similar to the return message 1554 or alternatively may include only portions of the return message 1554. For example, the message 1556 may contain information (e.g., marketing information, payment authentication information, etc.) to be rendered or otherwise used by the proximity broadcast receiver. In an embodiment, the message 1556 may include instructions for presenting marketing information, such as software instructions for rendering an advertising video.

In an embodiment, the central server may transmit a return message 1502 to the proximity broadcast receiver, which may in turn transmit a message 1560 to the local computing device that reports various information (e.g., the identification information of the wireless identity transmitter). In an embodiment, the proximity broadcast receiver may process the return message 1502 and the message 1556 and may store, utilize, and/or evaluate data of the return message 1502. For example, the stationary proximity broadcast receiver may detect software instructions within the return message 1502 or the message 1556, such as an instruction to re-calibrate a radio within the proximity broadcast receiver, and may perform operations in response to detecting the software instructions. As another example, the proximity broadcast receiver may store a list of wireless identity transmitter identities based on the return message 1502 or the message 1556. In an embodiment, the return message 1502, 1554 may not include identification information of the wireless identity transmitter, but may instead include an indicator of whether the wireless identity transmitter is related to an authorized user.

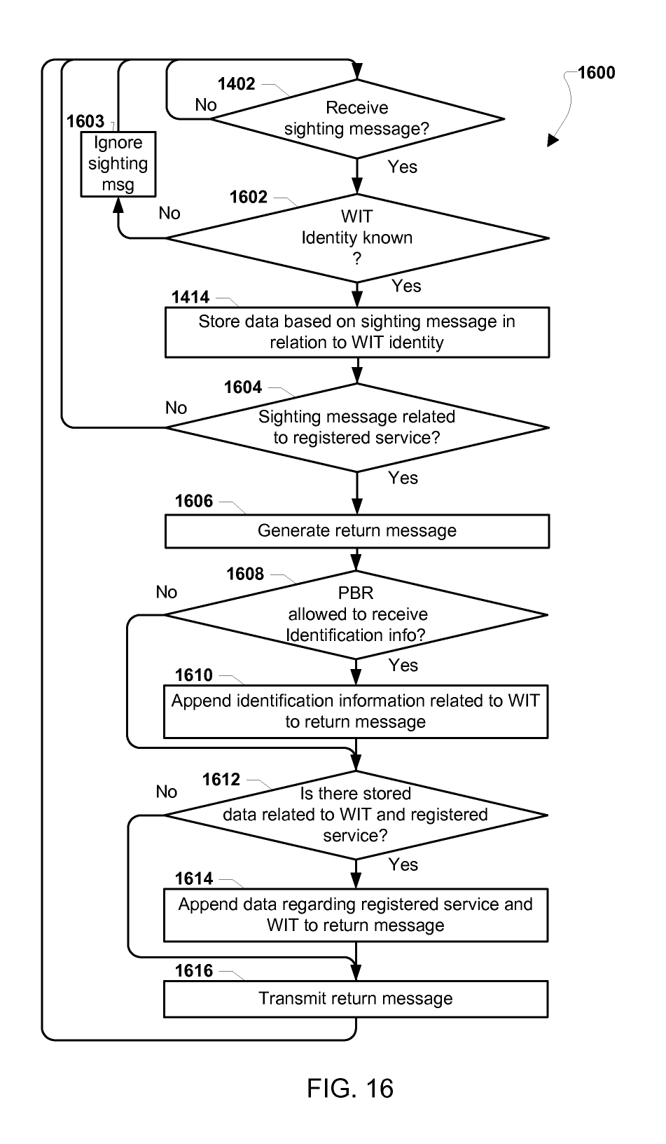

FIG. 16 illustrates an embodiment method 1600 for a central server to process sighting messages received from a proximity broadcast receiver. In general, based on the information within sighting messages, the central server may identify a wireless identity transmitter (and related user), determine whether there is a relationship between the proximity broadcast receiver and the wireless identity transmitter (i.e., related to a registered service), and transmit return messages with various data and/or information based on the sighting messages. Accordingly, return messages may be provided to proximity broadcast receivers such that no identifying information about the wireless identity transmitter is included. This may enable the proximity broadcast receiver to anonymously personalize equipment, devices, or other facilities, as described above, to benefit the user of the wireless identity transmitter without disclosing his/her identity. For example, a return message from the central server may include a user's configuration data for a piece of equipment but not the user's identity. In an embodiment, the method 1600 may be performed by the central server in connection with the proximity broadcast receiver performing the operations of the method 1100 as described above with reference to FIG. 11. In various embodiments, such return messages may be transmitted to any devices related to received sighting messages and/or the related wireless identity transmitter, such as third-parties (e.g., emergency services, retailers, etc.) or user devices associated with the sighting message.

In determination block 1402, the central server may determine whether a sighting message is received. If no sighting message is received (i.e., determination block 1402=“No”), the central server may continue with the operations in determination block 1402. If a sighting message is received (i.e., determination block 1402=“Yes”), in determination block 1602 the central server may determine whether the wireless identity transmitter identity is known. In other words, the central server may perform the operations in block 1404-1410 as described above with reference to FIG. 14A in order to evaluate, decode, decrypt, and otherwise access the data within the received sighting message to determine whether it includes a wireless identity transmitter identity (or identifier) that is associated with a user registered with the central server. For example, the central server may decrypt a rolling identifier within the received sighting message to identify a device identifier of a wireless identity transmitter and may match that identifier to stored information representing all registered users and/or devices. If the wireless identity transmitter is not known (i.e., determination block 1602=“No”), in block 1603 the central server may ignore the sighting message and continue to perform the operations in determination block 1402. If the wireless identity transmitter is known (i.e., determination block 1602=“Yes”), in block 1414 the central server may store data based on the sighting message in relation to the wireless identity transmitter identity, such as storing location data within the sighting message in a database in relation to the user of the wireless identity transmitter.

In determination block 1604, the central server may determine whether the received sighting message relates to a registered service. In other words, the central server may compare information obtained from the sighting message to lists of registered services to determine whether the sighting message is valid (or authenticated) and corresponding to a third-party, merchant, or other service registered with the central server. To make the determination, the central server may analyze the received sighting message and evaluate any metadata or header information that identifies the proximity broadcast receiver, the subject matter of the sighting message, or other descriptive information regarding the proximity broadcast receiver and/or the wireless identity transmitter that transmitted the broadcast message reported by the sighting message. For example, the sighting message may contain metadata that indicates the sighting message was sent by a proximity broadcast receiver in response to an active alert. Alternatively, the sighting message may contain header information that indicates relevance to a particular vendor facility or service. For example, the sighting message may contain metadata that indicates the proximity broadcast receiver is associated with a particular third-party application (e.g., a retail store app ID). As another example, the central server may evaluate metadata within the sighting message to detect a code that identifies a registered merchant or retail store that is associated with a marketing service or data collection scheme.

A sighting message may not relate to a registered service if the transmitting proximity broadcast receiver is not registered, authenticated, or otherwise known to the central server. If the sighting message is not related to a registered service (i.e., determination block 1604=“No”), the central server may continue with the operations in determination block 1402. If the sighting message does relate to a registered service, such as a valid vendor service or an active alert (i.e., determination block 1604=“Yes”), in block 1606 the central server may generate a return message. The return message may include information that indicates the sighting message, the proximity broadcast receiver, related services, time of receipt of the sighting message, and other informational data. In determination block 1608, the central server may determine whether the proximity broadcast receiver is allowed to receive identification info. In other words, the central server may determine whether the proximity broadcast receiver has permission or is authorized to receive identification information of the wireless identity transmitter. For example, based on metadata within the sighting message indicating that the proximity broadcast receiver is associated with a vendor or a registered service, the central server may determine that the identification of the wireless identity transmitter (or its user) may not be included within the return message. In an embodiment, the central server may evaluate a stored database that describes information permissions based on the identity of the proximity broadcast receiver and its associated services. For example, the database may indicate that the proximity broadcast receiver is associated with a service that is allowed to receive identification information about the wireless identity transmitter. As another example, using user identification information obtained based on the sighting message, the central server may look-up user permissions to identify whether the user authorized user data to be shared with registered services.

If the proximity broadcast receiver is allowed to receive identification information (i.e., determination block 1608=“Yes”), in block 1610 the central server may append identification information to the return message. For example, the return message may include the username, customer ID, address and/or name of the user of the wireless identity transmitter. If the proximity broadcast receiver is not allowed to receive identification information (i.e., determination block 1608=“No”) or if the central server appended identification information to the return message in block 1610, the central server may determine whether there is stored data related to the wireless identity transmitter and the registered service in determination block 1612. The central server may evaluate a database and identify whether the proximity broadcast receiver, its associated devices or services (e.g., a local server), and/or the wireless identity transmitter require data based on the sighting message. Examples of such data may include firmware, software instructions, configuration information, proprietary information (e.g., customer ID), activity information (e.g., information describing recent wireless identity transmitter activities related to the proximity broadcast receiver), or any other relevant information. The central server may query the database using the wireless identity transmitter identification information in combination with the proximity broadcast receiver identification information to detect data within the database that may be included in the return message. For example, the return message may contain personalization information for the user of the wireless identity transmitter to be used by the proximity broadcast receiver. In an embodiment, the database may indicate that the proximity broadcast receiver is associated with a service (e.g., vendor, merchant, etc.) that stores proprietary data within the central server database.

If there is stored data related to the wireless identity transmitter and the registered service (i.e., determination block 1612=“Yes”), in block 1614 the central server may append the data regarding registered service and the wireless identity transmitter to the return message. If there is no stored data related to the wireless identity transmitter and the registered service (i.e., determination block 1612=“No”), or if data is already appended, in block 1616 the central server may transmit the return message, such as to the proximity broadcast receiver. The central server may then continue to perform the operations in determination block 1402.

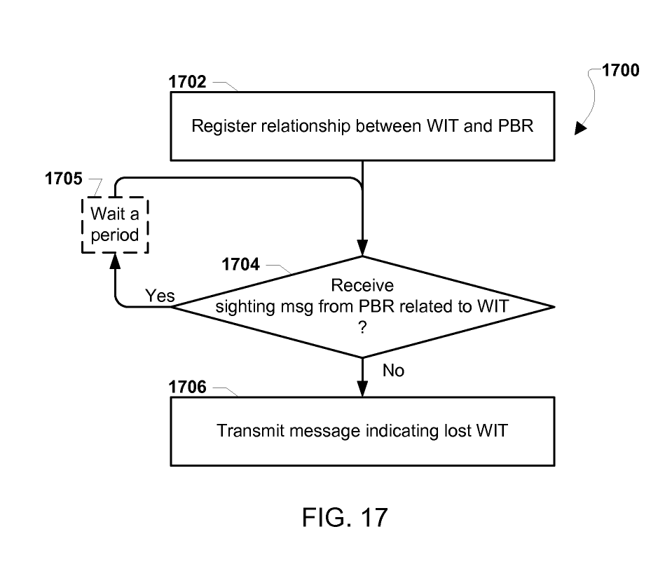

FIG. 17 illustrates an embodiment method 1700 for a central server determining whether a proximity broadcast receiver has lost a wireless identity transmitter. In the central server, the proximity broadcast receiver may be associated with the wireless identity transmitter. For example, the proximity broadcast receiver may be a user's smartphone that is associated with the wireless identity transmitter within an asset (e.g., wallet, purse, luggage, medicine bag, clothing, etc.). In response to failing to receive sighting messages from a proximity broadcast receiver associated with a particular wireless identity transmitter, the central server may be configured to transmit messages, such as warnings, indicating that the wireless identity transmitter (and the object it is connected to) is lost, absent, forgotten, or otherwise non-proximate to the proximity broadcast receiver. This embodiment method 1700 may be useful for leashing certain assets, such as possessions, pets, and children. For example, when a child runs from a parent, broadcast messages from the child's wireless identity transmitter may no longer be received by the parent's proximity broadcast receiver. As a result, the parent's proximity broadcast receiver may not transmit sighting messages to the central server and the central server may determine the child has been lost or run away.

In block 1702, the central server may register a relationship between the proximity broadcast receiver and the wireless identity transmitter, such as by storing information within a database. In various embodiments, each proximity broadcast receiver and wireless identity transmitter may be involved in numerous relationships. Additionally, the relationship information may be stored based on user input data to the central server via a registration web portal (e.g., the user may access a website and indicate all of his/her wireless identity transmitters). During such a registration, the central server may prompt the user to provide conditions under which the central server should transmit messages when wireless identity transmitters are lost or otherwise outside of the proximity of the proximity broadcast receiver. For example, the user may enter configuration data stored by the central server that indicates that if the proximity broadcast receiver does not receive broadcast messages from the wireless identity transmitter between certain hours of the day, the central server should transmit a warning message.

In determination block 1704, the central server may determine whether a sighting message has been received from the proximity broadcast receiver related to the wireless identity transmitter. In other words, based on whether or not such a sighting message is received, the central server may detect if the wireless identity transmitter is close to the proximity broadcast receiver. The central server may also evaluate sighting messages received over a period to determine whether the wireless identity transmitter is (or has recently been) within proximity of the proximity broadcast receiver. In an embodiment, the central server may determine whether it receives a sighting message for each wireless identity transmitter registered in the relationship. For example, if the registered relationship includes multiple wireless identity transmitters, the central server may expect to receive sighting messages from the proximity broadcast receiver regarding all the wireless identity transmitters. If the central server receives a sighting message related to the wireless identity transmitter (i.e., determination block 1704=“Yes”), in optional block 1705 the central server may wait a period and may continue with the operations in determination block 1704. In various embodiments, the central server may perform the operations in determination block 1704 periodically, such as every few seconds, minutes, or hours.

If the central server does not receive a sighting message related to the wireless identity transmitter (i.e., determination block 1704=“No”), in block 1706 the central server may transmit a message indicating the wireless identity transmitter is lost. In various embodiments, the central server may transmit such a message to the proximity broadcast receiver, other devices associated with the user of the proximity broadcast receiver (e.g., a smartphone, tablet), and/or any other device relevant to the wireless identity transmitter. For example, the central server may transmit a warning message to a police server when the wireless identity transmitter is lost and associated with a child.

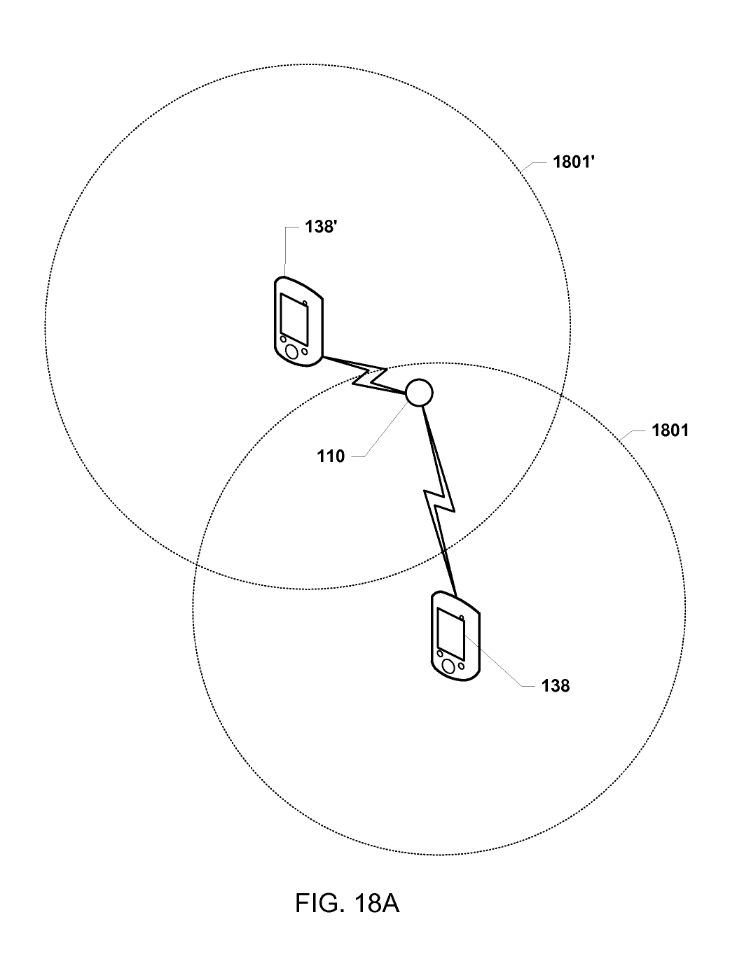

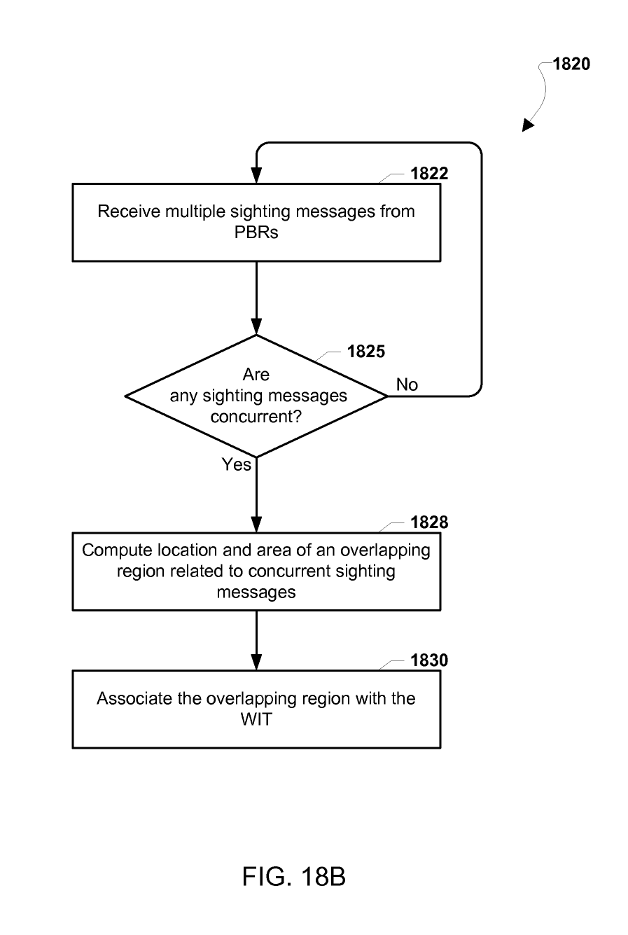

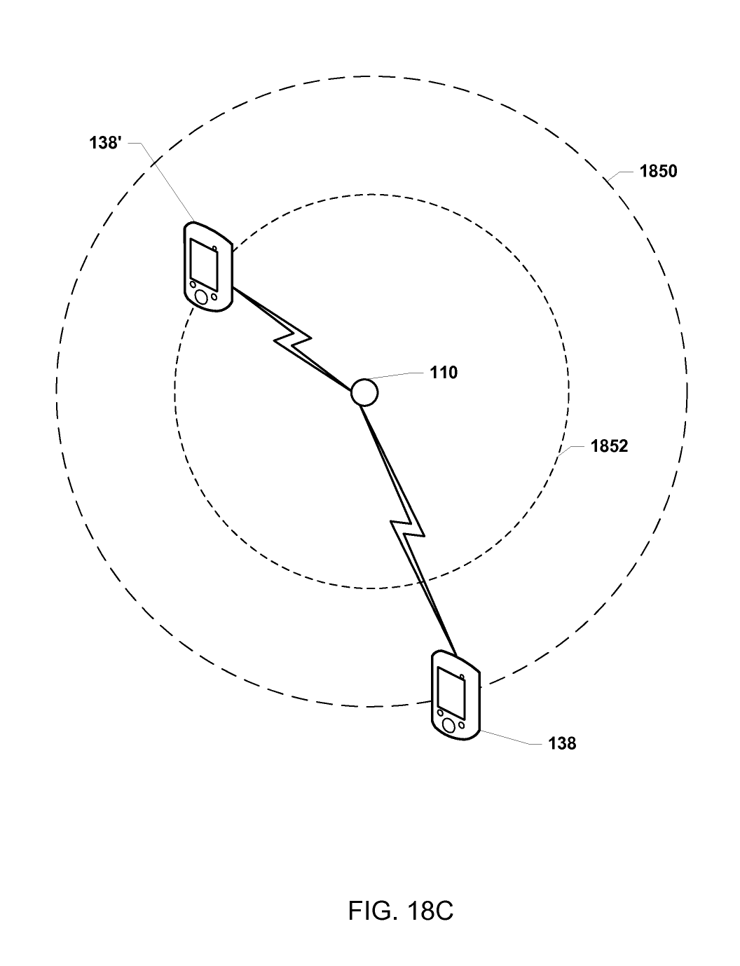

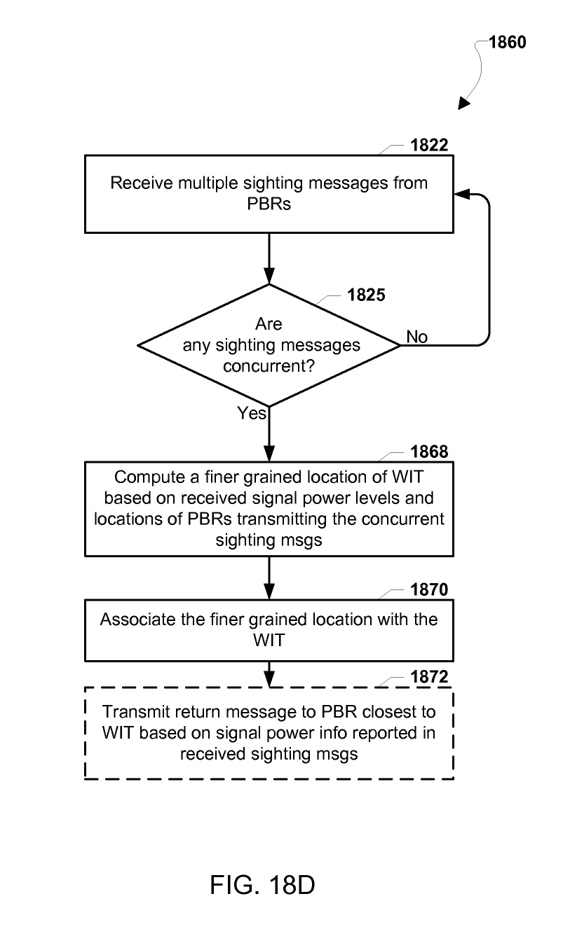

FIG. 18A illustrates two proximity broadcast receivers 138, 138′ receiving short-range broadcast messages from a wireless identity transmitter 110. In various embodiments, the communication system may provide increased location or proximity granularity when multiple proximity broadcast receivers (e.g., mobile proximity broadcast receivers) are able to successfully communicate with a wireless identity transmitter. As previously discussed, since the wireless identity transmitter relies on a short-range radio to broadcast its identifier to proximity broadcast receivers, the location of a proximity broadcast receiver receiving such a short-range broadcast message provides an approximate location for the wireless identity transmitter (i.e., the proximity broadcast receiver and wireless identity transmitter are within proximity of each other when a broadcast message is received). However, if multiple proximity broadcast receivers receive the broadcast message from the wireless identity transmitter, the location of the wireless identity transmitter may be more precisely approximated.

In particular, two proximity broadcast receivers 138, 138′ may receive broadcast messages from a wireless identity transmitter 110. Since the reception range of signals transmitted by wireless identity transmitters 110 is limited, proximity broadcast receivers 138, 138′ may receive the broadcast messages only if the wireless identity transmitter 110 is within that reception range 1801, 1801′. Thus, if both proximity broadcast receivers 138, 138′ receive the same broadcast message from the wireless identity transmitter 110, then the wireless identity transmitter 110 must be located in the overlapping region that is within the reception range 1801, 1801′ of both of the two proximity broadcast receivers 138, 138′. Since the reception range 1801, 1801′ will depend upon signal attenuators (e.g., structures and vegetation) along the transmission path and the sensitivity of proximity broadcast receivers 138, 138′, this variability may be taken into account by a central server, such as by treating the reception range 1801, 1801′ as a statistical parameter (e.g., average range with standard deviations, which may be determined through field testing). In such an embodiment, the central server may assign probabilities to different overlapping region sizes, which may help searchers focus initial search efforts.

FIG. 18B illustrates an embodiment method 1820 for a central server providing a finer grained location for a wireless identity transmitter. The central server may receive multiple sighting messages from proximity broadcast receivers in block 1822. The central server may determine whether any of the received sighting messages are concurrent in determination block 1825 (i.e., whether broadcast messages from the same wireless identity transmitter are reported as being received at approximately the same time from two different proximity broadcast receivers). The central server may not consider sighting messages concurrent unless they are associated with the same wireless identity transmitter (i.e., include the same identifier or corresponding rolling identifiers) and come from different proximity broadcast receivers. Further, the central server may determine whether sighting messages are concurrent based on the contents of the messages, such as by comparing and matching timestamps in the received sighting messages (i.e., the time the proximity broadcast receivers received broadcast messages from the same wireless identity transmitter). The timestamps may be matched without being exactly the same in order to accommodate differences due to unsynchronized clocks within the proximity broadcast receivers, transmission delays, etc. In some cases, such as if the wireless identity transmitter is assumed or determined to be stationary, received sighting messages may be matched for purposes of refining the position despite the messages being received at different times. The acceptable time range for matching may be adjustable. Alternately, if the wireless identity transmitter is using a rolling identifier that shifts with each broadcast message, the central server may match received sighting messages based on the rolling identifier rather than on timestamps. If none of the sighting messages are determined to be concurrent (i.e., determination block 1825=“No”), the central server may continue with the operations in block 1822.

If the central server determines that two or more sighting messages are concurrent (i.e., determination block 1825=“Yes”), the central server may compute the location and area of an overlapping region related to the concurrent sighting messages in block 1828. For example, based on the locations of each of the proximity broadcast receivers associated with the concurrent sighting messages and the known transmission range of the wireless identity transmitter, the central server may compute the reception radius of each proximity broadcast receiver to determine the overlapping region. The location of each proximity broadcast receiver may be included in sighting messages transmitted by each proximity broadcast receiver.

In block 1830, the central server may associate the overlapping region (i.e., the computed location and area of the overlapping region) with the wireless identity transmitter. In other words, the central server may associate a finer grained location of the wireless identity transmitter by calculating multiple reception radii for each of the proximity broadcast receivers and identifying an overlapping region that falls within the reception range of each proximity broadcast receiver. This finer grained location may also be associated with the contents of one or more of the proximity broadcast receiver sighting messages (e.g., timestamp, sensor data, etc.). Also as part of block 1830, the central server may identify a number of overlapping area boundaries and assign a probability value to each based on the average and variability of the transmission range.

Embodiment method 1820 may be applied to many concurrent sighting messages received from several proximity broadcast receivers, which may enable the overlapping area to be more narrowly defined. For example, the central server may compute the overlapping region between several proximity broadcast receiver listening ranges or refine a previously computed overlapping region based on another overlapping report (i.e., compute the overlapping region shared by a previous overlapping region and another proximity broadcast receiver listening area). For example, as searchers close in on the wireless identity transmitter, each of their respective mobile proximity broadcast receivers will begin to transmit sighting messages related to the wireless identity transmitter, which the central server may combine to further narrow the search area as searchers approach from different directions. This capability may be further leveraged by having some searchers move away from a suspected location of the wireless identity transmitter until their mobile proximity broadcast receivers are transmitting sighting messages only intermittently, indicating they are on the edge of the transmission range. With multiple proximity broadcast receivers positioned near the apparent maximum transmission range, the overlapping area computed by the central server can be minimized, thereby helping to further pinpoint the location of the wireless identity transmitter.

Further embodiments may provide increased location granularity by considering the power level of the broadcast messages received by multiple proximity broadcast receivers. As is well known, the signal strength of a radio transmission from a point transmitter decreases with distance by a factor proportional to the inverse of the square of the distance (i.e., 1/R²), with any intervening structure or vegetation causing further attenuation. Thus, proximity broadcast receivers located at different distances from a wireless identity transmitter will typically receive the broadcast messages with different signal strengths. For, example, FIG. 18C illustrates a wireless identity transmitter 110 whose transmissions (i.e., broadcast messages) are being received by two proximity broadcast receivers 138, 138′ at different ranges. Due to the attenuation of radio signals with distance, the proximity broadcast receiver 138′ at distance 1852 from the wireless identity transmitter 110 may typically receive the transmissions with a higher signal strength than a more distant proximity broadcast receiver, such as the proximity broadcast receiver 138 at distance 1850. Thus, by including the signal strength of received transmissions in sighting messages transmitted by proximity broadcast receivers 138, 138′ to a central server, the central server may be able to further refine the location of a wireless identity transmitter 110.

A proximity broadcast receiver's distance to the wireless identity transmitter 110 may be estimated as inversely proportional to the power level. Distance estimations may also account for channel conditions such as intervening signal attenuators (e.g., vegetation, buildings, etc.), echoes (i.e., multipath reception) or other interferences. The distance may be estimated locally on the proximity broadcast receiver 138,138′ or alternately by the central server if the proximity broadcast receiver 138, 138′ includes the power level in a sighting message. Each proximity broadcast receiver's own location and estimated distance from the wireless identity transmitter 110 may be used to triangulate the approximate location of the wireless identity transmitter 110. For example, as searchers close in on the wireless identity transmitter, the signal strength of received broadcast messages from the wireless identity transmitter may increase, enabling the central server to further narrow the search area as searchers approach from different directions. Thus, when proximity broadcast receivers 138, 138′ include signal strength data in sighting messages, the central server can reduce the overlap area for searching as multiple searchers approach the wireless identity transmitter 110 (which would not be the case in the circumstances similar to illustrated above with reference to FIGS. 18A and 18B as the overlap area was determined solely upon the maximum reception range).

FIG. 18D illustrates an embodiment method 1860 for a central server providing a finer grained location for a wireless identity transmitter based on the power level of broadcast messages received by proximity broadcast receivers. The central server may receive multiple sighting messages from proximity broadcast receivers in block 1822. The sighting messages may include the power level of a broadcast messages received by the reporting proximity broadcast receivers, or an estimated distance from the proximity broadcast receiver to the wireless identity transmitter determined based on the received signal strength. The central server may determine whether any of the sighting messages are concurrent in determination block 1825. The central server may not consider sighting messages concurrent unless they are associated with the same wireless identity transmitter (i.e., include the same identifier or corresponding rolling identifiers) and are received from different proximity broadcast receivers. Further, the central server may determine whether sighting messages are concurrent based on the contents of the sighting messages as described above with reference to FIG. 18B. If none of the sighting messages are concurrent (i.e., determination block 1825=“No”), the central server may continue with the operations in block 1822.

If the central server determines that two or more sighting messages are concurrent (i.e., determination block 1825=“Yes”), the central server may compute a finer grained location of the wireless identity transmitter based on the received signal power levels and the locations of proximity broadcast receivers transmitting the concurrent sighting messages in block 1868. The central server may estimate the distance between the proximity broadcast receivers and the wireless identity transmitter or may receive an estimated distance in the sighting messages as discussed above. Each proximity broadcast receiver's location and estimated distance from the wireless identity transmitter may be used to triangulate the finer grained location. Triangulation based on information within sighting messages received from only two proximity broadcast receivers may result in two possible locations for the wireless identity transmitter. However, information in sighting messages from three or more proximity broadcast receivers may be used to better approximate the wireless identity transmitter's location. The central server may associate the finer grained location (i.e., the triangulated location) with the wireless identity transmitter in block 1870. This finer grained location may also be associated with the contents of one or more of the proximity broadcast receiver sighting messages (e.g., timestamp, sensor data, etc.).

In optional block 1872, the central server may transmit a return message to a proximity broadcast receiver that is closest to the wireless identity transmitter based on signal power information reported in received sighting messages. In other words, the central server may determine the closest proximity broadcast receiver to the wireless identity transmitter among the plurality of proximity broadcast receivers that transmitted the concurrent sighting messages. Often, a user of a wireless identity transmitter may intend to use a device associated with a single proximity broadcast receiver within a plurality of proximity broadcast receivers (e.g., a point-of-sale device in a line of point-of-sale devices each connected to proximity broadcast receivers). The central server may use signal strength or signal power indicators within concurrent sighting messages, as well as any other relevant data (e.g., location information, direction of the wireless identity transmitter based on previous sighting messages, etc.) to determine the single proximity broadcast receiver the user of the wireless identity transmitter likely intends to interface. The return message may indicate to the proximity broadcast receiver that the wireless identity transmitter is likely intending to interface with that proximity broadcast receiver, and may additionally include instructions, data, or other information for the proximity broadcast receiver. For example, the return message may include a message indicating the user of the wireless identity transmitter is near, or alternatively instructions on how to handle the user.

In an embodiment, the return message may indicate information describing the certainty of the determination that the recipient proximity broadcast receiver is the closest to the wireless identity transmitter. Additionally, the return message may request a confirmation of proximity to the wireless identity transmitter. For example, the closest proximity broadcast receiver may confirm that it is the closest proximity broadcast receiver based on subsequent input data related to the user of the wireless identity transmitter (e.g., the user of the wireless identity transmitter pressed a ‘confirm’ button on the proximity broadcast receiver). In another embodiment, the central server may transmit messages to the proximity broadcast receivers determined to not be the closest proximity broadcast receiver, indicating that these proximity broadcast receivers are not closest and/or the identity of the determined closest proximity broadcast receiver. In response, the proximity broadcast receivers that are not the closest may modify their subsequent transmission of sighting messages regarding the wireless identity transmitter. For example, the proximity broadcast receivers may adjust (i.e., increase or decrease) the frequency of transmitting sighting messages regarding the wireless identity transmitter (i.e., adjust receiver thresholds) or alternatively may ignore future broadcast messages from the wireless identity transmitter for a period of time.

FIG. 19 illustrates an embodiment method 1900 that may be implemented within a central server. The method 1900 may be performed by the central server in response to receiving a sighting message from a proximity broadcast receiver that includes encoded, rolling, or otherwise protected data originally broadcast by a wireless identity transmitter. Privacy of users of wireless identity transmitters may be protected by using a rolling or randomly varying identifier for each wireless identity transmitter so the identifier changes with time. New identifiers may be generated periodically or based on certain events, such when a wireless identity transmitter broadcasts an identifier a certain number of times or for a certain time period (e.g., an hour), or after one or more pairings. This rolling of identifiers may be coordinated with the central server so that the wireless identity transmitter may still be tracked. For example, the wireless identity transmitter and the central server may each have a cryptographically secure pseudo-random number generator algorithm that is used to generate identifiers on a common time scale so that any given moment, the central server can calculate the identifier being transmitted by a particular wireless identity transmitter.

Generating rolling identifiers, or other methods of obfuscating identifiers, is important in that it may prevent sniffing attacks from a third party. For example, if the identifier was static, a third party could sniff the identifier, such as by impersonating a proximity broadcast receiver, and then use the identifier to track the wireless identity transmitter. A rolling identifier may hinder such an attack impossible if the third party lacks the pseudo-random number generator or other means of generating the latest rolling identifiers.

In block 1902, the central server may receive a wireless identity transmitter's rolling identifier in a sighting message from a proximity broadcast receiver. In block 1904, the central server may compare the rolling identifier with code calculated by an algorithm shared with the wireless identity transmitter, such as a pseudo-random function or an encryption algorithm with shared secret keys. The algorithm may be software instructions, routines, algorithms, circuitry, or modules that are utilized by the central server to calculate codes that are expected to align with rolling identifiers generated and broadcast by the wireless identity transmitter over a period. In various embodiments, the central server may compare the received identifier with the next several codes in case some identifiers were missed. If the received identifier matches any codes generated or expected by the central server, in block 1906 the central server may associate the matching identifier and any associated data with a serial code corresponding to the wireless identity transmitter. This way, if the central server later receives a user request with the wireless identity transmitter's serial code, such as a request from a parent to locate the wireless identity transmitter carried by a child, then the central server can find all the prior matches and any associated data without having to search for every previous rolling identifier.

In an embodiment, when initiating a search for a target wireless identity transmitter, the central server may use the shared algorithm and information (e.g., key) to generate a target device ID that is transmitted in an alert message. In this embodiment, alert messages may be retransmitted with an updated target device ID whenever the target wireless identity transmitter is scheduled to roll its identifier. Various algorithms for generating rolling identifiers or other encoded identifiers, as well as other decoding algorithms, are discussed below.

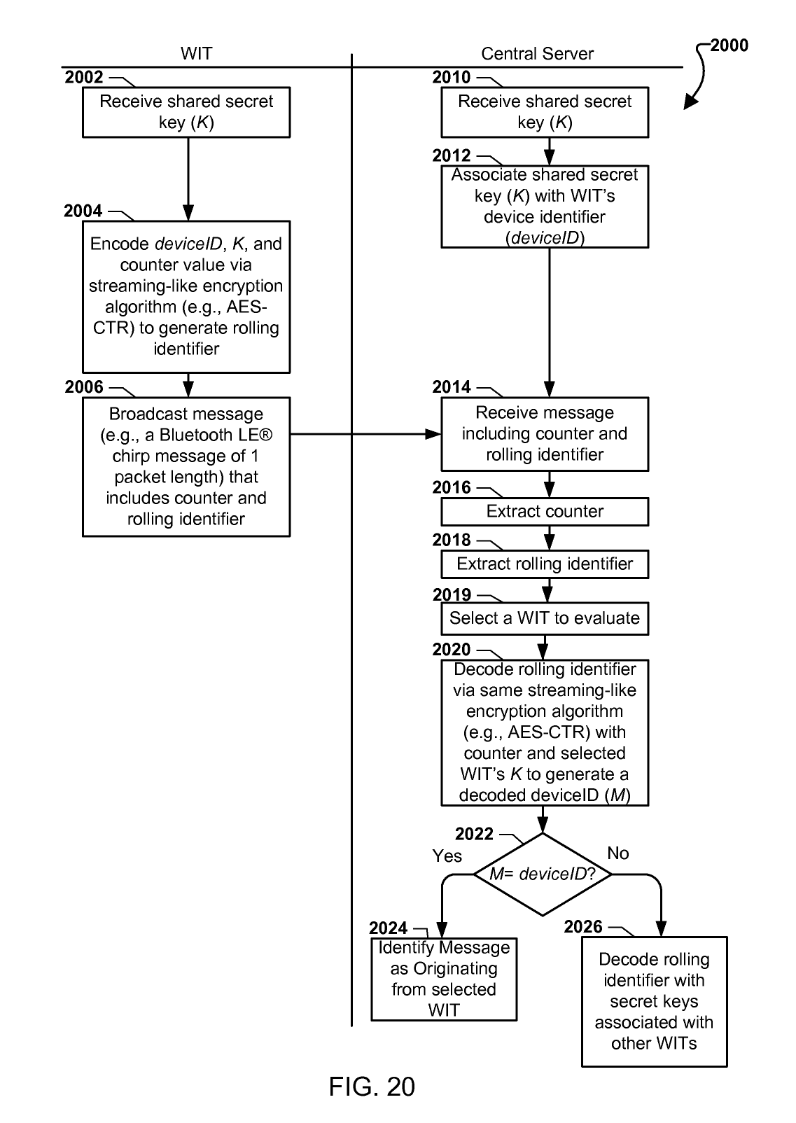

FIGS. 20-24C illustrate various embodiment methods for synchronizing a nonce or counter between a wireless identity transmitter and a central server to enable transmitting and receiving obscured information. The wireless identity transmitter may perform various methods for broadcasting messages that include obscured identifiers and data (i.e., payloads) that identify the wireless identity transmitter to the central server and provide a relative reading on the wireless identity transmitter clock. Likewise, the central server may perform various methods for processing obscured information within received messages corresponding to the wireless identity transmitter. As described above, the broadcast messages from the wireless identity transmitter may be sent to the central server directly or through intermediary devices, such as proximity broadcast receivers transmitting sighting messages.

Due to privacy concerns regarding unintended tracking of devices described above, the wireless identity transmitter may obscure information within the transmitted messages through obfuscation measures (e.g., encryption or pseudo-random data generation) known only to the central server and wireless identity transmitter. In an embodiment, the wireless identity transmitter may maintain a clock or timer mechanism that is represented by a nonce or counter value and that may begin once the device is operational (e.g., activated through the insertion of a battery). The clock may be relatively low-quality and therefore may drift unlike more accurate clocks, such as in the central server (e.g., clocks calibrated by periodic atomic clock readings). The counter or nonce may be a non-repeating number generated by the wireless identity transmitter, and may be changed each time wireless identity transmitter encodes its identifier for broadcasting, such as once every hour or even once every broadcast message. In various embodiments, nonces or counters (or counter values) may be encrypted or encoded using pseudo-random functions or other encryptions algorithms (e.g., AES). For example, a wireless identity transmitter may encode a nonce or counter value with an AES-CTR block cipher to create a nonce for use in generating the payload including a rolling identifier of a broadcast message. As another example, a nonce may be generated by applying a linear feedback shift register (LFSR) to a nonce or counter value.

As described throughout the disclosure, the wireless identity transmitter may also store a unique device identification code or number (i.e., a device identifier or ‘deviceID’) and be pre-provisioned with a per-device shared secret key (or K) which is associated with the unique identifier at the central server. For example, the central server may store the unique device identifier and the secret key in a database and may maintain a table of deviceID and K pairs for all wireless identity transmitters registered with the central server. The central server may use the device identifier and secret key, along with other information such as reported nonce or counter values, to identify, decrypt and otherwise process obscured messages from the wireless identity transmitter. In an embodiment, the device identifier (or deviceID) may be generated sequentially or randomly.

FIG. 20 illustrates an embodiment method 2000 for a central server to identify a wireless identity transmitter indicated by encrypted data within a message broadcast by the wireless identity transmitter. In block 2002, the wireless identity transmitter may receive a shared secret key (i.e., “K”). In other words, the wireless identity transmitter may be pre-provisioned with a per-device shared secret key (K), such as during manufacturing. In another embodiment, the wireless identity transmitter may receive the secret key in a messages broadcast from a proximate proximity broadcast receiver, such as described above with reference to FIG. 4. The secret key may be associated with the wireless identity transmitter's unique device identifier (i.e., deviceID) at the central server. In an embodiment, the secret key may be a 128 bit secret key.

In block 2004, the wireless identity transmitter may encode the device identifier (deviceID), secret key (K), and a nonce or counter value via a streaming-like encryption algorithm (e.g., AES-CTR encryption) to generate a rolling identifier. “AES-CTR” is one of the confidentiality modes recommended by the National Institute of Standards and Technology for implementations of the Advanced Encryption Standard (AES). In an embodiment, the wireless identity transmitter may include an AES coprocessor that is configured to support the “CTR” mode. In an embodiment, the rolling identifier may be represented by the following equation:

Rolling identifier=(deviceID∥data)XOR(MSB_{—}N(AES_{—}K(t)))

where t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘MSB_N( )’ means the ‘N’ most significant bits (e.g., 60 bits). This rolling identifier may then be included in the broadcast message that is regularly transmitted by the wireless transmitter device. In an embodiment, other device data (e.g., battery level, temperature, etc.) may be transmitted along with the rolling identifier in a broadcast packet.

In a further embodiment, other information may be included within the rolling identifier. Thus, in addition to providing an obscured identifier for the wireless identity transmitter, the rolling identifier field may include obscured data that only the central server can recover. One method for accomplishing this is to concatenate the additional information, such as a few bits to indicate the battery status (bat_stat) to the device identifier (deviceID) and applying the XOR function to the concatenation. The amount of additional information (i.e., number of bits of information) that can be included within (i.e., obscured within the same data field of) the rolling identifier is limited by the length N of significant bits within the rolling identifier field. Thus, if more bits are available in the data portion carrying the rolling identifier, more such data may be included within the encrypted rolling identifier. Since the data that is included within the rolling identifier is likely to change over time, this approach may further obscure the device's identity.

If more data is desired to be transmitted in broadcast messages, some of that data may be carried in the clear or encrypted with the data. There are a number of approaches for including data (e.g., battery state, temperature, etc.) within broadcast messages. In addition to including the data within the rolling identifier as described above, the data may be added by concatenating the data to the end of the rolling identifier as part of the manufacturer specific data payload, either before or after the rolling identifier, as sensor data in the clear. Thus, if there are more bits available in the manufacturer specific data payload they may be used to convey the data in the clear. Alternatively, the data may be encoded using the same key as used to generate the rolling identifier or an alternate key that is known to the server to be associated with the wireless identity transmitter or such data fields. In this alternative, the information in the rolling identifier enables the server to both determine the device's true identifier and the encryption key used to encrypt the other data included in the message. In yet a further embodiment, these options for carrying other data may be combined, such that some of it is included within the rolling identifier, some is carried in the clear and/or some data may be encrypted and included within the broadcast message.

In block 2006, the wireless identity transmitter may then broadcast a message that includes the nonce and the rolling identifier, or simply the rolling identifier (i.e., without a nonce). In an embodiment, the broadcast message may be a single packet length Bluetooth LE® chirp message. In various embodiments, the nonce included in the broadcast message may be 20 bits and the rolling identifier may be 60 bits, so that the entire broadcast message is 80 bits.

As an example embodiment in which the battery status is included within the rolling identifier, the broadcast message (or the payload of the broadcast message) may be represented by the following equation:

Payload=t∥(deviceID∥bat_stat)XOR(MSB_{—}N(AES_{—}K(t)))

where t is the value of the wireless identity transmitter's nonce, which may just be the nonce or counter (e.g., a 20 bit value), ‘bat_stat’ is the battery status information of the device (e.g., a 4-bit code), ‘∥’ means concatenation, ‘XOR’ denotes the bitwise exclusive-or operation, ‘AES_K( )’ is the AES block cipher with key ‘K’, and ‘MSB_N( )’ means the ‘N’ most significant bits (e.g., 60 bits). In other words, the embodiment broadcast message may include the nonce in the clear (i.e., not encrypted) in addition to a rolling identifier that includes a battery level indicator. In another embodiment, the battery level indicator (i.e., bat_stat) may not be encrypted, and may be included in another field of the broadcast message, such as within the service universally unique identifier (UUID) portion of a message.

In another embodiment, the payload may not include a nonce t, in which case the payload may be represented by the following equation:

Payload=(deviceID∥bat_stat)XOR(MSB_{—}N(AES_{—}K(t))).

In block 2010, the central server may receive the shared secret key (K), such as during the account creation operations described above with reference to FIG. 13. For example, the central server may generate the secret key in response to receiving account registration information from the user of the wireless identity transmitter (e.g., deviceID and registration request information). In block 2012, the central server may associate the shared secret key (i.e., K) with the wireless identity transmitter's device identifier (i.e., deviceID). For example, the central server may store the deviceID and K in a data table of registered devices.

In block 2014, the central server may receive a message including the nonce or counter and the rolling identifier. For example, the received message may be a sighting message from a proximity broadcast receiver that includes the information broadcast by the wireless identity transmitter with the operations in block 2006. In block 2016, the central server may extract the nonce or counter from the received message, and in block 2018 may extract the rolling identifier. In block 2019, the central server may select a wireless identity transmitter (i.e., selected wireless identity transmitter) to evaluate. In other words, the central server may obtain a stored deviceID, K, and nonce or counter for a registered wireless identity transmitter known to the central server, such as from the database or data table storing such information for all registered wireless identity transmitters. In block 2020, the central server may decode the rolling identifier via the same streaming-like encryption algorithm (e.g., AES-CTR) with the nonce or counter and the selected wireless identity transmitter's secret key (K) to generate a decoded device identifier (or M). For example, the central server may perform a decoding operation based on the AES-CTR algorithm that uses the rolling identifier as input along with the selected wireless identity transmitter's secret key (K) and the nonce or counter indicated in the received message.

In an embodiment, the decoded device identifier (M) may be represented by the following equation:

M=(rolling identifier)XOR(MSB_{—}{N−a}(AES_{—}K(t))),

where t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘MSB_{N−a}’ means the ‘N−a’ most significant bits (e.g., 56 bits when a is 4 bits and N is 60 bits).

In determination block 2022, the central server may determine whether the decoded device identifier (M) and the deviceID match. In other words, the central server may compare the decoded device identifier (M) to the deviceID for the selected wireless identity transmitter whose secret key (K) was used with the AES-CTR algorithm operations to obtain the decoded device identifier (M). If M and the deviceID do match (i.e., determination block 2022=“Yes”), in block 2024, the central server may identify the broadcast message as originating from the selected wireless identity transmitter. If M and the deviceID do not match (i.e., determination block 2022=“No”), in block 2026 the central server may decode the rolling identifier with secret keys associated with other wireless identity transmitters. For example, the central server may select the next registered wireless identity transmitter and use the corresponding stored pair of a secret key (K) and corresponding deviceID. In this manner, all K and deviceID pairs stored for all registered wireless identity transmitters and/or users of the system may be tried by the central server until a match is found that identifies the originator of the broadcast message.

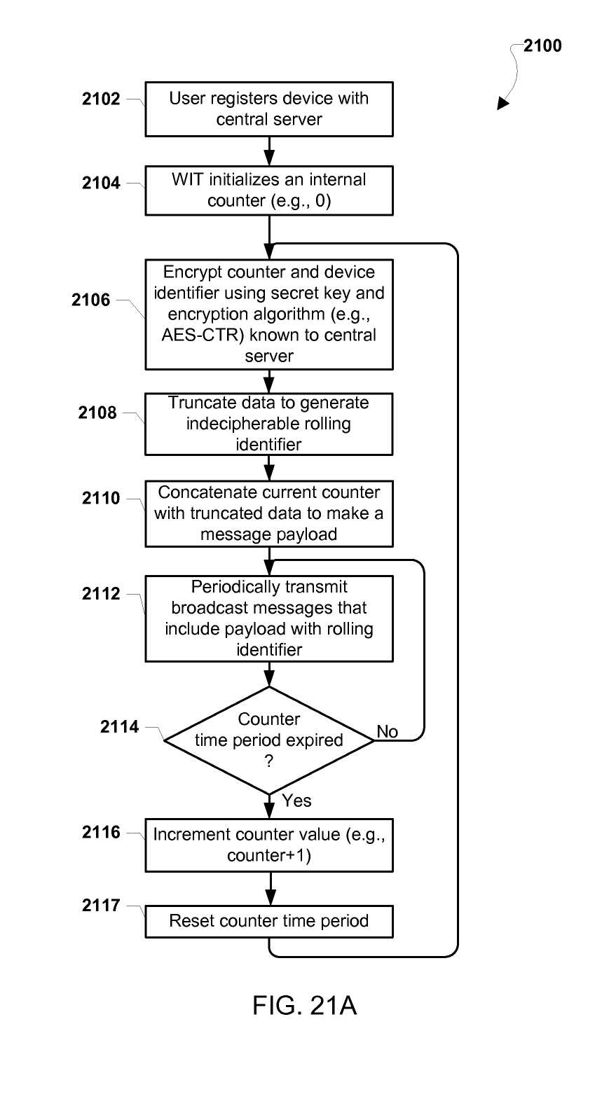

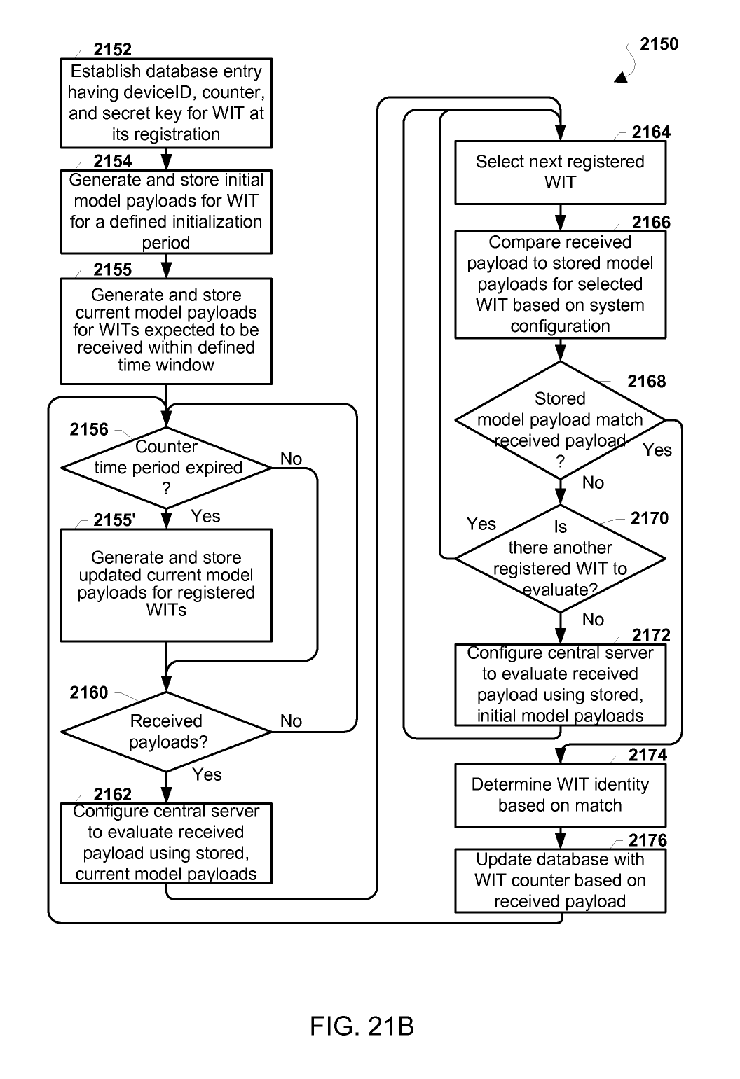

FIG. 21A illustrates the embodiment method 2100 for a wireless identity transmitter generating and broadcasting an encrypted message (i.e., a rolling identifier) for receipt/use by a central server.

In block 2102, a user of the wireless identity transmitter may register the device with the central server. The services the wireless identity transmitter utilizes may require registrations of all active devices employed by users (e.g., customers, proprietors, etc.). The registration process may include an initial synchronization with the central server by the user of the wireless identity transmitter. For example, the user of the wireless identity transmitter may register the device with the central server through a Web application, in a mobile device or a PC able to receive wireless identity transmitter messages and operated by the user. The wireless identity transmitter may be required to be registered with the central server within a certain time period from activation of the device. For example, the wireless identity transmitter may be required to be registered within the first 24 hours after the device is initiated (e.g., a battery is placed within the wireless identity transmitter). Registration operations are further described above with reference to FIG. 13.

In block 2104, the wireless identity transmitter may initialize an internal nonce or counter, such as by setting the nonce or counter to a zero value. The nonce or counter initialization may occur due to a triggering event, such as the placement of a battery or power source within the wireless identity transmitter. For example, the nonce or counter may begin incrementing once the wireless identity transmitter is activated or powered on. Alternatively, the initialization may occur in response to registration operations described above. The nonce or counter may begin with ‘0’ (or any other starting value, such as ‘1’) and may be incremented periodically by the wireless identity transmitter. In an embodiment, when the battery of the wireless identity transmitter is replaced (e.g., due to battery failure) or the wireless identity transmitter is otherwise reset/restarted/rebooted, the nonce or counter may return to the initial value (e.g., ‘0’). The nonce or counter may not repeat the value it represents unless the wireless identity transmitter is reset/restarted/rebooted. In an alternative embodiment, during initialization of the nonce or counter, the wireless identity transmitter may read from flash memory a predefined initial nonce or counter value. For example, the wireless identity transmitter may initialize the nonce or counter with a value set at a factory or updated by an installed application.

In an embodiment, the counter or nonce may be initialized and adjusted in a random or pseudo-random fashion using methods well known in the art. The nonce or counter may be a pseudo-randomly generated value that can be replicated in both the wireless identity transmitter and the central server. In another embodiment, the nonce or counter may be generated by the wireless identity transmitter using a linear feedback shift register (LFSR) with a proper period configured to create nonce or counter values that do not repeat during the lifetime of the device. Such nonces or counters derived from the LFSR may also be pseudo-random.

In block 2106, the wireless identity transmitter may encrypt the concatenated data using a secret key and encryption algorithm known to the central server. For example, the wireless identity transmitter may encode the nonce or counter and/or the device identifier (i.e., deviceID) using an AES-CTR block cipher. The encryption algorithm may utilize the secret key for encryption and decryption purposes, as the secret key is known by both the central server and wireless identity transmitter. The encryption algorithm may result in encrypted (or encoded) data of a certain size. For example, using the AES-CTR cipher, the wireless identity transmitter may generate encoded data of 128-bits. In an embodiment, the wireless identity transmitter may generate encrypted data represented by the following equation:

(deviceID∥bat_stat)XOR(MSB_{—}N(AES_{—}K(t))),

where t is the value of the wireless identity transmitter's nonce or counter (e.g., a 20 bit value), ‘bat_stat’ is the battery status information of the wireless identity transmitter (e.g., a 4-bit code), ‘∥’ means concatenation, ‘XOR’ denotes the bitwise exclusive-or operation, ‘AES_K( )’ is the AES block cipher with key ‘IC’, and ‘MSB_N( )’ means the ‘N’ most significant bits (e.g., 60 bits). In other words, the embodiment broadcast message may include the nonce or counter in the clear (i.e., not encrypted) in addition to a rolling identifier that includes a battery level indicator. In another embodiment, the encrypted data may be represented by the following equation:

(deviceID)XOR(AES_{—}K(t)),

where deviceID is a unique device identifier, t is the value of the wireless identity transmitter's nonce or counter (e.g., a 20 bit value), ‘XOR’ denotes the bitwise exclusive-or operation, ‘AES_K( )’ is the AES block cipher with key ‘IC’, and ‘MSB_N( )’ means the ‘N’ most significant bits (e.g., 60 bits).

Due to the limited communication capabilities of the wireless identity transmitter, the payload of broadcast messages (e.g., the payloads supported by Bluetooth LE broadcast packets) may not be able to contain the entire encrypted message, but instead only include a portion of an encrypted piece of data. Accordingly, in block 2108, the wireless identity transmitter may truncate data to generate an indecipherable rolling identifier. In other words, by truncating the encrypted data, the wireless identity transmitter may create an identifier to be put in a broadcast message (or payload) such that the identifier's size may be supported by the utilized communication format, such as Bluetooth LE. For example, the wireless identity transmitter may truncate the encrypted data to fit within an 80-bit payload maximum size. When encrypted data is truncated, the decryption of that data within the central server may be impossible. However, the incomplete encrypted data may still be used by the central server as described below with reference to FIG. 21B. In an embodiment, truncation may be accomplished with a function, such as a most-significant-bit operation. In another embodiment, the truncated data may be represented by the following equation:

TRUNC(deviceID XOR AES_{—}K(t)),

where t is the value of the wireless identity transmitter's nonce or counter (e.g., a 20 bit value), ‘XOR’ denotes the bitwise exclusive-or operation, ‘AES_K( )’ is the AES block cipher with key ‘IC’, and ‘TRUNC ( )’ denotes a truncation operations that may create a certain number of bits or bytes (e.g., 56 bits or 7 bytes).

In block 2110, the wireless identity transmitter may concatenate the current nonce or counter with the truncated data to make a message payload. For example, the wireless identity transmitter may combine the current wireless identity transmitter system clock value (e.g., 20 bits long) with the unique identification code of the wireless identity transmitter truncated to be 60 bits long. In an embodiment, the payload may include both encrypted data and unencrypted data (or “in the clear” data). For example, the payload may contain many bits representing the encrypted and/or truncated data and several other bits that represent the battery status of the wireless identity transmitter or a nonce or counter value.

In block 2112, the wireless identity transmitter may periodically transmit broadcast messages that include the payload with the rolling identifier, such as by broadcasting via short-range wireless communication techniques as described above. The frequency of transmissions of the broadcast messages may vary dependent upon system configurations, user settings, or any other source of scheduling and timing relevant for wireless identity transmitters communicating via radio signals. For example, the wireless identity transmitter may broadcast the rolling identifier every few seconds.

In determination block 2114, the wireless identity transmitter may determine whether a predefined nonce or counter time period has expired. This nonce or counter time period may be set in a similar manner as the broadcast frequency periodicity as described above. For example, the manufacturer or may establish the nonce or counter time period using various techniques, such as hard-coding variables within the wireless identity transmitter's processor circuitry.

If the nonce or counter time period has not expired (i.e., determination block 2114=“No”), the wireless identity transmitter may continue with the operations in block 2112. For example, the wireless identity transmitter may broadcast the payload via short-range radio transmissions at a frequency of a few seconds for a time period of many minutes.

If the device determines the nonce or counter time period has expired (i.e., determination block 2114=“Yes”), in block 2116 the wireless identity transmitter may increment the nonce or counter value, such as by adding 1. In block 2117, the wireless identity transmitter may reset the nonce or counter time period. For example, after a nonce or counter time period has expired, the wireless identity transmitter may increase the nonce or counter by a value of 1 and reset the nonce or counter time period to 0. The wireless identity transmitter may continue with the operations in block 2106 (e.g., the wireless identity transmitter may create a new payload and broadcast it for another nonce or counter time period).

FIG. 21B illustrates an embodiment method 2150 for a central server receiving messages and syncing timing nonce or counters based on payload information. In block 2152, the central server may establish a database entry having the device identifier (i.e., deviceID), nonce or counter, and secret key data for the wireless identity transmitter at its registration. The central server may maintain a database containing data records for each wireless identity transmitter associated with the central server and/or the central server's affiliated services. The database may be populated with information obtained via registration operations described above. Thus, there may be a data record for each wireless identity transmitter associated with the central server, and each record may contain information that represents a particular device's identification, its current nonce or counter (e.g., clock value), and a secret key associated with the wireless identity transmitter. In an embodiment, the secret key may be unique to each wireless identity transmitter registered with the central server. In an embodiment, the central server may also store the initial nonce or counter value for each wireless identity transmitter registered with the central server.

In various embodiments, when a wireless identity transmitter is registered, the central server may store the initial nonce or counter value for the wireless identity transmitter. Dependent upon the time between the activation of the wireless identity transmitter (e.g., when the battery was inserted and the device became operational) and the registration of the device, the initial nonce or counter for the wireless identity transmitter may or may not be 0. For example, if the registration of the wireless identity transmitter with the central server occurred several hours after a user inserted a battery in the wireless identity transmitter, the initial nonce or counter may not be 0. In an embodiment, the central server may also indicate the registration status of the wireless identity transmitter by setting a registration flag or other indicator and may store information describing wireless identity transmitters that have yet to be registered in the database. In an embodiment, the central server may maintain a database with initial values provided for all known wireless identity transmitter whether or not they have been registered. For example, based on manufacturing records, the central server may contain a database having information about every wireless identity transmitter created.

The central server may generate and store model payloads using operations similar to those described above with reference to blocks 2106-2110. Model payloads may be payloads the central server expects to receive from the wireless identity transmitter based on stored secret key, device identifier (deviceID), and nonce or counter information. For example, for each registered wireless identity transmitter, the central server may create a model payload by concatenating the device's deviceID to a nonce or counter value, encrypting the concatenated data using an encryption protocol that employs the secret key for the wireless identity transmitter, and truncating the encrypted data. Each model payload may be stored in a central server data table (or lookup table) in relation to the corresponding deviceID and nonce or counter values used to generate the respective model payloads. For example, for each model payload for each wireless identity transmitter, the central server may store in the data table the model payload, a time offset value (e.g., −2, −1, 1, 2, etc.), and the nonce or counter, all in relation to the deviceID of the wireless identity transmitter.

In block 2154, the central server may generate and store initial model payloads for the wireless identity transmitter for a defined initialization period. For example, starting at the initial nonce or counter value (e.g., 0 or a pseudo-random value known to the device and the central server), the central server may generate model payloads using nonce or counter values that are the same, lower, and/or higher than the actual initial nonce or counter of a wireless identity transmitter such that these model nonces or counters cover the initialization period. In an embodiment, the initialization period may be an hour, several hours, days, etc.). The central server may store the initial model payloads for use in the event of a registration/reset/reboot of a wireless identity transmitter.

In block 2155, the central server may also generate and store current model payloads for wireless identity transmitters expected to be received within a defined time window. To account for possible clock drift in wireless identity transmitters, the central server may generate and store model payloads for the defined time window (or time period) by using multiple derivative nonce or counter values that represent a range of possible nonces or counters. In other words, derivative nonce or counter values may be offsets to the current nonce or counter value stored for a wireless identity transmitter. For example, the central server may generate model payloads for derivative nonce or counter values that are lower and higher than the currently stored nonce or counter value in the database. A derivative nonce or counter value may be the result of an offset value (e.g., −2, −1, 1, 2, etc.) added to the stored nonce or counter value for a wireless identity transmitter. The central server may generate model payloads to represent the stored nonce or counter value and derivative nonce or counter values that incrementally represent the window time period. For example, the model payloads may represent nonces or counters increasing by a small time value, such as an hour, and covering a large period of time, such as multiple hours. As another example, the central server may store a payload corresponding to the current nonce or counter value stored for a wireless identity transmitter, a payload corresponding to the previous nonce or counter value for the device, and a payload corresponding to the next nonce or counter value for the device.

In an embodiment, the first generated current model payloads for a given wireless identity transmitter may be identical to the initial model payloads for the wireless identity transmitter as both sets of payloads may be generated by the central server based on the same initial nonce or counter values. In an embodiment, the initialization period may coincide with the defined time window. For example, the initialization period may involve a similar number of days, hours, minutes, etc. as the defined time window.

In determination block 2156, the central server may determine whether a nonce or counter time period has expired. The central server may initialize the evaluation of a nonce or counter time period at an arbitrary time or, alternatively, upon the receipt of a wireless identity transmitter registration. The nonce or counter time period may be the same period of time used by the wireless identity transmitters as described above with reference to determination block 2114.

If the nonce or counter time period has expired (i.e., determination block 2156=“Yes”), in block 2155′ the central server may generate and store updated current model payloads for registered wireless identity transmitters. The updated current model payloads may replace the previous current model payloads and may be based on the stored nonce or counter value in each respective wireless identity transmitter's database record.

If the nonce or counter time period has not expired (i.e., determination block 2156=“No”) or if the nonce or counter time period has expired and the central server has generated updated current model payloads, in determination block 2160, the central server may determine whether any payloads have been received. In an embodiment, payloads may be delivered directly from wireless identity transmitters or alternatively indirectly from proximity broadcast receivers via sighting messages which include (or relay) rolling identifier payloads from proximate wireless identity transmitters to the central server. If no payloads have been received (i.e., determination block 2160=“No”), the central server may continue with the operations in determination block 2156.

If a payload has been received (i.e., determination block 2160=“Yes”), in block 2162, the central server may be configured to evaluate the received payload using stored, current model payloads, such as the current model payloads stored for each registered wireless identity transmitter. As described above, the central server may maintain two sets of stored model payloads for each registered wireless identity transmitter, an initial model payload set that may include model payloads based on the initial nonce or counter and derivative nonce or counter values that span the initialization period, and a current model payload set that is based on the current nonce or counter value stored within the database record for each wireless identity transmitter. In an embodiment, the central server may set a system variable indicating the central server should compare the received payload to stored, current model payloads. The system variable may be set to direct the central server to evaluate either the current or initial model payloads for wireless identity transmitters.

In blocks 2164-2172, the central server may perform an operational loop in which the central server compares the received payload (i.e., data broadcast by the wireless identity transmitter) to stored model payloads for all registered wireless identity transmitters until a match is found. In block 2164, the central server may select a next registered wireless identity transmitter. The central server may determine the next registered device based on the database of registered wireless identity transmitters and may sequentially iterate through each device during the operations in blocks 2164-2172. In block 2166, the central server may compare the received payload to the stored model payloads for the selected wireless identity transmitter based on the system configuration, such as the configuration set in the operations in block 2162. For example, based on the system variable set to ‘current’ with the operations in block 2162, the central server may compare the received payload to stored current model payloads for the selected wireless identity transmitter. Based on the form of the encrypted data of the received payload, the comparison may be a pattern-matching routine in which the central server compares the data of the model payloads against the received payload. For example, the central server may compare the bit values for the stored and received payloads.

In determination block 2168, the central server may determine whether any of the stored model payloads match the received payload. If none of the stored model payloads match the received payload (i.e., determination block 2168=“No”), in determination block 2170, the central server may determine whether there is another registered wireless identity transmitter to evaluate. In other words, the central server may determine whether the stored model payloads of all registered wireless identity transmitters have been evaluated. If there is another registered wireless identity transmitter to evaluate (i.e., determination block 2170=“Yes”), the central server may continue by selecting the next registered wireless identity transmitter with the operations in block 2164.

If the central server has evaluated the stored model payloads of all registered wireless identity transmitters (i.e., determination block 2170=“No”), in block 2172, the central server may be configured to evaluate the received payload using stored, initial model payloads, such as the initial model payloads stored for each registered wireless identity transmitter at the time of the devices' registration. For example, the central server may set a system variable indicating the central server should compare the received payload to stored, initial model payloads for evaluated registered wireless identity transmitters (e.g., the system variable may be set to ‘initial’). The operational loop may then continue with the operations in blocks 2164-2168 wherein the central server may select each registered wireless identity transmitter and compare the initial model payloads of that selected device to the received payload.

If the central server does find a match between the received payload and any of the stored model payloads (current or initial) of a registered wireless identity transmitter (i.e., determination block 2168=“Yes”), in block 2174, the central server may determine a wireless identity transmitter identity based on the match. In other words, the central server may identify the wireless identity transmitter corresponding to the received payload based on the identification information (e.g., deviceID) stored in relation to the matching stored model payload. In block 2176, the central server may update the database with the identified wireless identity transmitter's nonce or counter based on the received payload. Based on the database record corresponding to the matching stored model payload, the central server may determine the derivative nonce or counter value corresponding to the received payload and may update the stored nonce or counter value to represent the derivative nonce or counter value, thus syncing the identified wireless identity transmitter's nonce or counter and the central server nonce or counter. In an embodiment, the central server may also store in the database the central server nonce or counter (or time) at which the central server received the received payload.

In an embodiment, the central server may maintain a list (or data table) of recently received messages and the corresponding wireless identity transmitter identification. For example, the central server may record within a data table the deviceID and payload information for messages received within a certain period. The central server may compare any subsequently received payload to the data table to determine whether the subsequently received payload is redundant based on recently received payloads from the same wireless identity transmitter. For example, a subsequently received payload may represent a certain nonce or counter value from a particular wireless identity transmitter that was already received and processed by the central server a few minutes ago. This may expedite the method 2150 process and decrease search times for the operations in blocks 2164-2172. In an embodiment, the central server may expunge (or clear) the data table of recently identified payloads and wireless identity transmitters and may schedule the clearing operations similarly as described in block 2176 (e.g., the recent data table may be cleaned every time the nonce or counter time period is determined to be expired).

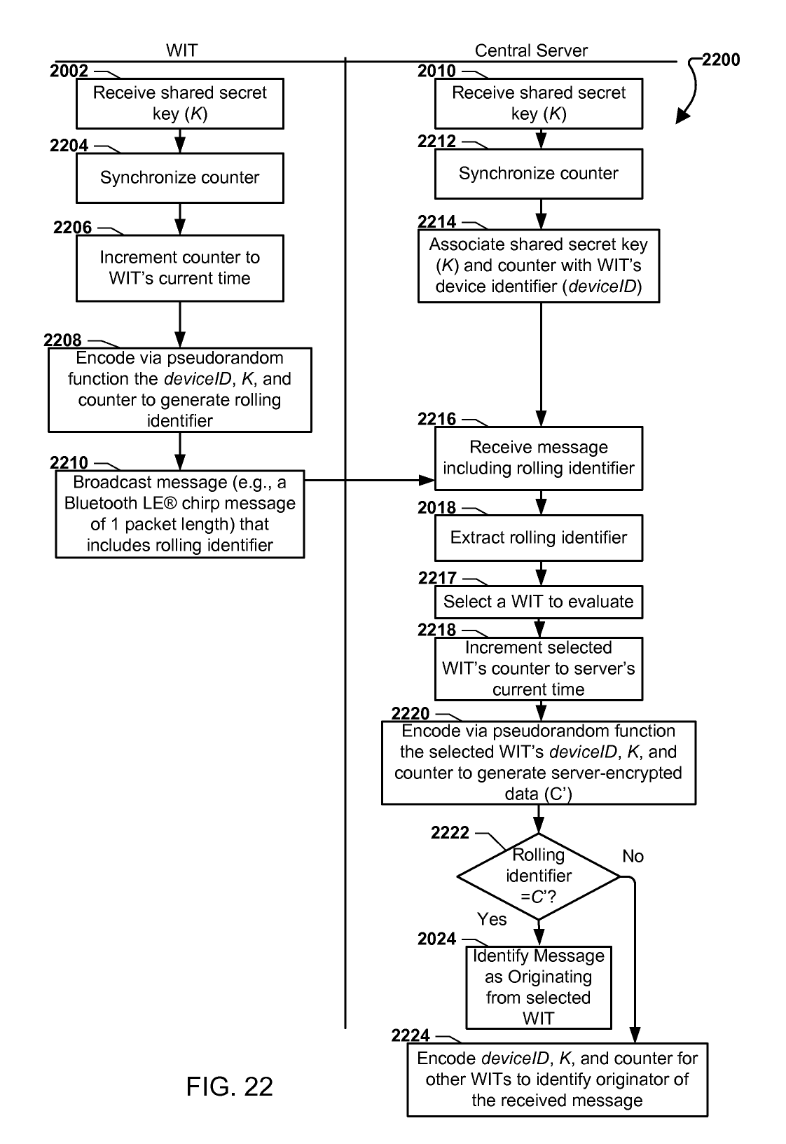

FIG. 22 illustrates another embodiment method 2200 for a central server to identify a wireless identity transmitter indicated by encrypted data within a message broadcast by the wireless identity transmitter. In the operations of the method 2200, nonce or counter values may never be included in broadcast messages to increase the security with which wireless identity transmitters transmit their identities. For example, as nonce or counter values may differ among different wireless identity transmitters, an attacker with the ability to capture a broadcast message may be able to easily predict values within future broadcast messages from the wireless identity transmitter. However, without nonce or counter data transmitted in the clear, nefarious snoopers may be better thwarted from following broadcasts from a particular wireless identity transmitter.

In block 2002, the wireless identity transmitter may receive a shared secret key (i.e., “K”). For example, each wireless identity transmitter may be pre-provisioned with a per-device shared secret key which is associated with the wireless identity transmitter's unique device identifier (or deviceID) at the central server. In block 2204, the wireless identity transmitter may synchronize a nonce or counter. The nonce or counter may be synchronized with the central server upon registration of the wireless identity transmitter at the central server. The synchronized nonce or counter value may also be associated with the deviceID and K in a data table stored in the central server (e.g., a table with stored pairs of IDs and K values).

In block 2206, the wireless identity transmitter may increment the nonce or counter to the wireless identity transmitter's current device time. For example, the nonce or counter may be incremented after a predefined number of seconds (e.g., one second, one hour, etc.). As another example, every 3600 seconds the wireless identity transmitter may increment the nonce or counter by one value. In this manner, the nonce or counter value may change to the current time as counted by the oscillator on the wireless identity transmitter. In block 2208, the wireless identity transmitter may encode via a pseudo-random function the device identifier (i.e., deviceID), the shared secret key (i.e., K), and the nonce or counter to generate a rolling identifier. In this manner, the rolling identifier may be generated as the nonce or counter value changes. In an embodiment, the pseudo-random function may be a polynomial time computable function with a seed (‘s’) and input variable (‘x’), such that when the seed is randomly selected and not known to observers, the pseudo-random function (e.g., PRF(s, x)) may be computationally indistinguishable from a random function defined on the same domain with output to the same range. For example, the Keyed-Hash Message Authentication Code (HMAC) or the Cipher-Based Message Authentication Code (CMAC) may be used as the pseudo-random function.

In block 2210, the wireless identity transmitter may broadcast a message (e.g., a Bluetooth LE chrp message of 1 packet length) that includes the rolling identifier. In an embodiment, the broadcast message (or the payload of the broadcast message) may be represented by the following equation:

Payload=MSB_{—}N(PRF(K,(deviceID∥t)))

where t is the value of the wireless identity transmitter's nonce or counter, ‘∥’ means concatenation, ‘PRF ( )’ is the pseudo-random function, and ‘MSB_N( )’ means the ‘N’ most significant bits (e.g., 80 bits). In other words, the wireless identity transmitter may intentionally obscure (or skew) the device identifier and the nonce or counter information, thus the broadcast message's payload may not include either the device identifier or the nonce or counter information in the clear.

In block 2010, the central server may receive the shared secret key (K). In block 2212, the central server may synchronize a nonce or counter. For example, the nonce or counter may be set to represent a value included in a previous message related to the wireless identity transmitter, such as a registration message. In block 2214, the central server may associate the shared secret key (i.e., K) and nonce or counter with the wireless identity transmitter's device identifier (i.e., deviceID). For example, the central server may store the deviceID, K, and nonce or counter in a data table of registered devices (e.g., in a tuple record of a database). In an embodiment, the central server may also store an indicator or flag indicating whether each wireless identity transmitter has been registered or activated.

In block 2216, the central server may receive a message including the rolling identifier. For example, the received message may be a sighting message from a proximity broadcast receiver that includes the rolling identifier broadcast by the wireless identity transmitter with the operations in block 2210. In block 2018, the central server may extract the rolling identifier, such as by parsing the received message to identify the payload of the rolling identifier.

In block 2019, the central server may select a wireless identity transmitter (i.e., selected wireless identity transmitter) to evaluate. In other words, the central server may obtain a stored deviceID, K, and nonce or counter for a registered wireless identity transmitter known to the central server, such as from the database or data table storing such information for all registered wireless identity transmitters. In block 2218, the central server may increment the selected wireless identity transmitter's nonce or counter to the server's current time. In an embodiment, the central server may then increment the stored nonce or counter value to account for the time that has elapsed since the stored nonce or counter value was synchronized. As an example, the central server may compare the time of receipt of the message with the operations in block 2216 to the central server's current time (e.g., via a central server clock or time mechanism). Based on a known periodicity that wireless identity transmitters may increment their individual nonces or counters (e.g., once every hour), the central server may increment the selected nonce or counter value to account for the time difference.

In an embodiment, the central server may only increment the selected nonce or counter an amount that represents the time between broadcasts by a wireless identity transmitter. In other words, the central server may not increment the selected nonce or counter to include the time between receiving the message within the operations in block 2216 and the time a proximity broadcast receiver received the broadcast message. For example, the proximity broadcast receiver may have buffered broadcast messages before relaying sighting messages to the central server. The central server may calculate this time difference based on metadata within the message received with the operations in block 2216. For example, a sighting message from a proximity broadcast receiver may indicate when a broadcast message was received. Thus, the amount the selected nonce or counter is incremented may be based on when the proximity broadcast receiver actually received the broadcast message and not when the message from the proximity broadcast receiver was received by the central server.

In block 2220, the central server may encode via a pseudo-random function the selected wireless identity transmitter's device identifier, secret key, and nonce or counter to generate a server-encrypted data (i.e., C′). The pseudo-random function may be the same pseudo-random function utilized in the operations in block 2208. In an embodiment, the generated server-encrypted data may be represented by the following equation:

C′=MSB_{—}N(PRF(sel_{—}K,(sel_deviceID∥sel_{—}t)))),

where sel_K is the value of the selected wireless identity transmitter's secret key, sel_deviceID is the value of the selected wireless identity transmitter's unique device identifier, sel_t is the value of the selected wireless identity transmitter's nonce or counter, ‘∥’ means concatenation, ‘PRF ( )’ is the pseudo-random function, and ‘MSB_N( )’ means the ‘N’ most significant bits (e.g., 60 bits, 74 bits, 80 bits, etc.).

In determination block 2222, the central server may determine whether the generated server-encrypted data (C′) is the same as the received rolling identifier. In other words, the central server may compare the received rolling identifier to the generated server-encrypted data to determine whether they match. If the rolling identifier and the generated server-encrypted data match (i.e., determination block 2222=“Yes”), in block 2024 the central server may identify the received message as originating from the selected wireless identity transmitter (e.g., corresponding to the selected wireless identity transmitter's unique identifier).

If the rolling identifier and the generated data do not match (i.e., determination block 2222=“No”), in block 2224 the central server may encode device identifiers, secret keys, and nonces or counters for other wireless identity transmitters to identify the originator of the received message. In other words, the central server may select the next stored deviceID, nonce or counter, and K group from the database, increment that selected nonce or counter value, encode the selected deviceID, nonce or counter, and K, and compare the generated encoded data to the received rolling identifier until a match is found and the identity of the originator of the rolling identifier in the received message is known.

In an embodiment, when the wireless identity transmitter's battery has been removed and re-installed, the latest nonce or counter value may be persisted in the non-volatile memory of the wireless identity transmitter, so that the nonce or counter value can be read back from the non-volatile memory of the wireless identity transmitter when the battery is removed and then put back in. Alternatively, if no non-volatile memory is available or is not used, the wireless identity transmitter may fall back to the initial nonce or counter value after a battery re-installation. The central server may be required to be modified slightly to accommodate such a “counter synchronization”. More specifically, in addition to trying values greater than the largest nonce or counter value for the pre-computed counter or nonce list, the central server may also try values, such as (counter+i) where i=0, . . . , n, when a “counter synchronization” is performed. In this case, a wireless identity transmitter user may need to be informed that the battery needs to be re-installed when “counter synchronization” fails multiple times.

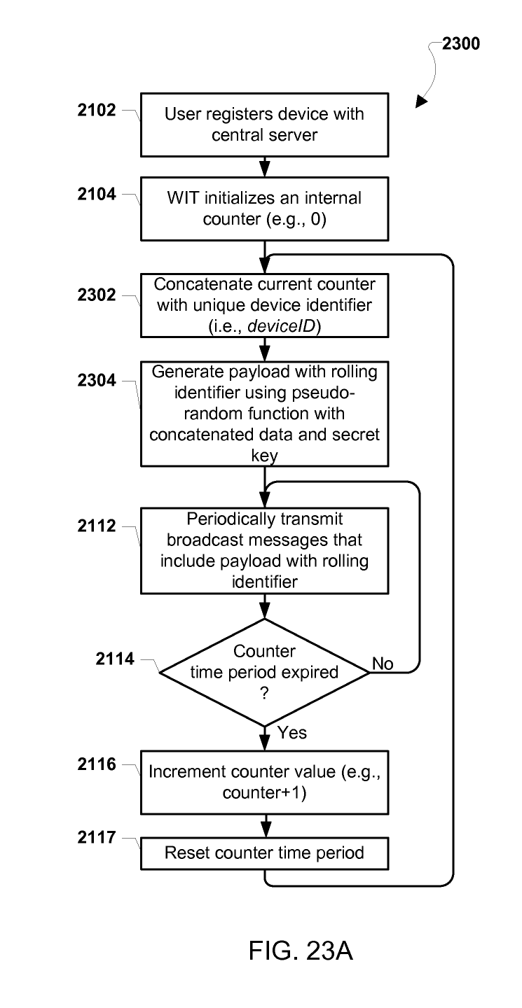

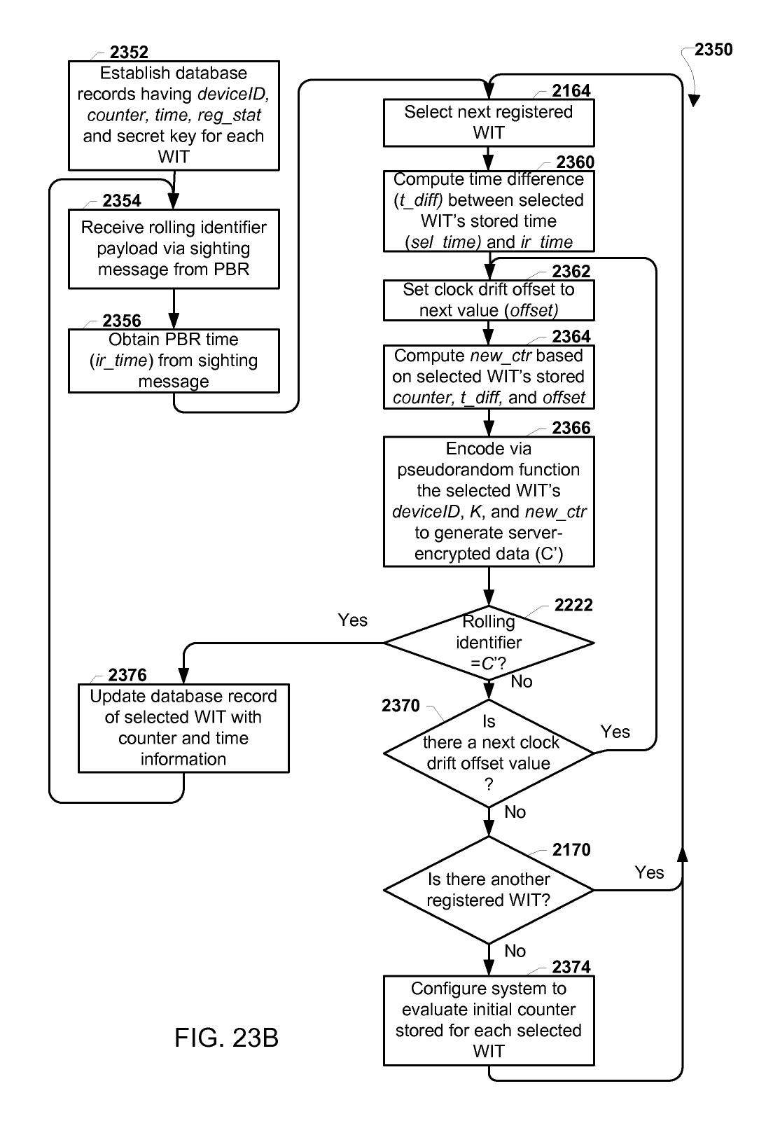

FIG. 23A illustrates an embodiment method 2300 for a wireless identity transmitter employing a pseudo-random function to generate a rolling identifier for broadcasting. The operations in the method 2300 may be similar to the embodiment method 2100 described above. However, instead of encrypting data, such as a nonce or counter value, with an AES-CTR encryption algorithm, the method 2300 may generate payloads based on the application of a pseudo-random function. As described above, the pseudo-random function and secret keys for each wireless identity transmitter may be known to both the corresponding wireless identity transmitter and a central server so that both may generate similar payloads based on similar data.

In block 2102, a user of the wireless identity transmitter may register the device with the central server. In block 2104, the wireless identity transmitter may initialize an internal nonce or counter, such as by setting the nonce or counter to a zero value. In block 2302, the wireless identity transmitter may concatenate the current nonce or counter with the wireless identity transmitter's unique device identifier (i.e., deviceID). In block 2304, the wireless identity transmitter may generate a payload with a rolling identifier using pseudo-random function with the concatenated data and the secret key. For example, the pseudo-random function may take as inputs the concatenated data (i.e., the deviceID+nonce/counter) and may use the secret key for the wireless identity transmitter as a randomness seed variable. The payload with the rolling identifier may include the output data from the pseudo-random function. In an embodiment, the payload with the rolling identifier may also include in-the-clear information regarding other aspects of the wireless identity transmitter. For example, the wireless identity transmitter may append to the payload several bits (e.g., 4 bits) of information which describe the battery status of the wireless identity transmitter. In an embodiment, the pseudo-random function may be a polynomial time computable function that is computationally indistinguishable from a random function defined on the same domain with output to the same range as the pseudo-random function. For example, the keyed hash Message Authentication Code (HMAC) or the Cipher-based Message Authentication Code (CMAC) may be used as the pseudo-random function. In an embodiment, the wireless identity transmitter may or may not perform a truncation operation to the generated rolling identifier payload. For example, the payload with the rolling identifier may be the result of performing a most-significant-bit operation on the results of the pseudo-random function.

In block 2112, the wireless identity transmitter may periodically transmit broadcast messages that include the payload with the rolling identifier, such as by broadcasting via short-range wireless communication techniques as described above. In determination block 2114, the wireless identity transmitter may determine whether a predefined nonce or counter time period has expired. If the nonce or counter time period has not expired (i.e., determination block 2114=“No”), the wireless identity transmitter may continue with the operations in block 2112. If the device determines the nonce or counter time period has expired (i.e., determination block 2114=“Yes”), in block 2116 the wireless identity transmitter may increment the nonce or counter value, such as by adding 1. In block 2117, the wireless identity transmitter may reset the nonce or counter time period, and may continue with the operations in block 2302.

FIG. 23B illustrates an embodiment method 2350 for a central server responding to received messages containing pseudo-random function rolling identifiers. The embodiment method 2350 operations may be similar to the operations described above with reference to FIG. 21B, with the exception that the central server may compare outputs of a pseudo-random function with time-synchronized information stored in the central server to match payloads in messages received from wireless identity transmitters.

In block 2352, the central server may establish database records having device identifier (i.e., deviceID), nonce or counter, time, registration status (i.e., ‘reg_stat’), and secret key (i.e., ‘K’) information for each wireless identity transmitter in a system. The time may indicate the last time the central server received a message corresponding to a particular wireless identity transmitter (e.g., a sighting message relaying a broadcast message), or in other words, the central server clock value at the moment when the nonce or counter value for a wireless identity transmitter was received/recorded in the database. It may be assumed that the period between when a wireless identity transmitter broadcasts a message with a rolling identifier (or rolling identifier payload) and when the central server receives the rolling identifier is very short. Thus, the stored nonce or counter and time values may be assumed to create a roughly accurate clock status of a wireless identity transmitter.

Additionally, once a wireless identity transmitter transmits registration information, the central server may indicate a valid registration by setting a registration flag in the database for the wireless identity transmitter (e.g. ‘reg_stat’). The central server may query the database for all wireless identity transmitter records where the reg_stat indicates a valid registration has been conducted and may create data tables that include only registered wireless identity transmitters based on the reg_stat values.

In block 2354, the central server may receive a rolling identifier payload via a sighting message from a proximity broadcast receiver. The sighting message may have time information appended to the payload that describes the time at which the proximity broadcast receiver encountered the payload via a broadcast message from the respective wireless identity transmitter. For example, a payload may be received by a smartphone proximity broadcast receiver which in turn may append its own system clock reading to the payload information and transmit the data to the central server as a sighting message. The time measurement provided by the proximity broadcast receiver may be approximately synchronized with the central server system time. In an embodiment, the proximity broadcast receiver may append other additional information to the sighting message, such as location information (e.g., GPS coordinates) of the proximity broadcast receiver. In block 2356, the central server may obtain a proximity broadcast receiver time (i.e., ‘ir_time’) from the sighting message, such as indicated within the sighting message. For example, the central server may parse the sighting message and extract a time value indicating when the proximity broadcast receiver received a broadcast message that corresponds to the rolling identifier payload.

In blocks 2164-2374, the central server may perform an operational loop in which the central server may evaluate all registered wireless identity transmitters stored within the central server's database to find a device record that matches the received rolling identifier payload. In block 2164, the central server may select a next registered wireless identity transmitter. For example, the central server may iteratively select the next wireless identity transmitter represented in a data table of all wireless identity transmitters that have the reg_stat variable set to indicate registration occurred. The central server may sequentially iterate through such a data table or list for each device during the operations in blocks 2164-2374. In an embodiment, the central server may access a stored database record corresponding to the selected registered wireless identity transmitter that contains the current values for the information established with registration operations in block 2352.

In block 2360, the central server may compute the time difference (i.e., ‘t_diff’) between the time indicated in the sighting message (ir_time) and the time stored within the database record of the selected registered wireless identity transmitter (i.e., ‘sel_time’). For example, the t_diff value may be a non-zero or a zero value. This time difference may be a measure of the expected elapsed time between instances of the central server receiving payloads from the selected wireless identity transmitter.

In block 2362, the central server may set a clock drift offset (i.e., ‘offset’) to a next value. In general, the central server may account for possible wireless identity transmitter clock drift (e.g., inaccurate device system clock readings) by setting the clock drift offset value. The clock drift offset values may represent offsets that, when applied to nonce or counter values, may represent nonces or counters lower, the same, or higher than an expected nonce or counter value. In other words, the clock drift offsets may represent time before, during, or after the time represented by the current nonce or counter for the selected registered device. The clock drift offset value may be one of a sequence of clock drift offset values. In an embodiment, the clock drift offset value may be 0. In an embodiment, possible clock drift offset values may include numbers within a set {−N, . . . , −1, 0, 1, . . . , N}, where N is an arbitrary number.

In block 2364, the central server may compute an expected nonce or counter value (i.e., ‘new_ctr’) using the selected wireless identity transmitter's stored nonce or counter value, the computed time difference (i.e., t_diff) and the set offset value (i.e., offset). As described above, the nonce or counter may be stored within the selected registered wireless identity transmitter database record. For example, the central server may calculate new_ctr by adding the clock drift offset value to the sum of the t_diff value and the stored nonce or counter value.

In determination block 2366, the central server may encode via a pseudo-random function the selected wireless identity transmitter's device identifier, secret key, and computed nonce or counter (i.e., new_ctr) to generate a server-encrypted data (i.e., C′). The pseudo-random function may be the same pseudo-random function utilized by a wireless identity transmitter as described above with reference to FIG. 23A.

In determination block 2222, the central server may determine whether the generated server-encrypted data (C′) is the same as the received rolling identifier. In other words, the central server may compare the received rolling identifier to the generated server-encrypted data to determine whether they match. If the rolling identifier and the generated server-encrypted data match (i.e., determination block 2222=“Yes”), the central server may identify the received message as originating from the selected wireless identity transmitter (e.g., corresponding to the selected wireless identity transmitter's unique identifier). In an embodiment, the secret key (K) may be the seed value of the pseudo-random function. In an embodiment, the central server may concatenate the selected wireless identity transmitter's deviceID and the computed new_ctr value and provide that concatenated data to the pseudo-random function. The pseudo-random function may return (or output) encrypted data having a similar structure as received rolling identifier payload.

If the rolling identifier, such as received in the sighting message, and the generated server-encrypted data (i.e., C′) match (i.e., determination block 2222=“Yes”), in block 1276 the central server may update the database record of the selected wireless identity transmitter with the nonce or counter and time information, such as the new_ctr and the ir_time. For example, the central server may update the database record's time value to represent the time of receipt of the payload within the proximity broadcast receiver (e.g., ir_time) and may also update the stored nonce or counter value to represent the new_ctr value. The central server may continue with the operations in block 2354.

If the rolling identifier, such as received in the sighting message, and the generated server-encrypted data (i.e., C′) do not match (i.e., determination block 2222=“No”), the central server may determine whether there is a next clock drift offset value in determination block 2370. In other words, the central server may determine whether new_ctr values have been computed using all possible clock drift offset values (e.g., −1, 0, 1, etc.). If there is a next clock drift offset value (i.e., determination block 2370=“Yes”), the central server may continue with the operations in block 2362. However, if there is not a next clock drift offset value (i.e., determination block 2370=“No”), in determination block 2170, the central server may determine whether there is another registered wireless identity transmitter to evaluate. If there is another registered wireless identity transmitter to evaluate (i.e., determination block 2170=“Yes”), the central server may continue with the operations in block 2164. However, if there is no other registered wireless identity transmitter (i.e., determination block 2170=“No”), in block 2374 the central server may configure the system to evaluate initial nonce or counter values stored for each registered wireless identity transmitter. In an embodiment, the registration database described above may further include data that represents the initial nonce or counter value corresponding to each registered wireless identity transmitter. This initial nonce or counter value may be used if/when the various wireless identity transmitters are rebooted or otherwise reset their counters. For example, a wireless identity transmitter may operate and deliver payloads describing non-initial nonces or counters for a period of time before resetting its internal nonce or counter due to battery replacement. In such a scenario, the wireless identity transmitter may broadcast messages that include rolling identifier payloads based on reset nonce or counter information.

In another embodiment, the operations in block 2374 may be performed for individual registered selected devices during the operational loop in blocks 2362-2370, wherein the stored nonce or counter value in block 2364 may be replaced with the initial stored nonce or counter value. For example, once the central server determines a selected registered wireless identity transmitter's stored nonce or counter value with the various clock drift offset values cannot be used to generate encrypted data that matches the received rolling identifier payload, the central server may evaluate the initial stored nonce or counter value of the selected wireless identity transmitter before selecting the next registered wireless identity transmitter.

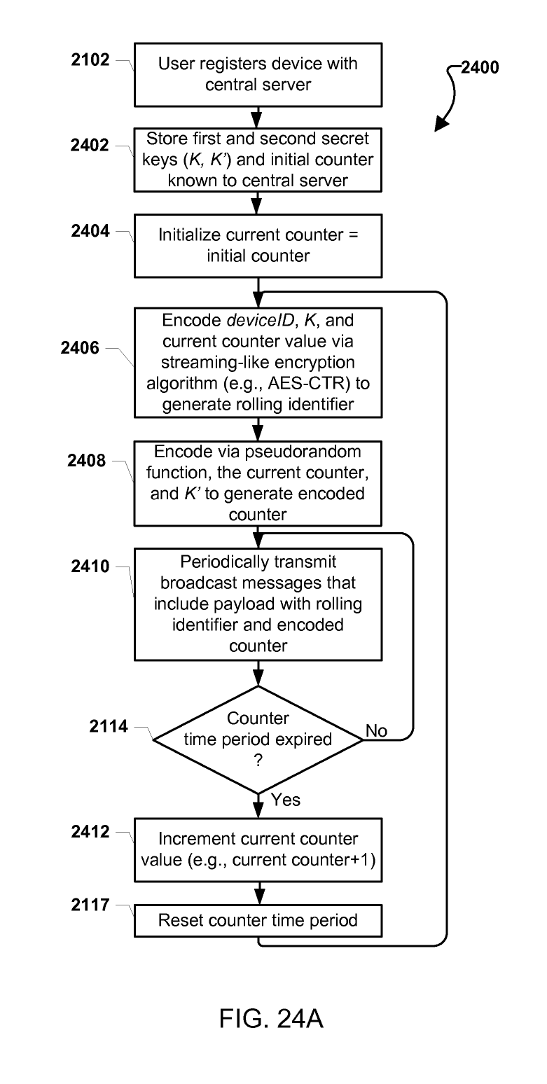

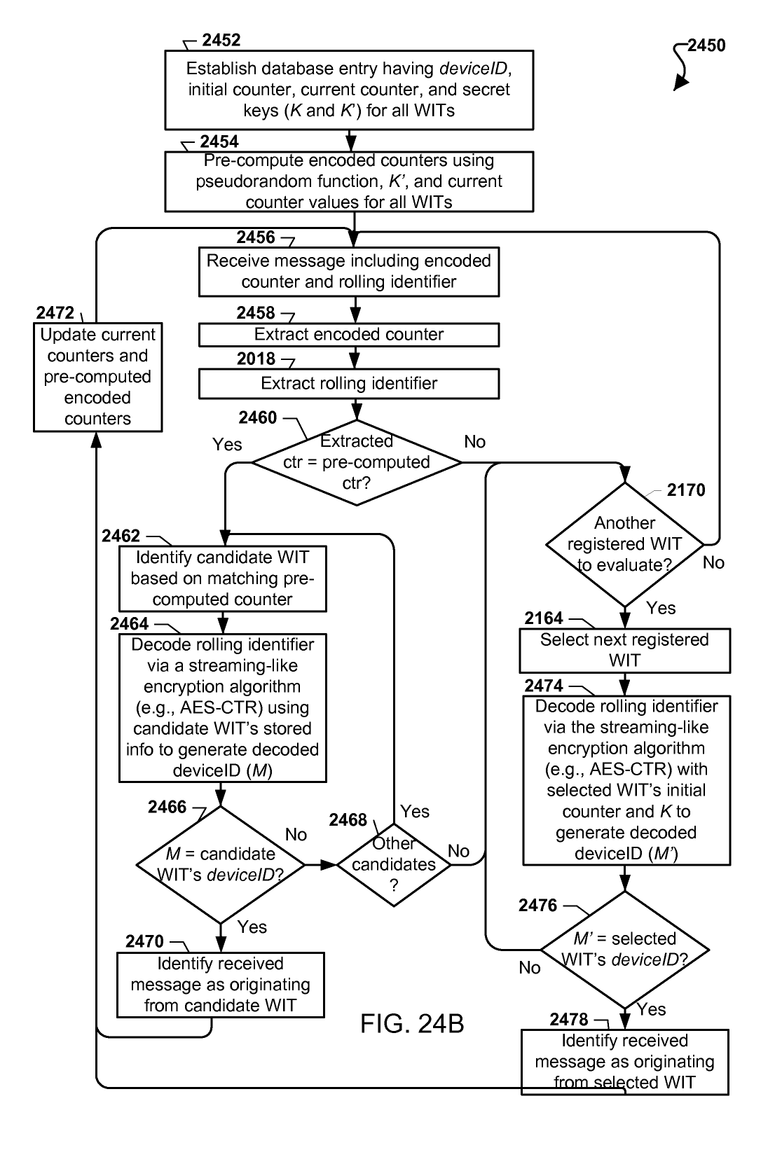

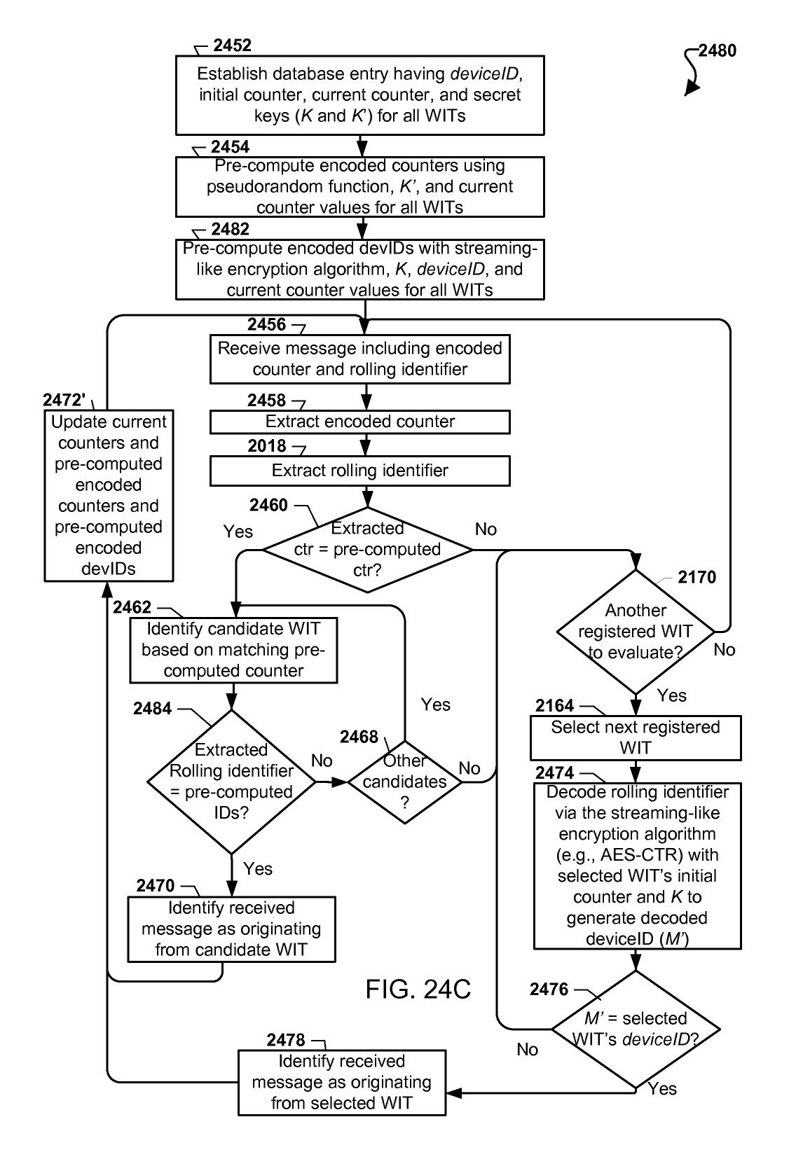

FIG. 24A illustrates an embodiment method 2400 for a wireless identity transmitter generating and broadcasting messages with rolling identifiers and encoded nonces or counters. The method 2400 may have operations performed by a wireless identity transmitter that are similar to those described above with reference to FIGS. 20, 21A, 22, and 23A. However, the method 2400 may involve broadcasting messages that include a rolling identifier (i.e., an encoded device identifier) as well as an encoded nonce or counter that may be evaluated separately by the central server with the operations described below with reference to FIG. 24B. In this manner, the wireless identity transmitter's nonce or counter value (or nonce) may not be sent in the clear in the payload of the broadcast message.

In block 2102, a user of the wireless identity transmitter may register the device with the central server. For example, the wireless identity transmitter may provide the unique device identifier (i.e., deviceID) to a central server for storage in a database of registered wireless identity transmitters. In block 2402, the wireless identity transmitter may store a first secret key (K) and a second secret key (K′) and an initial nonce or counter that are known to the central server. For example, these values may be shared between the central server and the wireless identity transmitter during registration operations described in this disclosure. In block 2404, the wireless identity transmitter may initialize a current nonce or counter by setting it to the value of the initial nonce or counter value.

Similar to as described above with reference to FIG. 20, in block 2406, the wireless identity transmitter may encode the device identifier (deviceID), the first secret key (K), and the current nonce or counter via a streaming-like encryption algorithm (e.g., AES-CTR) to generate a rolling identifier. In block 2408, the wireless identity transmitter may encode via a pseudo-random function, the current nonce or counter, and the second secret key (K′) to generate an encoded counter or nonce. In an embodiment, the encoded nonce or counter may be represented by the following equation:

Encoded nonce/counter=MSB_{—}M(PRF(K′,t)),

where ‘K’ is a per-device second secret key (usually different from the first per-device secret key K), ‘t’ is the current nonce or counter, PRF ( )’ is the pseudo-random function, and ‘MSB_M( )’ means the ‘M’ most significant bits (e.g., 20 bits).

In block 2410, the wireless identity transmitter may periodically transmit broadcast messages that include the payload with the rolling identifier and the encoded nonce or counter. In determination block 2114, the wireless identity transmitter may determine whether a predefined nonce or counter time period has expired. If the nonce or counter time period has not expired (i.e., determination block 2114=“No”), the wireless identity transmitter may continue with the operations in block 2410. If the device determines the nonce or counter time period has expired (i.e., determination block 2114=“Yes”), in block 2412 the wireless identity transmitter may increment the current nonce or counter value, such as by adding 1. In block 2117, the wireless identity transmitter may reset the nonce or counter time period and may continue with the operations in block 2406.

FIG. 24B illustrates an embodiment method 2450 for a central server receiving and handling messages including rolling identifiers and encoded nonces or counters. The central server may perform the operations of method 2450 in combination or response to a wireless identity transmitter performing the method 2400 described above. The method may include two passes: a first pass wherein the central server attempts to identify a wireless identity transmitter based on an encoded nonce or counter within a received message (e.g., a sighting message), and a second pass wherein the central server attempts the identification based on a rolling identifier to within the received message

In block 2452, the central server may establish a database entry having a device identifier (i.e., deviceID), initial nonce or counter, current nonce or counter, and secret keys (K and K′) for all wireless identity transmitters in the system. The current nonce or counter values may be the same as the initial nonces or counters at the time of registration of wireless identity transmitters. In block 2454, the central server may pre-compute encoded nonces or counters using a pseudo-random function, the second secret key (K′), and current nonce or counter values for all wireless identity transmitters. For example, the central server may generate a plurality of encoded nonce or counter values for each registered wireless identity transmitter, such as one based on the current nonce or counter value, another based on a value one larger than the current counter value, etc. In an embodiment, the central server may pre-compute 24 encoded nonce or counters for each registered wireless identity transmitter. In an embodiment, the central server may store a separate list (or data table) of the pre-computed encoded nonces or counters for all registered wireless identity transmitters that also includes the device identifiers associated with each stored pre-computed encoded nonce or counter.

In block 2456, the central server may receive a message including an encoded nonce or counter and a rolling identifier, such as within a sighting message transmitted by a proximity broadcast receiver. In block 2458, the central server may extract an encoded nonce or counter from the received message, and in block 2018 may extract a rolling identifier from the received message. In determination block 2460, the central server may determine whether the extracted nonce or counter (or ‘ctr’) matches any of the pre-computed nonce or counters. For example, the central server may compare the encoded nonce or counter value extracted from the received message to the plurality of central server-encoded nonce or counter values for each registered wireless identity transmitter to identify any matches. If the extracted nonce or counter matches a pre-computed nonce or counter (i.e., determination block 2460=“Yes”), in block 2462 the central server may identity a candidate wireless identity transmitter based on the matching pre-computed nonce or counter. In other words, the central server may identity the candidate as the deviceID stored in relation to the pre-computed nonce or counter in a data table in the central server. In block 2464, the central server may decode the rolling identifier via a streaming-like encryption algorithm (e.g., the same AES-CTR wireless identity transmitters use when performing the operations in FIG. 24A) using the candidate wireless identity transmitter's stored information (e.g., deviceID, secret key, etc.) to find a decoded device identifier (or M). In determination block 2466, the central server may determine whether the decoded device identifier (M) matches the candidate wireless identity transmitter's deviceID. Such a match may enable the central server to identify the wireless identity transmitter associated with that received rolling identifier without decoding the rolling identifier or the encoded nonce or counter value. If the deviceID and decoded identifier (M) match (i.e., determination block 2466=“Yes”), in block 2470 the central server may identity the received message as originating from the candidate wireless identity transmitter. In block 2472, the central server may update current nonces or counters and pre-computed encoded nonces or counters. For example, the database entry for the wireless identity transmitter identified as the originator of the received message may be updated with new current nonce or counter information as well as new pre-computed encoded nonces or counters. Additionally, any stored lists of pre-computed encoded nonces or counters may have older pre-computed encoded nonces or counters removed at the same time newly computed encoded nonces or counters corresponding to the identified wireless identity transmitter are added to the list. In another embodiment, if the wireless identity transmitter identified as the originator of the received message is indicated in the central server's database as “not activated” (i.e., a flag is not set), then the central server may also adjust the database to reflect that the identified wireless identity transmitter is now activated (e.g., set a flag). The central server may then continue with the operations in block 2456.

If the deviceID and decoded identifier (M) do not match (i.e., determination block 2466=“No”), in determination block 2468, the central server may determine whether there are other candidates, such as other registered wireless identity transmitters that have not been evaluated by the central server. If there are other candidates (i.e., determination block 2468=“Yes”), the central server may continue with the operations in block 2462, such as by identifying the next wireless identity transmitter to evaluate regarding the rolling identifier.

If there are no other candidates (i.e., determination block 2468=“No”), or if the extracted nonce or counter does not match the pre-computed nonce or counter (i.e., determination block 2460=“No”), the central server may attempt to identify the originator of the received message by comparing the extracted rolling identifier to information associated with all registered wireless identity transmitters in the system. Thus, in determination block 2170 the central server may determine whether there is another registered wireless identity transmitter to evaluate. For example, the central server may iteratively use information of all registered wireless identity transmitters. If there is not another (i.e., determination block 2170=“No”), the central server may continue with the operations in block 2456.

If there is another (i.e., determination block 2170=“Yes”), in block 2164 the central server may select the next registered wireless identity transmitter. In block 2474, the central server may decode the rolling identifier via the streaming-like encryption algorithm (e.g., AES-CTR) with the selected wireless identity transmitter's initial nonce or counter and first secret key (K) to find a decoded device identifier (M′), similar to as described above with reference to FIG. 20. In determination block 2476, the central server may determine whether the decoded device identifier (M′) matches the selected wireless identity transmitter's deviceID. If the identifiers do not match (i.e., determination block 2476=“No”), the central server may continue with the operations in determination block 2170. However, if the identifiers match (i.e., determination block 2476=“Yes”), in block 2478 the central server may identify the received messages as originating from the selected wireless identity transmitter, and may continue with the operations in block 2472.

FIG. 24C illustrates an embodiment method 2480 for a central server receiving and handling messages including rolling identifiers and encoded nonces or counters. The operations of method 2480 are similar to the operations of method 2450, except that rather than perform a two pass process as discussed above in FIG. 24B, the central server may perform method 2480 as a one pass process. In particular, the central server may generate both a plurality of central server encrypted nonce or counter values for each registered wireless identity transmitter and a plurality of central server-encrypted device identifiers (i.e., deviceID). The central server may use the data stored in the database for each wireless identity transmitter (e.g., deviceID, K, K′, initial nonce or counter, and current nonce or counter) and the plurality of pre-computed nonce or counter values for each device to encode a plurality of central server encrypted nonce or counter values and a plurality of server encrypted device IDs. When the central server receives the sighting message including the rolling identifier and encoded nonce or counter, the central server may compare the plurality of central server encrypted nonce or counter values and the plurality of central server encoded device IDs to the rolling identifier and encoded nonce or counters obtained from the received sighting message. The device identifier of the wireless identity transmitter that originated the rolling identifier may then be identified based entirely on matching the pre-computed nonce or counter values and device identifiers without requiring actual decoding of the rolling identifier itself.

In block 2452, the central server may establish a database entry having a device identifier (i.e., deviceID), initial nonce or counter, current nonce or counter, and secret keys (K and K′) for all wireless identity transmitters in the system. In block 2454, the central server may pre-compute encoded nonces or counters using a pseudo-random function, the second secret key (K′), and current nonce or counter values for all wireless identity transmitters. In block 2482, the central server may pre-compute encoded device identifiers with a streaming-like encryption algorithm (e.g., AES-CTR block cipher), the device identifier, current nonce or counter, and the first secret key (K) for all wireless identity transmitters. In other words, the central server may generate a plurality of encoded device identifiers for each registered wireless identity transmitter, such as by using the current nonce or counter and predefined offset nonce or counter values, or alternatively, only a single encoded device identifier based only on the current nonce or counter stored within the central server.

In block 2456, the central server may receive a message including an encoded nonce or counter and a rolling identifier, such as within a sighting message transmitted by a proximity broadcast receiver. In block 2458, the central server may extract an encoded nonce or counter from the received message, and in block 2018 may extract a rolling identifier from the received message. In determination block 2460, the central server may determine whether the extracted nonce or counter (or ‘ctr’) matches any of the pre-computed nonces or counters. If the extracted nonce or counter matches a pre-computed nonce or counter (i.e., determination block 2460=“Yes”), in block 2462 the central server may identity a candidate wireless identity transmitter based on the matching pre-computed nonce or counter. In determination block 2484, the central server may determine whether the extracted rolling identifier matches any of the pre-computed identifiers, such as the pre-computing device identifiers for the candidate wireless identity transmitter.

If the extracted rolling identifier does match any of the pre-computed identifiers for the candidate wireless identity transmitter (i.e., determination block 2484=“Yes”), in block 2470 the central server may identity the received message as originating from the candidate wireless identity transmitter. In block 2472′, the central server may update current nonces or counters and pre-computed encoded nonces or counters and pre-computed encoded device identifiers. For example, the database entry for the wireless identity transmitter identified as the originator of the received message may be updated with new current nonce or counter information as well as new pre-computed encoded nonces or counters and pre-computed encoded device identifiers. Additionally, any stored lists of pre-computed encoded nonces or counters may have older pre-computed encoded nonces or counters or encoded device identifiers removed at the same time newly computed encoded nonces or counters or device identifiers corresponding to the identified wireless identity transmitter are added to the list.

In another embodiment, if the wireless identity transmitter identified as the originator of the received message is indicated in the central server's database as “not activated” (i.e., a flag is not set), then the central server may also adjust the database to reflect that the identified wireless identity transmitter is now activated (e.g., set a flag). The central server may then continue with the operations in block 2456.

If the extracted rolling identifier does not match any of the pre-computed identifiers for the candidate wireless identity transmitter (i.e., determination block 2484=“No”), in determination block 2468, the central server may determine whether there are other candidates, such as other registered wireless identity transmitters that have not been evaluated by the central server. If there are other candidates (i.e., determination block 2468=“Yes”), the central server may continue with the operations in block 2462, such as by identifying the next wireless identity transmitter to evaluate regarding the rolling identifier.

If there are no other candidates (i.e., determination block 2468=“No”), or if the extracted nonce or counter does not match the pre-computed nonce or counter (i.e., determination block 2460=“No”), the central server may attempt to identify the originator of the received message by comparing the extracted rolling identifier to information associated with all registered wireless identity transmitters in the system. Thus, in determination block 2170 the central server may determine whether there is another registered wireless identity transmitter to evaluate. For example, the central server may iteratively use information of all registered wireless identity transmitters. If there is not another (i.e., determination block 2170=“No”), the central server may continue with the operations in block 2456.

If there is another (i.e., determination block 2170=“Yes”), in block 2164 the central server may select the next registered wireless identity transmitter. In block 2474, the central server may decode the rolling identifier via the streaming-like encryption algorithm (e.g., AES-CTR) with the selected wireless identity transmitter's initial nonce or counter and first secret key (K) to find a decoded device identifier (M′). In determination block 2476, the central server may determine whether the decoded device identifier (M′) matches the selected wireless identity transmitter's deviceID. If the identifiers do not match (i.e., determination block 2476=“No”), the central server may continue with the operations in determination block 2170. However, if the identifiers match (i.e., determination block 2476=“Yes”), in block 2478 the central server may identify the received messages as originating from the selected wireless identity transmitter, and may continue with the operations in block 2472′.

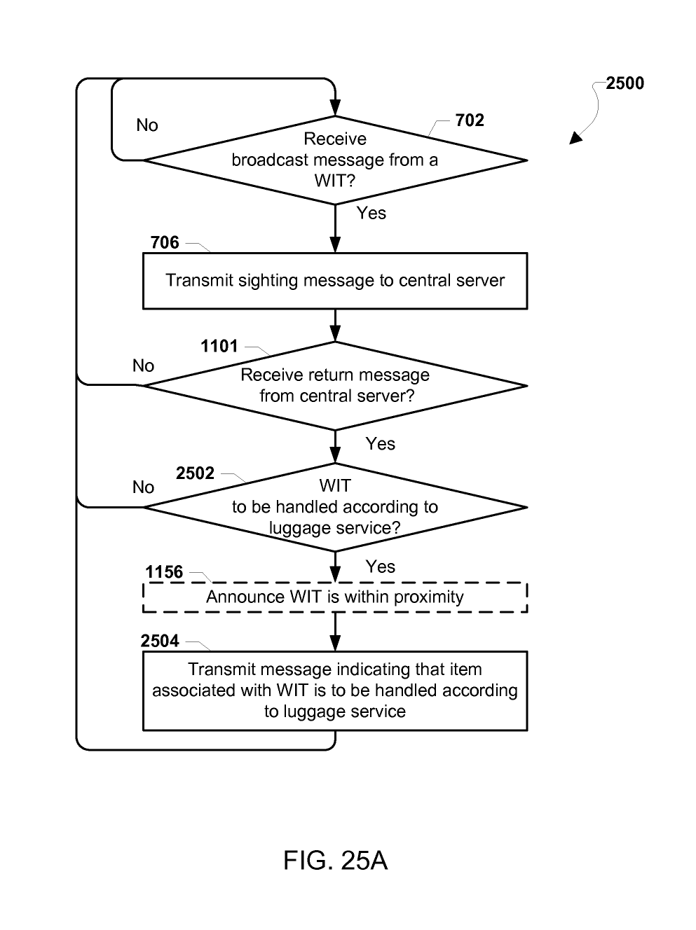

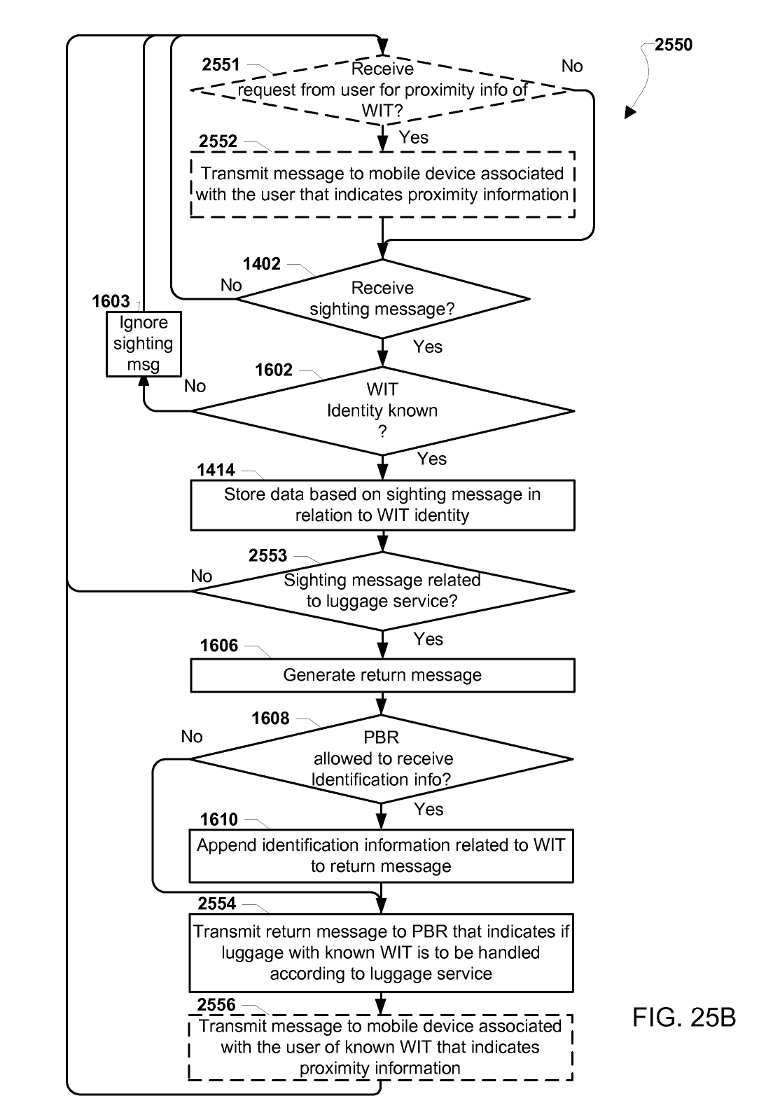

FIG. 25A illustrates an embodiment method 2500 for a proximity broadcast receiver transmitting messages in association with a luggage service. As described above, proximity broadcast receivers may be within various places, such as parks, retail stores, and homes. Proximity broadcast receivers may also be placed within an airport, such as within a baggage claim area. Such proximity broadcast receivers may be configured to communicate with various parties within the airport, such as customer service agents, baggage handlers, security personnel, and travelers. In particular, proximity broadcast receivers, such as stationary proximity broadcast receivers within a baggage claim area in the airport, may be configured to initiate actions for promoting the luggage service that handles, locates, and otherwise processes luggage of users who have opted-into, registered with, or otherwise agreed to be assisted by the luggage service. For example, based on return messages received from a central server, a proximity broadcast receiver associated with the luggage service (e.g., a customer service program) may detect when a registered bag is within proximity of the baggage claim area of the airport, and may notify a baggage handler to come remove the bag from the turnstile or conveyor. The luggage service may be very valuable for providing special perks or benefits to registered users, such as by conveniently segregating their bags from the mass of luggage being removed from an aircraft to create a faster, more pleasant experience in the airport after deplaning. In various embodiments, the luggage service may be similar to a preferred traveler program offered by an airline or airport, such that registered users of the service may be authorized to enter certain areas of the airport (e.g., a traveler's lounge).

As discussed above, in determination block 702, the proximity broadcast receiver may determine whether a broadcast message is received. If a broadcast message is not received (i.e., determination block 702=“No”), the proximity broadcast receiver may continue with the operations in determination block 702. If a broadcast message is received (i.e., determination block 702=“Yes”), in block 706 the proximity broadcast receiver may transmit a sighting message to a central server. In determination block 1101, the proximity broadcast receiver may determine whether a return message is received from the central server. Return messages may include various information stored and managed by the central server, such as data regarding the luggage service, users registered with the service (and their wireless identity transmitters), and other devices associated with the luggage service. For example, when authorized by permissions (or permissions settings) provided by users, identifying information about the users registered with the luggage service may be transmitted to the proximity broadcast receiver via a return message. If no return message is received (i.e., determination block 1101=“No”), the proximity broadcast receiver may continue with the operations in determination block 702.

If a return message is received (i.e., determination block 1101=“Yes”), in determination block 2502 the proximity broadcast receiver may determine whether the wireless identity transmitter is to be handled according to the luggage service, such as a baggage transport service provided by employees of the airport in which the proximity broadcast receiver is located. The proximity broadcast receiver may determine whether the wireless identity transmitter is registered with the luggage service based on the return message information. The return message may include metadata or some other indicator that represents a confirmation of the wireless identity transmitter's registration with the luggage service. For example, the proximity broadcast receiver may detect metadata, a bit, or a flag within the return message that indicates the luggage containing the wireless identity transmitter should be taken off a conveyor belt and loaded onto a baggage delivery van. In an embodiment, the return message may also include descriptive information about the identity of the item or asset associated with the wireless identity transmitter. For example, the return message may include the dimensions, color, weight, and other characteristics of the asset that may be useful in handling the luggage. In another embodiment, the return message may also include identifying information about the owner of the asset, such as the owner's picture or name. Such identifying information may be included only when authorized by the user of the wireless identity transmitter. FIG. 25B describes how a central server may determine whether to include identifying information within the return message.

If the wireless identity transmitter is not to be handled according to the luggage service (i.e., determination block 2502=“No”), the proximity broadcast receiver may continue with the operations in determination block 702. However, if the wireless identity transmitter is to be handled according to the luggage service (i.e., determination block 2502=“Yes”), in optional block 1156, the proximity broadcast receiver may announce the wireless identity transmitter is within proximity, such as by rendering a message on a connected display unit (e.g., an LCD display in wired or wireless communication with the proximity broadcast receiver). For example, the proximity broadcast receiver may cause a collocated display unit to display an indication of a nearby bag that should be removed from a conveyor (e.g., “This suitcase passing by now is registered for high-touch baggage handling. Please remove.”) Alternatively, the proximity broadcast receiver may emit a sound (e.g., a beep, a bell, a prerecorded audio sample, etc.) that indicates a proximate wireless identity transmitter is to be handled according to the luggage service.

In block 2504 the proximity broadcast receiver may transmit a message indicating that an item associated with the wireless identity transmitter is to be handled according to the luggage service. In particular, the proximity broadcast receiver may transmit a message to various other devices, parties, or places associated with the luggage service to initiate the execution of operations to process the item associated with the wireless identity transmitter. For example, the proximity broadcast receiver may transmit an SMS message, email, or other electronic signal to the mobile device of a baggage handler instructing the handler to remove a bag from a conveyor. In an embodiment, the proximity broadcast receiver may transmit a message including software, operations, or other instructions to be performed by the recipient device. For example, the proximity broadcast receiver may transmit a message to a computing device connected to a conveyor belt, instructing the computing device to slow or stop the operation of the luggage conveyor belt so that a customer service representative may easily remove luggage associated with the wireless identity transmitter. The proximity broadcast receiver may then continue with the operations in determination block 702.

In an embodiment, the message transmitted by the proximity broadcast receiver may include instructions directing that luggage should be placed on vehicles for delivery to homes or other preferred destinations. For example, a piece of luggage associated with an individual registered with the luggage service may be directed onto a delivery van. Such instructions may be based on preferences provided to the central server by the user during registration with the luggage service. For example, the user may indicate on a registration website that he/she prefers any luggage arriving at a certain airport to be delivered to a particular home or business destination address. Destinations may be received within the return message from the central server, or alternatively may be obtained from within locally stored information (e.g., an airport or airline database that stores the destination addresses for all frequent flyers registered with the luggage service).

Additionally, delivery vehicles may be equipped with proximity broadcast receivers that can provide up-to-date location information to the central server. For example, as the luggage is being transported to the destinations, a proximity broadcast receiver stored within a delivery van may use a cellular link to periodically transmit sighting messages that indicate the GPS coordinates of the proximity broadcast receiver (and therefore the wireless identity transmitters within the luggage being delivered). This may enable real-time delivery status information of the luggage based that may be transmitted to the owners via the central server. For example, a suitcase owner may use his/her smartphone executing a luggage service application to query the central server to obtain current location information of the suitcase being delivered from an airport.

In an embodiment, the method 2500 may be used to prevent luggage or other assets associated with wireless identity transmitters from entering certain areas, such as secured areas of an airport. In such a case, when the proximity broadcast receiver receives a return message from the central server indicating the related wireless identity transmitter is to be handled according to the luggage service (i.e., the user has opted-in with the luggage service), the proximity broadcast receiver may transmit messages to various airport facilities requesting the removal of the wireless identity transmitter (and the asset associated with the wireless identity transmitter). For example, a bag containing a wireless identity transmitter that is registered with the luggage service may be guided away from the area of a proximate proximity broadcast receiver that is positioned within a baggage claim area for unregistered luggage. As a contrasting example, a person carrying a wireless identity transmitter that is not registered with the luggage service (i.e., the person does not have privilege) may be escorted away from a “members-only” area. Further, the proximity broadcast receiver may transmit messages or render announcements when the wireless identity transmitter is determined to not be associated or registered with the proximity broadcast receiver and/or the luggage service. For example, in response to receiving a return message indicating a proximate wireless identity transmitter is not to be handled according to the luggage service, the proximity broadcast receiver may emit an audible announcement indicating the luggage must be removed from the “members-only” area.

In another embodiment, the method 2500 may be used to manage populations of wireless identity transmitters within particular locations, such as a security area or a check-in line within an airport. Based on return messages received from the central server, the proximity broadcast receiver may determine when the number of wireless identity transmitters within proximity becomes greater than a predefined maximum. In response, the proximity broadcast receiver may transmit messages indicating that the wireless identity transmitters (and thus the associated luggage, travelers, etc.) must be removed. For example, the messages may be sent to mobile devices (e.g., smartphones) associated with the registered users carrying luggage with wireless identity transmitters, instructing the users of the wireless identity transmitters to disperse. As another example, the messages may be sent to devices of management facilities or personnel instructing that the wireless identity transmitters (and associated assets) must be removed from the location. An application of this embodiment may also be used by other facilities or places, such as an amusement park or a retail store, to ensure that customers, employees, or other assets associated with wireless identity transmitters do not enter the same location at the same time. Additional applications may be to manage the placement of mobile vendors, employees, guards, or other assets within a place, such as an airport terminal.

FIG. 25B illustrates an embodiment method 2550 for a central server performing operations in response to receiving a sighting message from a proximity broadcast receiver related to a luggage service. The method 2550 is similar to the method 1600 described above with reference to FIG. 16, except that the method 2500 includes operations for transmitting messages relevant to devices associated with the luggage service. In various embodiments, the method 2550 may be performed by the central server in response to receiving sighting messages from a proximity broadcast receiver performing the method 2500 described above.

In optional determination block 2551, the central server may determine whether a request for proximity information of a wireless identity transmitter is received from a user. In other words, the central server may receive a message asking for the most recent location (or last seen location) of the user's wireless identity transmitter within a piece of luggage. The request may include identification information of the user and/or the wireless identity transmitter that the central server may match against stored information, such as listings of all registered users and/or registered devices. For example, the request may include the user's unique account number and/or the unique device ID of the user's wireless identity transmitter. The request may be a message from the user's mobile device (e.g., a SMS text message). Alternatively, the request may be sent via an app or software executing on the user's device, such as a request sent through a browser or a locator app on the user's smartphone.

If the central server has received a proximity information request (i.e., optional determination block 2551=“Yes”), in optional block 2552, the central server may transmit a message to a mobile device of the user that indicates proximity information. For example, a message may be transmitted to the smartphone of the user who owns the luggage connected to the wireless identity transmitter. The proximity information in the message may include the location information of the last proximity broadcast receiver that transmitted any sighting message related to the wireless identity transmitter, as well as other data (e.g., timestamp, signal strength of the broadcast message received by the proximity broadcast receiver, etc.), thus providing the user with the most up-to-date information describing the location of his/her luggage. For example, the message may indicate that the luggage associated with wireless identity transmitter indicated in the request was last within proximity of the baggage claim area of Terminal C. In various embodiments, the central server may transmit an SMS text message, email, or other message to the mobile device. The central server may obtain the contact information (e.g., email address, cell phone number, etc.) for the mobile device (or the related registered user) from stored information, such as data within the registered user's stored profile.

If the central server has not received a proximity information request (i.e., optional determination block 2551=“No”), or if the central server transmitted a message with the operations in optional block 2552, in determination block 1402, the central server may determine whether a sighting message is received. If no sighting message is received (i.e., determination block 1402=“No”), the central server may continue with the operations in optional determination block 2551. If a sighting message is received (i.e., determination block 1402=“Yes”), in determination block 1602 the central server may determine whether the wireless identity transmitter identity is known. In other words, the central server may perform operations to evaluate, decode, decrypt, and otherwise access the data within the received sighting message to determine whether it includes a wireless identity transmitter identity (or identifier) that is associated with a user registered with the central server. If the wireless identity transmitter is not known (i.e., determination block 1602=“No”), in block 1603 the central server may ignore the sighting message and continue to perform the operations in optional determination block 2551. If the wireless identity transmitter is known (i.e., determination block 1602=“Yes”), in block 1414 the central server may store data based on the sighting message in relation to the wireless identity transmitter identity, such as storing location data within the sighting message in a database in relation to the user of the wireless identity transmitter.

In determination block 2553, the central server may determine whether the received sighting message relates to a luggage service, such as a luggage tracking, handling, and/or delivery program affiliated with an airport. The central server may compare information obtained from the received sighting message to lists of registered services associated with luggage handling or processing to determine whether the sighting message is valid (or authenticated) and corresponding to a third-party (e.g., the airport) or other service registered with the central server. For example, the central server may compare metadata within the received sighting message that identifies a proximity broadcast receiver to stored information for all airports or luggage handling parties that are registered and authenticated with the central server. The received sighting message may not relate to a luggage service if the proximity broadcast receiver that transmitted the sighting message is not associated with a party that is registered, authenticated, or otherwise known to the central server. This may be important to avoid spoofed sighting messages from unregistered parties that cannot be trusted.

If the sighting message is not related to a luggage service (i.e., determination block 2553=“No”), the central server may continue with the operations in optional determination block 2551. If the sighting message does relate to a luggage service, such as a valid airport that provides luggage handling services (i.e., determination block 2553=“Yes”), in block 1606 the central server may generate a return message. In determination block 1608, the central server may determine whether the proximity broadcast receiver is allowed to receive identification information. In other words, the central server may determine whether the proximity broadcast receiver that transmitted the received sighting message has permission or is authorized to receive identification information of the wireless identity transmitter. The central server may base this determination on stored permissions (or permissions settings) within a profile linked to the user of the identified wireless identity transmitter. For example, based on the user's profile privacy settings stored within a database, the central server may determine that only an indication of whether the user's wireless identity transmitter is signed up for the luggage service may be transmitted to the proximity broadcast receiver.

If the proximity broadcast receiver is allowed to receive identification information (i.e., determination block 1608=“Yes”), in block 1610 the central server may append identification information to the return message. For example, the return message may include the user's address to which luggage may be delivered, the user's name for verification purposes by airport customer service, or other identifying data (e.g., a photo, a video, and/or audio data representing the user's likeness). If the proximity broadcast receiver is not allowed to receive identification information (i.e., determination block 1608=“No”) or if the central server appended identification information to the return message in block 1610, in block 2554 the central server may transmit the return message to the proximity broadcast receiver that indicates if luggage with the known wireless identity transmitter is to be handled according to the luggage service. For example, the return message include data that indicates to the proximity broadcast receiver that transmitted the received sighting message that the luggage near a baggage claim area should be removed from the conveyor belt. The return message may include flags, tokens, or other information that the proximity broadcast receiver may identify as indicating whether the wireless identity transmitter (and the corresponding luggage) has been registered, signed-up, or opted in to be handled according to the luggage service. For example, the return message may include a bit that indicates the wireless identity transmitter is not signed up or registered with the luggage service, and thus the corresponding luggage may be ignored by the proximity broadcast receiver. In an embodiment, the central server may not transmit the return message when the wireless identity transmitter is not registered to be handled by the luggage service. For example, when the user associated with the wireless identity transmitter does not want his/her bags moved by baggage handlers within an airport, he/she may refuse to opt-into the luggage service, and thus the central server may have no need to transmit a return message. In other words, with no return message, the proximity broadcast receiver that transmitted the received sighting message may simply ignore the wireless identity transmitter.

In optional block 2556, the central server may transmit a message to a mobile device associated with the known wireless identity transmitter that indicates proximity information. For example, the central server may transmit an SMS text message to the smartphone of the registered user who owns the luggage connected to the wireless identity transmitter, indicating that the luggage is within proximity of a device in the baggage claim area of Terminal C. The operations in optional block 2556 may be similar to the operations in optional block 2552 described above, except the central server may perform the operations in optional block 2556 concurrently with the transmission of the return message as opposed to transmitting proximity information in response to a request from a user. The central server may then continue to perform the operations in optional determination block 2551.

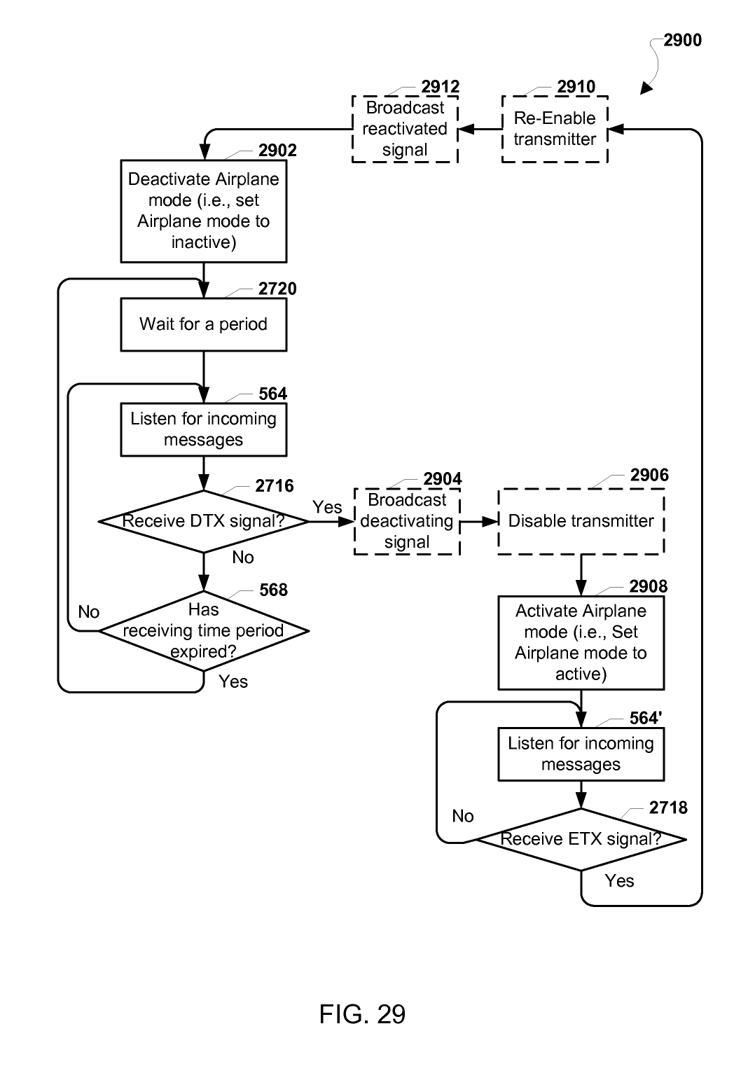

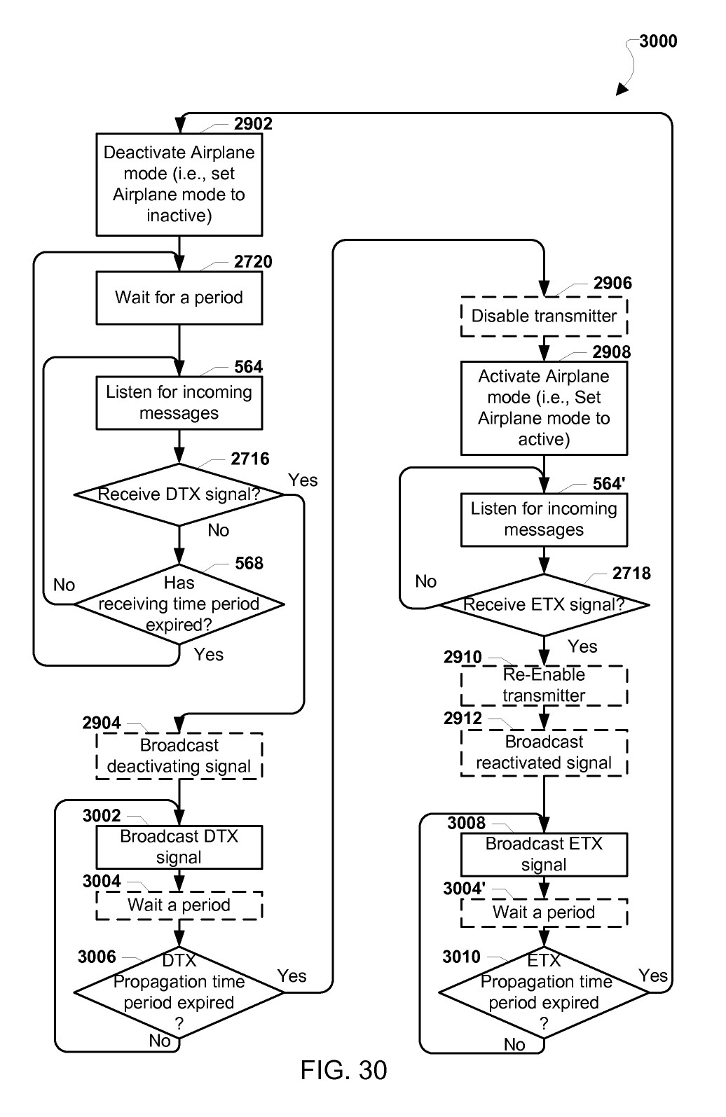

In an embodiment, the central server may notify the registered user associated with the wireless identity transmitter within the luggage that the device is being deactivating or reactivated (i.e., entering or exiting an activated airplane mode). As described below with reference to FIGS. 29-30, wireless identity transmitters may be configured to broadcast signals that indicate whether they are entering or exiting an activated airplane mode. Thus, the message transmitted by the central server with the operations in optional block 2556 may include flags, metadata, or other indications that the wireless identity transmitter is entering or leaving the activated airplane mode. This additional information in the message may be important to inform the user of the wireless identity transmitter (and the owner of the corresponding luggage) that no proximity information should be expected in between when the wireless identity transmitter's short-range wireless transmitter has been disabled and re-enabled in accordance with the airplane mode.

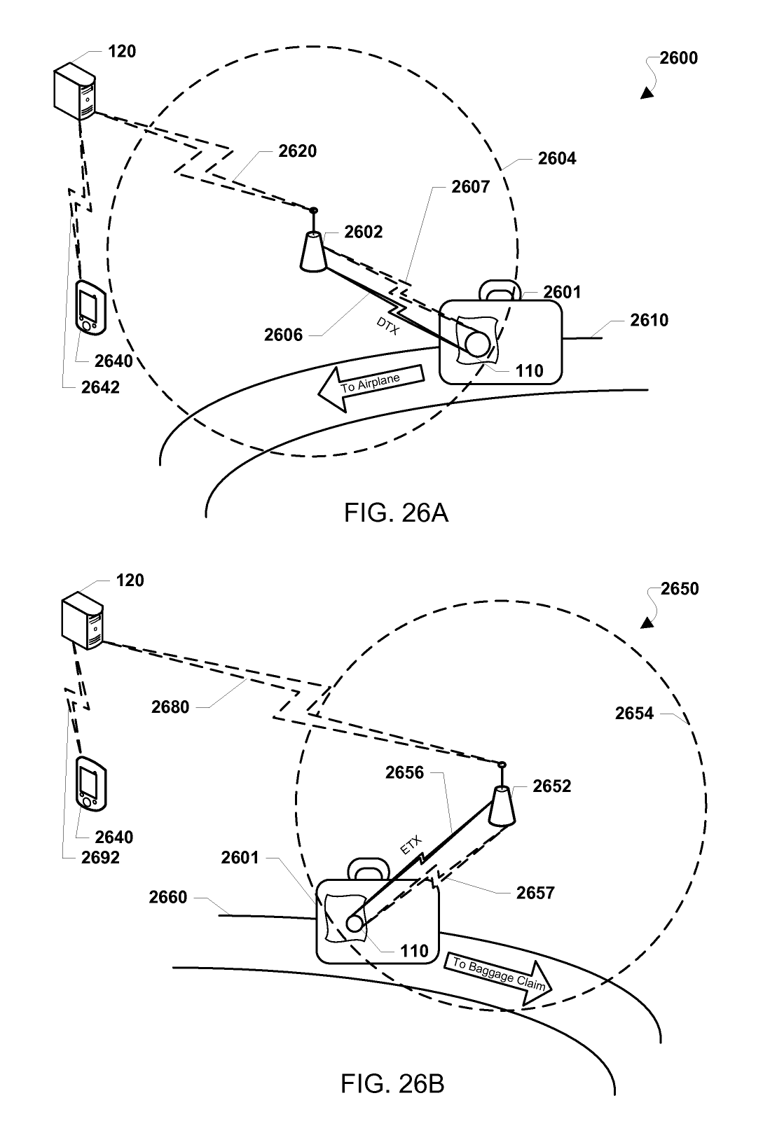

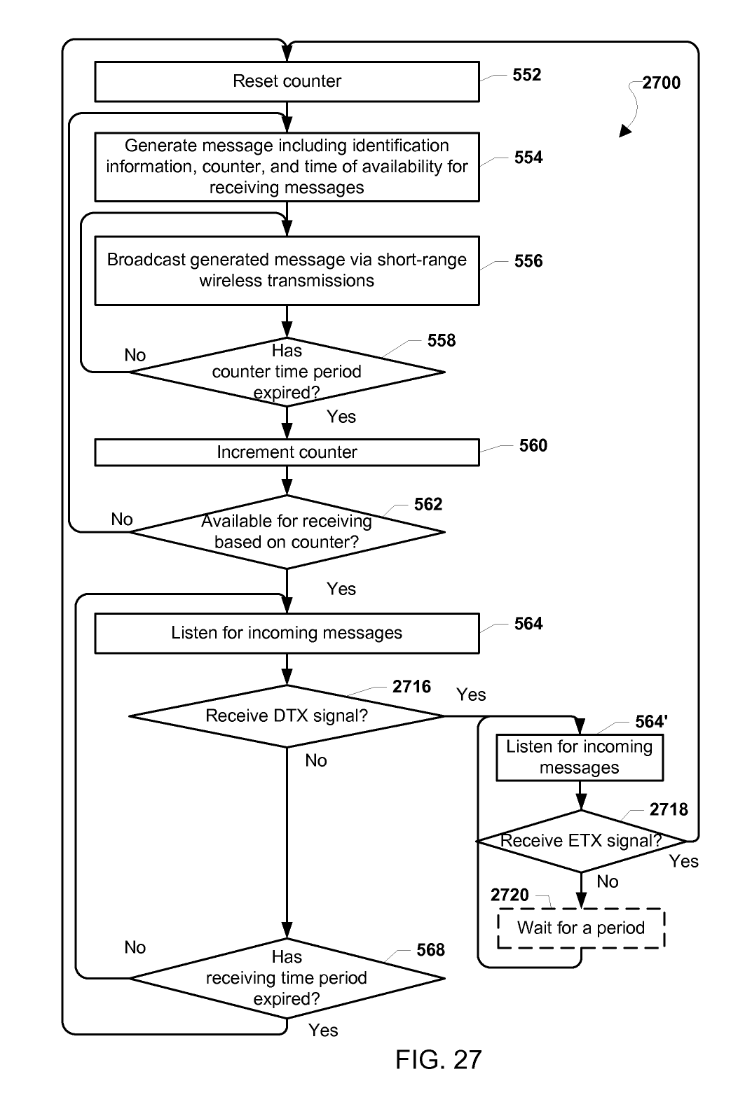

FIGS. 26A and 26B illustrate situations in which a deactivation signaling transmitter 2602 and an activation signaling transmitter 2652, respectively, may broadcast signals that may be received by a wireless identity transmitter 110 within proximity. In an embodiment, the signaling transmitters 2602, 2652 may be any devices, such as proximity broadcast receivers (or transceivers), that are configured to transmit as well as receive short-range wireless signals. Likewise, as described above with reference to FIG. 5 and below with reference to FIGS. 27, 29, and 30, the wireless identity transmitter 110 may be configured to transmit broadcast messages as well as periodically receive signals from the signaling transmitters 2602, 2652. In other words, the signaling transmitters 2602, 2652 and the wireless identity transmitter 110 may conduct two-way communications.

The signaling transmitters 2602, 2652 may broadcast signals in a similar manner as the wireless identity transmitter. For example, the signaling transmitters 2602, 2652 may perform operations or execute software enabling a periodic broadcast of a signal that may be received by an arbitrary device within proximity and configured to communicate with the same short-range wireless protocols (e.g., Bluetooth®, Zigbee®, Peanut®, etc.). In various embodiments, signaling transmitters 2602, 2652 may be placed in various high traffic locations where they are more likely to come within short communication range of wireless identity transmitters 110. For example, a deactivation signaling transmitter 2602 may be attached to a screening device in an airport. In various embodiments, the signaling transmitters 2602, 2652 may be configured to store data, messages, software instructions, and other information to include within such broadcasts received by the proximate wireless identity transmitter 110.

In another embodiment, the signaling transmitters 2602, 2652 may be configured to only broadcast signals and not to receive short-range wireless signals from the wireless identity transmitter 110. However, the signaling transmitters 2602, 2652 may be positioned next to, on, within, or otherwise within proximity of proximity broadcast receivers which may receive short-range wireless signals from wireless identity transmitters 110. FIG. 37 illustrates an embodiment signaling transmitter with components suitable for various embodiments.

FIG. 26A illustrates a diagram 2600 showing a deactivation signaling transmitter 2602 broadcasting a disable wireless signal 2606 that instructs a wireless identity transmitter 110 to operate in a mode in which the wireless identity transmitter 110 is disabled from transmitting wireless signals. This mode may be referred to as an “activated” airplane mode. As mentioned above, when traveling in an aircraft, wireless communications from consumer mobile devices, such as smartphones or tablets, may cause interference to the aircraft's systems and may be restricted by various regulations (e.g., airline policy, government regulations, etc.). Accordingly, an airport may use the deactivation signaling transmitter 2602 to wirelessly disable transmissions (e.g., broadcasts) from the wireless identity transmitter 110 to adhere to policies without causing inconvenience to passengers. During the activated airplane mode, the wireless identity transmitter 110 may still receive short-range wireless transmissions.

The deactivation signaling transmitter 2602 may be located within an aircraft, the airport, or other place related to the transport, shipping, and/or handling of luggage, baggage, cargo, and other items. In particular, the deactivation signaling transmitter 2602 may be a stationary device located near a conveyor belt 2610 that moves luggage towards aircrafts. For example, the conveyor belt 2610 may be used to move luggage from a check-in area within the airport (e.g., within a terminal) to the tarmac where an aircraft is parked for loading passenger luggage.

A case 2601 may travel on the conveyor belt 2610 towards an aircraft for loading. The case 2601 may include the wireless identity transmitter 110 for tracking purposes. For example, the owner of the case 2601 may place the wireless identity transmitter 110 within the case 2601 so that he/she may check the location of the case 2601 during travel. The wireless identity transmitter 110 may be configured to periodically broadcast identification information (i.e., secure, rolling identifiers) and receive incoming messages (e.g., the disable wireless signal 2606), as described below with reference to FIG. 26A.

The deactivation signaling transmitter 2602 may be configured to periodically broadcast the disable wireless signal 2606 (referred to in FIG. 26A as “DTX”) that includes metadata, software instructions, or other information indicating that short-range wireless transceivers, such as Bluetooth or RF radios, must not transmit signals. In particular, the disable wireless signal 2606 may indicate that any wireless identity transmitters receiving the disable wireless signal 2606 must operate in an activated airplane mode that prevents the transmission of wireless signals (i.e., broadcasting is disabled). As the case 2601 is moved along by the conveyor belt 2610, the wireless identity transmitter 110 within the case 2601 may come within the broadcast range 2604 of the deactivation signaling transmitter 2602. In other words, the wireless identity transmitter 110 may be moved within proximity of the deactivation signaling transmitter 2602. When within the broadcast range 2604, the wireless identity transmitter 110 may receive the disable wireless signal 2606 indicating the wireless identity transmitter 110 must be configured to not transmit wireless signals.

In an embodiment, the deactivation signaling transmitter 2602 may be configured to transmit signals 2620 to a central server 120. For example, in response to receiving broadcast messages from the wireless identity transmitter 110, the deactivation signaling transmitter 2602 may transmit signals 2620 via long-range communications to the central server. In an embodiment, the signals 2620 may be sighting messages that include information from broadcast messages received from the proximate wireless identity transmitter 110 (e.g., the rolling identifier), as well as associated data (e.g., the identity and/or location of the deactivation signaling transmitter 2602, timestamp info, etc.). In response to receiving the signals 2620, the central server 120 may identify the wireless identity transmitter 110 by decoding, decrypting, and otherwise access any obscured identification information (i.e., rolling identifier), and may store data in relation to the wireless identity transmitter 110 or its associated user. For example, the central server 120 may decrypt identification information within the signals 2620 to determine the identity of the wireless identity transmitter 110 based on its rolling identifier. In various embodiments, the deactivation signaling transmitter 2602 may utilize a long-range transceiver, such as a cellular modem and antenna, to transmit the signals 2620, or alternatively, may be configured to transmit the signals 2620 via a local area network (e.g., over a WiFi router, not shown in FIG. 26A).

In another embodiment, in response to the central server 120 receiving signals 2620 from the deactivation signaling transmitter 2602, the central server 120 may automatically determine that the wireless identity transmitter 110 is entering an activated airplane mode. For example, the central server 120 may store information indicating that the deactivation signaling transmitter 2602 is located near the conveyor belt 2610 going towards an aircraft and is broadcasting the disable wireless signal 2606. Based on that stored information, the central server 120 may determine that any wireless identity transmitter 110 identified within signals 2620 must be deactivating broadcasting. In other words, by the fact that the deactivation signaling transmitter 2602 was within proximity of the wireless identity transmitter 110 and capable of transmitting a sighting message related to the wireless identity transmitter 110, the central server 120 may determine the wireless identity transmitter 110 received the disable wireless signal 2606 and thus must be entering an airplane mode.

In an embodiment, the wireless identity transmitter 110 may broadcast a deactivating signal 2607 in response to receiving the disable wireless signal 2606 from the deactivation signaling transmitter 2602. As described below, the wireless identity transmitter 110 may broadcast the deactivating signal 2607 for receipt by the deactivation signaling transmitter 2602 to indicate that the disable wireless signal 2606 was received and that the wireless identity transmitter 110 is entering an activated airplane mode (i.e., broadcasting by the wireless identity transmitter 110 will be disabled). In another embodiment, the deactivation signaling transmitter 2602 may receive and relay the deactivating signal 2607 to the central server 120 via the signals 2620. For example, the deactivation signaling transmitter 2602 may transmit signals 2620, such as a sighting message, that includes the deactivating signal 2607 along with the time of receipt, the deactivation signaling transmitter 2602 location and identity, and any other relevant information (e.g., the name of the airport, associated flight numbers, etc.). In another embodiment, the deactivating signal 2607 may be received by any device configured to receive short-range broadcast signals, such as proximity broadcast receiver within proximity of the wireless identity transmitter 110.

In an embodiment, the deactivating signal 2607 may be a broadcast message transmitted by the wireless identity transmitter 110 that includes identification information (e.g., a rolling identifier) as well as metadata or other information indicating the wireless identity transmitter 110 is entering an activated airplane mode. For example, in response to receiving the disable wireless signal 2606, the wireless identity transmitter 110 may broadcast a message that includes an additional code known by the central server as indicating an activated airplane mode.

In various embodiments, the information stored within the central server 120 based on the signals 2620 from the deactivation signaling transmitter 2602 may be used to provide information to users registered to locate their luggage containing the wireless identity transmitter 110. For example, an owner of the case 2601 may use a software application (an “app”) executing on a mobile device 2640 (e.g., a smartphone) to query the central server 120 for information that indicates whether the wireless identity transmitter 110 has received the disable wireless signal 2606. In an embodiment, the central server 120 may transmit a deactivating notification message 2642 to the mobile device 2640 that indicates that the deactivating signal 2607 was broadcast by the wireless identity transmitter 110 associated with the mobile device 2640. For example, the deactivating notification message 2642 may be automatically sent by the central server 120 to the luggage owner's mobile device 2640 in response to receiving the signal 2620 from the deactivation signaling transmitter 2602 indicating the wireless identity transmitter 110 is configured to operate in activated airplane mode. In an embodiment, the deactivating notification message 2642 may include a location report (or position report) or other information indicating the location of the wireless identity transmitter 110 at the time the deactivation signaling transmitter 2602 received the deactivating signal 2607. For example, upon receiving a sighting message indicating a deactivating signal 2607 from the wireless identity transmitter 110, the central server 120 may transmit a message to the mobile device 2640 of the owner of the case 2601 indicating the location of the last known proximity broadcast receiver (or signaling transmitter) to receive a broadcast from the wireless identity transmitter 110.

FIG. 26B illustrates a diagram 2650 showing an activation signaling transmitter 2652 broadcasting an enable wireless signal 2656 that instructs a wireless identity transmitter 110 to operate in a mode in which the wireless identity transmitter 110 is enabled to transmit wireless signals. This mode may be referred to as a “deactivated” airplane mode. The diagram 2650 is similar to the diagram 2600, except the diagram 2650 illustrates an embodiment in which luggage is being removed from an aircraft and so there may be no restriction on wireless transmissions. For example, once the aircraft has landed, passengers may use mobile devices without fear of creating interference prohibited by federal regulations. Accordingly, an airport may use the activation signaling transmitter 2652 to wirelessly enable broadcasts from the wireless identity transmitter 110 without causing inconvenience to passengers.

The activation signaling transmitter 2652 may be located within an aircraft or within various places in an airport, such as near a conveyor belt 2660 that moves luggage away from aircrafts. For example, the conveyor belt 2660 may be used to move luggage from landed aircrafts on a tarmac into the baggage claim area within a terminal. A case 2601 may travel on the conveyor belt 2660 away from the landed aircraft and may include the wireless identity transmitter 110 for tracking purposes. The wireless identity transmitter 110 may be configured to not periodically broadcast via short-range wireless transceiver. In other words, in response to receiving a disable wireless signal 2606 described above with reference to FIG. 26A, the wireless identity transmitter 110 may be configured to operate in an activated airplane mode in which the wireless identity transmitter 110 may not transmit wireless signals (i.e., broadcasting is disabled).

The activation signaling transmitter 2652 may be configured to periodically broadcast the enable wireless signal 2656 (referred to in FIG. 26B as “ETX”) that includes metadata, software instructions, or other information indicating that short-range wireless transceivers, such as Bluetooth or RF radios, may transmit signals. In particular, the enable wireless signal 2656 may indicate that after receiving the enable wireless signal 2656, the wireless identity transmitter 110 may operate in a deactivated airplane mode in which the wireless identity transmitter 110 may transmit wireless signals (i.e., broadcasting is enabled). As the case 2601 is moved along by the conveyor belt 2660, the wireless identity transmitter 110 within the case 2601 may come within the broadcast range 2654 of the activation signaling transmitter 2652 and may receive the enable wireless signal 2656 indicating the wireless identity transmitter 110 may transmit wireless signals.

In an embodiment, the wireless identity transmitter 110 may broadcast a reactivated signal 2657 in response to receiving the enable wireless signal 2656 from the activation signaling transmitter 2652. As described below, the wireless identity transmitter 110 may broadcast the reactivated signal 2657 for receipt by the activation signaling transmitter 2652 (or a proximity broadcast receiver within proximity) to indicate that the enable wireless signal 2656 was received and that the wireless identity transmitter 110 has resumed a deactivated airplane mode (i.e., broadcasting by the wireless identity transmitter 110 is re-enabled). In another embodiment, the activation signaling transmitter 2652 may receive and relay the reactivated signal 2657 to a central server 120 via signals 2680. For example, the activation signaling transmitter 2652 may transmit a sighting message via the signals 2680 (e.g., WiFi transmissions) that includes information related to or taken from the reactivated signal 2657, along with the time of receipt, the activation signaling transmitter 2652 location and identity, and any other relevant information (e.g., the name of the airport, associated flight numbers, etc.). In various embodiments, the activation signaling transmitter 2652 may utilize a long-range transceiver, such as a cellular modem and antenna, to transmit the signals 2680, or alternatively, may be configured to transmit the signals 2680 via a local area network (e.g., WiFi transmissions via a WiFi router).

In another embodiment, in response to the central server 120 receiving signals 2680 from the activation signaling transmitter 2652, the central server 120 may determine the identity of the wireless identity transmitter 110 from identification information (e.g., rolling identifiers, etc.) within the signals 2680 and may automatically determine that the wireless identity transmitter 110 is entering a deactivated airplane mode. For example, the central server 120 may store information indicating that the activation signaling transmitter 2652 is located near the conveyor belt 2660 going away from an aircraft and is broadcasting the enable wireless signal 2656. Based on that stored information, the central server 120 may determine that any wireless identity transmitter 110 identified within the signals 2680 must be broadcasting again. In other words, by the fact that the activation signaling transmitter 2652 was within proximity of the wireless identity transmitter 110, the central server 120 may determine the wireless identity transmitter 110 received the enable wireless signal 2656 and thus has resumed broadcasting.

In various embodiments, the information stored within the central server 120 based on the signals 2680 from the activation signaling transmitter 2652 may be used to provide information to users registered to locate their luggage containing the wireless identity transmitter 110. For example, an owner of the case 2601 may use a software application (an “app”) executing on a mobile device 2640 to query the central server 120 for information that indicates whether the wireless identity transmitter 110 has received the enable wireless signal 2656. In an embodiment, the central server 120 may transmit a reactivated notification message 2692 to the mobile device 2640 that indicates that the reactivated signal 2657 was broadcast by the wireless identity transmitter 110 associated with the mobile device 2640. For example, the reactivated notification message 2692 may be automatically sent by the central server 120 to the owner's mobile device 2640 in response to receiving the signal 2680 from the activation signaling transmitter 2652 indicating the wireless identity transmitter 110 is configured to operate in deactivated airplane mode. In an embodiment, the reactivated notification message 2692 may include a location report (or position report) or other information indicating the proximity of the wireless identity transmitter 110 to other devices (e.g., proximity broadcast receivers or signaling transmitters 2652) at the time of broadcasting the reactivated signal 2657.

In an embodiment, the activation signaling transmitter 2652 may be the same device as the deactivation signaling transmitter 2602 described above with reference to FIG. 26A, and vice versa. For example, the activation signaling transmitter 2652 may receive instructions from a central server, a local computing device or server, and/or from user input (e.g., a switch or button on the activation signaling transmitter 2652) that indicates the activation signaling transmitter 2652 may broadcast a disable wireless signal 2606. For example, an activation signaling transmitter 2652 placed on an airport's tarmac may be configured to broadcast the disable wireless signal 2606 when passengers are boarding an aircraft about to take-off and may be configured to broadcast the enable wireless signal 2656 when another aircraft arrives.

In a further embodiment, the deactivation signaling transmitter 2602 and activation signaling transmitter 2652 may be placed within an aircraft (e.g., an aircraft). For example, before take-off, the deactivation signaling transmitter 2602 may be configured to broadcast the disable wireless signal 2606 so that the wireless identity transmitter 110 within the aircraft may not transmit wireless signals. As another example, after landing, the activation signaling transmitter 2652 may be configured to broadcast the enable wireless signal 2656 so that the wireless identity transmitter 110 within the aircraft may resume transmitting wireless signals.

Further, signaling transmitters 2602, 2652 may be configured to utilize switches to toggle or otherwise change signaling behaviors in response to input data, such as sensor data. For example, a signaling transmitter within the cargo-hold of an airplane and configured to broadcast the enable wireless signal 2656 may be configured to broadcast the disable wireless signal 2606 based on sensor data from an altimeter connected to a switch. Such switches may be any of a variety of switches designed to respond to a variety of different triggering events. Some examples of types of switches that may be utilized by signaling transmitters 2602, 2652 may include a mercury switch which may close in response to the device being moved or tilted, a magnetic switch that may be activated when the device is removed from a magnetic field (e.g., when the device is moved away from a magnet), a magnetic switch that may be activate when a magnetic field is applied to the device (e.g., when an electric motor is energized), a mechanical switch that may be activated in response to acceleration or physical movement, an accelerometer sensor-activated switch configured to activate when the device is accelerated beyond a pre-defined threshold acceleration, a pressure sensor switch (or altimeter switch) which may activate when the ambient pressure changes (e.g., if the device is taken up in an airplane, etc.), a moisture-sensitive sensor switch that activates when exposed to water, a strain gauge-activated switch configured to activate when strain across a portion of the device exceeds a predefined threshold (e.g., if a monitored structure begins to bend or breaks), and a temperature sensor switch configured to activate when temperature rises above and/or falls below a predefined threshold.

FIG. 27 illustrates an embodiment method 2700 for configuring a wireless identity transmitter to stop transmitting wireless signals (e.g., broadcast messages) in response to receiving a disable wireless signal. The method 2700 is similar to the method 500 as described above with reference to FIG. 5, as both the methods 500, 2700 may enable the wireless identity transmitter to receive signals that may include data, software instructions, or other information. However, based on received wireless signals, the method 2700 may also automatically configure a wireless identity transmitter to operate in an activated airplane mode that prevents the wireless identity transmitter from broadcasting short-range wireless signals. Automatically setting the activated airplane mode may be convenient for users during situations when wireless signal transmissions may be inappropriate, dangerous, or restricted, such as on an airplane.

In general, a wireless identity transmitter may be configured to operate in an activated airplane mode in response to receiving a disable wireless signal, such as broadcast by a signaling transmitter positioned beside a luggage conveyor belt as described above with reference to FIG. 26A. While in the activated airplane mode, the wireless identity transmitter may be safely placed within regulated areas, but may not be tracked in real-time as broadcast message may not be transmitted for relay to a central server. Additionally, the wireless identity transmitter may continually wait to receive an enable wireless signal, such as transmitted by activation signaling transmitters positioned near a conveyor going away from a landed aircraft as described above with reference to FIG. 26B. When an enable signal is received, the wireless identity transmitter may exit the activated airplane mode (i.e., operate in a deactivated airplane mode) and resume transmitting broadcast messages that include the device's rolling identifier. In various embodiments, the wireless identity transmitter may also operate in a deactivated airplane mode in response to removal and replacement of its battery or in response to a user input. For example, in an embodiment in which the wireless identity transmitter includes a “reset” button, the wireless identity transmitter may reboot in a deactivated airplane mode in response to a user pressing the reset button. The method 2700 may benefit users of wireless identity transmitters by seamlessly configuring such devices to comply with regulations as well as by re-enabling signaling to promote efficient tracking.

As described above, in block 552 the wireless identity transmitter may reset a counter, such as a counter variable to indicate the beginning (or initialization) of a period during which the wireless identity transmitter may not receive messages. In block 554, the wireless identity transmitter may generate a message including identification information, counter, and time of availability for receiving messages. In other embodiments, the generated message may only include the wireless identity transmitter's identification information (e.g., the rolling identifier) and not any availability information. In block 556, the wireless identity transmitter may broadcast the generated message via short-range wireless transmissions, such as Bluetooth® LE packets. In determination block 558, the wireless identity transmitter may determine whether the predetermined counter time period has expired. If the counter time period has not expired (i.e., determination block 558=“No”), the wireless identity transmitter may continue to broadcast the generated message periodically in block 556. If the counter time period has expired (i.e., determination block 558=“Yes”), in block 560 the wireless identity transmitter may increment the counter and, in determination block 562, determine whether the wireless identity transmitter has become available for receiving messages based on the counter. If it is not available to receive messages (i.e., determination block 562=“No”), the wireless identity transmitter may continue with the operations in block 554.

However, if the wireless identity transmitter is available to receive messages (i.e., determination block 562=“Yes”), in block 564 the wireless identity transmitter may listen for incoming messages, such as by monitoring a receiver circuit (or a wireless receiver circuit) for incoming short-range radio transmissions. In determination block 2716, the wireless identity transmitter may determine whether a disable wireless signal (referred to in FIG. 27 as “DTX” signal) is received. In an embodiment, the wireless identity transmitter may evaluate received incoming messages and detect when metadata, header information, software instructions, or other data within the incoming message indicates a disable wireless signal is present within a message. For example, the wireless identity transmitter may detect an identifying bit or a code within an incoming message that corresponds to a known disable command or trigger.

If a disable wireless signal is received (i.e., determination block 2716=“Yes”), the wireless identity transmitter may be considered to be in an activated airplane mode during which incoming messages may be received but wireless signals may not be transmitted by the wireless identity transmitter. In other words, the wireless identity transmitter may not perform routines or operations to transmit wireless signals but may still perform operations to receive incoming messages. In an embodiment, the wireless identity transmitter may represent operating in the activated (or deactivated) airplane mode by setting a system variable, bit, or other stored data. In an embodiment, the wireless identity transmitter may deactivate circuitry, modules, and/or subsystems exclusively designed for transmitting signals in response to determining a disable wireless signal is received.

In block 564′, the wireless identity transmitter may listen for incoming messages, such as by monitoring a wireless receiver circuit for incoming activation signals. For example, incoming messages may be received from proximity broadcast receivers or activation signaling transmitters broadcasting signals within proximity of the wireless identity transmitter. In determination block 2718 the wireless identity transmitter may determine whether an enable wireless signal (referred to in FIG. 27 as “ETX” signal) is received. As described above with reference to disable wireless signals, the wireless identity transmitter may determine whether an enable wireless signal has been received based on metadata, header information, software instructions, or other data represented within received incoming messages. In an embodiment, the wireless identity transmitter may re-activate (or re-enable) circuitry, modules, and/or subsystems exclusively designed for transmitting signals in response to determining an enable wireless signal is received.

If no enable wireless signal is received (i.e., determination block 2718=“No”), in optional block 2720 the wireless identity transmitter may wait for a period and then may continue with the operations in block 564′. For example, the wireless identity transmitter may sleep for a predefined time (e.g., a few seconds, minutes, etc.) and then wake-up to monitor for incoming messages. The wireless identity transmitter may continually perform the operations in blocks 564′, 2718, and 2720 until an enable wireless signal is received. In other words, the wireless identity transmitter may be configured to operate in the activated airplane mode for a period of an indefinite duration. If an enable wireless signal is received (i.e., determination block 2718=“Yes”), the wireless identity transmitter may be considered to no longer be in the activated airplane mode. Accordingly, the wireless identity transmitter may continue with the operations in block 552.

If a disable wireless signal is not received (i.e., determination block 2716=“No”), in determination block 568, the wireless identity transmitter may determine whether the receiving time period has expired. In other words, the wireless identity transmitter may determine whether incoming messages, such as disable signals, may still be received. The time period for receiving incoming messages may be based on a counter variable maintained by the wireless identity transmitter, a clock signal indication, or information within a received message. If the receiving time period has not expired (i.e., determination block 568=“No”), the wireless identity transmitter may continue to listen for incoming messages in block 564. However, if the receiving time period has expired (i.e., determination block 568=“Yes”), the wireless identity transmitter may repeat the process by returning to block 552.

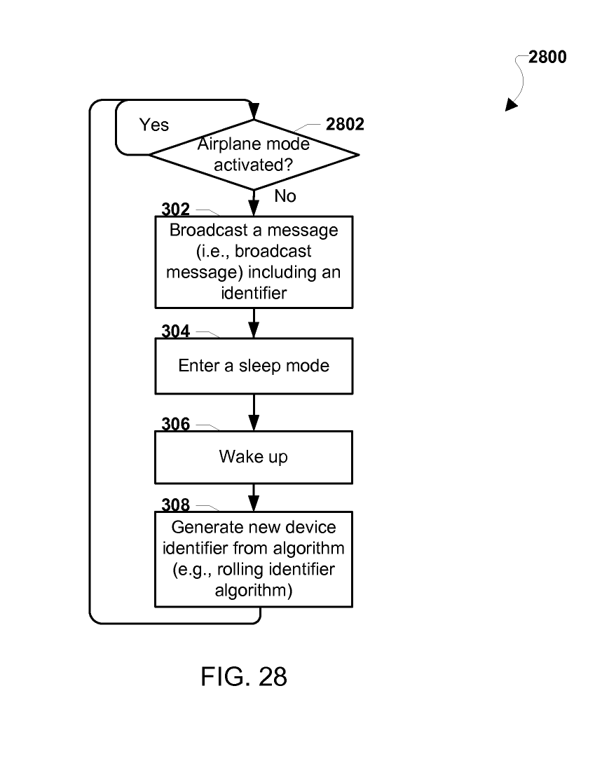

FIGS. 28-30 illustrate embodiment methods 2800, 2900, and 3000 for configuring a wireless identity transmitter to disable transmitting wireless signals in response to receiving a disable wireless signal and enable transmitting wireless signals in response to receiving an enable wireless signal. The methods 2800, 2900, and 3000 may be performed concurrently, such as with software routines or operating system threads concurrently executing on the wireless identity transmitter's processing unit. For example, the wireless identity transmitter may execute the method 2800 with a first operating system thread and may concurrently execute the method 2900 with a second operating system thread. When executed in combination, the method 2800 and the method 2900 (or the method 2800 and the method 3000) may function in a similar manner as the method 2700 described above. In particular, the method 2900 or the method 3000 may be performed by the wireless identity transmitter to handle received incoming messages and to activate/deactivate the airplane mode, and the method 2800 may be performed to separately handle operations for transmitting broadcast messages that include the identification information (e.g., secured, rolling identifier).

FIG. 28 illustrates an embodiment method 2800 for a wireless identity transmitter broadcasting a short-range wireless message based on whether an airplane mode is activated. The method 2800 is similar to the operations associated with the wireless identity transmitter described above with reference to FIG. 3, except that when executing the method 2800, the wireless identity transmitter may only perform the operations in blocks 302-308 when the airplane mode is deactivated. As described above, the method 2800 may be performed as or by a routine, application, or thread by the wireless identity transmitter's operating system. For example, the method 2800 may be executed as an operating system routine that runs concurrently with other routines, such as the method 2900.

In determination block 2802, the wireless identity transmitter may determine whether the airplane mode is activated. For example, the wireless identity transmitter may evaluate the current value of a stored variable corresponding to the airplane mode. As described above, when the airplane mode is active (or activated), the wireless identity transmitter may not transmit wireless signals, but may still receive wireless signals. In various embodiments, the wireless identity transmitter may utilize a system variable, bit, or other stored data that indicates a current activation state of an airplane mode. For example, the wireless identity transmitter may store an integer variable that indicates whether the airplane mode is activated or deactivated. In an embodiment, the airplane mode may be represented in the wireless identity transmitter by a variable or bit that is accessible by various routines, threads, or applications executed by the operating system of the wireless identity transmitter. If the airplane mode is activated (i.e., determination block 2802=“Yes”), the wireless identity transmitter may continue to perform the operations in determination block 2802.

However, if the airplane mode is not activated (i.e., determination block 2802=“No”), in block 302′ the wireless identity transmitter may broadcast a message that includes an identifier (e.g., a rolling identifier). In block 304 the wireless identity transmitter may enter a sleep mode for a period, in block 306 may wake up from the sleep mode when the period elapses, and in block 308 may determine a new device identifier based on an algorithm. The wireless identity transmitter may then continue with the operations in determination block 2802. Due to the operations in block 308, the identifier may change periodically (or roll) to ensure security. In an embodiment, the identifier may be changed by the wireless identity transmitter in response to a detected event, such as waking up from a sleep mode in the operations in block 306.

FIG. 29 illustrates an embodiment method 2900 for a wireless identity transmitter configuring an airplane mode based on received short-range wireless incoming messages. The method 2900 is similar to operations described above with reference to FIG. 27, except that the method 2900 may only include operations for receiving and processing incoming messages. As described above, the method 2900 may be performed as or by a routine, application, or thread by the wireless identity transmitter's operating system. For example, the method 2900 may be executed as an operating system routine that runs concurrently with other routines, such as the method 2800.

In block 2902, the wireless identity transmitter may deactivate the airplane mode. In other words, the wireless identity transmitter may set the airplane mode to be deactivated, such as by setting the value of an airplane mode system variable or bit to indicate a deactivated state or condition. The deactivated state may be the default state for the airplane mode. In block 2720, the wireless identity transmitter may wait for a period. For example, the wireless identity transmitter may be configured to listen for incoming messages once every so many seconds or minutes, and so may wait for the period in between time when the wireless identity transmitter is listening for incoming messages. In block 564, the wireless identity transmitter may listen for incoming messages, as described above. For example, the wireless identity transmitter may monitor a receiver circuit to listen for incoming wireless signals, such as Bluetooth LE broadcast messages that are transmitted by other devices within proximity.

In determination block 2716, the wireless identity transmitter may determine whether a disable wireless signal (referred to as “DTX signal” in FIG. 29) is received. If a disable wireless signal is not received (i.e., determination block 2716=“No”), in determination block 568 the wireless identity transmitter may determine whether a predefined receiving time period has expired. If the receiving time period has not expired (i.e., determination block 568=“No”), the wireless identity transmitter may continue with the operations in block 564. If the receiving time period has expired (i.e., determination block 568=“Yes”), the wireless identity transmitter may continue with the operations in block 2720.

If a disable wireless signal is received (i.e., determination block 2716=“Yes”), in optional block 2904, the wireless identity transmitter may broadcast a deactivating signal. In particular, the wireless identity transmitter may broadcast a message that includes metadata, header information, or other information that indicates the wireless identity transmitter is entering an activated airplane mode. In other words, the wireless identity transmitter may broadcast information to proximate proximity broadcast receivers and/or deactivation signaling transmitters configured to receive short-range wireless signals that the wireless identity transmitter is disabling its transmission of broadcast messages. In an embodiment, the deactivating signal may include identification information similar to other broadcast messages transmitted by the wireless identity transmitter. As described above with reference to FIG. 26A, the deactivating signal may be relayed to a central server, which may store information to indicate the wireless identity transmitter's entrance into an activated airplane mode. In optional block 2906, the wireless identity transmitter may also disable a transmitter, transmitter circuitry or transmitter module in response to receiving the disable wireless signal. In an embodiment, the wireless identity transmitter may be able to conserve additional power by disabling the transmitter.

In block 2908 the wireless identity transmitter may activate the airplane mode. In other words, the wireless identity transmitter may set the airplane mode to be activated, such as by setting the value of an airplane mode system variable or bit to indicate an activated state or condition. In block 564′, the wireless identity transmitter may listen for incoming messages and in determination block 2718 may determine whether an enable wireless signal (referred to as “ETX signal” in FIG. 29) is received. If an enable wireless signal is not received (i.e., determination block 2718=“No”), the wireless identity transmitter may continue with the operations in block 564′. If an enable wireless signal is received (i.e., determination block 2718=“Yes”), in optional block 2910, the wireless identity transmitter may re-enable its transmitter, such as a transmitter circuitry or transmitter module, in response to receiving the enable wireless signal. In optional block 2912, the wireless identity transmitter may broadcast a reactivated signal in response to the transmitter being re-enabled. In particular, the wireless identity transmitter may broadcast a message that includes metadata, header information, or other information that indicates the wireless identity transmitter is operating in a deactivated airplane mode. In other words, the wireless identity transmitter may broadcast information to proximate proximity broadcast receivers and/or activation signaling transmitters configured to receive short-range wireless signals that the wireless identity transmitter has resumed transmission of broadcast messages. In an embodiment, the reactivated signal may include identification information (e.g., a rolling identifier) similar to other broadcast messages transmitted by the wireless identity transmitter. As described above, the reactivated signal may be relayed to a central server, which may store information to indicate the wireless identity transmitter's exit from an activated airplane mode. The wireless identity transmitter may then continue with the operations in block 2902. In other words, if an enable wireless signal is received, the wireless identity transmitter may again operate in a deactivated airplane mode.

FIG. 30 illustrates an embodiment method 3000 for a wireless identity transmitter configuring an airplane mode based on received incoming messages or signals. The method 3000 is similar to the method 2900 described above, except that the method 3000 may also include operations for relaying signals to propagate disable and/or enable wireless signals from wireless identity transmitter to wireless identity transmitter. In particular, when receiving either a disable wireless signal (referred to in FIG. 30 as a “DTX signal”) or an enable wireless signal (referred to in FIG. 30 as an “ETX signal”), the wireless identity transmitter may be configured to broadcast the received signal for a predefined period so that other devices within proximity may also receive the signal. This may be important to supplement the operations and broadcast coverage of deactivation signaling transmitters and/or activation signaling transmitters, making disable and/or enable wireless signals more available to proximate devices. For example, a wireless identity transmitter in receipt of a disable wireless signal from a deactivation signaling transmitter may broadcast the disable wireless signal at a different periodicity. This may be useful if other proximate devices are otherwise unable to receive enable or disable signals due to being out of sync with signaling transmitters. Additionally, propagating received disable and/or enable wireless signals may be beneficial in increasing the distribution of such signals. For example, an activation signaling transmitter may only be configured to broadcast enable wireless signals that can be received within a certain number of inches, feet, meters, etc., however through re-broadcasting (or propagating) received enable wireless signals, wireless identity transmitters in receipt of the enable wireless signals may increase the area in which other wireless identity transmitters may receive the enable wireless signals.

In block 2902, the wireless identity transmitter may deactivate the airplane mode. In block 2720, the wireless identity transmitter may wait for a period. In block 564, the wireless identity transmitter may listen for incoming messages. In determination block 2716, the wireless identity transmitter may determine whether a disable wireless signal is received. If the wireless identity transmitter determines that a disable wireless signal is not received (i.e., determination block 2716=“No”), in determination block 568 the wireless identity transmitter may determine whether a receiving time period has expired. If the wireless identity transmitter determines that the receiving time period has not expired (i.e., determination block 568=“No”), the wireless identity transmitter may continue with the operations in block 564. If the wireless identity transmitter determines that the receiving time period has expired (i.e., determination block 568=“Yes”), the wireless identity transmitter may continue with the operations in block 2720.

If the wireless identity transmitter determines that a disable wireless signal is received (i.e., determination block 2716=“Yes”), in optional block 2904, the wireless identity transmitter may broadcast a deactivating signal. In block 3002, the wireless identity transmitter may broadcast a disable wireless signal, for instance the disable wireless signal determined to be received in the operations in determination block 2716. In an embodiment, the wireless identity transmitter may store the received disable wireless signal and may broadcast the signal exactly as it was received. Alternatively, the wireless identity transmitter may append additional information to the disable wireless signal, such as the wireless identity transmitter's identification, timestamp information, and/or information that indicates the disable wireless signal is being broadcast by a receiving wireless identity transmitter as opposed to a deactivation signaling transmitter. In another embodiment, the wireless identity transmitter may further append a counter indicator, bit, or other information that indicates the number of devices that have propagated the disable wireless signal. For example, the wireless identity transmitter may broadcast a disable wireless signal that includes an indicator of the number of unique devices that have broadcast the disable wireless signal before the wireless identity transmitter. In another embodiment, the wireless identity transmitter may append a time-to-live indication that describes how many subsequent devices may propagate the disable wireless signal. For example, the time-to-live indication may inform subsequent recipient devices that they are not authorized to propagate the disable wireless signal. In this way, the extent of the disable wireless signal may be confined to a certain number of devices and/or a certain proximity from deactivation signaling transmitters.

In optional block 3004, the wireless identity transmitter may wait a period. For example, the wireless identity transmitter may wait a predefined number of milliseconds, seconds, or minutes. In determination block 3006, the wireless identity transmitter may determine whether the disable wireless signal propagation time period (referred to as the “DTX propagation time period” in FIG. 30) has expired. In particular, the wireless identity transmitter may be configured to only broadcast the disable wireless signal for a predefined period before disabling its own transmitter. For example, after receiving the disable wireless signal, the wireless identity transmitter may only re-broadcast the disable wireless signal for a few seconds. In an embodiment, the disable wireless signal propagation time period may be defined by the number of times the wireless identity transmitter broadcasts the disable wireless signal and may be indicated with a counter variable stored and modified by the wireless identity transmitter. If the wireless identity transmitter determines that the disable wireless signal propagation time period has not expired (i.e., determination block 3006=“No”), the wireless identity transmitter may continue with the operations in block 3002.

However, if the wireless identity transmitter determines that the disable wireless signal propagation time period has expired (i.e., determination block 3006=“Yes”), in optional block 2906, the wireless identity transmitter may disable a transmitter, such as a transmitter circuitry or transmitter module in response to receiving the disable wireless signal. In block 2908 the wireless identity transmitter may activate the airplane mode. In block 564′, the wireless identity transmitter may listen for incoming messages and in determination block 2718 may determine whether an enable wireless signal is received. If an enable wireless signal is not received (i.e., determination block 2718=“No”), the wireless identity transmitter may continue with the operations in block 564′. If the wireless identity transmitter determines that an enable wireless signal is received (i.e., determination block 2718=“Yes”), in optional block 2910, the wireless identity transmitter may re-enable its transmitter, such as a transmitter circuitry or transmitter module, in response to receiving the enable wireless signal. In optional block 2912 the wireless identity transmitter may broadcast a reactivated signal, such as in response to the transmitter being re-enabled.

In block 3008, the wireless identity transmitter may broadcast an enable wireless signal, for instance the enable wireless signal determined to be received in the operations in determination block 2718. In an embodiment, the wireless identity transmitter may store the received enable wireless signal and may broadcast the signal exactly as it was received. Alternatively, the wireless identity transmitter may append additional information as described above with reference to the received disable wireless signal. For example, the wireless identity transmitter may append the wireless identity transmitter's identification, timestamp information, information that indicates the enable wireless signal is being broadcast by a receiving wireless identity transmitter as opposed to an activation signaling transmitter, a counter indicator that indicates the number of devices that have propagated the enable wireless signal, and/or a time-to-live indication.

In optional block 3004′, the wireless identity transmitter may wait a period. For example, the wireless identity transmitter may wait a predefined number of milliseconds, seconds, or minutes. In determination block 3010, the wireless identity transmitter may determine whether an enable wireless signal propagation time period (referred to in FIG. 30 as the “ETX propagation time period”) has expired. In particular, the wireless identity transmitter may be configured to only broadcast the enable wireless signal for a predefined period. For example, after receiving the enable wireless signal, the wireless identity transmitter may only broadcast the enable wireless signal for a few seconds. In an embodiment, the enable wireless signal propagation time period may be defined by the number of times the wireless identity transmitter broadcasts the enable wireless signal and may be indicated with a counter variable stored and modified by the wireless identity transmitter. If the wireless identity transmitter determines that the enable wireless signal propagation time period has not expired (i.e., determination block 3010=“No”), the wireless identity transmitter may continue with the operations in block 3008. However, if the wireless identity transmitter determines that the enable wireless signal propagation time period has expired (i.e., determination block 3010=“Yes”), the wireless identity transmitter may continue with the operations in block 2902. In other words, if an enable wireless signal is received, the wireless identity transmitter may again operate in the deactivated airplane mode.

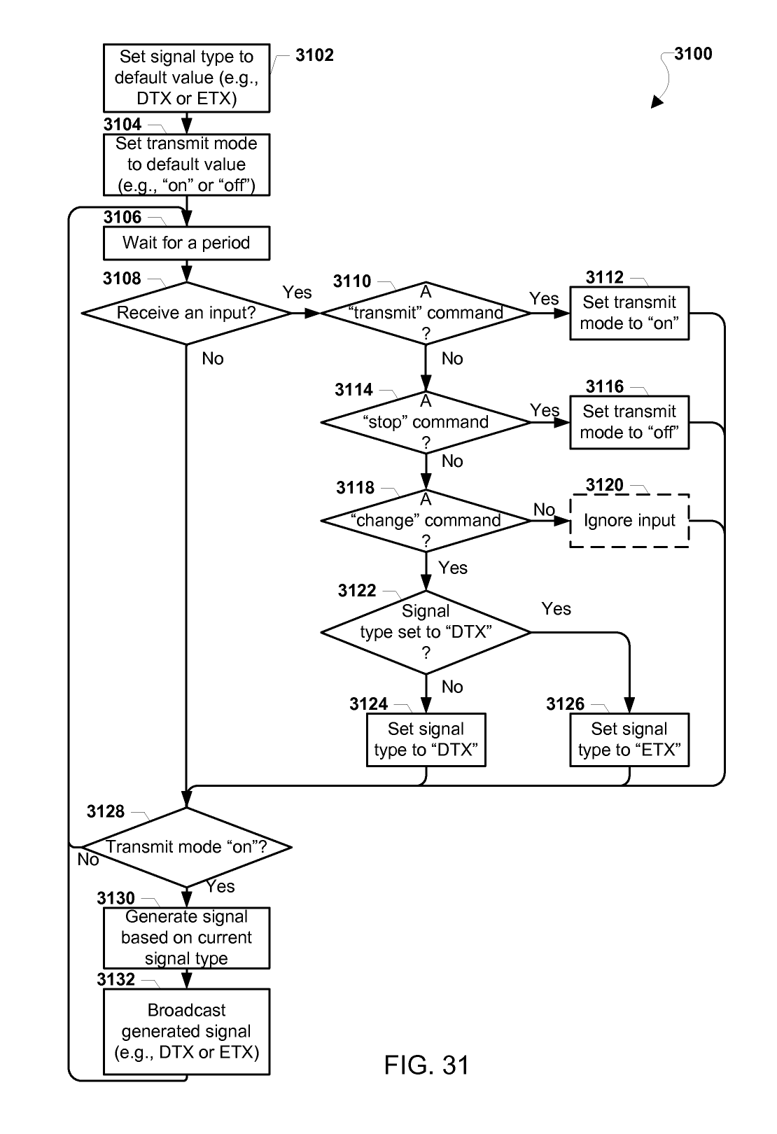

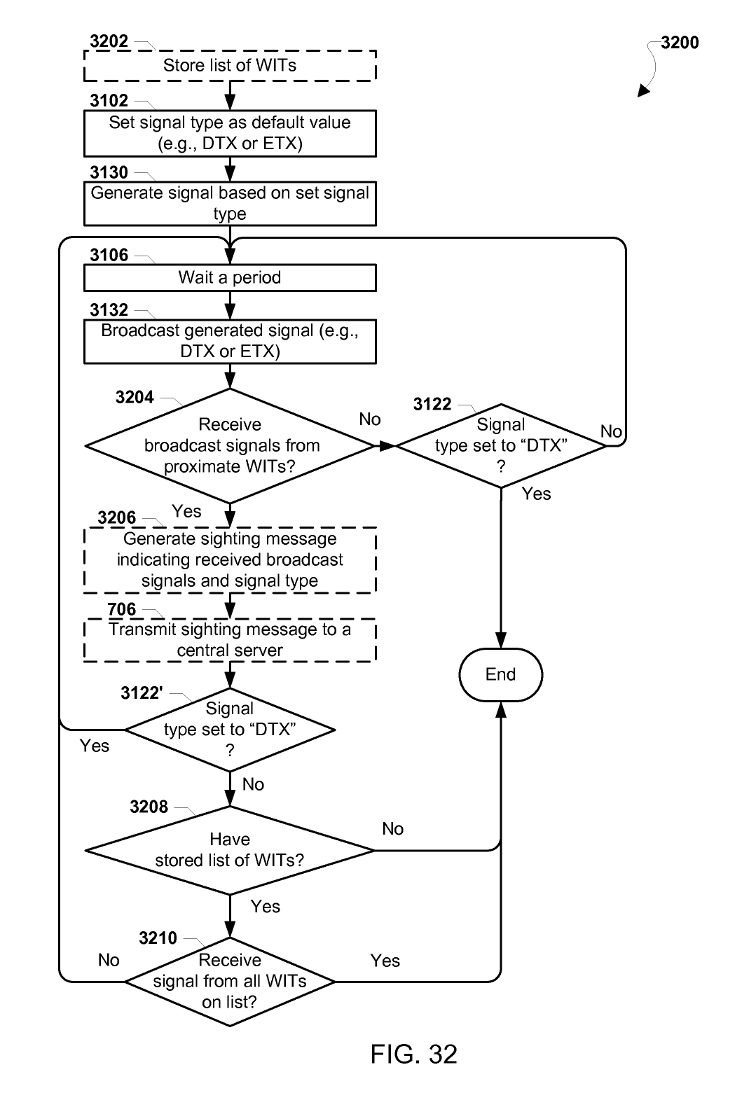

FIGS. 31-32 describe methods 3100, 3200 to be performed by a signaling transmitter. The term “signaling transmitter” refers to a device that is configured to transmit disable wireless signals and/or enable wireless signals. Signaling transmitters may include deactivation signaling transmitters, activation signaling transmitters, and proximity broadcast receivers configured to operate as deactivation and/or activation signaling transmitters. For example, the signaling transmitter may be a smartphone executing software that enables reception of broadcast messages from wireless identity transmitters as well as transmission of disable and/or enable wireless signals.

Further, a signaling transmitter that is configured to operate as a deactivation signaling transmitter, an activation signaling transmitter, or both may store a “signal type” variable, such as a stored system variable or bit, that defines the type of signal that may be broadcast for receipt by proximate wireless identity transmitters. In particular, the “signal type” variable may be set to indicate whether the signaling transmitter broadcasts a disable wireless signal (i.e., the “signal type” variable is set to “DTX”) or an enable wireless signal (i.e., the “signal type” variable is set to “ETX”).

FIG. 31 illustrates an embodiment method 3100 for a signaling transmitter to broadcast disable wireless signals and/or enable wireless signals in response to receiving an input. In addition to storing a signal type variable as described above, the signaling transmitter may store a transmit mode variable, bit, or flag that indicates whether the signaling transmitter is configured to transmit wireless signals at a given time. For example, when the transmit mode variable is set to “off”, the signaling transmitter may not broadcast any disable wireless signals or enable wireless signals for receipt by proximate wireless identity transmitters.

The behavior or operations performed by the signaling transmitter, such as broadcasting disable wireless signals, may be configured in response to receiving various inputs. For example, in response to receiving a particular input, the signaling transmitter may start or stop broadcasting a wireless signal. Inputs may include user inputs (e.g., buttons presses), trigger signals from other devices, and/or sensor data, such as data from an altimeter or accelerometer sensor unit within or coupled to a deactivation signaling transmitter. Received inputs may be associated with various commands for modifying the signaling transmitter's operations. The following descriptions of exemplary commands should be considered non-limiting illustrations of how the signaling transmitter may execute circuitry, software, or other operations to be configured to transmit various signals based on inputs.

In an embodiment, an input may correspond to a “transmit” command that may cause the signaling transmitter to set the transmit mode variable to “on” or “off,” thereby enabling or disabling broadcasting by the signaling transmitter, respectively. Another input may correspond to a “stop” command that may cause the signaling transmitter to stop broadcasting signals. For example, the “stop” command may cause the signaling transmitter to set the “transmit mode” variable to “off.” Another input may correspond to a “change” command that may cause the signaling transmitter to set the “signal type” variable to another value. For example, when the “signal type” variable is set to the disable wireless signal (referred to as “DTX” in FIG. 31) and the signaling transmitter receives an input that corresponds to the “change” command, the signaling transmitter may set the “signal type” variable to the enable wireless signal (referred to as “ETX” in FIG. 31). In this manner, the signaling transmitter may be configured to broadcast either disable or enable wireless signals based on inputs. For example, an airport employee may flip a switch on the signaling transmitter that may cause an input corresponding to the “change” command.

In block 3102, the signaling transmitter may set the signal type to a default value. In an embodiment, the default value may represent the disable wireless signal (i.e., “DTX”) or the enable wireless signal (i.e., “ETX”) and may be based on the current role the signaling transmitter is serving. For example, if located within a baggage claim area, the signaling transmitter may have a signal type default value of “ETX” to enable the signaling transmitter to broadcast enable wireless signals to wireless identity transmitters within proximity. In block 3104, the signaling transmitter may set the transmit mode to a default value. For example, the signaling transmitter default setting may be “off” such that is does not transmit disable or enable wireless signals until the transmit mode is changed (i.e., activated) via an input. The default mode may be set when the signaling transmitter is activated, booted-up, or restarted.

In block 3106, the signaling transmitter may wait for a period. In an embodiment, the period may be a time period greater than a time period that wireless identity transmitters are known to sleep (e.g., a duration for a sleep cycle). This period may be important to ensure that all proximate wireless identity transmitters can receive signals transmitted by the signaling transmitter. In determination block 3108, the signaling transmitter may determine whether an input is received. For example, the signaling transmitter may determine whether it receives an input from a user (e.g., a button press on the transmitter), sensor data from sensors within the signaling transmitter (e.g., pressure sensor data from a pressure sensor), and/or wireless signals (e.g., a trigger signal transmitted via a WiFi connection). As another example, the signaling transmitter may determine whether a ‘start’ button has been pressed, accelerometer sensor data has been detected, altimeter sensor data has been detected, or a command signal from a central server has been received via a cellular modem.

If an input is received (i.e., determination block 3108=“Yes”), in determination block 3110, the signaling transmitter may determine whether the input corresponds to a “transmit” command. For example, the signaling transmitter may compare the input to a list of known commands to identify a match with the “transmit” command. For example, a signaling transmitter in an aircraft may determine whether sensor data has been received from an accelerometer or altimeter that indicates the aircraft is taking off or has taken off, which would be interpreted as a signal to transmit a disable wireless signal. If an input is detected that corresponds to the “transmit” command” (i.e., determination block 3110=“Yes”), in block 3112 the signaling transmitter may set the transmit mode to “on”. In other words, the signaling transmitter may set a flag, system variable, or other stored data to indicate wireless signals may be transmitted by the signaling transmitter. If the detected input does not correspond to the “transmit” command” (i.e., determination block 3110=“No”), in determination block 3114 the signaling transmitter may determine whether the input corresponds to a “stop” command. In other words, the signaling transmitter may determine whether an input has been received that instructs the signaling transmitter to stop broadcasting. If the input corresponds to the “stop” command” (i.e., determination block 3114=“Yes”), in block 3116 the signaling transmitter may set the transmit mode to “off”. In other words, the signaling transmitter may set a flag, system variable, or other stored data to indicate wireless signals may not be transmitted by the signaling transmitter. If the input does not correspond to the “stop” command” (i.e., determination block 3114=“No”), in determination block 3118 the signaling transmitter may determine whether the input corresponds to a “change” command. If the input does not correspond to the “change” command” (i.e., determination block 3118=“No”), in optional block 3120 the signaling transmitter may ignore the input and continue with the operations in determination block 3128. For example, the signaling transmitter may be configured to only recognize the “transmit,” “stop,” and “change” commands corresponding to inputs.

If the input corresponds to the “change” command” (i.e., determination block 3118=“Yes”), in determination block 3122 the signaling transmitter may determine whether the signal type is set to the disable wireless signal (i.e., “DTX”), such as by checking the signal type variable, bit, or semaphore that is stored in the signaling transmitter to determine whether it indicates that disable wireless signals should be broadcast. If the signal type is set to the disable wireless signal (i.e., determination block 3122=“Yes”), in block 3126 the signaling transmitter may set the signal type to the enable wireless signal (i.e., “ETX”). In other words, in response to the “change” command, the signaling transmitter may be configured to change from broadcasting disable wireless signals to broadcasting enable wireless signals. The signaling transmitter may continue with the operations in determination block 3128. If the signal type is not set to the disable wireless signal (i.e., determination block 3122=“No”), in block 3124 the signaling transmitter may set the signal type to the disable wireless signal (or “DTX”). In other words, based on the “change” command, the signaling transmitter may be configured to change from broadcasting enable wireless signals to broadcasting disable wireless signals. The signaling transmitter may continue with the operations in determination block 3128.

If no input is received (i.e., determination block 3108=“No”) or after the signaling transmitter performs the operations in block 3124 or block 3126, in determination block 3128, the signaling transmitter may determine whether the transmit mode is “on.” In other words, the signaling transmitter may determine whether it is configured to broadcast signals by evaluating the value stored in a transmit mode variable. If the transmit mode is not “on” (i.e., determination block 3128=“No”), the signaling transmitter may be configured to not broadcast signals and may continue with the operations in block 3106. If the transmit mode is “on” (i.e., determination block 3128=“Yes”), in block 3130 the signaling transmitter may generate a signal based on the current signal type. For example, if the signal type variable is set to “ETX” the signaling transmitter may generate an enable wireless signal, and if the signal type variable is set to “DTX,” the signaling transmitter may generate a disable wireless signal. In block 3132, the signaling transmitter may broadcast the generated signal and may continue with the operations in block 3106.

FIG. 32 illustrates an embodiment method 3200 for a signaling transmitter re-broadcasting disable wireless signals and/or enable wireless signals based on receiving broadcast messages from proximate wireless identity transmitters. The method 3200 is similar to the method 3100 described above, except that the signaling transmitter may be configured to continue or discontinue broadcasting signals when wireless identity transmitters within proximity are not responding to the signaling transmitter's broadcasts as expected. For example, when the signaling transmitter broadcasts disable wireless signals, the signaling transmitter may expect proximate wireless identity transmitters to discontinue transmitting broadcast messages that include encrypted identifiers. As another example, when the signaling transmitter broadcasts enable wireless signals, the signaling transmitter may expect all proximate wireless identity transmitters to start broadcasting messages. Because the signaling transmitter's disable and/or enable wireless signals may not be received by proximate wireless identity transmitters, the signaling transmitter may periodically monitor for signals from wireless identity transmitters to determine whether they are broadcasting as expected, and may re-broadcast or continue broadcasting the enable and/or disable wireless signals as long as wireless identity transmitters are not behaving as expected.

In optional block 3202, the signaling transmitter may store a list of wireless identity transmitters (referred to as “WITs” in FIG. 32). In an embodiment, the signaling transmitter may receive a list of wireless identity transmitters in a transmission from a central server and/or from user input (e.g., data loaded onto the signaling transmitter from an airport employee). For example, a flight attendant and/or a baggage handler may input a list of wireless identity transmitters that correspond to the passengers and/or luggage on a particular flight. This list may be used to determine when broadcast messages have been received from all wireless identity transmitters on an aircraft or within a known or controlled area. In various embodiments, the stored list may include obscured or otherwise anonymous indicators of wireless identity transmitters. For example, the stored list may include rolling identifiers or other data that is encrypted, encoded, or obscured such that users associated with the various wireless identity transmitters may not be identified.

In block 3102, the signaling transmitter may set the signal type to a default value. For example the default value may indicate whether the signaling transmitter may broadcast disable wireless signals, such as by setting the signal type variable represent the disable wireless signal (i.e., “DTX”) or to the enable wireless signal (i.e., “ETX”). In block 3130, the signaling transmitter may generate a signal based on the current signal type. For example, the signaling transmitter may generate a disable wireless signal or an enable wireless signal based on the current value of the signal type variable. In block 3106, the signaling transmitter may wait a period, and in block 3132, the signaling transmitter may broadcast the generated signal, such as the enable wireless signal or the disable wireless signal.

In determination block 3204, the signaling transmitter may determine whether broadcast signals from proximate wireless identity transmitters are received. For example, the signaling transmitter may check a message receiving circuit, buffer, or queue that indicates whether a short-range wireless signal, such as a broadcast message, has been received from a proximate wireless identity transmitter. If no broadcast signals are received (i.e., determination block 3204=“No”), in determination block 3122 the signaling transmitter may determine whether the signal type is set to the disable wireless signal (i.e., “DTX”) In other words, the signaling transmitter may determine whether disable wireless signals were broadcast with the operations in block 3132. If the signal type is set to the disable wireless signal (i.e., determination block 3122=“Yes”), the signaling transmitter may expect no signals to have been received and may end its operations. However, if the signal type is not set to the disable wireless signal (i.e., determination block 5422=“No”), the signaling transmitter may expect to receive signals as enable wireless signals have been broadcast by the signaling transmitter, and thus may continue with the operations in block 3106. For example, the signaling transmitter may wait a period and re-broadcast an enable wireless signal.

If broadcast signals are received (i.e., determination block 3204=“Yes”), in optional block 3206 the signaling transmitter may generate sighting messages indicating the received broadcast signals and signal type. In other words, the signaling transmitter may be configured to operate as a proximity broadcast receiver and may relay received broadcast message from wireless identity transmitters along with relevant information at the time of the receipt. For example, the signaling transmitter may generate sighting messages that include the received signals from the wireless identity transmitters, the current values of the signal type variable (e.g., “DTX” or “ETX”), location information about the signaling transmitter, and timestamp information. In optional block 706, the signaling transmitter may transmit the sighting messages to a central server. As described above, the central server may be configured to store, process, evaluate, and transmit other messages in response to receiving the sighting messages. For example, the central server may transmit messages, such as emails, SMS messages, or telephonic phone calls to luggage owners indicating that their related wireless identity transmitters are within proximity of the signaling transmitter that is currently broadcasting disable or enable wireless signals. In an embodiment, the sighting messages may indicate that the signaling transmitter received deactivating signals or reactivated signals as described above.

In determination block 3122′, the signaling transmitter may determine whether the signal type is set to the disable wireless signal (i.e., “DTX”). If the signal type is set to disable wireless signal (i.e., determination block 5422′=“Yes”), the signaling transmitter may expect no signals to be received and may continue with the operations in block 3106. In other words, when signals from proximate wireless identity transmitters are received, the signaling transmitter may continue to broadcast disable wireless signals. However, if the signal type is not set to the disable wireless signal (i.e., determination block 5422′=“No”), in determination block 3208 the signaling transmitter may determine whether it has a stored list of wireless identity transmitters. In other words, the signaling transmitter may determine whether a list is stored in memory that can be used to determine whether all expected broadcast signals have been received from wireless identity transmitters. If there is no stored device list (i.e., determination block 3208=“No”), the signaling transmitter may end the method 3200, as at least a signal has been received after the signaling transmitter broadcast enable wireless signals. However, if there is a stored list (i.e., determination block 3208=“Yes”), in determination block 3210 the signaling transmitter may determine whether broadcast signals have been received from all wireless identity transmitters on the list. In other words, because the signaling transmitter has a stored list, the signaling transmitter may keep track of the wireless identity transmitters that should broadcast signals. The comparisons of the received signals and the stored list may be important to conduct “roll calls” and determine whether wireless identity transmitters are missing. For example, the signaling transmitter may determine whether luggage is missing from an airplane when the luggage's associated wireless identity transmitter does not broadcast a signal in response to the signaling transmitter broadcasting an enable wireless signal. If the signaling transmitter has received a signal from all wireless transmitting devices on the list (i.e., determination block 3210=“Yes”), the signaling transmitter may end the operations of the method 3200. If the signaling transmitter has not received a signal from all wireless transmitting devices on the list (i.e., determination block 3210=“No”), the signaling transmitter may continue with the operations in block 3106 to continue broadcasting enable wireless signals until every wireless identity transmitter on the stored list begins to broadcast signals. In an embodiment, the signaling transmitter may keep track of whether deactivating signals and/or reactivated signals are received from wireless identity transmitters on the stored list. Additionally, the signaling transmitter may transmit messages to the central server to report whether all expected reactivated signals and/or deactivating signals are received from all wireless identity transmitters on the list.

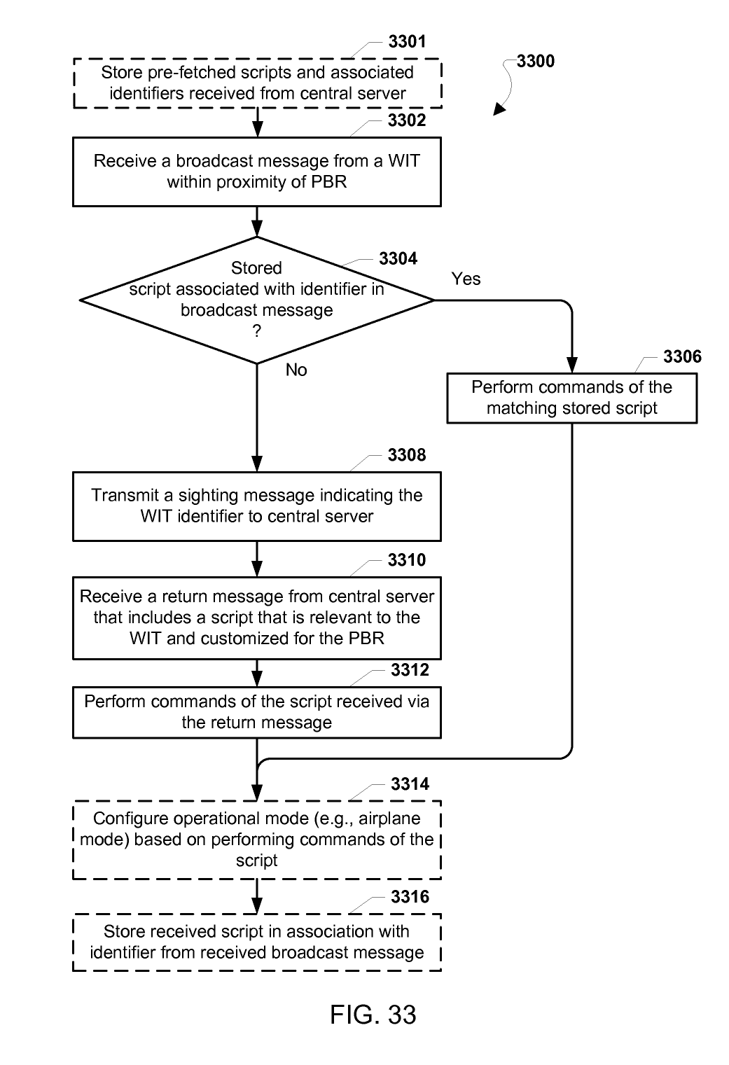

FIG. 33 illustrates an embodiment method 3300 for a proximity broadcast receiver performing scripts in response to receiving broadcast messages from a proximate wireless identity transmitter. The method 3300 is similar to the method 1000 described above with reference to FIG. 10, except the method 3300 includes operations to perform various scripts that are customized by a central server based on stored profile information related to the proximity broadcast receiver. In particular, the proximity broadcast receiver may receive scripts that include commands, actions, routines, and/or instructions that may control the behavior of the proximity broadcast receiver (e.g., a smartphone implementing a PRB application) and that may be performed in response to receiving a message from a certain wireless identity transmitter. For example, a particular script that causes a proximity broadcast receiver to deactivate a long-range transmitter for a period of time (i.e., operate in an activated airplane mode) may be performed by the proximity broadcast receiver when within broadcast range of a wireless identity transmitter within an airport terminal. As another example, the proximity broadcast receiver may perform a script that lowers the volume on the device's speaker or places the device in “silent” mode in response to receiving a broadcast message from a wireless identity transmitter within a concert hall. A wide variety of behaviors and mode-changing operations may be implemented by such scripts under the control of the trusted central server. Being managed by the central server, the implemented scripts may be tailored to the specific user and/or proximity broadcast receiver (e.g., user's smartphone), and triggered by receipt of proximity signal, the implemented scripts are user/device location. Thus, the embodiment system and methods enables implementation of user/device-location specific action or operating modes.

As described above, an embodiment proximity broadcast receiver may be a mobile device (e.g., a smartphone) that is configured to operate as a proximity broadcast receiver and/or an identity transceiver my way of an application executing on the device's processor. For example, a smartphone device may be configured with an application to utilize a Bluetooth LE radio to receive broadcast messages from nearby wireless identity transmitters, and perform the operations of transmitting sighting reports to the central server as described above. In another embodiment, the proximity broadcast receiver may also, or alternatively, be configured to operate as an identity transceiver by transmitting broadcast messages that include a unique rolling identifier generated as described above. In various embodiments, wireless identity transmitters may be identity transceivers, signaling transmitters, or any other devices registered with the central server and configured to transmit broadcast short-range messages that include obscured identifiers for receipt by nearby proximity broadcast receivers.

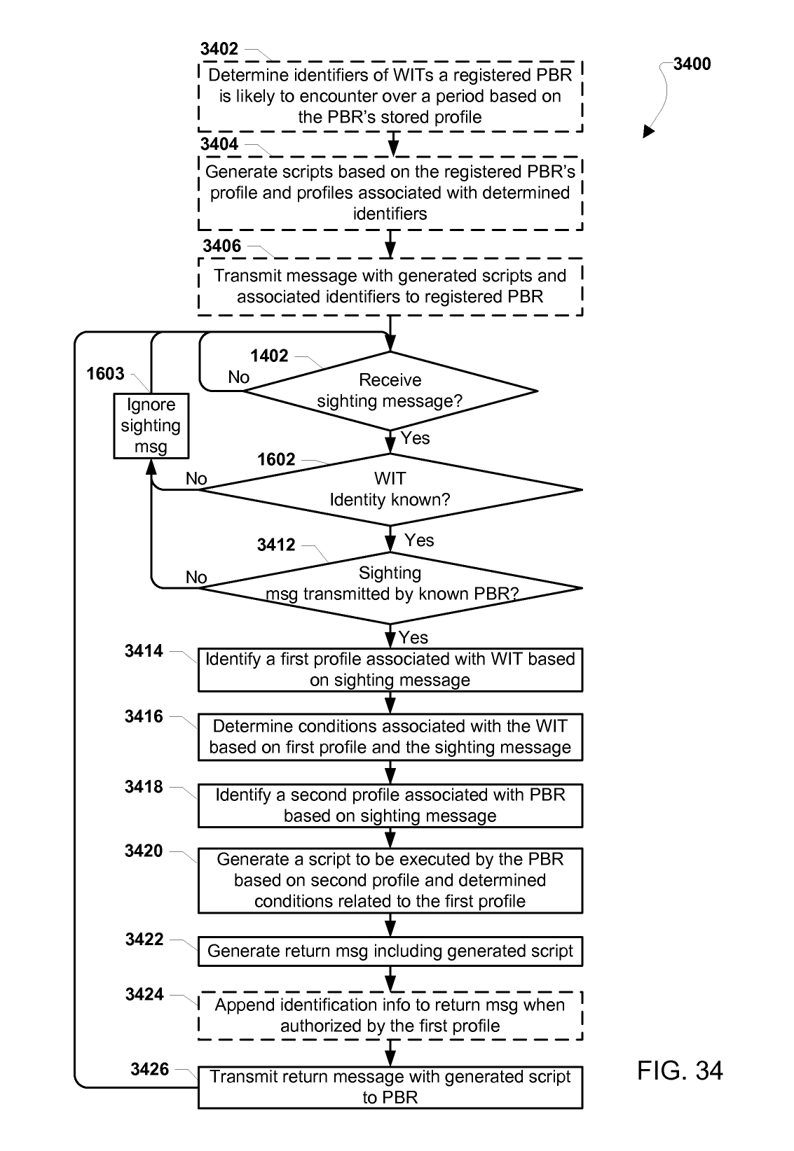

In optional block 3301, the proximity broadcast receiver may store pre-fetched scripts and associated identifiers received from a central server. For example, the proximity broadcast receiver may store the pre-fetched scripts in a database in relation to associated identifiers. As described below with reference to FIG. 34, the central server may periodically evaluate stored profile information associated with proximity broadcast receiver, generate scripts that are likely be needed by the proximity broadcast receiver based on the profile information, and transmit (or “push”) the scripts to the proximity broadcast receiver. For example, the pre-fetched scripts may be related to the airports, retail stores, residences, and other places the user of the proximity broadcast receiver frequently visits. Further, the associated identifiers may be the identifiers of wireless identity transmitters associated with the places the user and/or the proximity broadcast receiver are likely to be near. For example, the proximity broadcast receiver may receive the identifier of a wireless identity transmitter located within an airport the user of the proximity broadcast receiver travels to each week. Thus, by receiving and storing the pre-fetched scripts and associated identifiers, the proximity broadcast receiver may avoid expending additional energy communicating with the central server (i.e., downloading scripts) when receiving broadcast messages from wireless identity transmitters that are frequently encountered by the proximity broadcast receiver. In an embodiment, the associated identifiers may or may not be encrypted, encoded, or otherwise obscured.

In block 3302, the proximity broadcast receiver may receive a broadcast message from a wireless identity transmitter within proximity of the proximity broadcast receiver. As described above, the broadcast message may be a short-range wireless signal that includes obscured information, such as a rolling identifier of the wireless identity transmitter. In an embodiment, the received broadcast message may include a flag, metadata, bit, code, or other data that indicates the broadcast message may correspond to an important condition. For example, the broadcast message may include a flag that indicates the proximity broadcast receiver is within an area that may have special behavioral/operating mode constraints and thus should contact a central server to download a script. In an embodiment, a proximity broadcast receiver receiving a short-range wireless signal that includes obscured identifier that the receiver cannot decode (which would not match a cached identifier) may transmit the obscured identifier to the central server in a sighting message, and standby for a response from the server, which may include an executable script.

In determination block 3304, the proximity broadcast receiver may determine whether there is a stored script that is associated with the identifier in the broadcast message. For example, the proximity broadcast receiver may identify a rolling identifier within the received broadcast message and may compare that rolling identifier to the stored identifiers that are associated with pre-fetched scripts. Stored scripts may include pre-fetched scripts received periodically from the central server and/or scripts received from the central server in response to transmitting a sighting message, as described below. If there is a stored script that is associated with the identifier in the broadcast message (i.e., determination block 3304=“Yes”), in block 3306 the proximity broadcast receiver may execute (i.e., perform commands of) the matching stored script. For example, the proximity broadcast receiver may execute a set of operations defined within the matching pre-fetched script that cause the proximity broadcast receiver to operate in an airplane mode (i.e., with all radios powered off) for a certain period of time. As another example, the proximity broadcast receiver may execute a set of commands that disable components within the proximity broadcast receiver, such as a speaker, ringers/ringtones, a camera and/or a microphone. The proximity broadcast receiver may continue with the operations in optional block 3314 described below.

However, if no stored script is associated with the identifier of the broadcast message (i.e., determination block 3304=“No”), in block 3308 the proximity broadcast receiver may transmit a sighting message indicating the received wireless identity transmitter identifier to the central server. For example, the proximity broadcast receiver may utilize a long-range transceiver to transmit a sighting message via a cellular network. As described throughout the disclosure, the sighting message may contain information from the received broadcast message (e.g., an obscured or rolling identifier of the wireless identity transmitter), as well as associated data, such as identification information of the proximity broadcast receiver (e.g., a unique PBR identifier), the time of receipt of the broadcast message, and location information (e.g., GPS coordinates) of the proximity broadcast receiver at the time of receiving the broadcast message. In block 3310, the proximity broadcast receiver may receive a return message from the central server that includes a script, such as a set of commands, that is relevant to the wireless identity transmitter (or relevant to the proximity of the wireless identity transmitter) and customized for the proximity broadcast receiver. In other words, the received script may include commands that cause the proximity broadcast receiver to operate in a particular manner when within proximity of the wireless identity transmitter indicated in the received broadcast message. For example, the script may include commands that cause the proximity broadcast receiver to operate in an activated airplane mode for a number of minutes based on historical activity stored within the central server. As another example, the script may include commands that cause a smartphone implementing a proximity broadcast receiver application to operate in silent mode while receiving the identifier messages or for predefined windows of time, such as during movie showing times or performances in a server, with those time periods identified by the central server. Such customized scripts are described below with reference to FIG. 34.

In block 3312, the proximity broadcast receiver may perform the commands of the script received via the return message. For example, the proximity broadcast receiver may utilize its processor to execute operations defined within the script for activating or deactivating components (e.g., camera, microphone, GPS receiver, short-range radio, etc.). In an embodiment, the received script may indicate a time for the proximity broadcast receiver to begin and/or end the execution of the script's commands. For example, the received script may include variables, codes, flags, or other indicators that instruct the proximity broadcast receiver to schedule the execution of the script for a certain time of day, day of the week, etc. In another embodiment, the script may include commands that instruct the proximity broadcast receiver to download updated scripts based on certain conditions, such as certain GPS coordinates, time of day, duration, etc. For example, the script may include commands that instruct the proximity broadcast receiver to request a new script from the central server after a period of time has elapsed.

In optional block 3314, the proximity broadcast receiver may configure an operational mode, such as an airplane mode, concert mode or school mode, based on performing the commands of the script. In particular, in response to executing or otherwise performing commands, operations, and/or routines defined within the script, the proximity broadcast receiver may activate various modes of operation. For example, based on performing the script, the proximity broadcast receiver may activate (or deactivate) an airplane mode in which the proximity broadcast receiver may not receive or transmit wireless transmissions, a silent mode in which the proximity broadcast receiver may not utilize speakers to emit sounds, and a vibrate mode in which a motor may be utilized by the proximity broadcast receiver for rendering notifications. In other embodiments, the operational mode may be a continuous schedule of behaviors, such as the periodic performance of an action (e.g., transmit a message to the central server, monitor an incoming transmissions buffer, broadcast a signal, etc.).

In optional block 3316, the proximity broadcast receiver may store the received script in association with the identifier from the received broadcast message. For example, the proximity broadcast receiver may store the received script and the identifier from the broadcast message in a relational database. Storing the received script for future use may be similar to the operations described above with reference to optional block 3301 and may be important to increase the proximity broadcast receiver's efficiency by avoiding subsequent unnecessary transmissions to the central server. In various embodiments, the proximity broadcast receiver may not receive an identifier within the received script, based on privacy settings or other preferences stored in the central server. In such an embodiment, the proximity broadcast receiver may store the received script and may associate the received script with other known information other than the identifier, such as a timestamp, GPS coordinates, or other circumstantial information.

FIG. 34 illustrates an embodiment method 3400 for a central server transmitting scripts to a proximity broadcast receiver in response to receiving sighting messages indicating wireless identity transmitter identifiers. As described above with reference to FIG. 33, a proximity broadcast receiver may transmit sighting messages to the central server in response to receiving broadcast messages from nearby wireless identity transmitters. For example, a smartphone configured to operate as a proximity broadcast receiver may transmit a sighting message when receiving a broadcast message from a wireless identity transmitter within an airport terminal, a movie theatre, concert hall, school, etc. In response to receiving these sighting messages, the central server may generate scripts that include action lists, command flows, or routines that are relevant to the wireless identity transmitter and/or the conditions related to receiving the wireless identity transmitter's broadcast message. In other words, the central server may act as a trustworthy source of commands that guide the behavior of the proximity broadcast receiver. For example, the central server may generate scripts that configure the proximity broadcast receiver to operate in an airplane mode when the sighting message indicates the proximity broadcast receiver is within an aircraft that has taken off. As another example, the central server may generate scripts that configure the proximity broadcast receiver to operate in silent mode when the sighting message indicates the proximity broadcast receiver is within a movie theater, the current time matches when a movie is being shown, and the user's profile indicates the user is not a policeman (for example). Further, since such scripts may be delivered to the proximity broadcast receiver via secure communications from the trusted central server, third-parties may not nefariously control or hijack the proximity broadcast receiver.

The scripts delivered to each proximity broadcast receiver may be tailored to the particular user such that all users and/or devices registered with the central server may not be configured to behave in the same way when within proximity of a wireless identity transmitter. For example, certain users may never want certain software, routines, or actions to be executed on their proximity broadcast receivers. Thus, the central server may also utilize stored profiles (or profile information) associated with the proximity broadcast receivers when selecting or generating scripts to be sent to a reporting proximity broadcast receiver. For example, based on stored profile information that identifies an operating system of a user's proximity broadcast receiver, the central server may generate a script that only includes API commands known by that operating system. As another example, based on user preferences within a user's stored profile that indicate the user's desire to maintain a long battery life, the central server may generate a script that includes commands for activating an airplane mode that lasts for a longer period of time than if the user did not value a long battery life. In this way, the central server may generate customized scripts (i.e., different sets of commands) for various proximity broadcast receivers within proximity of the same wireless identity transmitter. In various embodiments, the method 3400 may be executed by the central server in combination with a proximity broadcast receiver performing the method 3300 described above.

In optional blocks 3402-3406, the central server may generate scripts to be pushed to a proximity broadcast receiver that is registered with the central server. In other words, the central server may perform optional blocks 3402-3406 to generate and transmit the pre-fetched scripts described above with reference to FIG. 33. In an embodiment, the operations in optional blocks 3402-3406 may be performed by the central server for all devices and/or users registered with the central server. For example, the central server may generate and transmit scripts for all proximity broadcast receivers that are associated with users having profiles stored by the central server. In an embodiment, the operations in optional blocks 3402-3406 may be performed periodically, such as once every hour, day, week, or month.

In optional block 3402, the central server may determine identifiers of wireless identity transmitters a registered proximity broadcast receiver is likely to encounter over a period based on the proximity broadcast receiver's stored profile. In various embodiments, the central server may create and store profiles for users, services, businesses, and various entities when they register with the central server, such as via a web registration process. Such profiles may contain personal information, descriptive information about registered parties (e.g., age, business type, demographics, etc.), and information indicating the area associated with the registered parties and/or related devices (e.g., located in a certain state, wireless identity transmitters within a certain building, etc.). Profiles may further contain stored data related to registered parties activities, such as previous location data over a period (e.g., GPS coordinates over a day, week, month, etc.).

Returning to FIG. 34, the central server may evaluate stored profile data associated with the registered proximity broadcast receiver (or its associated user), such as historical location data over a period, and may determine identifiers of wireless identity transmitters that are associated with places, trends, and/or conditions related to the stored data. For example, the central server may evaluate stored GPS locations of the registered proximity broadcast receiver that are stored within a profile to identify that on certain mornings the registered proximity broadcast receiver (or its user) is typically near a particular wireless identity transmitter within an airport. Alternatively, the central server may determine the identifiers based on stored lists of wireless identity transmitters the registered proximity broadcast receiver has been within proximity of over a period.

In optional block 3404, the central server may generate scripts based on the registered proximity broadcast receiver's profile and the profiles associated with the determined identifiers. The central server may use the determined identifiers to identify stored profiles associated with the wireless identity transmitters, and based on data within such profiles may determine the related services, locations, facilities, functionalities, and conditions associated with the wireless identity transmitters. For example, based on a stored profile associated with a wireless identity transmitter within an aircraft, the central server may determine that wireless transmissions are not allowed within proximity of the wireless identity transmitter. The central server may use such profile information to generate commands that may cause the registered proximity broadcast receiver to behave or operate in a manner appropriate for the corresponding identifiers. For example, the central server may generate a script with commands for the registered broadcast receiver to activate an airplane mode when in proximity of the wireless identity transmitter within the aircraft. In an embodiment, the central server may generate a script for each determined identifier. For example, a separate script may be generated to correspond to conditions associated with each individual wireless identity transmitter identifier the central server has determined the registered proximity broadcast receiver is likely to encounter over the next day.

The central server may also utilize the stored profile associated with the registered proximity broadcast receiver (i.e., a user profile) to generate commands, actions, and/or routines within the scripts. In particular, using the stored profile associated with the registered proximity broadcast receiver, the central server may identify characteristics of the corresponding user, such as an occupation, preferences, and other data, that may be used to augment, modify, or operations of the registered proximity broadcast receiver when executing the scripts. For example, the central server may identify that the registered proximity broadcast receiver is associated with a sky marshal, and thus may not generate scripts that include commands that disable the registered proximity broadcast receiver's long-range transceiver. In an embodiment, the operations in optional block 3404 may be similar to the operations in blocks 3414-3420 described below.

In optional block 3406, the central server may transmit a message with the generated scripts and associated identifiers to the registered proximity broadcast receiver. For example, the message may initiate or push a download of the scripts and associated rolling identifiers to the registered proximity broadcast receiver via a cellular network. In various embodiments, the message may or may not be transmitted to the registered proximity broadcast receiver based on privacy preferences (or preference information) stored within the profiles associated with the identifiers. For example, an identifier and associated script may not be transmitted to the registered broadcast receiver when the profile linked to the identifier indicates that no identifying information may be distributed by the central server.

In determination block 1402, the central server may determine whether a sighting message is received. As described above, the sighting message may include an obscured or rolling identifier of a wireless identity transmitter as well as associated data (e.g., proximity broadcast receiver identification information, timestamp data, location information, etc.). If no sighting message is received (i.e., determination block 1402=“No”), the central server may continue with the operations in determination block 1402. If a sighting message is received (i.e., determination block 1402=“Yes”), in determination block 1602 the central server may determine whether the wireless identity transmitter identity is known. In other words, the central server may perform the operations in block 1404-1410 as described above with reference to FIG. 14A in order to evaluate, decode, decrypt, and otherwise access the data within the received sighting message to determine whether it includes a wireless identity transmitter identity (or identifier) that is associated with a user, business, service, or other entity registered with the central server. For example, using an algorithm shared with a wireless identity transmitter, the central server may decrypt a rolling identifier within the received sighting message to identify a device identifier of the wireless identity transmitter and may match that identifier to data within a stored profile of a registered user. As another example, the central server may decrypt a rolling identifier within the received sighting message to identify a wireless identity transmitter identifier that is known to be associated with an airport registered with the central server.

If the wireless identity transmitter is not known (i.e., determination block 1602=“No”), in block 1603 the central server may ignore the sighting message and continue to perform the operations in determination block 1402. If the wireless identity transmitter is known (i.e., determination block 1602=“Yes”), in determination block 3412 the central server may determine whether the sighting message was transmitted by a known proximity broadcast receiver. In other words, the central server may obtain the identity of the proximity broadcast receiver indicated within the sighting message and compare the identity to lists of registered devices and/or users in order to determine whether the proximity broadcast receiver is known to the central server (i.e., whether the PBR is authentic or valid). If the proximity broadcast receiver that transmitted the sighting message is not known (i.e., determination block 3412=“No”), the central server may continue with the operations in block 1603. However, if the proximity broadcast receiver that transmitted the sighting message is known (i.e., determination block 3412=“Yes”), in block 3414 the central server may identify a first profile associated with the wireless identity transmitter based on the sighting message. In other words, the central server may match the wireless identity transmitter's identifier indicated within the sighting message to a profile linked to a registered service, user, or other entity that is registered with the central server. For example, the profile may be associated with a retail store, an airport, or a governmental entity.

In block 3416, the central server may determine conditions associated with the wireless identity transmitter based on the first profile and the sighting message. In other words, the central server may evaluate the first profile to determine characteristics of the place near the proximity broadcast receiver (i.e., the area near the wireless identity transmitter) that may require the proximity broadcast receiver to behave in a particular manner. For example, when the profile associated with the wireless identity transmitter indicates the wireless identity transmitter is located within an aircraft, the central server may determine that proximity broadcast receivers within proximity of the wireless identity transmitter may need to operate in airplane mode when the aircraft takes off. As another example, if the wireless identity transmitter is within a retail store that offers free WiFi, the central server may determine that nearby proximity broadcast receivers may activate WiFi radios in order to benefit from free Internet coverage. The central server may also utilize timestamp information, location information, or other data represented within the sighting message to further determine conditions relevant to the first profile. For example, based on the timestamp indicated in the sighting message, the central server may determine that the proximity broadcast receiver is near an area that has a “no ringers” policy in place at that time of day.

The first profile associated with the wireless identity transmitter may also include indications of particular states or conditions of the place near the proximity broadcast receiver. For example, the first profile may include information that indicates whether the aircraft the wireless identity transmitter is within has landed, taken off, and/or has a certain estimated time of arrival or departure. As another example, the first profile may indicate that the wireless identity transmitter is associated with a theater that has an active show or, alternatively, a show that is currently in intermission. Such states may be configured and/or updated by the registered user or service linked to the first profile, or alternatively may change based on rule sets stored in association with the first profile. For example, the first profile may store a rule set that indicates an aircraft may only be in an “airborne” state between predefined hours on a predefined day of the week.

In another embodiment, the first profile may include recommendations for the behaviors or operational modes of proximity broadcast receivers, such as suggested ringer settings, wireless signaling settings, and power saving settings. For example, the first profile may include suggested ringer or wireless signaling settings for any smartphone within proximity. As another example, the first profile may suggest that nearby devices may deactivate GPS receivers to save power, as the wireless identity transmitter is within an underground structure.

In block 3418, the central server may identity a second profile associated with the proximity broadcast receiver based on the sighting message. Similar to the operations in block 3414, the central server may identify the second profile by matching the proximity broadcast receiver's identifier indicated within the sighting message to identifiers associated with registered users and/or devices. The second profile may be a registered user's profile that indicates the user's personal information, such as age, occupation, contact information, and preferences (e.g., the user always prefers to leave Bluetooth radios activated in his various proximity broadcast receivers). As an example, the second profile may include preference information that indicates the registered user associated with the proximity broadcast receiver always wants his/her devices to comply with power saving settings recommended by proximate wireless identity transmitters.

In block 3420, the central server may generate a script to be executed by the proximity broadcast receiver based on the second profile and the determined conditions related to the first profile. The central server may create rules, actions, and/or routines for the proximity broadcast receiver to perform in order to conform with or operate satisfactorily with the determined conditions. For example, when the determined conditions indicate the wireless identity transmitter is within an aircraft that has taken off, the central server may generate a script that includes commands for the proximity broadcast receiver to enter or activate an airplane mode and/or temporarily discontinue transmitting with wireless radios. As a further example, when the determined conditions indicate the wireless identity transmitter is within the aircraft, but the aircraft has landed, the central server may generate a script that includes commands for the proximity broadcast receiver to deactivate or exit the airplane mode. Thus, based on conditions determined from the first profile, the central server may generate different scripts for the proximity broadcast receiver is near the same wireless identity transmitter.

Additionally, the script may include commands that are informed by the data, characteristics, preferences, and/or other information indicated within the second profile. For example, when the second profile indicates the registered user associated with the proximity broadcast receiver is a policeman or “sky marshal,” the central server may generate a script that causes the proximity broadcast receiver to never disable communication functions (e.g., airplane mode may not be activated). Alternatively, when the second profile indicates the registered user is a regular citizen, the central server may generate a script that commands the proximity broadcast receiver to enter an airplane operating mode when within an airborne aircraft. As another example, when the second profile indicates the proximity broadcast receiver is associated with an employee of a theater, the central server may generate a script that only causes the proximity broadcast receiver to lower the volume on its speaker, whereas if the second profile indicated the proximity broadcast receiver is associated with a regular member of the public, the script may include commands to configured to proximity broadcast receiver to operate in a silent mode when within a theater having an active performance (e.g., play, orchestra, movie, etc.). The script may also include commands that are based on the proximity broadcast receiver's capabilities as defined within the second profile. For example, the script may only include commands to only disable a Zigbee radio instead of both a Zigbee radio and a WiFi radio when the second profile indicates the proximity broadcast receiver does not contain a Zigbee radio.

In block 3422, the central server may generate a return message including the generated script. In optional block 3424, the central server may append identification information, such as decrypted, decoded, or otherwise non-obscured identifiers, to the return message when authorized by the first profile. As described above, the first profile may include privacy settings and/or preferences that authorize the transmission of the identification information (i.e., permit or prohibit the sharing of profile data by the central server). For example, the first profile may be associated with a registered third-party that does not prefer to have identification information about the third-party known by any other party except the central server.

In block 3426, the central server may transmit the return message with the generated script to the proximity broadcast receiver. For example, the return message may be transmitted to the proximity broadcast receiver via Internet protocols. In various embodiments, the return message may include scheduling instructions and other conditions for executing the script. For example, the return message may include the duration for the proximity broadcast receiver to operate in an airplane mode, the frequency to query the central server for new scripts, and/or the time of day to begin executing the script. In an alternative embodiment, such scheduling instructions may be included within the commands of the script itself. The central server may continue with the operations in determination block 3408.

For the purposes of illustrating the operations of FIGS. 33-34: a user registered with a central server and carrying a smartphone configured to operate as a proximity broadcast receiver may walk into a concert hall at 1:15 PM. The concert hall may also be registered with the central server and may deploy a wireless identity transmitter at the entry to a performance area within the concert hall. When the smartphone is within proximity of the wireless identity transmitter, the smartphone may receive a short-range wireless broadcast message (e.g., a Bluetooth LE packet) that includes an obscured identifier of the wireless identity transmitter. The smartphone may in turn utilize a cellular network to transmit to the central server a sighting message that includes the received broadcast message (e.g., obscured identifier, other payload data, etc.) as well as a unique identifier of the smartphone and/or the smartphone's user, the GPS coordinates of the smartphone at the time of receiving the broadcast message, and the time the smartphone received the broadcast message. Upon receipt of the sighting message, the central server may perform operations to associate the wireless identity transmitter identifier with a stored profile of the concert hall and associate the smartphone with the user's stored profile. Based on the concert hall's profile, the central server may determine that an orchestra is scheduled to perform from 1:00 PM to 1:30 PM every day of the week, and that the concert hall requests that all electronic devices be silenced when within proximity of the performance area. The central server may then generate a script of commands that may be executed by the user's smartphone that may configure the smartphone to turn off its ringer if the smartphone is within a tolerance threshold of the GPS coordinates indicated in the sighting message and the current time is between 1:00 PM and 1:30 PM. Alternatively, based on the time of receipt of the broadcast message indicated in the sighting message (e.g., 1:15 PM), the central server may generate a script that simply instructs the smartphone to turn off its ringer for several minutes (e.g., fifteen minutes) and then query the central server for an updated script. The central server may transmit the script to the smartphone via secure communication protocols. The user's smartphone phone may receive and store the script, and may perform operations defined in the script to silence the smartphone during the scheduled shows.

As another illustration: a passenger train may deploy a first wireless identity transmitter in a first train car established for the congregation of passengers and a second wireless identity transmitter in a second train car established as a passenger rest area. The central server may store a profile for the train that indicates that the first train car has no limitations on electronic devices. However, the profile for the train may also indicate that the second train car forbids any communications or wireless transmissions (i.e., all phones must be in airplane mode when within the second train car). In other words, the first train car may be a safe zone for making phone calls and the second train car may be a quiet zone. When a registered user carrying a smartphone configured to operate as a proximity broadcast receiver walks within proximity of the first wireless identity transmitter, the proximity broadcast receiver may receive a first broadcast message from the first wireless identity transmitter, transmit a first sighting message to a central server, and receive a first return message from the central server that includes a first script with a routine for configuring the smartphone to operate normally (i.e., various radios are activated or enabled). When the user walks with the smartphone into the second train car, the smartphone may receive a second broadcast message from the second wireless identity transmitter, transmit a second sighting message to a central server, and receive a second return message from the central server that includes a second script with a routine for configuring the smartphone to operate in an airplane mode (i.e., various radios are deactivated or disabled). The second script may also include commands for the smartphone to periodically disable the airplane mode in order to receive subsequent broadcast messages from wireless identity transmitters and/or query the central server for subsequent scripts.

A security agent carrying a proximity broadcast receiver may be registered with the central server and may also be on the train. The security agent's profile stored within the central server may indicate that because he/she is a security agent, the central server may never transmit a script that includes instructions that disable the communication functions of the security agent's proximity broadcast receiver. Thus, when the security agent walks with his proximity broadcast receiver within proximity of the second wireless identity transmitter in the second train car, the proximity broadcast receiver may receive a broadcast message from the second wireless identity transmitter, transmit a sighting message to the central server, and receive a return message from the central server that does not include a script with a routine for configuring the security agent's proximity broadcast receiver to operate in an airplane mode.

FIG. 35A illustrates components of an exemplary wireless identity transmitter 110. The wireless identity transmitter 110 may include a microcontroller 3502, a short-range radio 3504 (e.g., a Bluetooth® radio or transceiver) coupled to an antenna 3506, a memory 3508, and a battery 3510. Although these components are shown linked by a common connection, they may be interconnected and configured in various ways. For example, a wireless identity transmitter 110 may be configured such that the microcontroller 3502 may determine when to transmit a message based on the contents of the memory 3508. In an embodiment, the microcontroller 3502 may be a Bluetooth® system-on-chip unit. The memory 3508 may also include one or more messages or message portions to be transmitted by the short-range radio 3504 via the antenna 3506 based on commands from the microcontroller 3502. The battery 3510 may supply power as needed by the other components. Also, in some implementations the microcontroller 3502, the short-range radio 3504 and/or the memory 3508 may be integrated together as a single integrated circuit. Since these components may be microchips of standard or off-the-shelf configuration, they are represented in FIG. 35A as blocks consistent with the structure of an example embodiment.

The wireless identity transmitter 110 may be coupled with or built into various objects, such as a bracelet. For example, an exemplary wireless identity transmitter 110 may be in a form easily attached to a strap, such as a watchband or dog collar. Alternate embodiments may incorporate a wireless identity transmitter 110 into any other mobile objects that may need tracking.

The wireless identity transmitter 110 may conserve power by periodically entering a power saving mode or going to sleep, such as regularly alternating between sleeping and broadcasting of the packet with the wireless identity transmitter 110's identification code. Various embodiments may include different cycles of broadcasting and sleeping, such as some embodiments broadcasting more or less frequently, such as waking and broadcasting every few seconds or minutes between periods of sleep.

In an embodiment, the battery 3510 may be a replaceable coin cell battery. In another embodiment, the wireless identity transmitter 110 may utilize the antenna 3506 to receive update software, instructions, or other data for storage and use in configuration operations, such as configuring transmission intervals and/or transmissions power. The wireless identity transmitter 110 may also store and execute software, algorithms, instructions, code, or other routines for generating rolling codes or identifiers, as described above. In an embodiment, the wireless identity transmitter may not maintain time (e.g., UTC) information, but may instead use a 30 ppm 16 kHz crystal as a clock. Such use of a crystal as a clock may create a timing drift of approximately 40 seconds per year.

FIG. 35B illustrates components of an embodiment wireless identity transmitter 110. Similar to the embodiment described above with reference to FIG. 35A, the wireless identity transmitter 110 may include a microcontroller 3502, a short-range radio 3504 (e.g., Bluetooth®, BTLE, Zigbee®, Peanut®, etc.) connected to an antenna 3506 and coupled to the microcontroller 3502, memory 3508, and a battery unit 3510. Alternatively the memory 3508 may be contained within the microcontroller 3502, which may also include a separate processing unit. The short-range radio 3504 may be a transmitter capable of broadcasting messages or signals including a device ID or, alternatively, a transceiver configured to transmit and receive RF signals, enabling communications with other devices utilizing a communication protocol. For example, the wireless identity transmitter 110 may be configured to communicate with other short-range radio enabled devices, such as smartphones. In an embodiment, the short-range radio 3504 may be configured to communicate via various low-energy, wireless communication protocols, such as LTE-D, peer-to-peer LTE-D, and WiFi-Direct.

In an embodiment, the wireless identity transmitter 110 may include a speaker (not shown) configured to emit a sound capable of being received by a proximity broadcast receiver and/or being heard by a heard by a user. For example, the wireless identity transmitter 110 may emit audible communications that may indicate its presence to listening proximity broadcast receivers. In another embodiment, the wireless identity transmitter 110 may be configured to transmit signals at varying signal strengths, thereby varying the range at which broadcasts from the wireless identity transmitter 110 may be received by proximity broadcast receivers.

Additionally, the wireless identity transmitter 110 may include one or more sensors for measuring various conditions and variables. In an embodiment, the wireless identity transmitter 110 may include an accelerometer 3515 (or any other motion sensor such as a gyroscope or gravitometer), which may collect data indicative of motion of an asset associated with the wireless identity transmitter 110. For example, the accelerometer 3515 may generate motion data describing the movements of a child carrying the wireless identity transmitter 110. Other sensors that may be included within the wireless identity transmitter 110 include a temperature sensor 3516 (such as a thermistor), a radiation sensor 3517, a humidity sensor 3518, and a carbon dioxide (CO₂) sensor 3519. In the various embodiments, the wireless identity transmitter 110 may include any combination of these and other sensors. These potential sensors are only examples of the types of sensors that may be integrated into wireless identity transmitters 110 and other types of sensors may be included. For example, the wireless identity transmitter 110 may also include sensors not shown in the various diagrams, such as a microphone, a camera, a heat sensor, a pressure sensor, and a light sensor.

FIG. 36A illustrates primary components of an exemplary proximity broadcast receiver embodiment. The proximity broadcast receiver 142 may include a short-range radio 3604 (e.g., a Bluetooth radio or transceiver) capable of communicating with a short-range wireless radio (e.g., a Bluetooth® radio within a wireless identity transmitter) coupled to an antenna 3606, and a secondary network device 3608 capable of communicating directly or indirectly back to a central server via a network, such as the Internet. In some embodiments, the secondary network device 3608 may be a cellular or wireless radio or a modem or other wired network device. The proximity broadcast receiver 142 may also include a processor 3602, a memory 3612, and a battery 3610 either as the primary power supply or as a backup power supply in the case of proximity broadcast receiver 142 coupled to utility power. The proximity broadcast receiver 142 may include a GPS receiver 3614 or other type of location determining mechanism for determining a current location to associate with any message received from a wireless identity transmitter. If the proximity broadcast receiver is not mobile, it may not include a GPS receiver 3614 in some embodiments since the location may be known and constant. Although these components are shown linked by a common connection, they may interconnected and configured in various ways. Since these components may be microchips of standard or off-the-shelf configuration, they are represented in FIG. 36A as blocks consistent with the structure of an example embodiment.

FIG. 36B illustrates an embodiment proximity broadcast receiver 3675 that can be plugged into a power outlet. Similar to the embodiment described above with reference to FIG. 36A, the proximity broadcast receiver 3675 may include a processor 3602, a memory unit 3612, and a short-range radio 3604 (e.g., Bluetooth®, Bluetooth® LE, LTE-D, peer-to-peer LTE-D, Zigbee®, Peanut®, etc.) connected to an antenna 3606. The proximity broadcast receiver 3675 may also include a WiFi system-on-chip 3678 (referred to as “SOC” in FIG. 36B) coupled to a second antenna 3676. In another embodiment, the system-on-chip 3678 may be a Bluetooth® Low Energy system-on-chip. The proximity broadcast receiver 3675 may utilize the system-on-chip 3678 to exchange data over a wireless local area network, such as by communicating with a WiFi router. Additionally, the proximity broadcast receiver 3675 may include a plug 3682 for interfacing with a power supply or otherwise receiving power, such as alternating current power (or “AC”). In various embodiments, the plug 3682 may be configured to connect with different power outlets standards (e.g., British Standards, National Electrical Manufacturers Association, etc.), and may include a grounding element (not shown). The plug 3682 may be coupled to a USB Power supply 3680 that provides power to the various components of the proximity broadcast receiver 3675, such as the processor 3602. In an alternative embodiment, the proximity broadcast receiver 3675 may recharge an internal battery (not shown) using power received from the plug 3682 and/or USB power supply 3680.

In an embodiment, the proximity broadcast receiver 3675 may store software instructions, such as within the memory 3612 or other circuitry that may be utilized by the processor 3602 and/or the system-on-chip 3678 to perform operations to transmit and/or receive short-range and long-range signals, respectively. In an embodiment, the proximity broadcast receiver 3675 may utilize the antennas 3606, 3676 to receive update software, instructions, or other data for storage and use in updating firmware, modifying operating parameters, and other configuration modifications.

FIG. 37 is a system block diagram of a smartphone type mobile device suitable for use with various embodiments. A smartphone 3700 may include a processor 3701 coupled to internal memory 3702, a display 3703, and to a speaker 3754. Additionally, the smartphone 3700 may include an antenna 3704 for sending and receiving electromagnetic radiation that may be connected to a wireless data link and/or cell telephone transceiver 3705 coupled to the processor 3701 and capable of communicating over a wide area wireless communication network. Smartphones may include a separate short-range radio transceiver 3724 capable of communicating or pairing with wireless identity transmitters. Smartphones 3700 typically may also include menu selection buttons or rocker switches 3708 for receiving user inputs.

FIG. 38 is a system block diagram of a server 3800 suitable for implementing the various embodiments of this disclosure. The server 3800 may be a commercially available server device. Such a server 3800 typically includes a processor 3801 coupled to volatile memory 3802 and a large capacity nonvolatile memory, such as a disk drive 3803. The server 3800 may also include a floppy disc drive, compact disc (CD) or DVD disc drive 3806 coupled to the processor 3801. The server 3800 may also include network access ports 3804 coupled to the processor 3801 for establishing data connections with a network 3805, such as a local area network coupled to other broadcast system computers and servers.

The processors 3701, 3801 may be any programmable microprocessor, microcomputer or multiple processor chip or chips that can be configured by software instructions (applications) to perform a variety of functions, including the functions of the various embodiments described below. In some mobile proximity broadcast receivers, multiple processors 3701 may be provided, such as one processor dedicated to wireless communication functions and one processor dedicated to running other applications. Typically, software applications may be stored in the internal memory 3702, 3802 before they are accessed and loaded into the processor 3701, 3801. The processor 3701, 3801 may include internal memory sufficient to store the application software instructions.

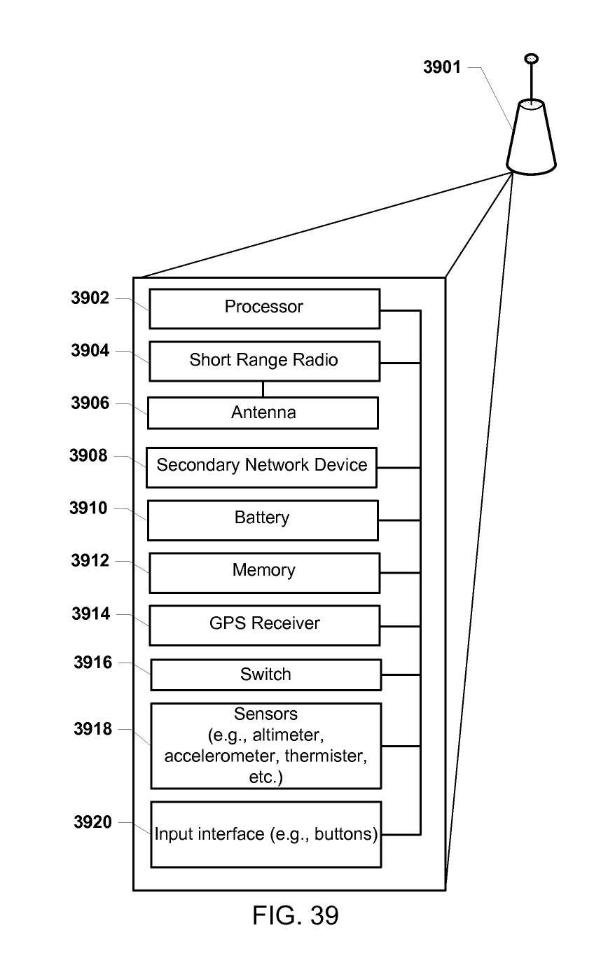

FIG. 39 illustrates primary components of an exemplary signaling transmitter embodiment. The signaling transmitter 3901 may include a short-range radio 3904 capable of communicating with a short-range wireless radio (e.g., a Bluetooth® radio) coupled to an antenna 3906. In various embodiments, the short-range radio 3904 may be used to broadcast disable wireless signals and enable wireless signals. The signaling transmitter 3901 may also include a secondary network device 3908 capable of communicating directly or indirectly back to a central server via a network, such as the Internet. In some embodiments, the secondary network device 3908 may be a cellular or wireless radio or a modem or other wired network device. The signaling transmitter 3901 may also include a processor 3902, a memory 3912, and a battery 3910 either as the primary power supply or as a backup power supply in the case of signaling transmitter 3901 coupled to utility power. The signaling transmitter 3901 may include a GPS receiver 3914 or other type of location determining mechanism for determining a current location to associate with any message received from a wireless identity transmitter. If the signaling transmitter 3901 is not mobile, it may not include a GPS receiver 3914 in some embodiments since the location may be known and constant. In an embodiment, the signaling transmitter 3901 may also include a switch 3916 that may be utilized to provide the processor 3902 with input data, such as indicators of triggering events. Embodiment switches are described above with reference to FIG. 26B. Further, the signaling transmitter 3901 may include various sensors 3918, such as accelerometer sensors, altimeter sensors, pressure sensors, and thermister sensors. The signaling transmitter 3901 may also include various input interfaces 3920, such as buttons that may be depressed by users in order to provide input data to the processor 3902. Although these components are shown linked by a common connection, they may interconnected and configured in various ways. Since these components may be microchips of standard or off-the-shelf configuration, they are represented in FIG. 39 as blocks consistent with the structure of an example embodiment. In various embodiments, the signaling transmitter 3901 may function as a proximity broadcast receiver and vice versa, as described above.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of configuring a wireless identity transmitter to operate in an acceptable manner based on its location, comprising:
receiving a disable wireless signal via a receiver circuit;
disabling a transmitter of the wireless identity transmitter when the disable wireless signal is received;
receiving an enable wireless signal via the receiver circuit;
re-enabling the transmitter of the wireless identity transmitter in response to receiving the enable wireless signal; and
periodically transmitting, via the transmitter when the transmitter is enabled, a broadcast message that includes a rolling identifier of the wireless identity transmitter, wherein the rolling identifier is generated via an algorithm and information shared with a server.

2. The method of claim 1, further comprising:
transmitting a deactivating signal in response to receiving the disable wireless signal; and
transmitting a reactivated signal in response to the transmitter being re-enabled,
wherein disabling a transmitter of the wireless identity transmitter when the disable wireless signal is received comprises disabling the transmitter of the wireless identity transmitter when the disable wireless signal is received and after the deactivating signal is transmitted.

3. The method of claim 2, wherein the deactivating signal is configured to be received by at least one of a proximity broadcast receiver and a deactivation signaling transmitter, and wherein the reactivated signal is configured to be received by at least one of the proximity broadcast receiver and an activation signaling transmitter.

4. The method of claim 1, further comprising:
broadcasting the received disable wireless signal during a first propagation period in response to receiving the disable wireless signal and before disabling the transmitter; and
broadcasting the received enable wireless signal during a second propagation period in response to receiving the enable wireless signal.

5. The method of claim 1, wherein receiving a disable wireless signal comprises monitoring the receiver circuit for the disable wireless signal only when the transmitter of the wireless identity transmitter is enabled.

6. The method of claim 1, wherein receiving an enable wireless signal comprises monitoring the receiver circuit for the enable wireless signal only when the transmitter of the wireless identity transmitter is disabled.

7. The method of claim 1, wherein the disable wireless signal is transmitted by a deactivation signaling transmitter, and the enable wireless signal is transmitted by an activation signaling transmitter.

8. The method of claim 7, wherein the deactivation signaling transmitter is positioned within an aircraft, and the activation signaling transmitter is positioned within the aircraft.

9. The method of claim 7, wherein the deactivation signaling transmitter is positioned within an airport, and the activation signaling transmitter is positioned within the airport.

10. A method for controlling operations on a mobile device, comprising:
receiving a short-range wireless broadcast message including a rolling identifier of a wireless identity transmitter within proximity;
determining whether the identifier of the wireless identity transmitter is associated with a stored first script;
performing commands of the stored first script when the identifier is associated with the stored first script;
transmitting a sighting message via long-range communications to a server in response to the received broadcast message, wherein the sighting message includes the rolling identifier of the wireless identity transmitter and associated data, wherein the associated data includes at least one of identification information corresponding to a proximity broadcast receiver, location information, and timestamp data;
receiving a return message from the server that includes a second script that is relevant to the identifier of the wireless identity transmitter and that is customized for the proximity broadcast receiver; and
performing commands of the second script.

11. The method of claim 10, further comprising storing pre-fetched scripts and associated identifiers received from the server.

12. The method of claim 10, further comprising storing the second script in association with the identifier of the wireless identity transmitter.

13. The method of claim 10, further comprising configuring an operational mode based on performing commands of at least one of the first script and the second script, wherein the operational mode includes at least one of an airplane mode, a silent mode, and a vibrate mode.

14. A method for generating scripts for execution by proximity broadcast receivers, comprising:
receiving a sighting message including a rolling identifier and associated data, wherein the associated data includes at least one of identification information corresponding to a proximity broadcast receiver, location information, and timestamp data;
determining whether a wireless identity transmitter is known based on whether the rolling identifier matches information calculated using an algorithm and information shared with the wireless identity transmitter;
identifying a first profile stored within a server that is associated with the wireless identity transmitter when the wireless identity transmitter is known;
determining whether the proximity broadcast receiver is known based on the sighting message;
identifying a second profile stored within the server that is associated with the proximity broadcast receiver when the proximity broadcast receiver is known;
determining conditions associated with the wireless identity transmitter based on the first profile and the sighting message;
generating a script to be executed by the proximity broadcast receiver based on the second profile and the determined conditions related to the first profile, wherein the script includes at least one of commands, actions, routines, and instructions;
generating a return message including the generated script; and
transmitting the return message to the proximity broadcast receiver.

15. The method of claim 14, further comprising:
determining identifiers of wireless identity transmitters that registered proximity broadcast receivers are likely to encounter over a period;
generating scripts based on profiles associated with the determined identifiers and profiles associated with the registered proximity broadcast receivers; and
transmitting the generated scripts and the determined identifiers to the registered proximity broadcast receivers.

16. The method of claim 14, further comprising appending identification information to the return message when authorized by the first profile, wherein the first profile includes at least one of privacy settings and preferences that authorize a transmission of the identification information.

17. The method of claim 14, wherein the determined conditions include at least one of characteristics of a place nearby, an indication of a state related to the place, and a recommendation for a behavior of the proximity broadcast receiver,
wherein the state indicates at least one of whether an aircraft has landed, whether the aircraft has taken off, whether the aircraft has a certain estimated time of arrival, whether the aircraft has a certain estimated time of departure, whether a show in a theater is active, and whether the show in the theater is currently in intermission, and
wherein the recommendation includes at least one of a suggested ringer setting, a suggested wireless signaling setting, and a suggested power saving setting.

18. A wireless identity transmitter configured to operate in an acceptable manner based on its location, comprising:
means for receiving a disable wireless signal via a receiver circuit;
means for disabling a transmitter of the wireless identity transmitter when the disable wireless signal is received;
means for receiving an enable wireless signal via the receiver circuit;
means for re-enabling the transmitter of the wireless identity transmitter in response to receiving the enable wireless signal; and
means for periodically transmitting, via the transmitter when the transmitter is enabled, a broadcast message that includes a rolling identifier of the wireless identity transmitter, wherein the rolling identifier is generated via an algorithm and information shared with a server.

19. The wireless identity transmitter of claim 18, further comprising:
means for transmitting a deactivating signal in response to receiving the disable wireless signal; and
means for transmitting a reactivated signal in response to the transmitter being re-enabled,
wherein means for disabling a transmitter of the wireless identity transmitter when the disable wireless signal is received comprises means for disabling the transmitter of the wireless identity transmitter when the disable wireless signal is received and after the deactivating signal is transmitted.

20. The wireless identity transmitter of claim 19, wherein the deactivating signal is configured to be received by at least one of a proximity broadcast receiver and a deactivation signaling transmitter, and wherein the reactivated signal is configured to be received by at least one of the proximity broadcast receiver and an activation signaling transmitter.

21. The wireless identity transmitter of claim 18, further comprising:
means for broadcasting the received disable wireless signal during a first propagation period in response to receiving the disable wireless signal and before disabling the transmitter; and
means for broadcasting the received enable wireless signal during a second propagation period in response to receiving the enable wireless signal.

22. The wireless identity transmitter of claim 18, wherein means for receiving a disable wireless signal comprises means for monitoring the receiver circuit for the disable wireless signal only when the transmitter of the wireless identity transmitter is enabled.

23. The wireless identity transmitter of claim 18, wherein means for receiving an enable wireless signal comprises means for monitoring the receiver circuit for the enable wireless signal only when the transmitter of the wireless identity transmitter is disabled.

24. The wireless identity transmitter of claim 18, wherein the disable wireless signal is transmitted by a deactivation signaling transmitter, and the enable wireless signal is transmitted by an activation signaling transmitter.

25. The wireless identity transmitter of claim 24, wherein the deactivation signaling transmitter is positioned within an aircraft, and the activation signaling transmitter is positioned within the aircraft.

26. The wireless identity transmitter of claim 24, wherein the deactivation signaling transmitter is positioned within an airport, and the activation signaling transmitter is positioned within the airport.

27. A proximity broadcast receiver configured to perform operations customized by a server based on stored profiles, comprising:
means for receiving a short-range wireless broadcast message including a rolling identifier of a wireless identity transmitter within proximity;
means for determining whether the identifier of the wireless identity transmitter is associated with a stored first script;
means for performing commands of the stored first script when the identifier is associated with the stored first script;
means for transmitting a sighting message via long-range communications to the server in response to the received broadcast message, wherein the sighting message includes the rolling identifier of the wireless identity transmitter and associated data, wherein the associated data includes at least one of identification information corresponding to the proximity broadcast receiver, location information, and timestamp data;
means for receiving a return message from the server that includes a second script that is relevant to the identifier of the wireless identity transmitter and that is customized for the proximity broadcast receiver; and
means for performing commands of the second script.

28. The proximity broadcast receiver claim 27, further comprising means for storing pre-fetched scripts and associated identifiers received from the server.

29. The proximity broadcast receiver claim 27, further comprising means for storing the second script in association with the identifier of the wireless identity transmitter.

30. The proximity broadcast receiver claim 27, further comprising means for configuring an operational mode based on performing commands of at least one of the first script and the second script, wherein the operational mode includes at least one of an airplane mode, a silent mode, and a vibrate mode.

31. A server configured to generate scripts for execution by proximity broadcast receivers, comprising:
means for receiving a sighting message including a rolling identifier and associated data, wherein the associated data includes at least one of identification information corresponding to a proximity broadcast receiver, location information, and timestamp data;
means for determining whether a wireless identity transmitter is known based on whether the rolling identifier matches information calculated using an algorithm and information shared with the wireless identity transmitter;
means for identifying a first profile stored within the server that is associated with the wireless identity transmitter when the wireless identity transmitter is known;
means for determining whether the proximity broadcast receiver is known based on the sighting message;
means for identifying a second profile stored within the server that is associated with the proximity broadcast receiver when the proximity broadcast receiver is known;
means for determining conditions associated with the wireless identity transmitter based on the first profile and the sighting message;
means for generating a script to be executed by the proximity broadcast receiver based on the second profile and the determined conditions related to the first profile, wherein the script includes at least one of commands, actions, routines, and instructions;
means for generating a return message including the generated script; and
means for transmitting the return message to the proximity broadcast receiver.

32. The server of claim 31, further comprising:
means for determining identifiers of wireless identity transmitters that registered proximity broadcast receivers are likely to encounter over a period;
means for generating scripts based on profiles associated with the determined identifiers and profiles associated with the registered proximity broadcast receivers; and
means for transmitting the generated scripts and the determined identifiers to the registered proximity broadcast receivers.

33. The server of claim 31, further comprising means for appending identification information to the return message when authorized by the first profile, wherein the first profile includes at least one of privacy settings and preferences that authorize a transmission of the identification information.

34. The server of claim 31, wherein the determined conditions include at least one of characteristics of a place nearby, an indication of a state related to the place, and a recommendation for a behavior of the proximity broadcast receiver,
wherein the state indicates at least one of whether an aircraft has landed, whether the aircraft has taken off, whether the aircraft has a certain estimated time of arrival, whether the aircraft has a certain estimated time of departure, whether a show in a theater is active, and whether the show in the theater is currently in intermission, and
wherein the recommendation includes at least one of a suggested ringer setting, a suggested wireless signaling setting, and a suggested power saving setting.

35. A wireless identity transmitter configured to operate in an acceptable manner based on its location, comprising:
a memory; and
a processor coupled to the memory, wherein the processor is configured with processor-executable instructions to perform operations comprising:
receiving a disable wireless signal via a receiver circuit;
disabling a transmitter of the wireless identity transmitter when the disable wireless signal is received;
receiving an enable wireless signal via the receiver circuit;
re-enabling the transmitter of the wireless identity transmitter in response to receiving the enable wireless signal; and
periodically transmitting, via the transmitter when the transmitter is enabled, a broadcast message that includes a rolling identifier of the wireless identity transmitter, wherein the rolling identifier is generated via an algorithm and information shared with a server.

36. The wireless identity transmitter of claim 35, wherein the processor is configured with processor-executable instructions to perform operations further comprising:
transmitting a deactivating signal in response to receiving the disable wireless signal; and
transmitting a reactivated signal in response to the transmitter being re-enabled,
wherein the processor is configured with processor-executable instructions to perform operations such that disabling a transmitter of the wireless identity transmitter when the disable wireless signal is received comprises disabling the transmitter of the wireless identity transmitter when the disable wireless signal is received and after the deactivating signal is transmitted.

37. The wireless identity transmitter of claim 36, wherein the deactivating signal is configured to be received by at least one of a proximity broadcast receiver and a deactivation signaling transmitter, and wherein the reactivated signal is configured to be received by at least one of the proximity broadcast receiver and an activation signaling transmitter.

38. The wireless identity transmitter of claim 35, wherein the processor is configured with processor-executable instructions to perform operations further comprising:
broadcasting the received disable wireless signal during a first propagation period in response to receiving the disable wireless signal and before disabling the transmitter; and
broadcasting the received enable wireless signal during a second propagation period in response to receiving the enable wireless signal.

39. The wireless identity transmitter of claim 35, wherein the processor is configured with processor-executable instructions to perform operations such that receiving a disable wireless signal comprises monitoring the receiver circuit for the disable wireless signal only when the transmitter of the wireless identity transmitter is enabled.

40. The wireless identity transmitter of claim 35, wherein the processor is configured with processor-executable instructions to perform operations such that receiving an enable wireless signal comprises monitoring the receiver circuit for the enable wireless signal only when the transmitter of the wireless identity transmitter is disabled.

41. The wireless identity transmitter of claim 35, wherein the disable wireless signal is transmitted by a deactivation signaling transmitter, and the enable wireless signal is transmitted by an activation signaling transmitter.

42. The wireless identity transmitter of claim 41, wherein the deactivation signaling transmitter is positioned within an aircraft, and the activation signaling transmitter is positioned within the aircraft.

43. The wireless identity transmitter of claim 41, wherein the deactivation signaling transmitter is positioned within an airport, and the activation signaling transmitter is positioned within the airport.

44. A proximity broadcast receiver configured to perform operations customized by a server based on stored profiles, comprising:
a memory; and
a processor coupled to the memory, wherein the processor is configured with processor-executable instructions to perform operations comprising:
receiving a short-range wireless broadcast message including a rolling identifier of a wireless identity transmitter within proximity;
determining whether the identifier of the wireless identity transmitter is associated with a stored first script;
performing commands of the stored first script when the identifier is associated with the stored first script;
transmitting a sighting message via long-range communications to the server in response to the received broadcast message, wherein the sighting message includes the rolling identifier of the wireless identity transmitter and associated data, wherein the associated data includes at least one of identification information corresponding to the proximity broadcast receiver, location information, and timestamp data;
receiving a return message from the server that includes a second script that is relevant to the identifier of the wireless identity transmitter and that is customized for the proximity broadcast receiver; and
performing commands of the second script.

45. The proximity broadcast receiver claim 44, wherein the processor is configured with processor-executable instructions to perform operations further comprising storing pre-fetched scripts and associated identifiers received from the server.

46. The proximity broadcast receiver claim 44, wherein the processor is configured with processor-executable instructions to perform operations further comprising storing the second script in association with the identifier of the wireless identity transmitter.

47. The proximity broadcast receiver claim 44, wherein the processor is configured with processor-executable instructions to perform operations further comprising configuring an operational mode based on performing commands of at least one of the first script and the second script, wherein the operational mode includes at least one of an airplane mode, a silent mode, and a vibrate mode.

48. A server configured to generate scripts for execution by proximity broadcast receivers, comprising:
a server processor configured with server-executable instructions to perform operations comprising:
receiving a sighting message including a rolling identifier and associated data, wherein the associated data includes at least one of identification information corresponding to a proximity broadcast receiver, location information, and timestamp data;
determining whether a wireless identity transmitter is known based on whether the rolling identifier matches information calculated using an algorithm and information shared with the wireless identity transmitter;
identifying a first profile stored within the server that is associated with the wireless identity transmitter when the wireless identity transmitter is known;
determining whether the proximity broadcast receiver is known based on the sighting message;
identifying a second profile stored within the server that is associated with the proximity broadcast receiver when the proximity broadcast receiver is known;
determining conditions associated with the wireless identity transmitter based on the first profile and the sighting message;
generating a script to be executed by the proximity broadcast receiver based on the second profile and the determined conditions related to the first profile, wherein the script includes at least one of commands, actions, routines, and instructions;
generating a return message including the generated script; and
transmitting the return message to the proximity broadcast receiver.

49. The server of claim 48, wherein the server processor is configured with server executable instructions to perform operations further comprising:
determining identifiers of wireless identity transmitters that registered proximity broadcast receivers are likely to encounter over a period;
generating scripts based on profiles associated with the determined identifiers and profiles associated with the registered proximity broadcast receivers; and
transmitting the generated scripts and the determined identifiers to the registered proximity broadcast receivers.

50. The server of claim 48, wherein the server processor is configured with server executable instructions to perform operations further comprising appending identification information to the return message when authorized by the first profile, wherein the first profile includes at least one of privacy settings and preferences that authorize a transmission of the identification information.

51. The server of claim 48, wherein the determined conditions include at least one of characteristics of a place nearby, an indication of a state related to the place, and a recommendation for a behavior of the proximity broadcast receiver,
wherein the state indicates at least one of whether an aircraft has landed, whether the aircraft has taken off, whether the aircraft has a certain estimated time of arrival, whether the aircraft has a certain estimated time of departure, whether a show in a theater is active, and whether the show in the theater is currently in intermission, and
wherein the recommendation includes at least one of a suggested ringer setting, a suggested wireless signaling setting, and a suggested power saving setting.

52. A non-transitory processor-readable storage medium having stored thereon processor-executable software instructions configured to cause a processor to perform operations for configuring a wireless identity transmitter to operate in an acceptable manner based on its location, the operations comprising:
receiving a disable wireless signal via a receiver circuit;
disabling a transmitter of the wireless identity transmitter when the disable wireless signal is received;
receiving an enable wireless signal via the receiver circuit;
re-enabling the transmitter of the wireless identity transmitter in response to receiving the enable wireless signal; and
periodically transmitting, via the transmitter when the transmitter is enabled, a broadcast message that includes a rolling identifier of the wireless identity transmitter, wherein the rolling identifier is generated via an algorithm and information shared with a server.

53. The non-transitory processor-readable storage medium of claim 52, wherein the stored processor-executable software instructions are configured to cause the processor to perform operations further comprising:
transmitting a deactivating signal in response to receiving the disable wireless signal; and
transmitting a reactivated signal in response to the transmitter being re-enabled,
wherein the stored processor-executable software instructions are configured to cause the processor to perform operations such that disabling a transmitter of the wireless identity transmitter when the disable wireless signal is received comprises disabling the transmitter of the wireless identity transmitter when the disable wireless signal is received and after the deactivating signal is transmitted.

54. The non-transitory processor-readable storage medium of claim 53, wherein the deactivating signal is configured to be received by at least one of a proximity broadcast receiver and a deactivation signaling transmitter, and wherein the reactivated signal is configured to be received by at least one of the proximity broadcast receiver and an activation signaling transmitter.

55. The non-transitory processor-readable storage medium of claim 52, wherein the stored processor-executable software instructions are configured to cause the processor to perform operations further comprising:
broadcasting the received disable wireless signal during a first propagation period in response to receiving the disable wireless signal and before disabling the transmitter; and
broadcasting the received enable wireless signal during a second propagation period in response to receiving the enable wireless signal.

56. The non-transitory processor-readable storage medium of claim 52, wherein the stored processor-executable software instructions are configured to cause the processor to perform operations such that receiving a disable wireless signal comprises monitoring the receiver circuit for the disable wireless signal only when the transmitter of the wireless identity transmitter is enabled.

57. The non-transitory processor-readable storage medium of claim 52, wherein the stored processor-executable software instructions are configured to cause the processor to perform operations such that receiving an enable wireless signal comprises monitoring the receiver circuit for the enable wireless signal only when the transmitter of the wireless identity transmitter is disabled.

58. The non-transitory processor-readable storage medium of claim 52, wherein the disable wireless signal is transmitted by a deactivation signaling transmitter, and the enable wireless signal is transmitted by an activation signaling transmitter.

59. The non-transitory processor-readable storage medium of claim 58, wherein the deactivation signaling transmitter is positioned within an aircraft, and the activation signaling transmitter is positioned within the aircraft.

60. The non-transitory processor-readable storage medium of claim 58, wherein the deactivation signaling transmitter is positioned within an airport, and the activation signaling transmitter is positioned within the airport.

61. A non-transitory processor-readable storage medium having stored thereon processor-executable software instructions configured to cause a processor to perform operations for a proximity broadcast receiver to perform operations customized by a server based on stored profiles, comprising:
receiving a short-range wireless broadcast message including a rolling identifier of a wireless identity transmitter within proximity;
determining whether the identifier of the wireless identity transmitter is associated with a stored first script;
performing commands of the stored first script when the identifier is associated with the stored first script;
transmitting a sighting message via long-range communications to the server in response to the received broadcast message, wherein the sighting message includes the rolling identifier of the wireless identity transmitter and associated data, wherein the associated data includes at least one of identification information corresponding to the proximity broadcast receiver, location information, and timestamp data;
receiving a return message from the server that includes a second script that is relevant to the identifier of the wireless identity transmitter and that is customized for the proximity broadcast receiver; and
performing commands of the second script.

62. The non-transitory processor-readable storage medium of claim 61, wherein the stored processor-executable software instructions are configured to cause the processor to perform operations further comprising storing pre-fetched scripts and associated identifiers received from the server.

63. The non-transitory processor-readable storage medium of claim 61, wherein the stored processor-executable software instructions are configured to cause the processor to perform operations further comprising storing the second script in association with the identifier of the wireless identity transmitter.

64. The non-transitory processor-readable storage medium of claim 61, wherein the stored processor-executable software instructions are configured to cause the processor to perform operations s further comprising configuring an operational mode based on performing commands of at least one of the first script and the second script, wherein the operational mode includes at least one of an airplane mode, a silent mode, and a vibrate mode.

65. A non-transitory server-readable storage medium having stored thereon server-executable instructions configured to cause a server to perform operations to generate scripts for execution by proximity broadcast receivers, the operations comprising:
receiving a sighting message including a rolling identifier and associated data, wherein the associated data includes at least one of identification information corresponding to a proximity broadcast receiver, location information, and timestamp data;
determining whether a wireless identity transmitter is known based on whether the rolling identifier matches information calculated using an algorithm and information shared with the wireless identity transmitter;
identifying a first profile stored within the server that is associated with the wireless identity transmitter when the wireless identity transmitter is known;
determining whether the proximity broadcast receiver is known based on the sighting message;
identifying a second profile stored within the server that is associated with the proximity broadcast receiver when the proximity broadcast receiver is known;
determining conditions associated with the wireless identity transmitter based on the first profile and the sighting message;
generating a script to be executed by the proximity broadcast receiver based on the second profile and the determined conditions related to the first profile, wherein the script includes at least one of commands, actions, routines, and instructions;
generating a return message including the generated script; and
transmitting the return message to the proximity broadcast receiver.

66. The non-transitory server-readable storage medium of claim 65, wherein the stored server-executable instructions are configured to cause the server to perform operations further comprising:
determining identifiers of wireless identity transmitters that registered proximity broadcast receivers are likely to encounter over a period;
generating scripts based on profiles associated with the determined identifiers and profiles associated with the registered proximity broadcast receivers; and
transmitting the generated scripts and the determined identifiers to the registered proximity broadcast receivers.

67. The non-transitory server-readable storage medium of claim 65, wherein the stored server-executable instructions are configured to cause the server to perform operations further comprising appending identification information to the return message when authorized by the first profile, wherein the first profile includes at least one of privacy settings and preferences that authorize a transmission of the identification information.

68. The non-transitory server-readable storage medium of claim 65, wherein the determined conditions include at least one of characteristics of a place nearby, an indication of a state related to the place, and a recommendation for a behavior of the proximity broadcast receiver,
wherein the state indicates at least one of whether an aircraft has landed, whether the aircraft has taken off, whether the aircraft has a certain estimated time of arrival, whether the aircraft has a certain estimated time of departure, whether a show in a theater is active, and whether the show in the theater is currently in intermission, and
wherein the recommendation includes at least one of a suggested ringer setting, a suggested wireless signaling setting, and a suggested power saving setting.

69. A system, comprising:
a server;
a wireless identity transmitter;
a deactivation signaling transmitter positioned within proximity of where luggage passes during loading of the luggage on an aircraft; and
an activation signaling transmitter positioned within proximity of where the luggage passes during unloading of the luggage from the aircraft, and
wherein the wireless identity transmitter comprises:
a first memory;
a first transceiver using a transmitter circuitry configured to broadcast short-range wireless signals and a receiver circuit configured to receive incoming short-range wireless signals; and
a first processor coupled to the first memory and the first transceiver, and configured with processor-executable instructions to perform operations comprising:
receiving a disable wireless signal via the receiver circuit of the first transceiver;
disabling the transmitter circuitry of the first transceiver when the disable wireless signal is received;
receiving an enable wireless signal via the receiver circuit of the first transceiver;
re-enabling the transmitter circuitry of the first transceiver in response to receiving the enable wireless signal; and
periodically transmitting, via the first transceiver when the transmitter circuitry is enabled, a broadcast message that includes a rolling identifier of the wireless identity transmitter, wherein the rolling identifier is generated via an algorithm and information shared with the server,
wherein the deactivation signaling transmitter comprises:
a second memory;
a second transceiver configured to exchange short-range wireless signals with the wireless identity transmitter;
a first network device configured to exchange signals with the server;
a second processor coupled to the second memory, the second transceiver, and the first network device and configured with processor-executable instructions to perform operations comprising:
transmitting the disable wireless signal via the second transceiver;
receiving via the second transceiver the broadcast message from the wireless identity transmitter; and
transmitting via the first network device a first sighting message from the deactivation signaling transmitter to the server that includes the rolling identifier of the wireless identity transmitter,
wherein the activation signaling transmitter comprises:
a third memory;
a third transceiver configured to exchange short-range wireless signals with the wireless identity transmitter;
a second network device configured to exchange signals with the server;
a third processor coupled to the third memory, the third transceiver, and the second network device and configured with processor-executable instructions to perform operations comprising:
transmitting the enable wireless signal via the third transceiver, and
wherein the server is configured with server-executable instructions to perform operations comprising:
receiving the first sighting message from the deactivation signaling transmitter;
determining, in the server, whether an identity associated with the wireless identity transmitter is known to the server based on the rolling identifier; and
transmitting a first message including proximity information of the wireless identity transmitter from the server to a mobile device associated with the wireless identity transmitter when the wireless identity transmitter is known.

70. The system of claim 69, wherein the activation signaling transmitter and the deactivation signaling transmitter are positioned within an airport.

71. The system of claim 69, wherein the activation signaling transmitter and the deactivation signaling transmitter are positioned within the aircraft.

72. The system of claim 71, wherein the deactivation signaling transmitter is configured to transmit the disable wireless signal before the aircraft takes off, and wherein the activation signaling transmitter is configured to transmit the enable wireless signal when the aircraft lands.

73. The system of claim 69, wherein the deactivation signaling transmitter and the activation signaling transmitter are the same signaling device.

74. The system of claim 69,
wherein the first processor is configured with processor-executable instructions to perform operations further comprising:
transmitting via the first transceiver a deactivating signal from the wireless identity transmitter in response to receiving the disable wireless signal and before disabling the transmitter circuitry of the first transceiver; and
transmitting via the first transceiver a reactivated signal from the wireless identity transmitter in response to the transmitter circuitry being re-enabled,
wherein the second processor is configured with processor-executable instructions to perform operations further comprising:
receiving via the second transceiver the deactivating signal in the deactivation signaling transmitter, and wherein the first sighting message indicates the received deactivating signal, and
wherein the third processor is configured with processor-executable instructions to perform operations further comprising:
receiving via the third transceiver the reactivated signal in the activation signaling transmitter; and
transmitting via the second network device to the server a second sighting message that indicates the received reactivated signal, and
wherein the server is configured with server-executable instructions to perform operations further comprising:
transmitting a second message including the proximity information of the wireless identity transmitter from the server to the mobile device associated with the wireless identity transmitter in response to receiving the second sighting message and when the wireless identity transmitter is known.

75. The system of claim 74, wherein the first message indicates that the wireless identity transmitter is being deactivated, and
wherein the second message indicates that the wireless identity transmitter has been reactivated.

76. A system, comprising:
a server;
a wireless identity transmitter;
a proximity broadcast receiver, and
wherein the wireless identity transmitter comprises:
a first memory;
a first transceiver using a transmitter circuitry configured to broadcast short-range wireless signals; and
a first processor coupled to the first memory and the first transceiver, and configured with processor-executable instructions to perform operations comprising:
periodically transmitting, via the first transceiver when the transmitter circuitry is enabled, a broadcast message that includes a rolling identifier of the wireless identity transmitter, wherein the rolling identifier is generated via an algorithm and information shared with the server,
wherein the proximity broadcast receiver comprises:
a second memory;
a second transceiver configured to receive short-range wireless signals with the wireless identity transmitter;
a first network device configured to exchange signals with the server;
a second processor coupled to the second memory, the second transceiver, and the first network device and configured with processor-executable instructions to perform operations comprising:
receiving the broadcast message including the rolling identifier of the wireless identity transmitter within proximity;
determining whether the identifier of the wireless identity transmitter is associated with a stored first script;
performing commands of the stored first script when the identifier is associated with the stored first script;
transmitting a sighting message to the server via the first network device in response to the received broadcast message, wherein the sighting message includes the rolling identifier of the wireless identity transmitter and associated data, wherein the associated data includes at least one of identification information corresponding to the proximity broadcast receiver, location information, and timestamp data;
receiving a return message from the server that includes a second script that is relevant to the identifier of the wireless identity transmitter and that is customized for the proximity broadcast receiver; and
performing commands of the second script, and
wherein the server is configured with server-executable instructions to perform operations comprising:
receiving the sighting message including the rolling identifier and the associated data;
determining whether the wireless identity transmitter is known based on whether the rolling identifier matches information calculated using the algorithm and the information shared with the wireless identity transmitter;
identifying a first profile stored within the server that is associated with the wireless identity transmitter when the wireless identity transmitter is known;
determining whether the proximity broadcast receiver is known based on the sighting message;
identifying a second profile stored within the server that is associated with the proximity broadcast receiver when the proximity broadcast receiver is known;
determining conditions associated with the wireless identity transmitter based on the first profile and the sighting message;
generating the second script based on the second profile and the determined conditions related to the first profile, wherein the second script includes at least one of commands, actions, routines, and instructions;
generating the return message including the generated script; and
transmitting the return message to the proximity broadcast receiver.

77. The system of claim 76, wherein the second processor is configured with processor-executable instructions to perform operations further comprising storing the second script in association with the identifier of the wireless identity transmitter.

78. The system of claim 76, wherein the second processor is configured with processor-executable instructions to perform operations further comprising configuring an operational mode based on performing commands of at least one of the first script and the second script, wherein the operational mode includes at least one of an airplane mode, a silent mode, and a vibrate mode.

79. The system of claim 76, wherein the server is configured with server-executable instructions to perform operations further comprising:
determining identifiers of wireless identity transmitters that the proximity broadcast receiver is likely to encounter over a period;
generating scripts based on profiles associated with the determined identifiers and the second profile associated with the proximity broadcast receiver; and
transmitting the generated scripts and the determined identifiers to the proximity broadcast receiver, and
the second processor is configured with processor-executable instructions to perform operations further comprising:
receiving from the server the scripts and the determined identifiers that the proximity broadcast receiver is likely to encounter over the period; and
storing the scripts and the determined identifiers that the proximity broadcast receiver is likely to encounter over the period.

80. The system of claim 76, wherein the server is configured with server-executable instructions to perform operations further comprising appending identification information to the return message when authorized by the first profile, wherein the first profile includes at least one of privacy settings and preferences that authorize a transmission of the identification information.

81. The system of claim 76, wherein the determined conditions include at least one of characteristics of a place nearby, an indication of a state related to the place, and a recommendation for a behavior of the proximity broadcast receiver,
wherein the state indicates at least one of whether an aircraft has landed, whether the aircraft has taken off, whether the aircraft has a certain estimated time of arrival, whether the aircraft has a certain estimated time of departure, whether a show in a theater is active, and whether the show in the theater is currently in intermission, and
wherein the recommendation includes at least one of a suggested ringer setting, a suggested wireless signaling setting, and a suggested power saving setting.
